(19) United States
(12) Patent Application Publication
(10) Pub. No.: US 2026/0227611 A1
(43) Pub. Date: Aug. 6, 2026

(54) VARIABLE MAGNIFICATION IMAGING OPTICAL SYSTEM

(71) Applicant: SIGMA CORPORATION, Kanagawa (JP)

(72) Inventor: Yasumoto OGINOME, Tokyo (JP)

(73) Assignee: SIGMA CORPORATION, Kanagawa (JP)

(21) Appl. No.: 19/453,528

(22) Filed: Jan. 20, 2026

(30) Foreign Application Priority Data
Feb. 6, 2025 (JP) 2025-018668
Nov. 10, 2025 (JP) 2025-189322

(51) Int. Cl. G02B 15/14

(52) U.S. Cl. CPC G02B 15/1461

(57) ABSTRACT

A variable magnification imaging optical system includes, in order from an object side, a first front lens group GF1 consisting of one or two lens groups and having a positive refractive power as a whole, a second front lens group GF2 consisting of one or more lens groups and having a negative refractive power as a whole, a middle group GM consisting of one or more lens groups, and a subsequent group GR, in which the first front lens group GF1 has a first lens group G1 at a position closest to the object side, an aperture diaphragm S is disposed closer to an image side than the second front lens group GF2, the second front lens group GF2 has a lens group having a strongest negative refractive power among lens groups disposed closer to the object side than an aperture diaphragm S.

### TECHNICAL FIELD

The present invention relates to a variable magnification imaging optical system suitable for an imaging optical system used in an imaging apparatus such as a digital camera or a video camera.

### BACKGROUND ART

In recent years, mirrorless digital cameras and video cameras have been developed, and high-performance cameras have been mounted on smartphones and mobile data terminals. Therefore, in order to differentiate digital cameras and video cameras from these mobile devices, there is an increasing demand for a super telephoto zoom lens.

In addition, in recent years, the image sensor of the digital camera and the video camera has been further increased in resolution, and the demand for high performance and size reduction and weight reduction of the imaging optical system has been further increased.

Patent Document 1 to Patent Document 3 disclose examples of a variable magnification imaging optical system in which a half angle of view at a telephoto end is approximately 3 degrees or less.

### RELATED ART DOCUMENT

### Patent Document

[Patent Document 1] JP-A-2013-167749
[Patent Document 2] Japanese Patent No. 7570685
[Patent Document 3] JP-A-2019-020450

### SUMMARY OF THE INVENTION

In a super telephoto zoom lens having a narrow angle of view at a telephoto end, in order to improve usability as a zoom lens, it is necessary to achieve three points of a large magnification change ratio, size reduction for improving portability, and imaging performance. In addition, in the super telephoto zoom lens, a lens having a large diameter is disposed on the object side, and thus a center of gravity is likely to be positioned on the object side. In this case, in a case where a heavy lens group is largely moved, the center of gravity is likely to be largely moved, and this is often disadvantageous in a case of video imaging using a gimbal.

The optical system disclosed in Patent Document 1 is an example of a super telephoto zoom lens having a fixed total length, and aberrations are suppressed over the entire zoom range, and thus the imaging performance is high. However, in an example in which the half angle of view is approximately 3 degrees, the magnification change ratio is also small, that is, 2 or less. From the viewpoint of size reduction, the magnification change ratio and the angle of view at the telephoto end are insufficient.

The optical system disclosed in Patent Document 2 is an example of a super telephoto zoom lens in which the first lens group is moved to the object side during zooming toward the telephoto side, and the total length is variable. The magnification change ratio is large, the total lens length is short at the wide-angle end, and size reduction is achieved. However, in terms of a movement amount of the first lens group during zooming being approximately 100 mm and the center of gravity being largely moved, the super telephoto zoom lens is disadvantageous.

The optical system disclosed in Patent Document 3 includes an example of a super telephoto zoom lens having a fixed total length, but there is room for improvement in terms of size reduction in consideration of the magnification change ratio and the angle of view at the telephoto end.

The present invention has been made in view of such problems, and an object thereof is to provide a variable magnification imaging optical system that has a large magnification change ratio, suppresses a movement of a center of gravity due to zooming, achieves size reduction and weight reduction, and has favorable optical performance from infinity to a closest distance over an entire zoom range.

In order to solve the above-described problem, a variable magnification imaging optical system includes in order from an object side, a first front lens group GF1 consisting of one or two lens groups and having a positive refractive power as a whole, a second front lens group GF2 consisting of one or more lens groups and having a negative refractive power as a whole, a middle group GM consisting of one or more lens groups, and a subsequent group GR, in which the first front lens group GF1 has a first lens group G1 at a position closest to the object side, an aperture diaphragm S is disposed closer to an image side than the second front lens group GF2, the second front lens group GF2 has a lens group having a strongest negative refractive power among lens groups disposed closer to the object side than an aperture diaphragm S, distances between adjacent lens groups changes during magnification change or focusing, and during magnification change from a wide-angle end to a telephoto end (in a case of focusing on an infinite distance object), a lens group having a largest negative refractive power among lens groups constituting the second front lens group GF2 moves to the image side, and the following conditional expression is satisfied:

$$2.5 < fT / fF 1 < 11. \qquad ( 1 )$$

$$0.15 < LiT / fT < 0.7 \qquad ( 2 )$$

where:
fT: focal length of entire system at telephoto end at infinity
fF1: focal length of first front lens group GF1 at telephoto end at infinity
LiT: length on optical axis from lens surface closest to object side at telephoto end at infinity to image surface.

### Advantage of the Invention

According to the present invention, a variable magnification imaging optical system that has a large magnification change ratio, suppresses a movement of a center of gravity due to zooming, achieves size reduction and weight reduction, and has favorable optical performance from infinity to a closest distance over an entire zoom range is provided.

### BRIEF DESCRIPTION OF THE DRAWINGS

FIG. 1 is a lens configuration diagram of an example 1 of a variable magnification imaging optical system according to the present invention at a wide-angle end in a case of focusing on infinity.

FIG. 2 is a longitudinal aberration diagram of the example 1 of the variable magnification imaging optical system according to the present invention at the wide-angle end in a case of focusing on infinity.

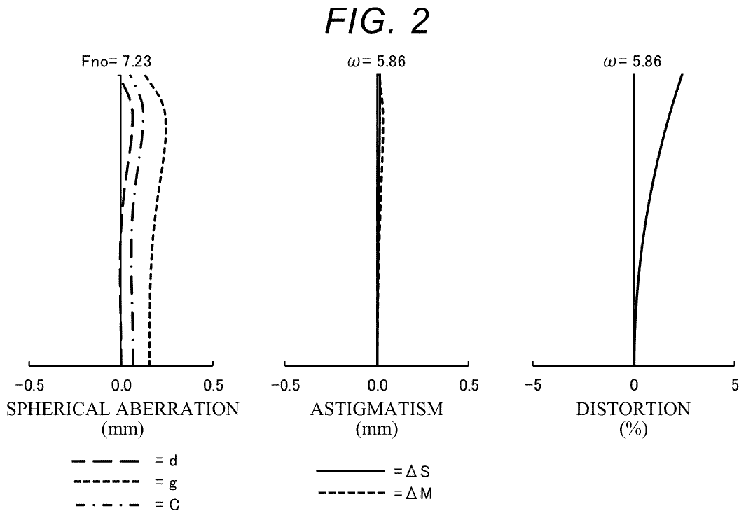

FIG. 3 is a longitudinal aberration diagram of the example 1 of the variable magnification imaging optical system according to the present invention at an intermediate focal length in a case of focusing on infinity.

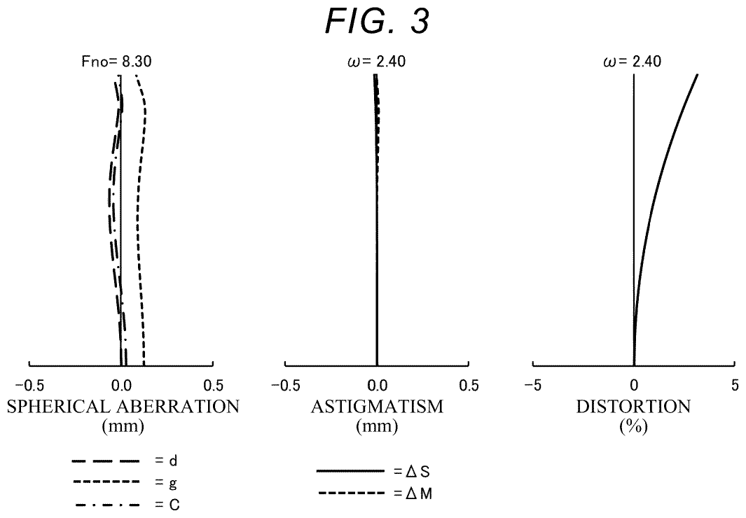

FIG. 4 is a longitudinal aberration diagram of the example 1 of the variable magnification imaging optical system according to the present invention at a telephoto end in a case of focusing on infinity.

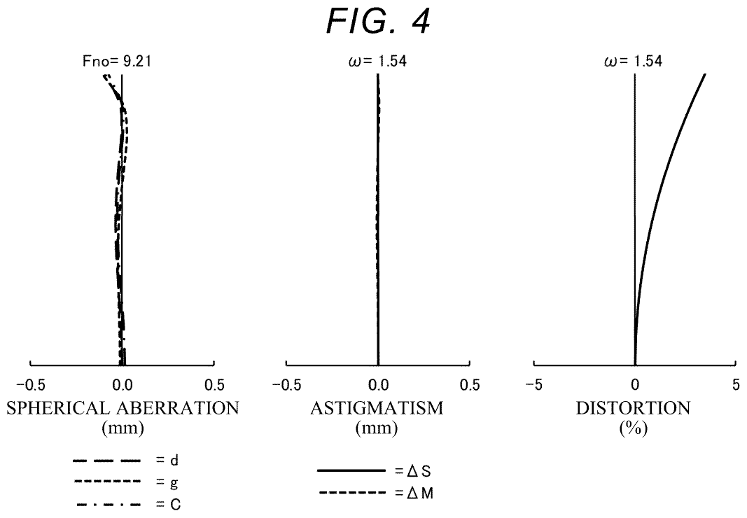

FIG. 5 is a lateral aberration diagram of the example 1 of the variable magnification imaging optical system according to the present invention at the wide-angle end in a case of focusing on infinity.

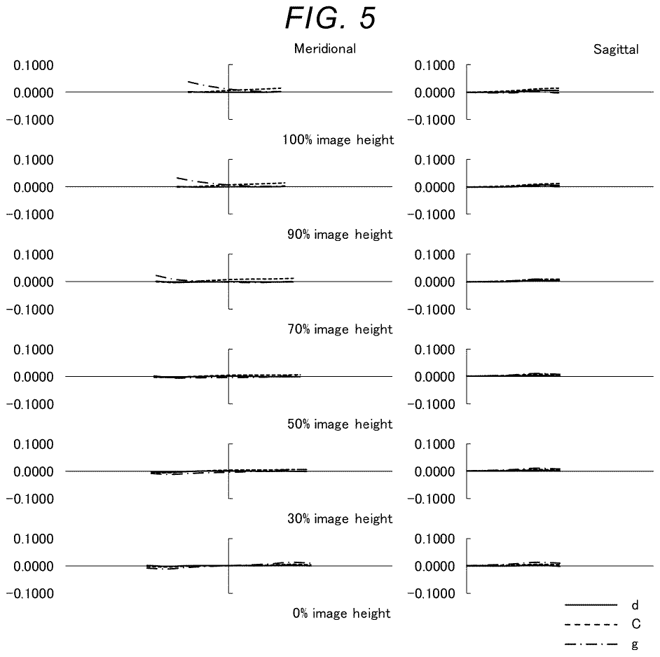

FIG. 6 is a lateral aberration diagram of the example 1 of the variable magnification imaging optical system according to the present invention at the intermediate focal length in a case of focusing on infinity.

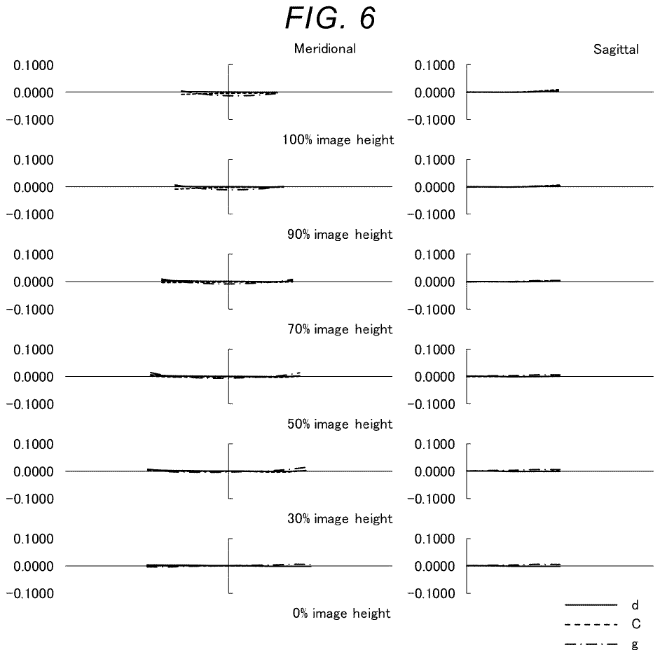

FIG. 7 is a lateral aberration diagram of the example 1 of the variable magnification imaging optical system according to the present invention at the telephoto end in a case of focusing on infinity.

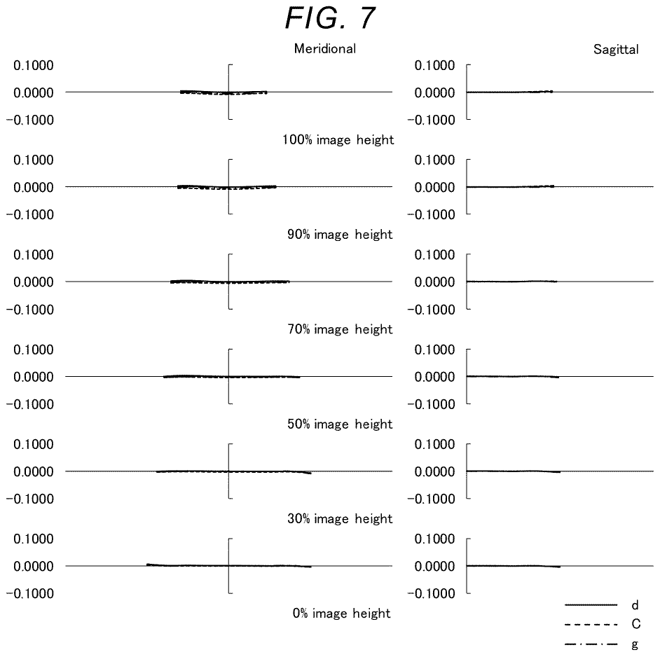

FIG. 8 is a lateral aberration diagram of the example 1 of the variable magnification imaging optical system according to the present invention at the wide-angle end in a case of focusing on an object at a distance of 4.0 m.

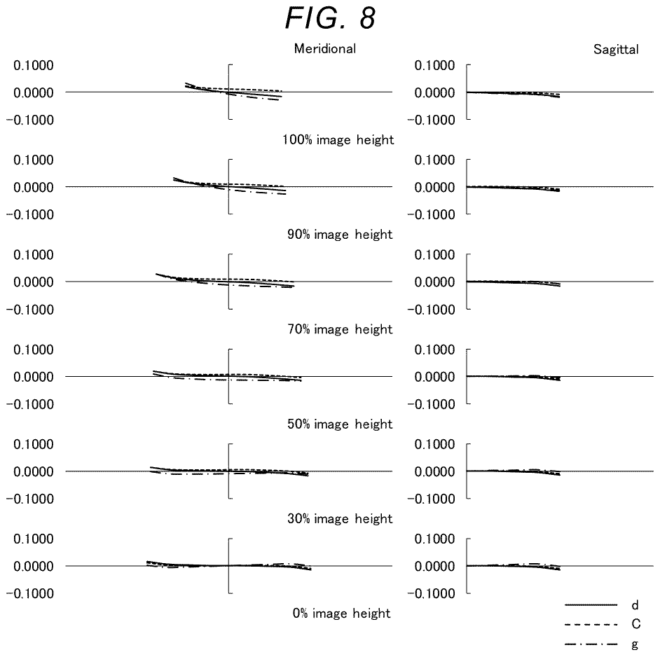

FIG. 9 is a lateral aberration diagram of the example 1 of the variable magnification imaging optical system according to the present invention at the intermediate focal length in a case of focusing on an object at a distance of 4.0 m.

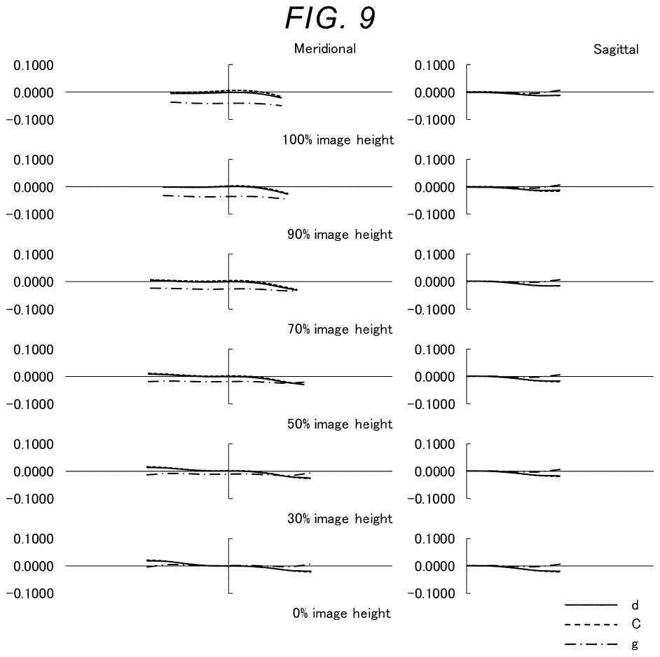

FIG. 10 is a lateral aberration diagram of the example 1 of the variable magnification imaging optical system according to the present invention at the telephoto end in a case of focusing on an object at a distance of 4.0 m.

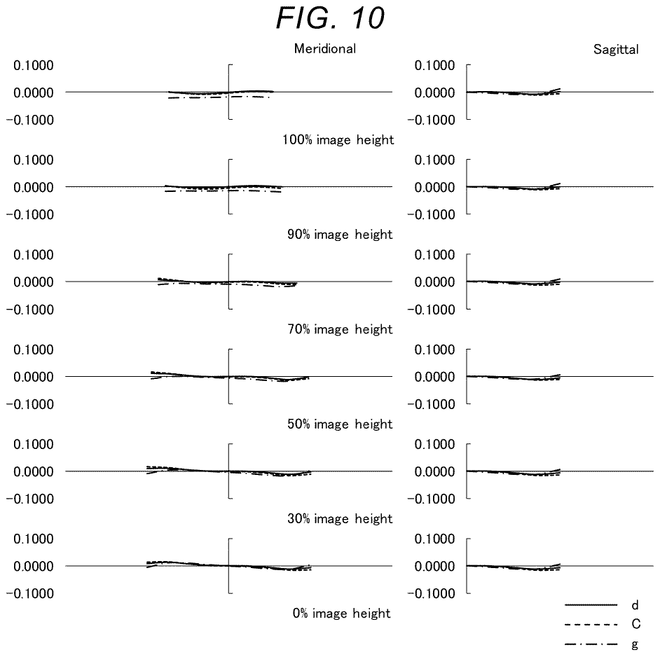

FIG. 11 is a lateral aberration diagram of the example 1 of the variable magnification imaging optical system according to the present invention in a case of vibration reduction at the wide-angle end in a case of focusing on infinity with a shake angle of 0.3 degrees.

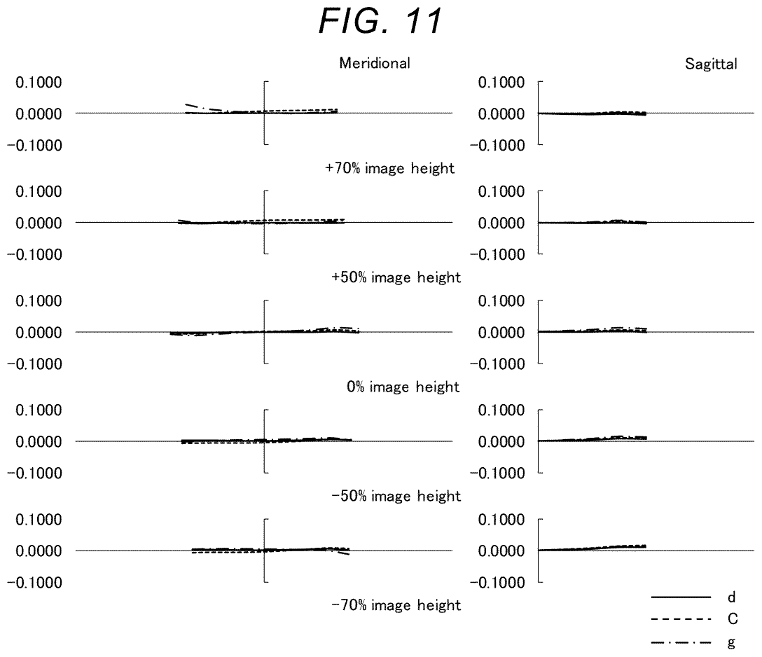

FIG. 12 is a lateral aberration diagram of the example 1 of the variable magnification imaging optical system according to the present invention in a case of vibration reduction at the intermediate focal length in a case of focusing on infinity with a shake angle of 0.3 degrees.

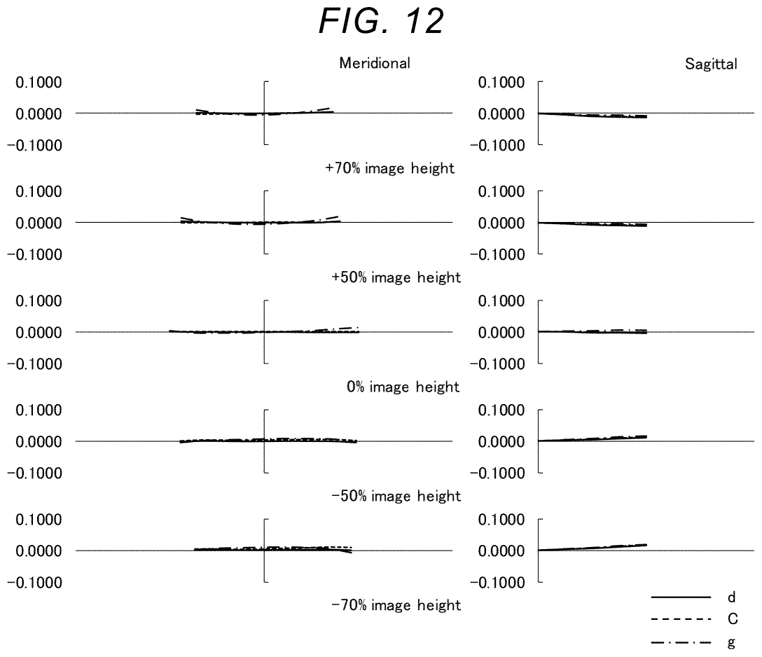

FIG. 13 is a lateral aberration diagram of the example 1 of the variable magnification imaging optical system according to the present invention in a case of vibration reduction at the telephoto end in a case of focusing on infinity with a shake angle of 0.3 degrees.

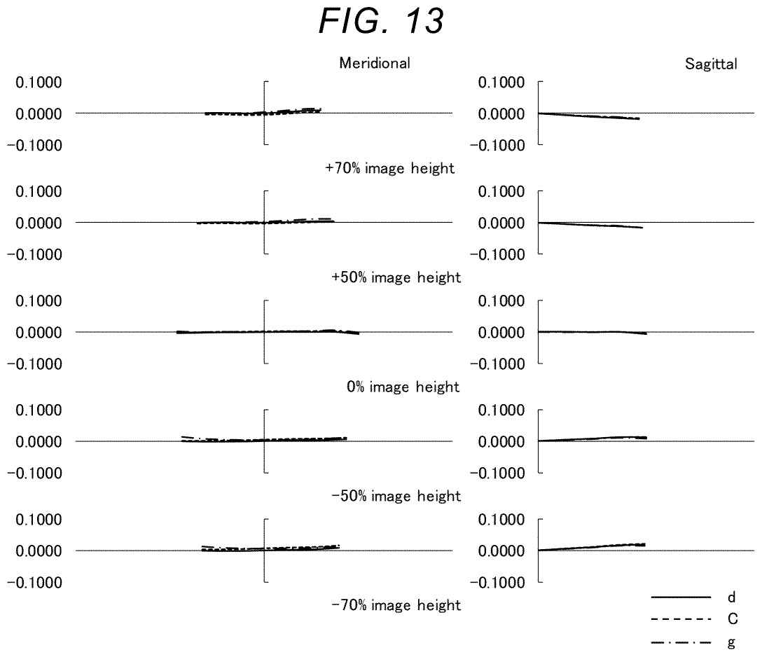

FIG. 14 is a lens configuration diagram of an example 2 of a variable magnification imaging optical system according to the present invention at the wide-angle end in a case of focusing on infinity.

FIG. 15 is a longitudinal aberration diagram of the example 2 of the variable magnification imaging optical system according to the present invention at the wide-angle end in a case of focusing on infinity.

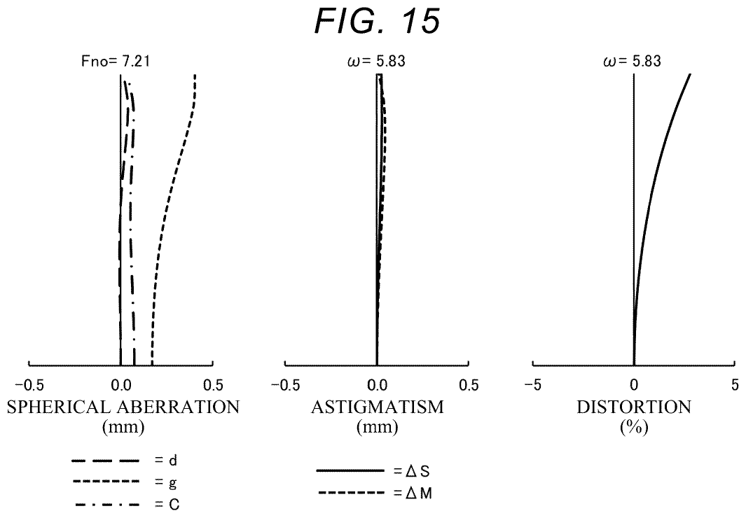

FIG. 16 is a longitudinal aberration diagram of the example 2 of the variable magnification imaging optical system according to the present invention at the intermediate focal length in a case of focusing on infinity.

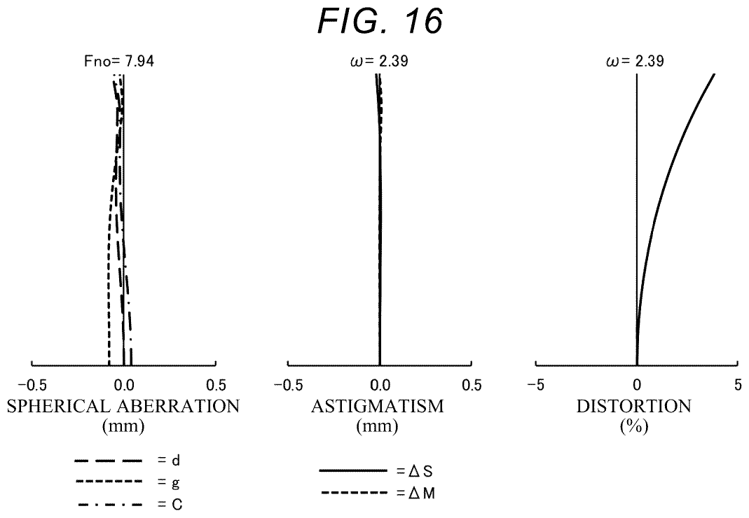

FIG. 17 is a longitudinal aberration diagram of the example 2 of the variable magnification imaging optical system according to the present invention at the telephoto end in a case of focusing on infinity.

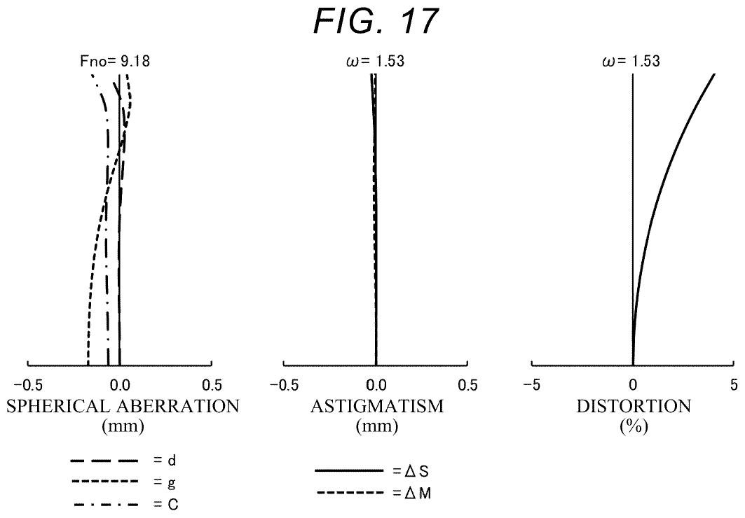

FIG. 18 is a lateral aberration diagram of the example 2 of the variable magnification imaging optical system according to the present invention at the wide-angle end in a case of focusing on infinity.

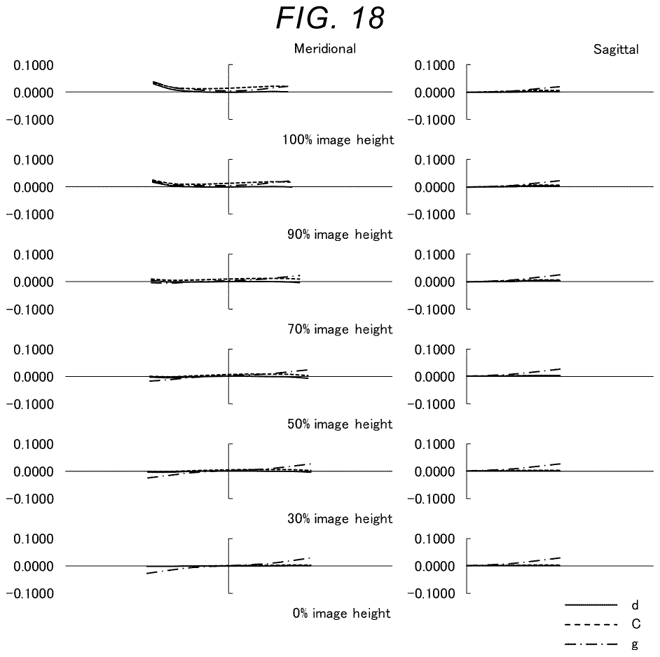

FIG. 19 is a lateral aberration diagram of the example 2 of the variable magnification imaging optical system according to the present invention at the intermediate focal length in a case of focusing on infinity.

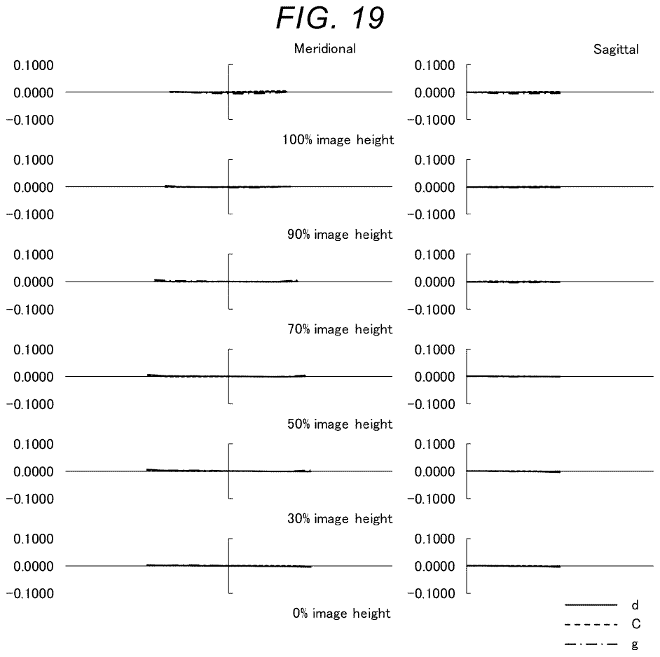

FIG. 20 is a lateral aberration diagram of the example 2 of the variable magnification imaging optical system according to the present invention at the telephoto end in a case of focusing on infinity.

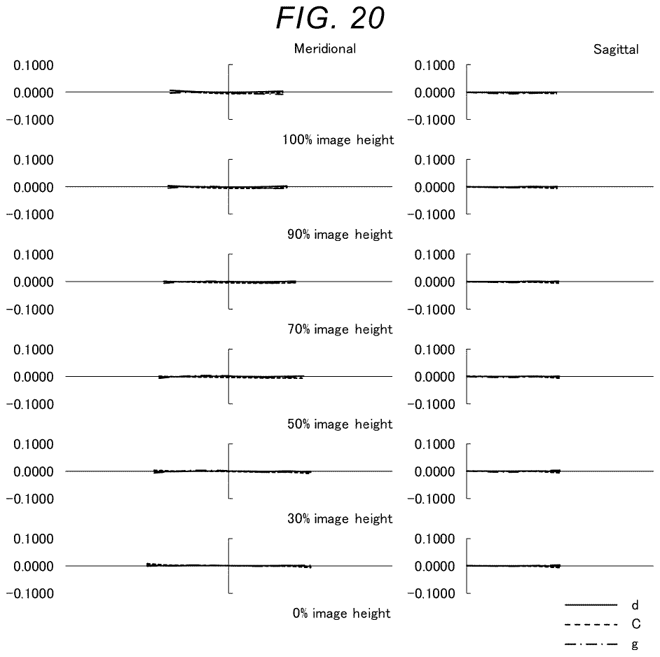

FIG. 21 is a lateral aberration diagram of the example 2 of the variable magnification imaging optical system according to the present invention at the wide-angle end in a case of focusing on an object at a distance of 4.5 m.

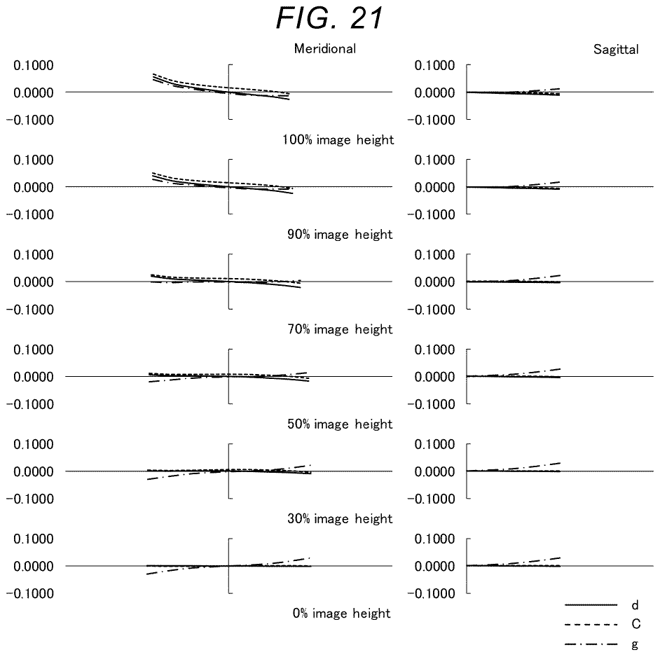

FIG. 22 is a lateral aberration diagram of the example 2 of the variable magnification imaging optical system according to the present invention at the intermediate focal length in a case of focusing on an object at a distance of 4.5 m.

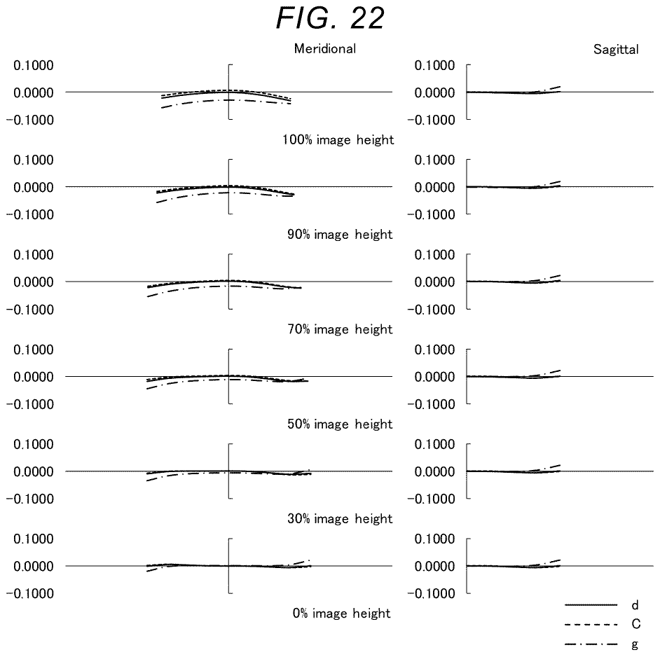

FIG. 23 is a lateral aberration diagram of the example 2 of the variable magnification imaging optical system according to the present invention at the telephoto end in a case of focusing on an object at a distance of 4.5 m.

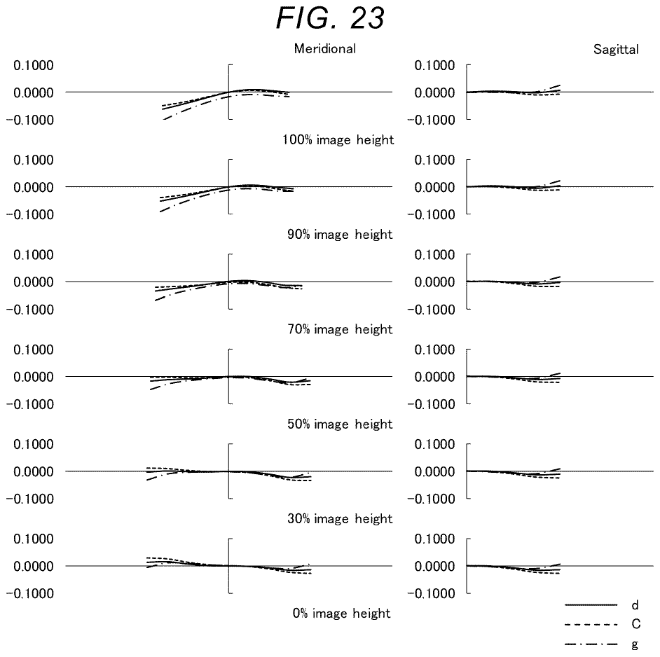

FIG. 24 is a lateral aberration diagram of the example 2 of the variable magnification imaging optical system according to the present invention at the wide-angle end in a case of vibration reduction in a case of focusing on infinity with a shake angle of 0.3 degrees.

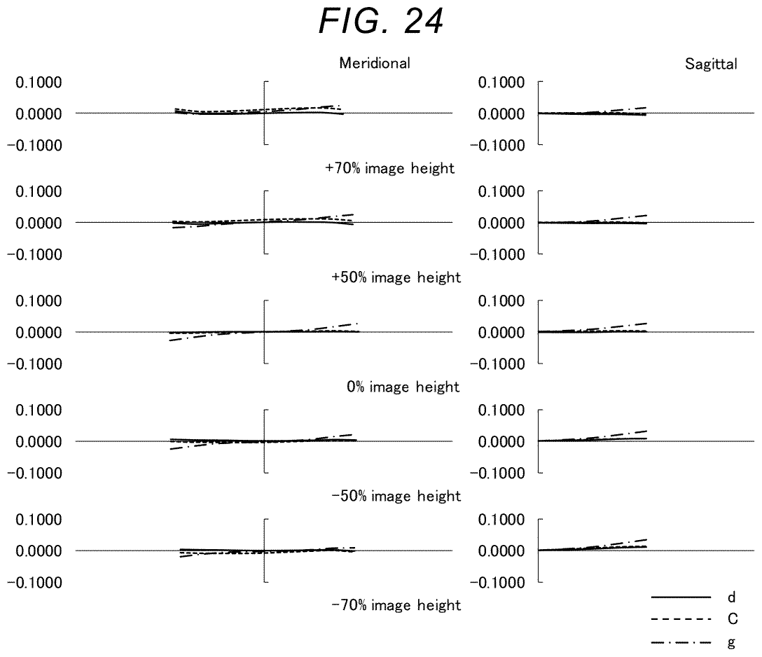

FIG. 25 is a lateral aberration diagram of the example 2 of the variable magnification imaging optical system according to the present invention at the intermediate focal length in a case of vibration reduction in a case of focusing on infinity with a shake angle of 0.3 degrees.

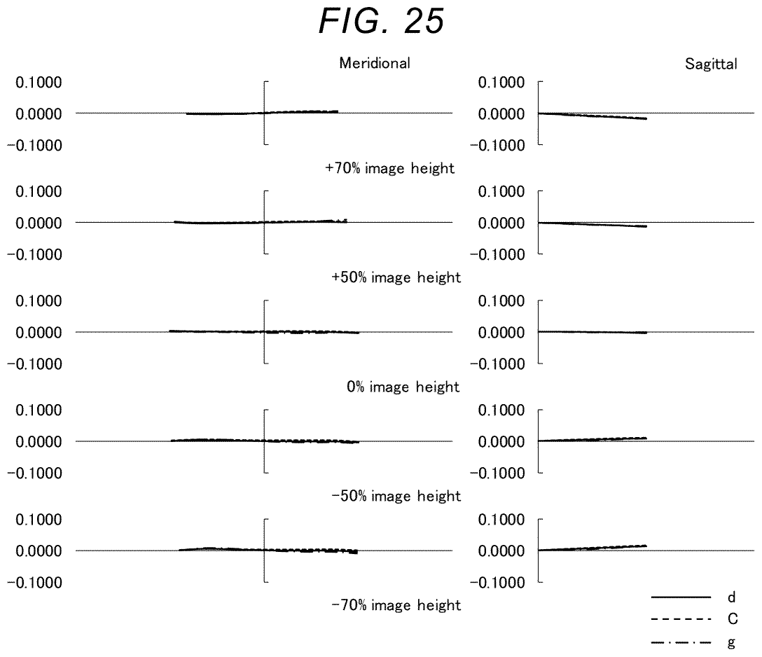

FIG. 26 is a lateral aberration diagram of the example 2 of the variable magnification imaging optical system according to the present invention at the telephoto end in a case of vibration reduction in a case of focusing on infinity with a shake angle of 0.3 degrees.

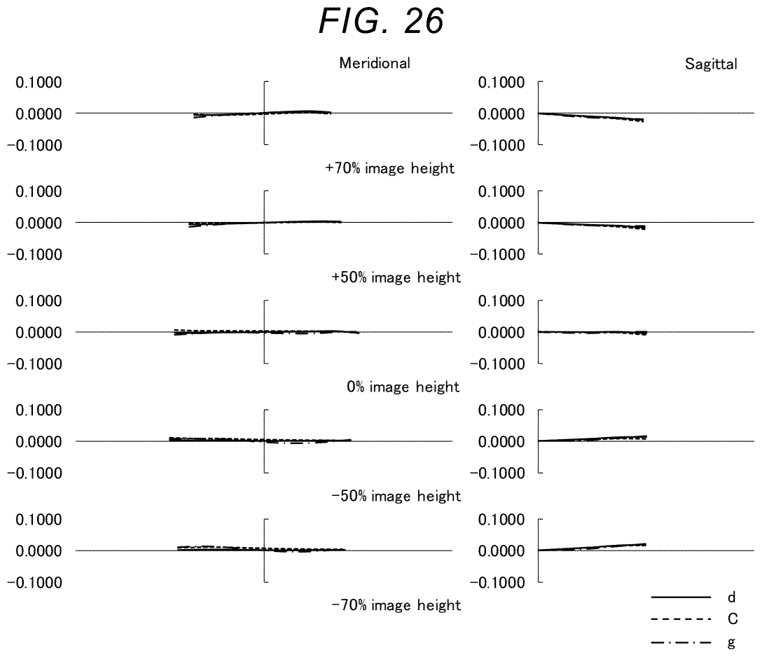

FIG. 27 is a lens configuration diagram of an example 3 of a variable magnification imaging optical system according to the present invention at a wide-angle end in a case of focusing on infinity.

FIG. 28 is a longitudinal aberration diagram of the example 3 of the variable magnification imaging optical system according to the present invention at the wide-angle end in a case of focusing on infinity.

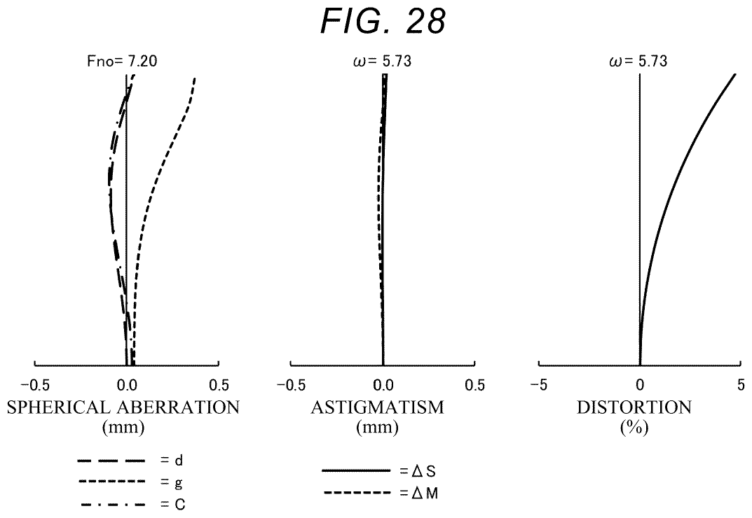

FIG. 29 is a longitudinal aberration diagram of the example 3 of the variable magnification imaging optical system according to the present invention at the intermediate focal length in a case of focusing on infinity.

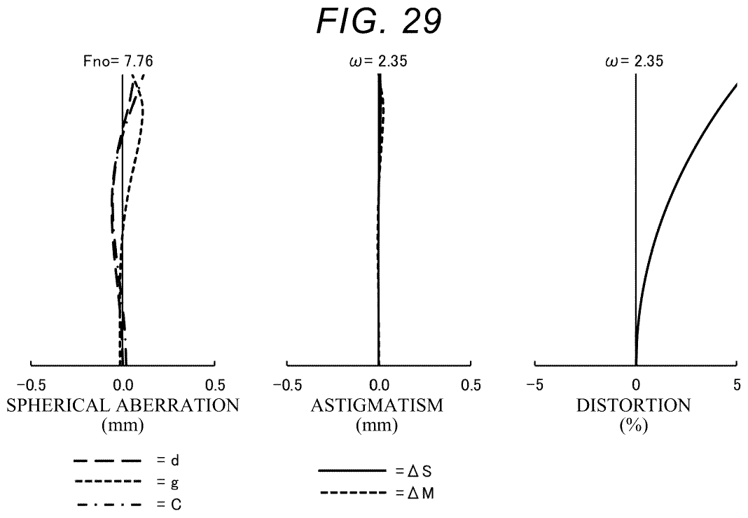

FIG. 30 is a longitudinal aberration diagram of the example 3 of the variable magnification imaging optical system according to the present invention at the telephoto end in a case of focusing on infinity.

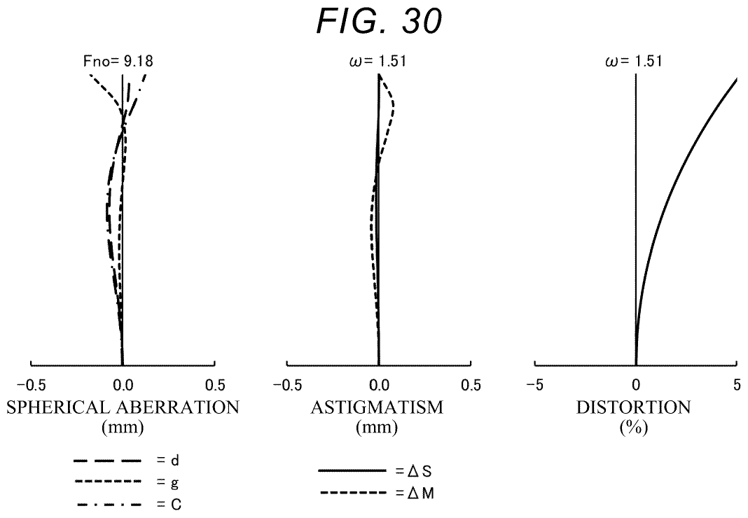

FIG. 31 is a lateral aberration diagram of the example 3 of the variable magnification imaging optical system according to the present invention at the wide-angle end in a case of focusing on infinity.

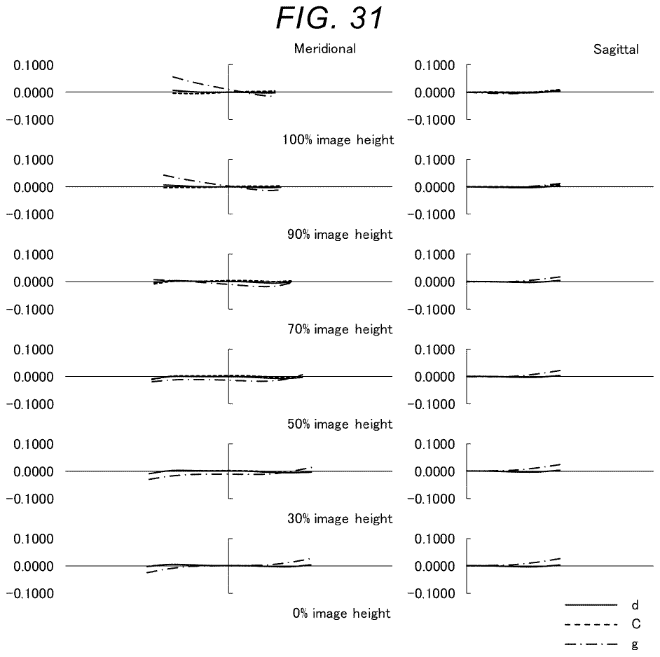

FIG. 32 is a lateral aberration diagram of the example 3 of the variable magnification imaging optical system according to the present invention at the intermediate focal length in a case of focusing on infinity.

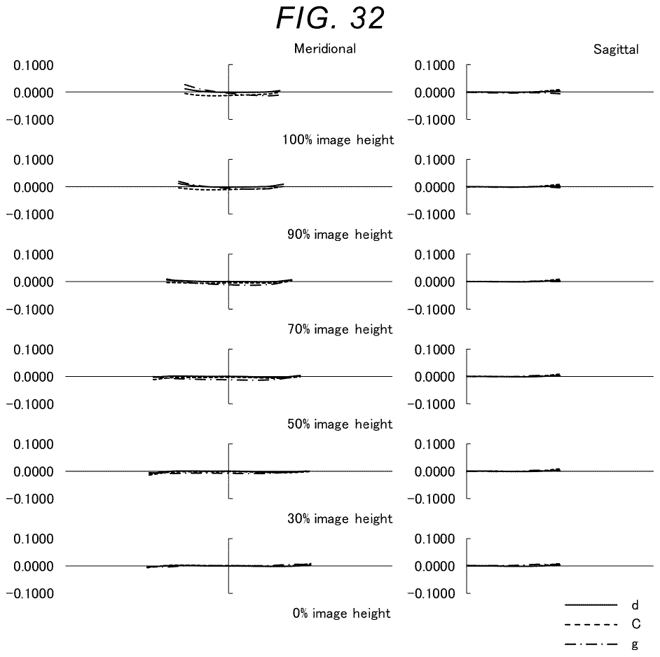

FIG. 33 is a lateral aberration diagram of the example 3 of the variable magnification imaging optical system according to the present invention at the telephoto end in a case of focusing on infinity.

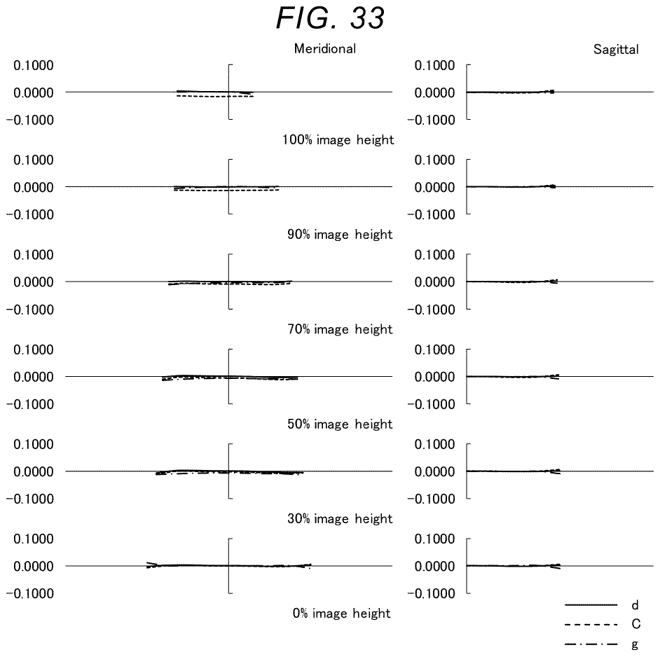

FIG. 34 is a lateral aberration diagram of the example 3 of the variable magnification imaging optical system according to the present invention at the wide-angle end in a case of focusing on an object at a distance of 6.0 m.

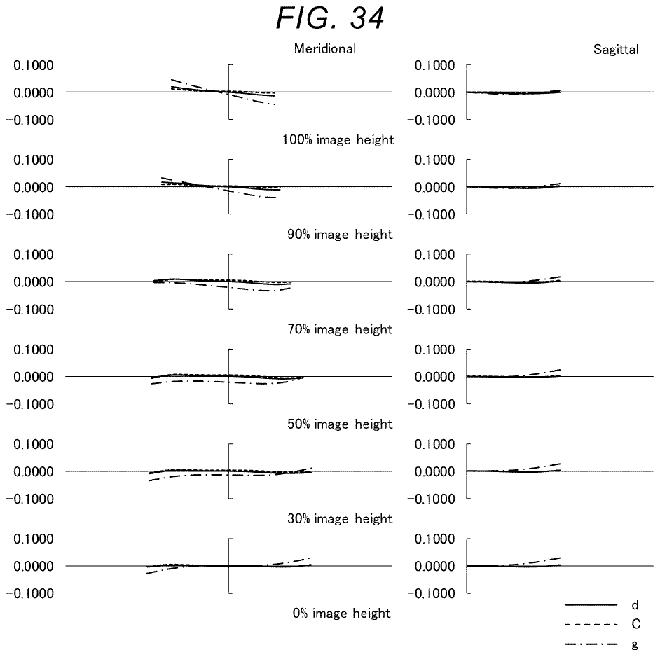

FIG. 35 is a lateral aberration diagram of the example 3 of the variable magnification imaging optical system according to the present invention at the intermediate focal length in a case of focusing on an object at a distance of 6.0 m.

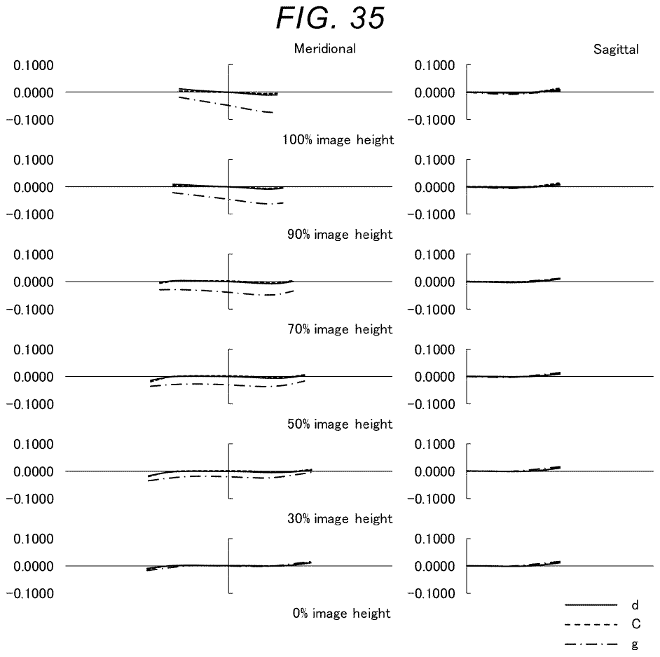

FIG. 36 is a lateral aberration diagram of the example 3 of the variable magnification imaging optical system according to the present invention at the telephoto end in a case of focusing on an object at a distance of 6.0 m.

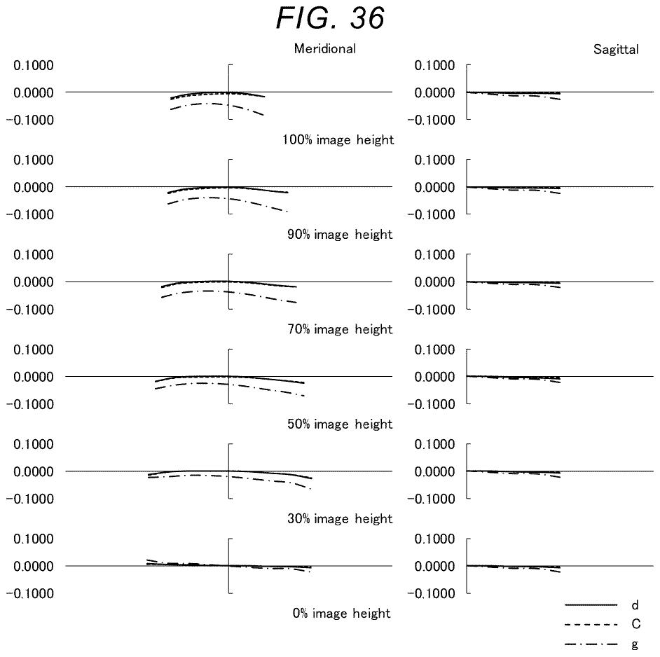

FIG. 37 is a lateral aberration diagram of the example 3 of the variable magnification imaging optical system according to the present invention at the wide-angle end in a case of vibration reduction in a case of focusing on infinity with a shake angle of 0.3 degrees.

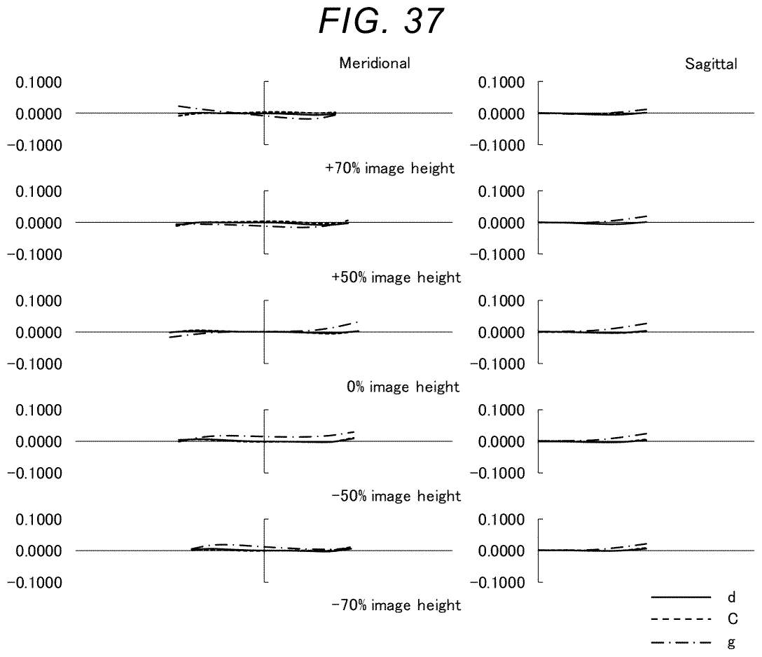

FIG. 38 is a lateral aberration diagram of the example 3 of the variable magnification imaging optical system according to the present invention at the intermediate focal length in a case of vibration reduction in a case of focusing on infinity with a shake angle of 0.3 degrees.

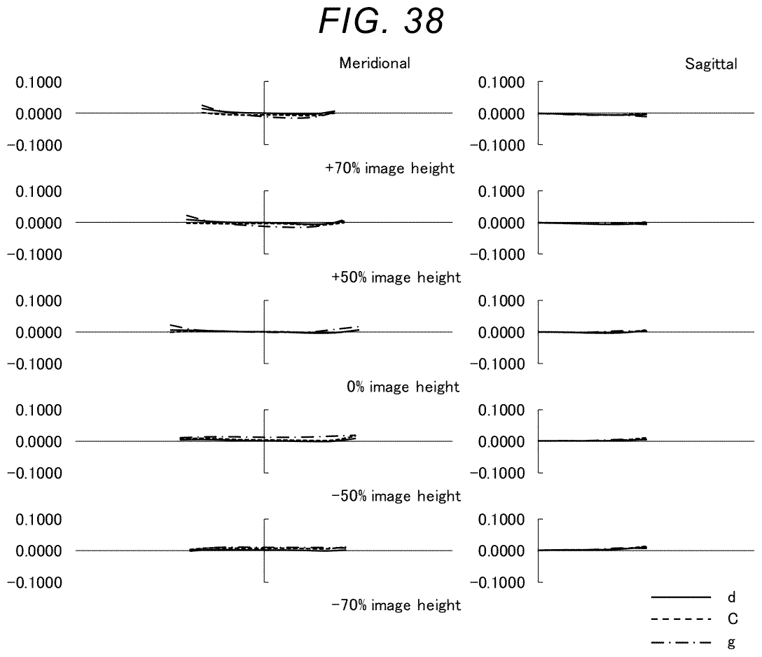

FIG. 39 is a lateral aberration diagram of the example 3 of the variable magnification imaging optical system according to the present invention at the telephoto end in a case of vibration reduction in a case of focusing on infinity with a shake angle of 0.3 degrees.

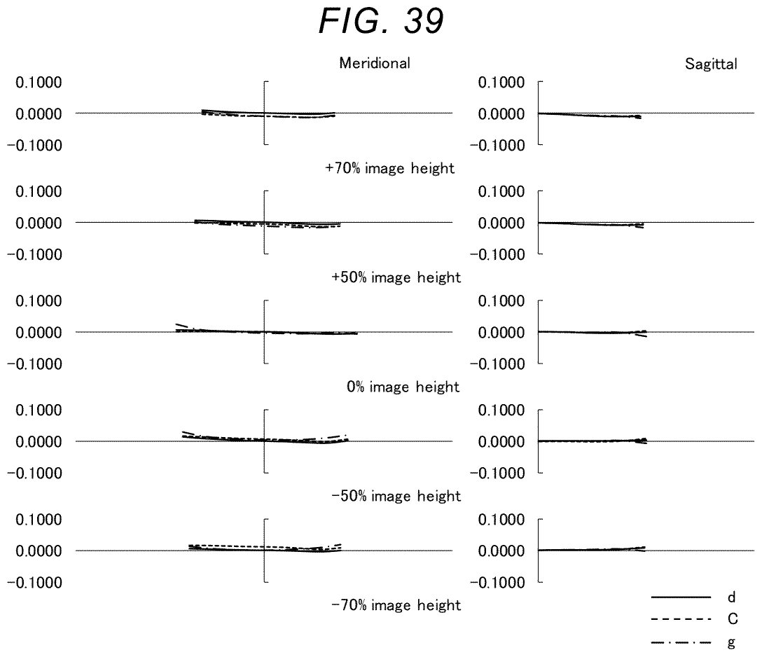

FIG. 40 is a lens configuration diagram of an example 4 of a variable magnification imaging optical system according to the present invention at a wide-angle end in a case of focusing on infinity.

FIG. 41 is a longitudinal aberration diagram of the example 4 of the variable magnification imaging optical system according to the present invention at the wide-angle end in a case of focusing on infinity.

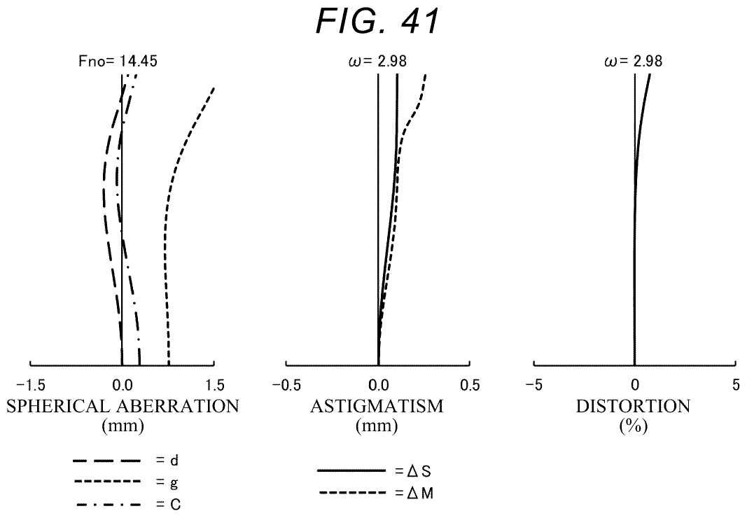

FIG. 42 is a longitudinal aberration diagram of the example 4 of the variable magnification imaging optical system according to the present invention at the intermediate focal length in a case of focusing on infinity.

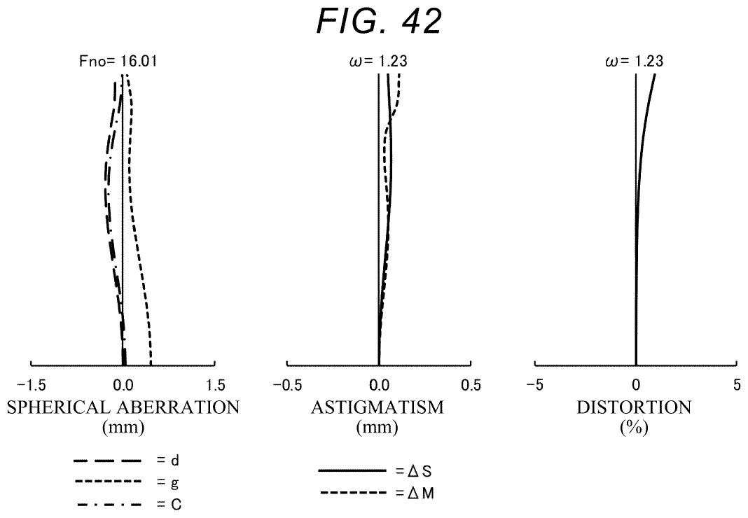

FIG. 43 is a longitudinal aberration diagram of the example 4 of the variable magnification imaging optical system according to the present invention at the telephoto end in a case of focusing on infinity.

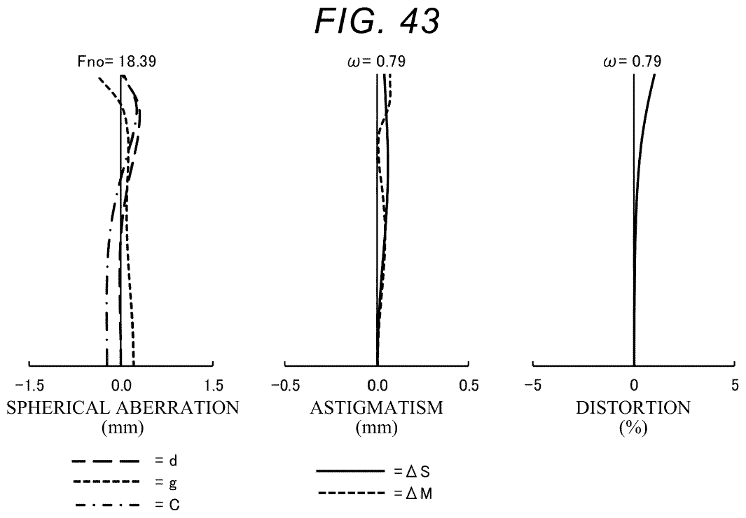

FIG. 44 is a lateral aberration diagram of the example 4 of the variable magnification imaging optical system according to the present invention at the wide-angle end in a case of focusing on infinity.

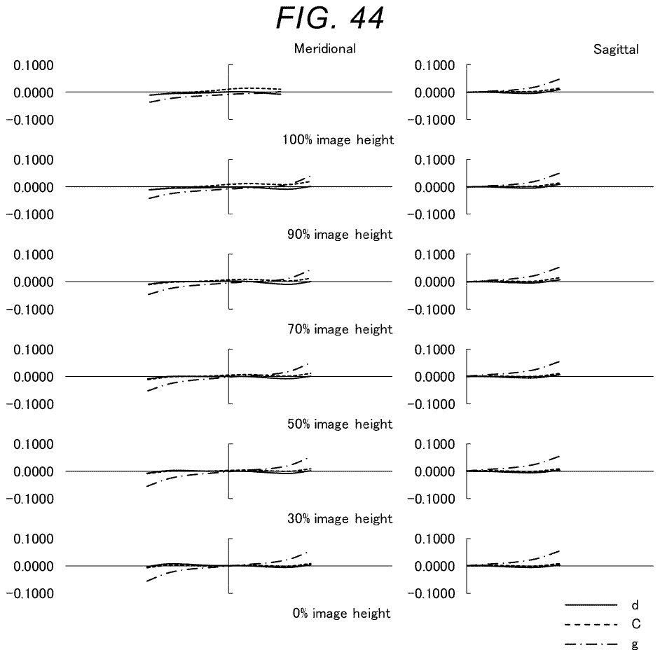

FIG. 45 is a lateral aberration diagram of the example 4 of the variable magnification imaging optical system according to the present invention at the intermediate focal length in a case of focusing on infinity.

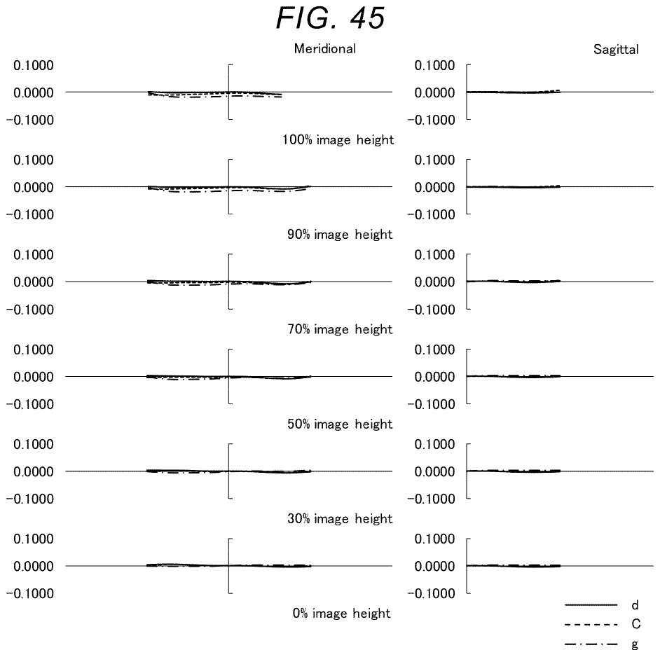

FIG. 46 is a lateral aberration diagram of the example 4 of the variable magnification imaging optical system according to the present invention at the telephoto end in a case of focusing on infinity.

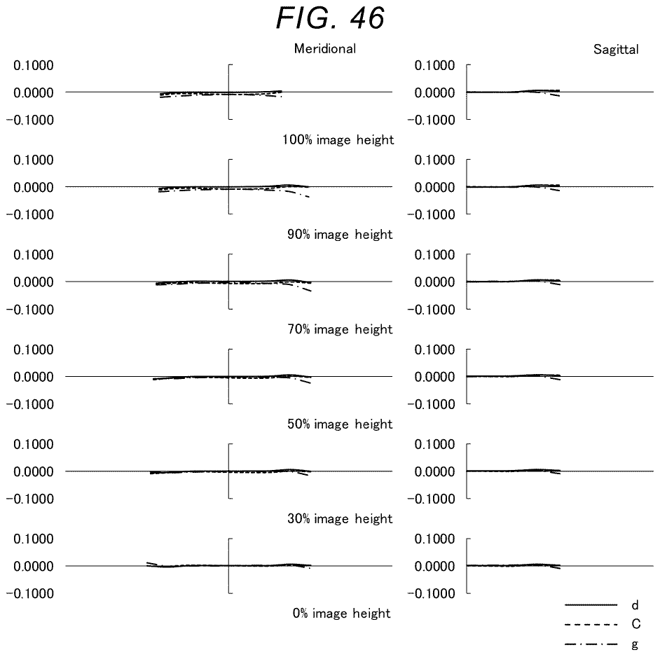

FIG. 47 is a lateral aberration diagram of the example 4 of the variable magnification imaging optical system according to the present invention at the wide-angle end in a case of focusing on an object at a distance of 5.0 m.

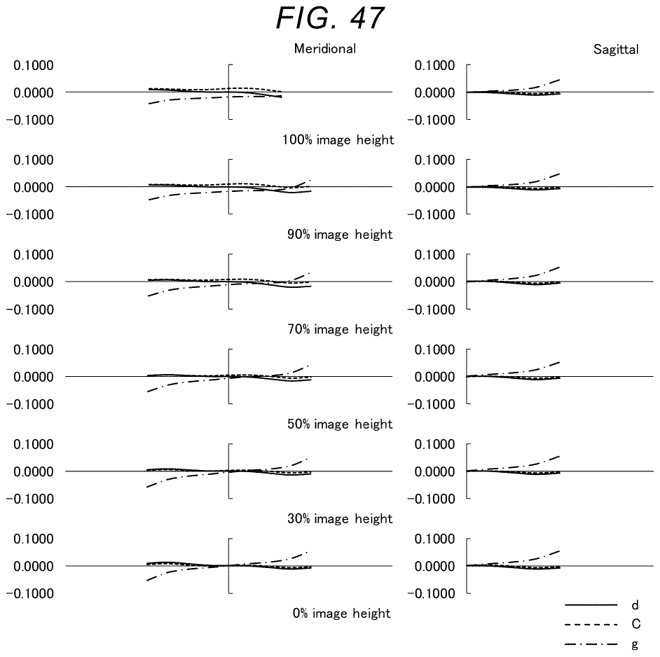

FIG. 48 is a lateral aberration diagram of the example 4 of the variable magnification imaging optical system according to the present invention at the intermediate focal length in a case of focusing on an object at a distance of 5.0 m.

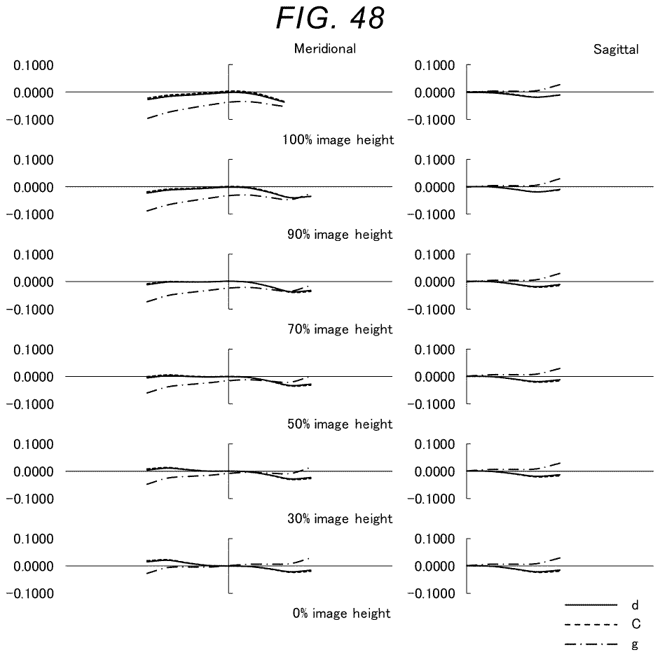

FIG. 49 is a lateral aberration diagram of the example 4 of the variable magnification imaging optical system according to the present invention at the telephoto end in a case of focusing on an object at a distance of 5.0 m.

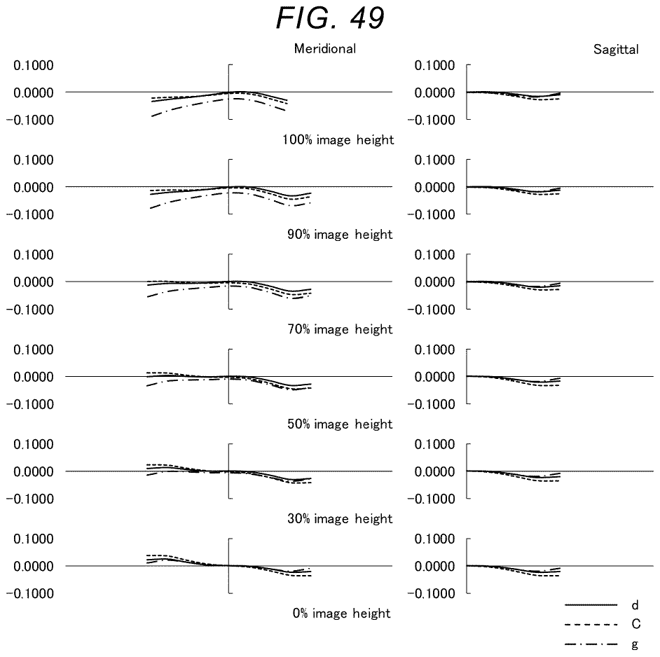

FIG. 50 is a lateral aberration diagram of the example 4 of the variable magnification imaging optical system according to the present invention at the wide-angle end in a case of vibration reduction in a case of focusing on infinity with a shake angle of 0.3 degrees.

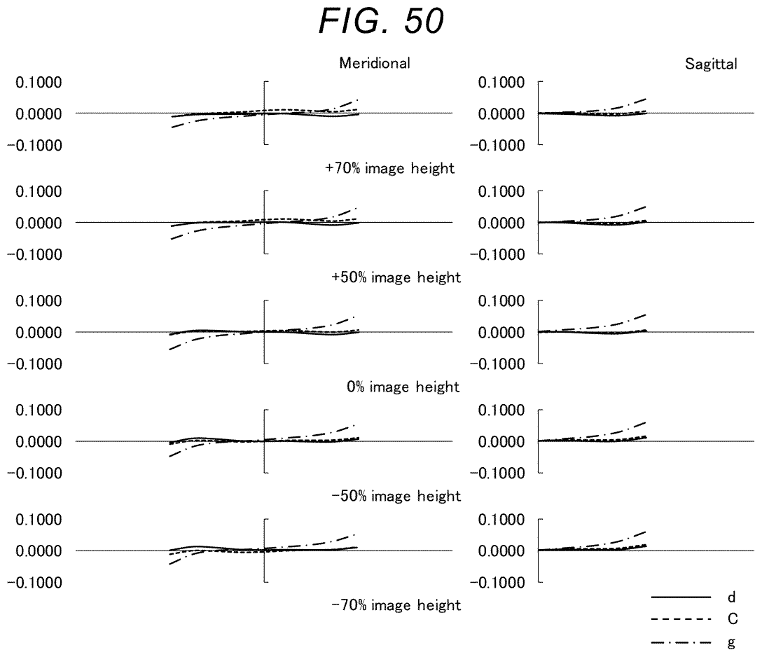

FIG. 51 is a lateral aberration diagram of the example 4 of the variable magnification imaging optical system according to the present invention at the intermediate focal length in a case of vibration reduction in a case of focusing on infinity with a shake angle of 0.3 degrees.

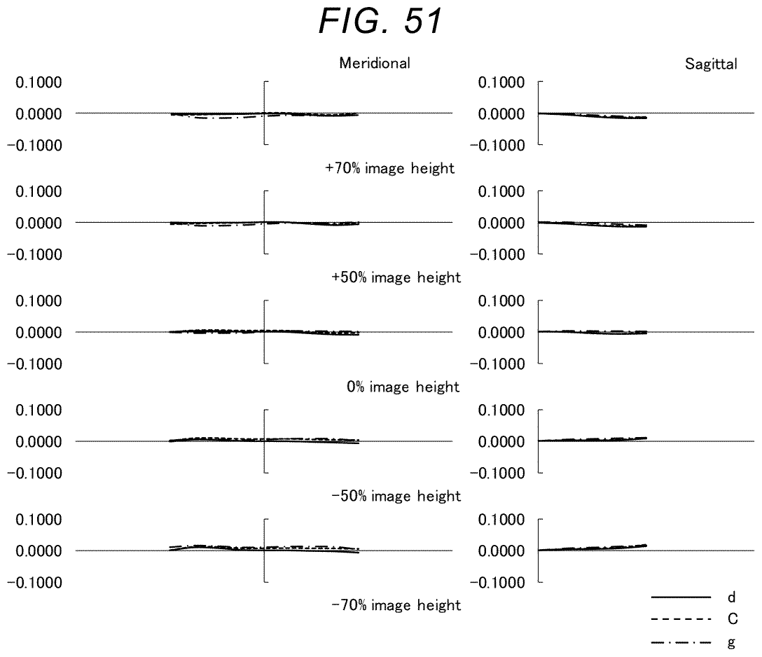

FIG. 52 is a lateral aberration diagram of the example 4 of the variable magnification imaging optical system according to the present invention at the telephoto end in a case of vibration reduction in a case of focusing on infinity with a shake angle of 0.3 degrees.

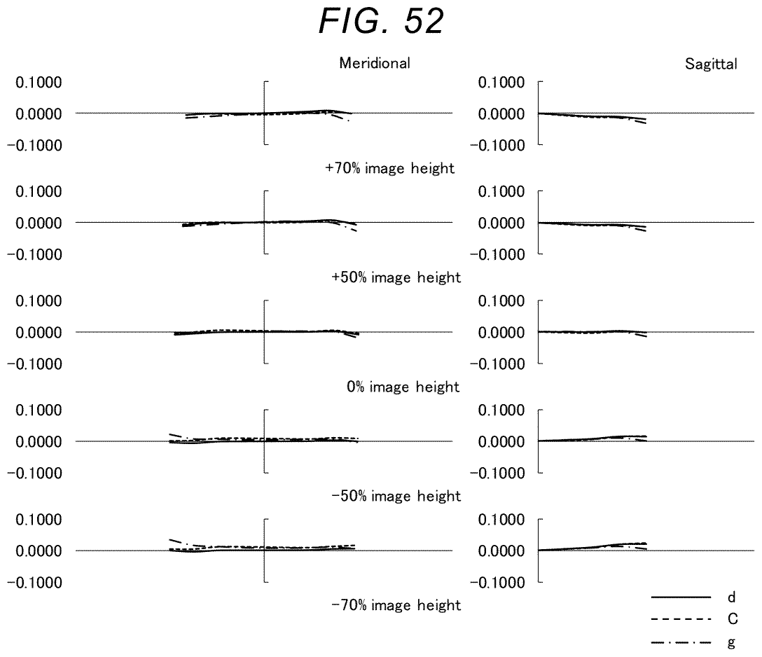

FIG. 53 is a lens configuration diagram of an example 5 of a variable magnification imaging optical system according to the present invention at a wide-angle end in a case of focusing on infinity.

FIG. 54 is a longitudinal aberration diagram of the example 5 of the variable magnification imaging optical system according to the present invention at the wide-angle end in a case of focusing on infinity.

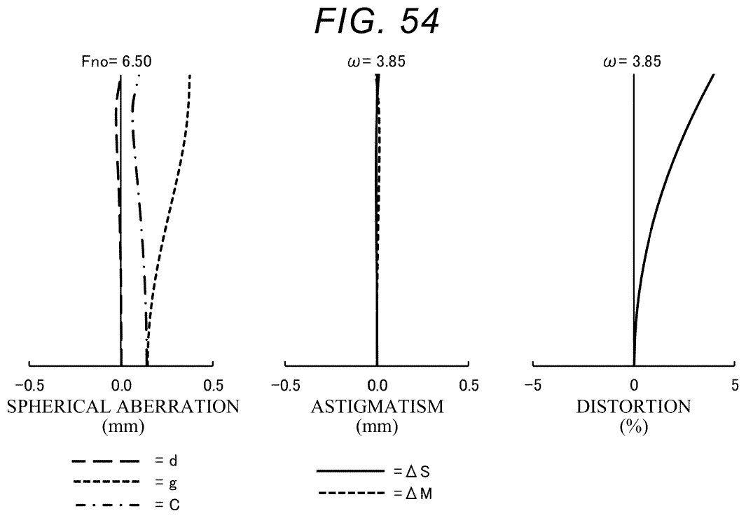

FIG. 55 is a longitudinal aberration diagram of the example 5 of the variable magnification imaging optical system according to the present invention at the intermediate focal length in a case of focusing on infinity.

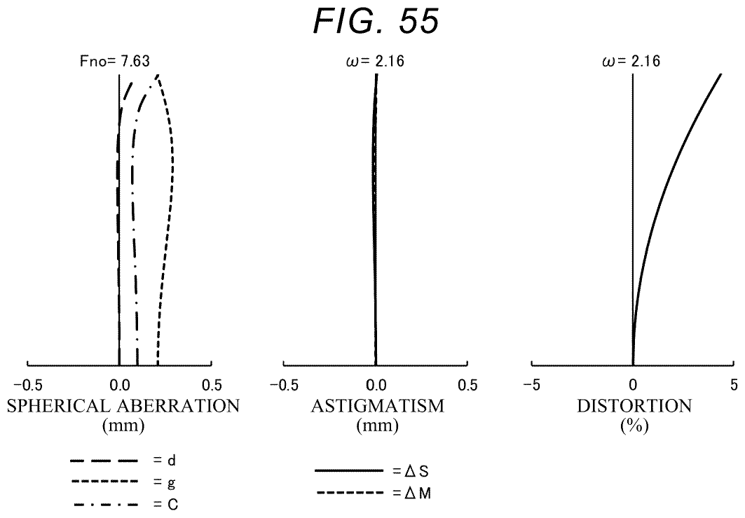

FIG. 56 is a longitudinal aberration diagram of the example 5 of the variable magnification imaging optical system according to the present invention at the telephoto end in a case of focusing on infinity.

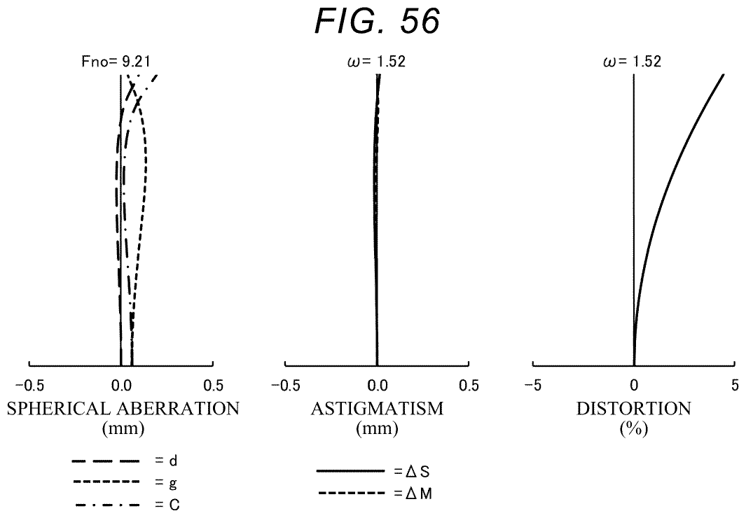

FIG. 57 is a lateral aberration diagram of the example 5 of the variable magnification imaging optical system according to the present invention at the wide-angle end in a case of focusing on infinity.

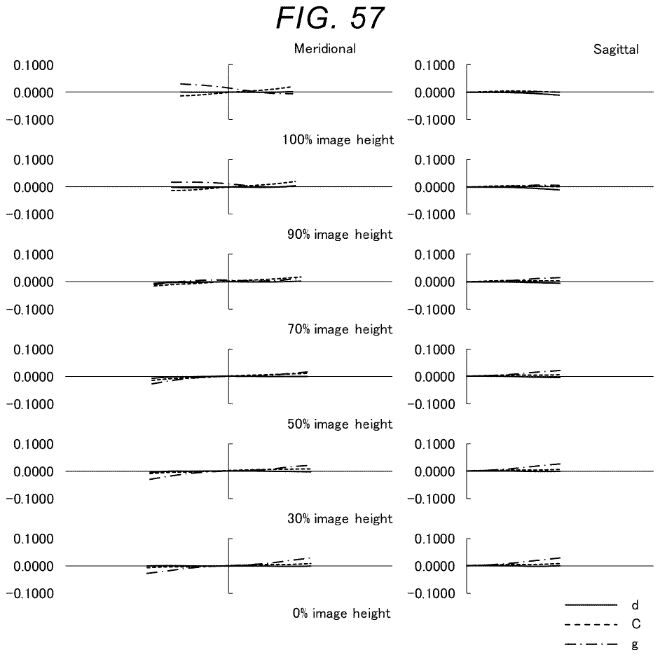

FIG. 58 is a lateral aberration diagram of the example 5 of the variable magnification imaging optical system according to the present invention at the intermediate focal length in a case of focusing on infinity.

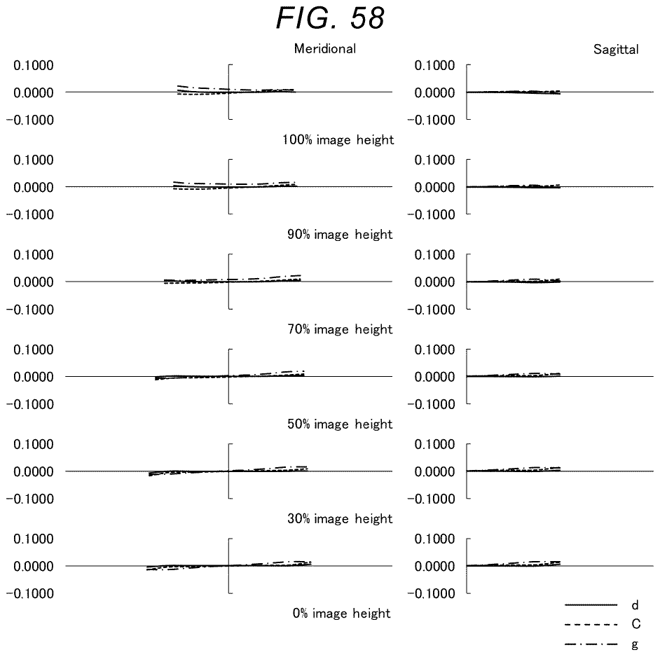

FIG. 59 is a lateral aberration diagram of the example 5 of the variable magnification imaging optical system according to the present invention at the telephoto end in a case of focusing on infinity.

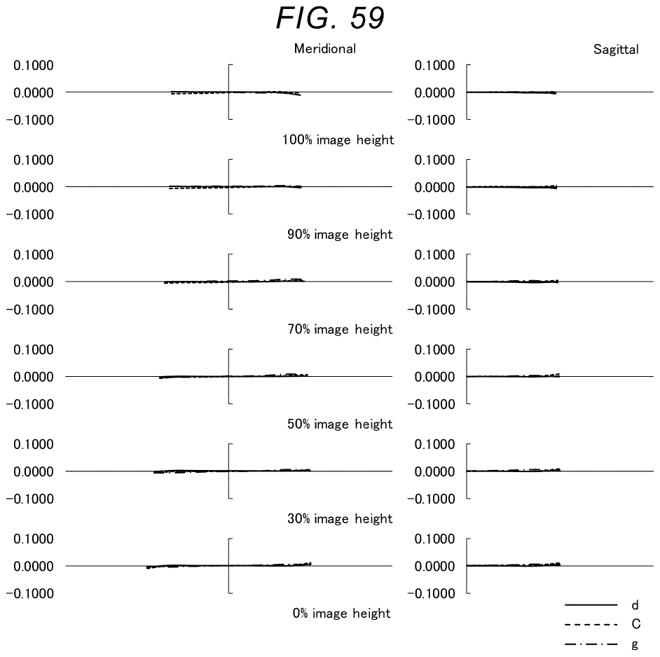

FIG. 60 is a lateral aberration diagram of the example 5 of the variable magnification imaging optical system according to the present invention at the wide-angle end in a case of focusing on an object at a distance of 4.0 m.

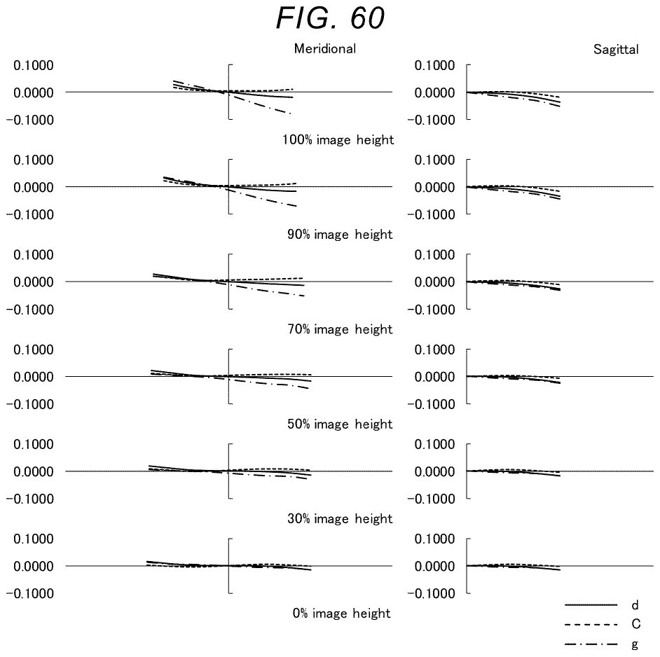

FIG. 61 is a lateral aberration diagram of the example 5 of the variable magnification imaging optical system according to the present invention at the intermediate focal length in a case of focusing on an object at a distance of 4.0 m.

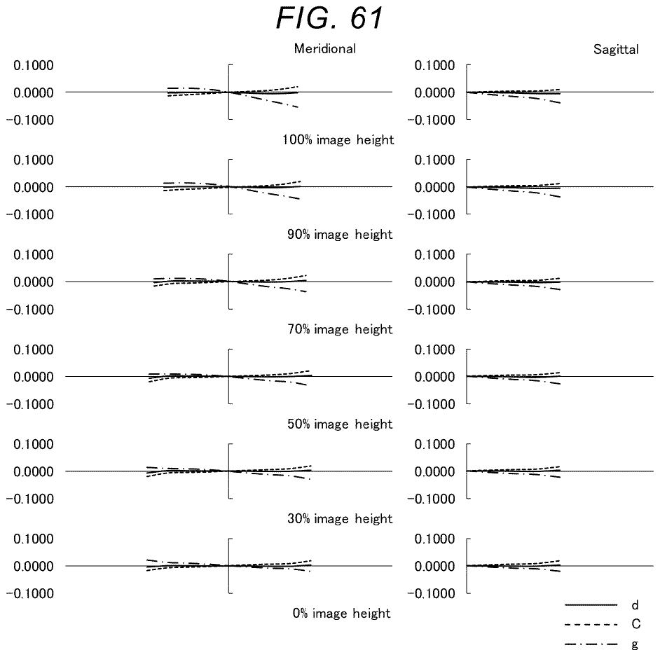

FIG. 62 is a lateral aberration diagram of the example 5 of the variable magnification imaging optical system according to the present invention at the telephoto end in a case of focusing on an object at a distance of 4.0 m.

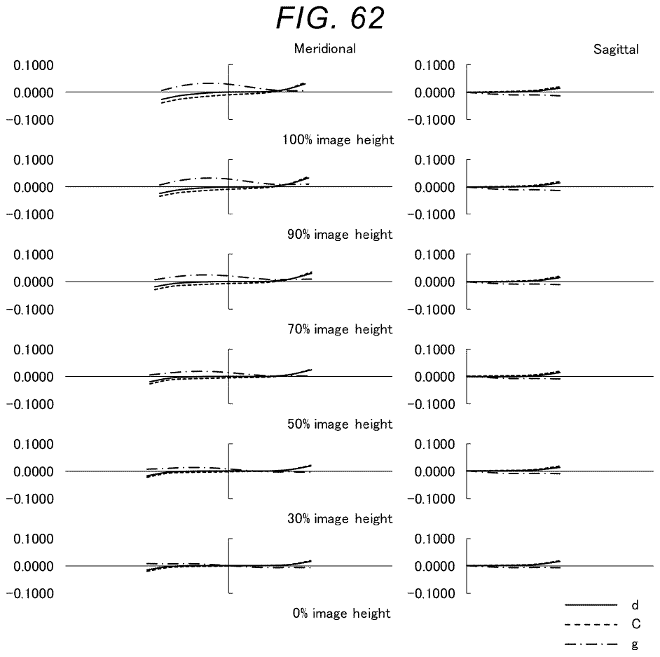

FIG. 63 is a lateral aberration diagram of the example 5 of the variable magnification imaging optical system according to the present invention at the wide-angle end in a case of vibration reduction in a case of focusing on infinity with a shake angle of 0.3 degrees.

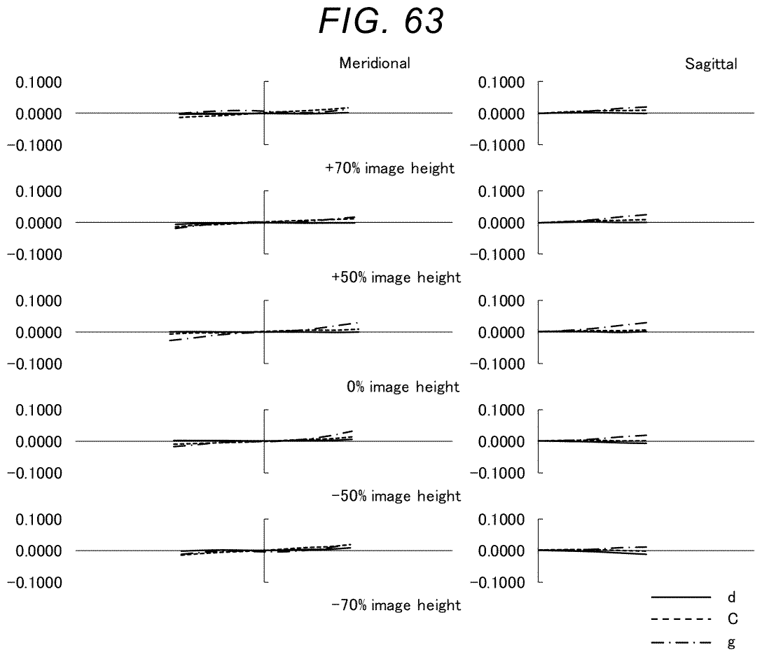

FIG. 64 is a lateral aberration diagram of the example 5 of the variable magnification imaging optical system according to the present invention at the intermediate focal length in a case of vibration reduction in a case of focusing on infinity with a shake angle of 0.3 degrees.

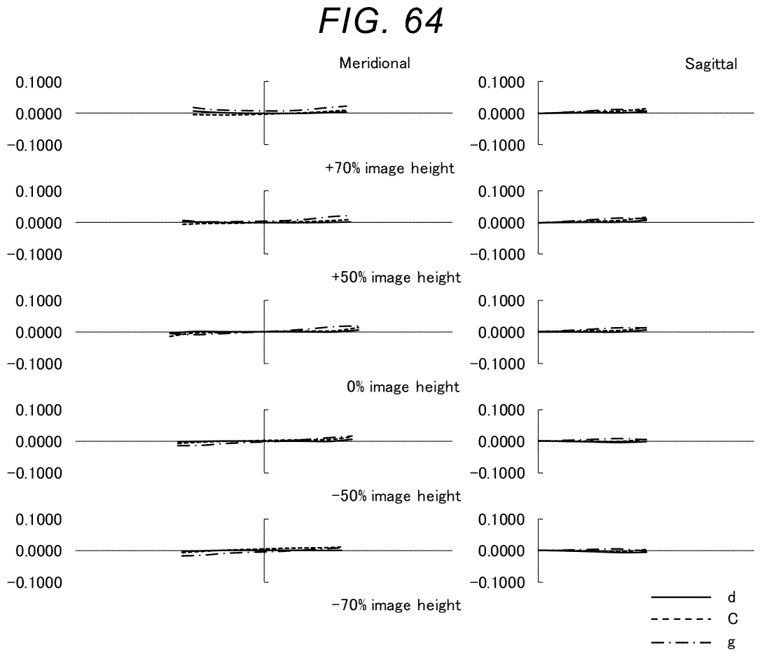

FIG. 65 is a lateral aberration diagram of the example 5 of the variable magnification imaging optical system according to the present invention at the telephoto end in a case of vibration reduction in a case of focusing on infinity with a shake angle of 0.3 degrees.

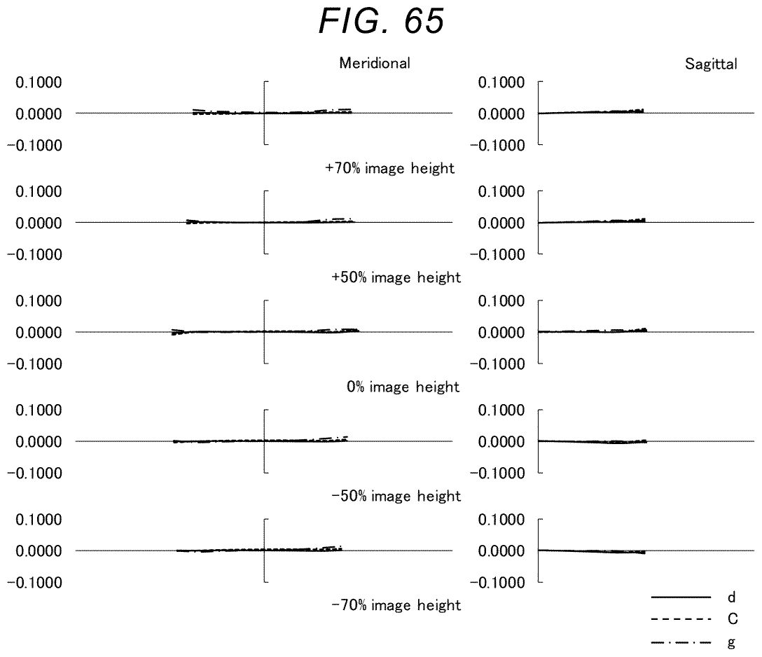

FIG. 66 is a lens configuration diagram of an example 6 of a variable magnification imaging optical system according to the present invention at a wide-angle end in a case of focusing on infinity.

FIG. 67 is a longitudinal aberration diagram of the example 6 of the variable magnification imaging optical system according to the present invention at the wide-angle end in a case of focusing on infinity.

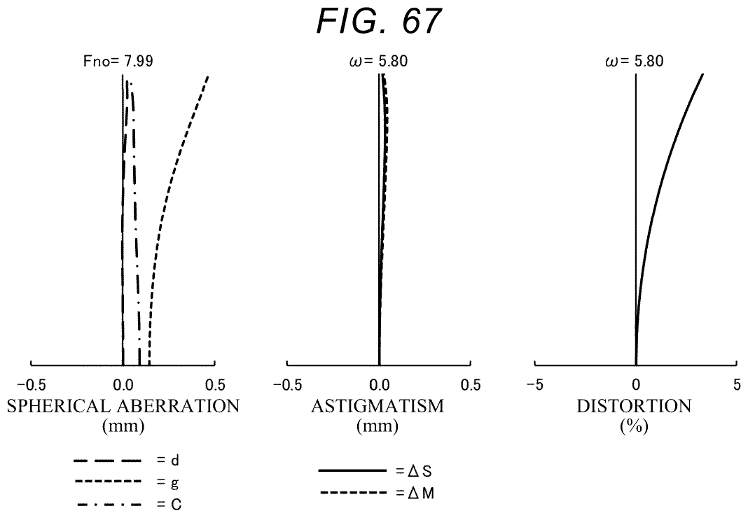

FIG. 68 is a longitudinal aberration diagram of the example 6 of the variable magnification imaging optical system according to the present invention at the intermediate focal length in a case of focusing on infinity.

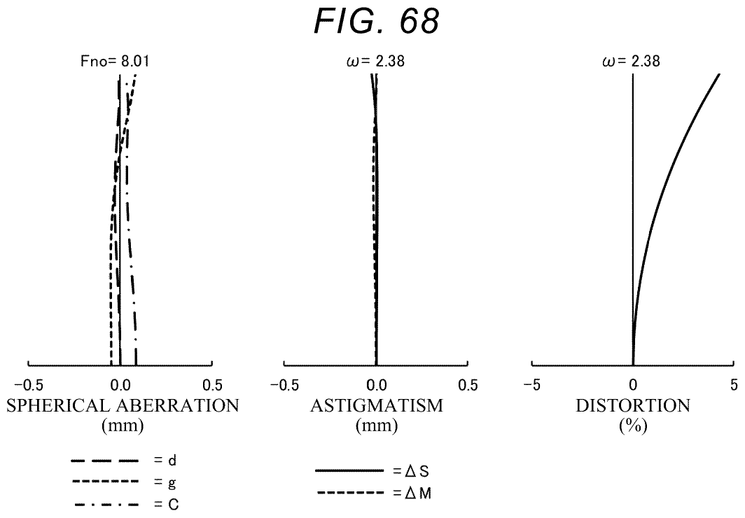

FIG. 69 is a longitudinal aberration diagram of the example 6 of the variable magnification imaging optical system according to the present invention at the telephoto end in a case of focusing on infinity.

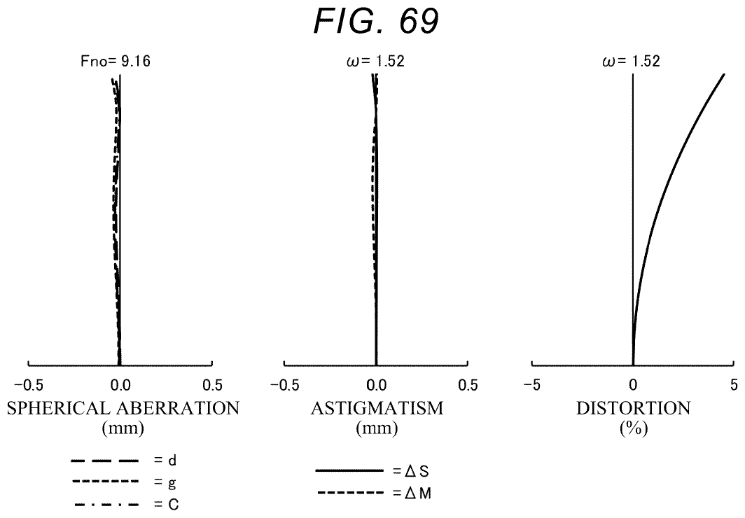

FIG. 70 is a lateral aberration diagram of the example 6 of the variable magnification imaging optical system according to the present invention at the wide-angle end in a case of focusing on infinity.

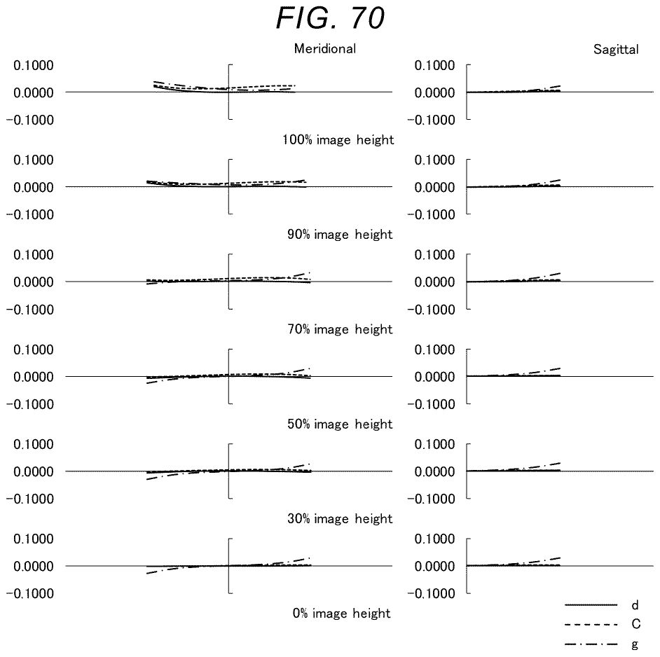

FIG. 71 is a lateral aberration diagram of the example 6 of the variable magnification imaging optical system according to the present invention at the intermediate focal length in a case of focusing on infinity.

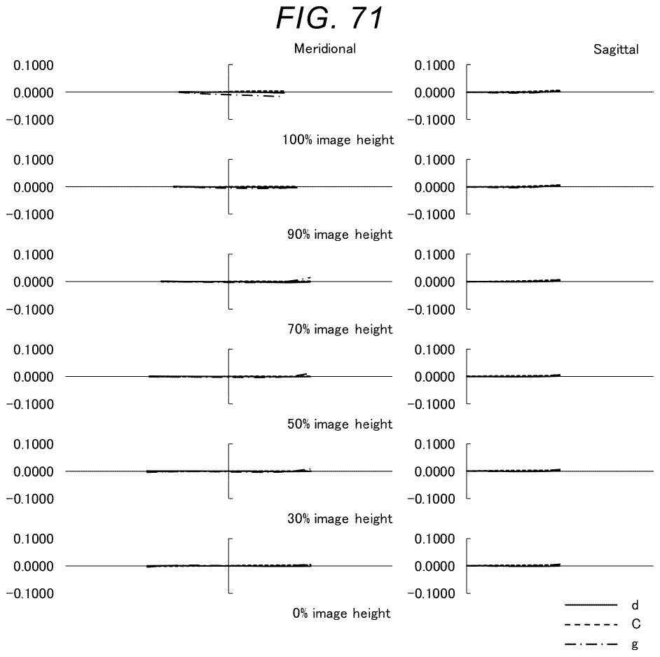

FIG. 72 is a lateral aberration diagram of the example 6 of the variable magnification imaging optical system according to the present invention at the telephoto end in a case of focusing on infinity.

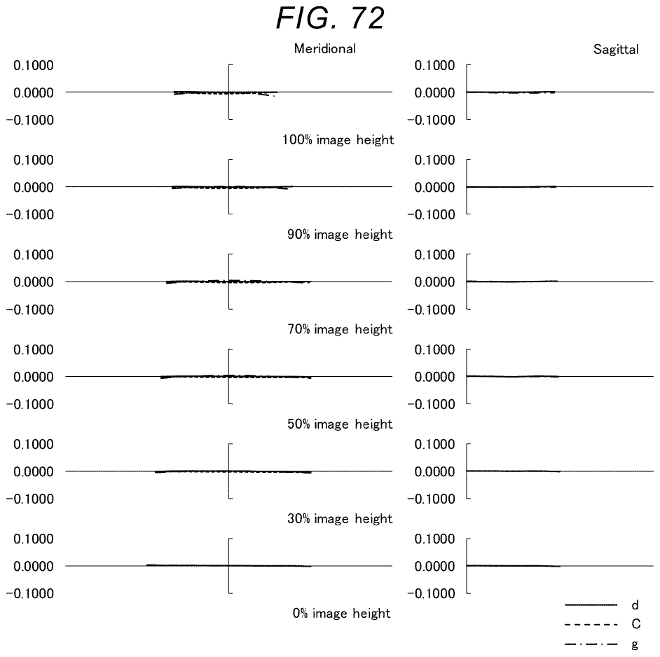

FIG. 73 is a lateral aberration diagram of the example 6 of the variable magnification imaging optical system according to the present invention at the wide-angle end in a case of focusing on an object at a distance of 4.3 m.

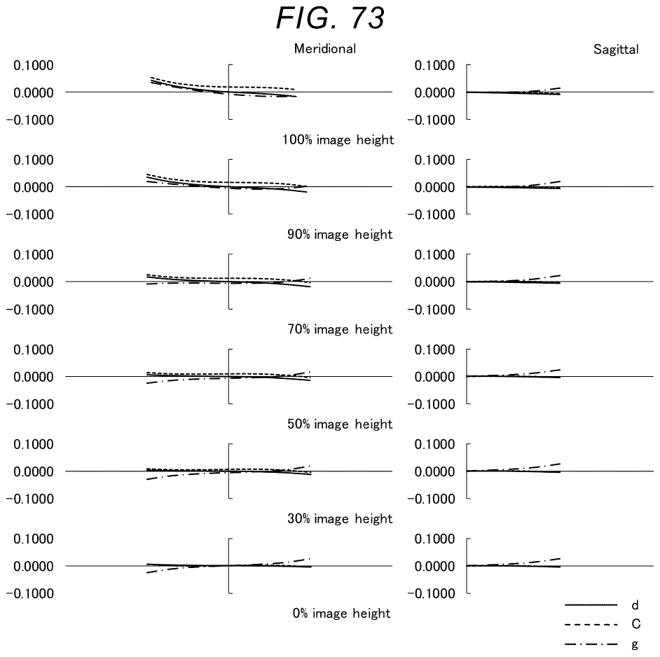

FIG. 74 is a lateral aberration diagram of the example 6 of the variable magnification imaging optical system according to the present invention at the intermediate focal length in a case of focusing on an object at a distance of 4.3 m.

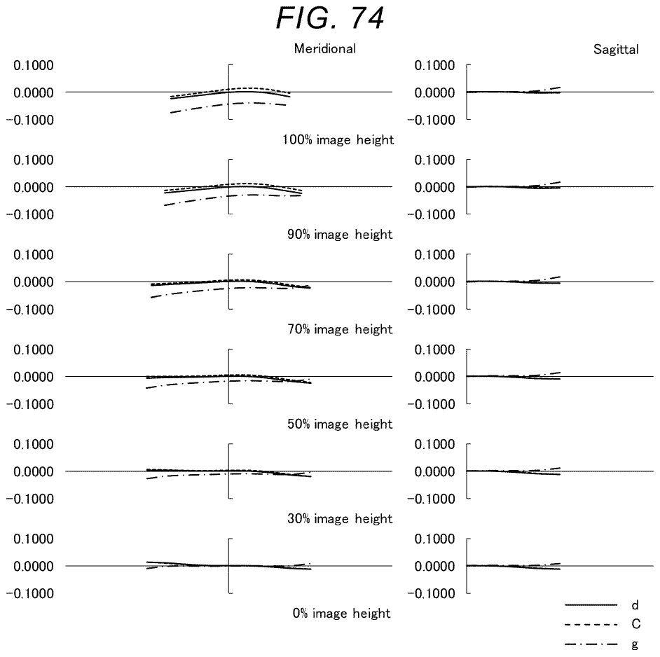

FIG. 75 is a lateral aberration diagram of the example 6 of the variable magnification imaging optical system according to the present invention at the telephoto end in a case of focusing on an object at a distance of 4.3 m.

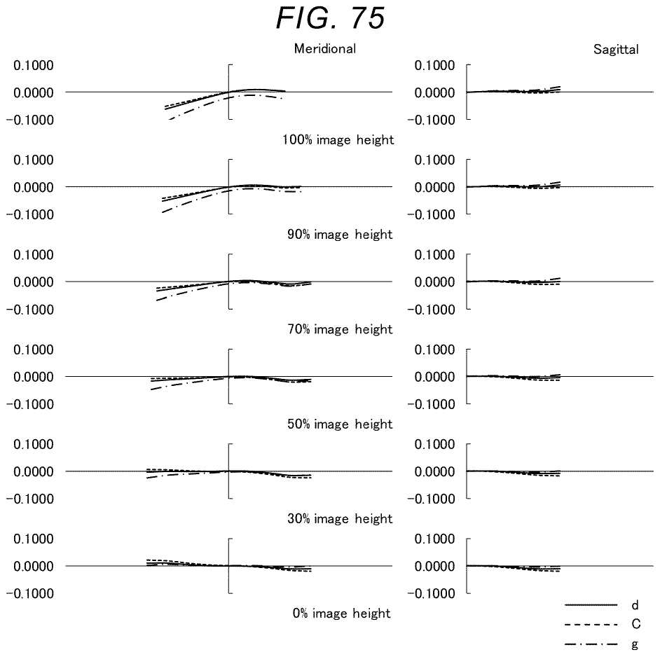

FIG. 76 is a lateral aberration diagram of the example 6 of the variable magnification imaging optical system according to the present invention at the wide-angle end in a case of vibration reduction in a case of focusing on infinity with a shake angle of 0.3 degrees.

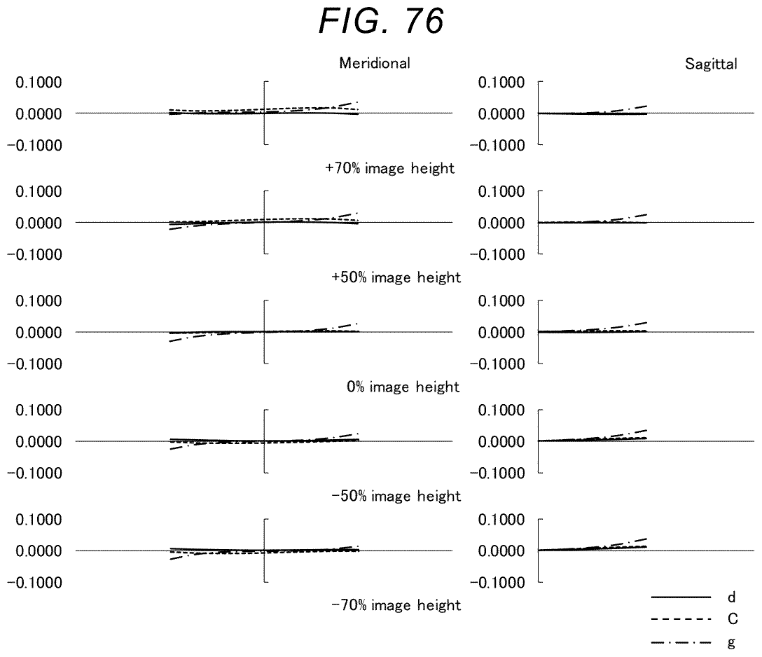

FIG. 77 is a lateral aberration diagram of the example 6 of the variable magnification imaging optical system according to the present invention at the intermediate focal length in a case of vibration reduction in a case of focusing on infinity with a shake angle of 0.3 degrees.

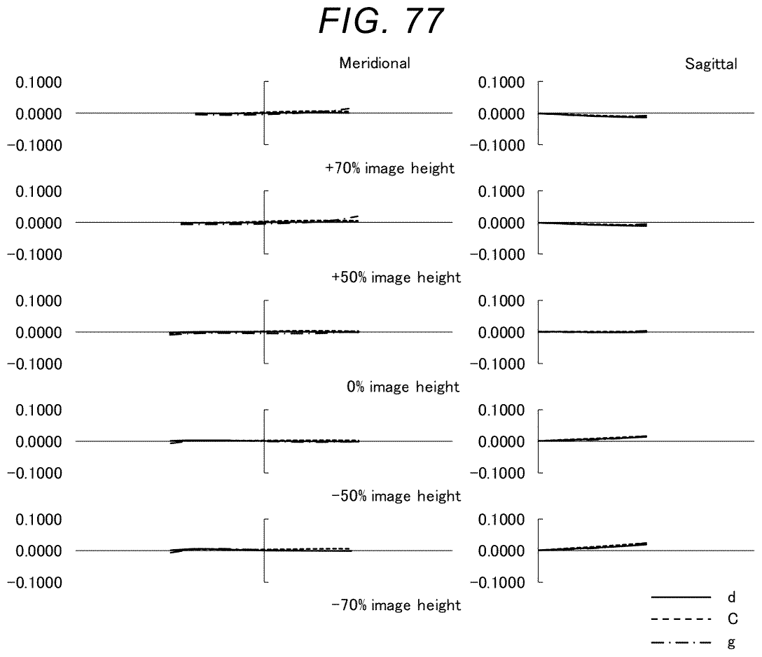

FIG. 78 is a lateral aberration diagram of the example 6 of the variable magnification imaging optical system according to the present invention at the telephoto end in a case of vibration reduction in a case of focusing on infinity with a shake angle of 0.3 degrees.

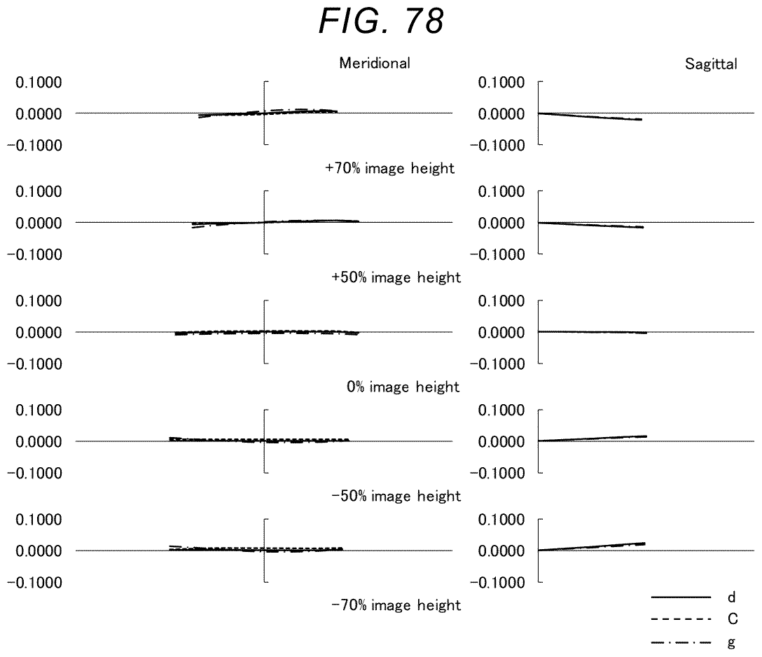

FIG. 79 is a lens configuration diagram of an example 7 of a variable magnification imaging optical system according to the present invention at a wide-angle end in a case of focusing on infinity.

FIG. 80 is a longitudinal aberration diagram of the example 7 of the variable magnification imaging optical system according to the present invention at the wide-angle end in a case of focusing on infinity.

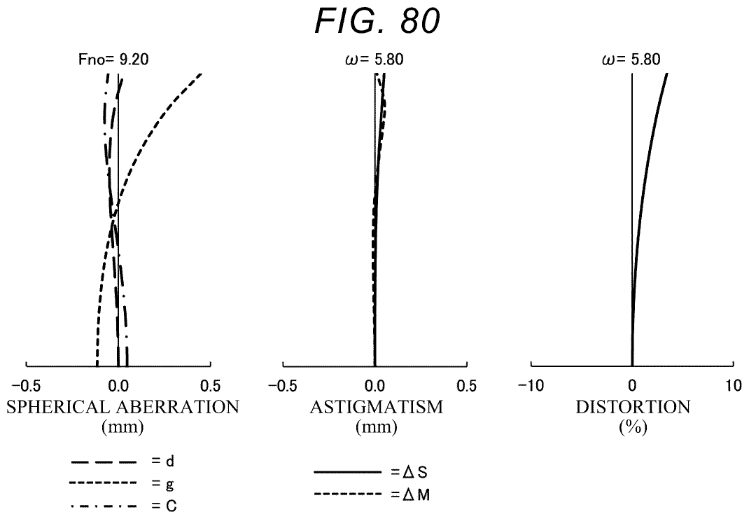

FIG. 81 is a longitudinal aberration diagram of the example 7 of the variable magnification imaging optical system according to the present invention at the intermediate focal length in a case of focusing on infinity.

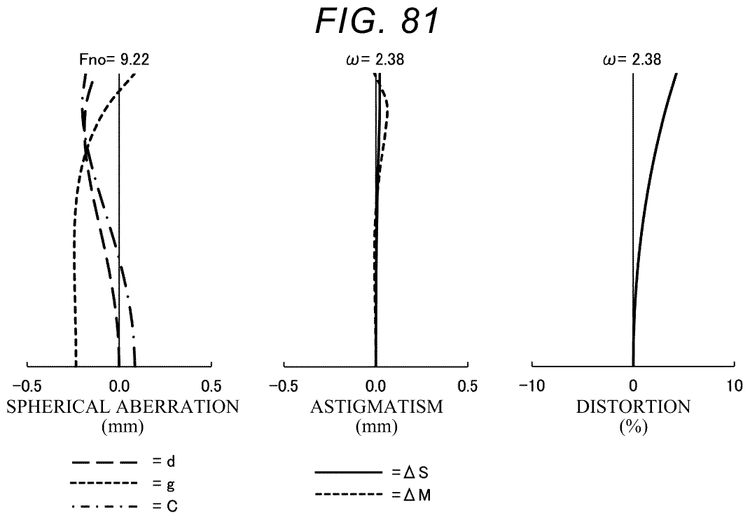

FIG. 82 is a longitudinal aberration diagram of the example 7 of the variable magnification imaging optical system according to the present invention at the telephoto end in a case of focusing on infinity.

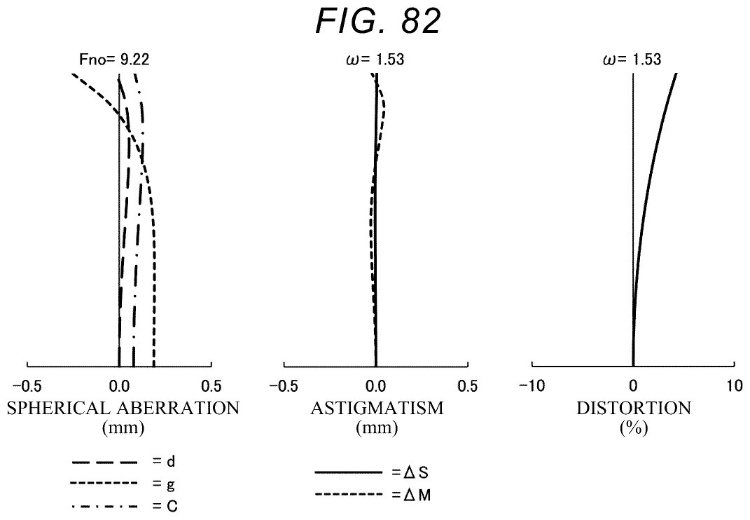

FIG. 83 is a lateral aberration diagram of the example 7 of the variable magnification imaging optical system according to the present invention at the wide-angle end in a case of focusing on infinity.

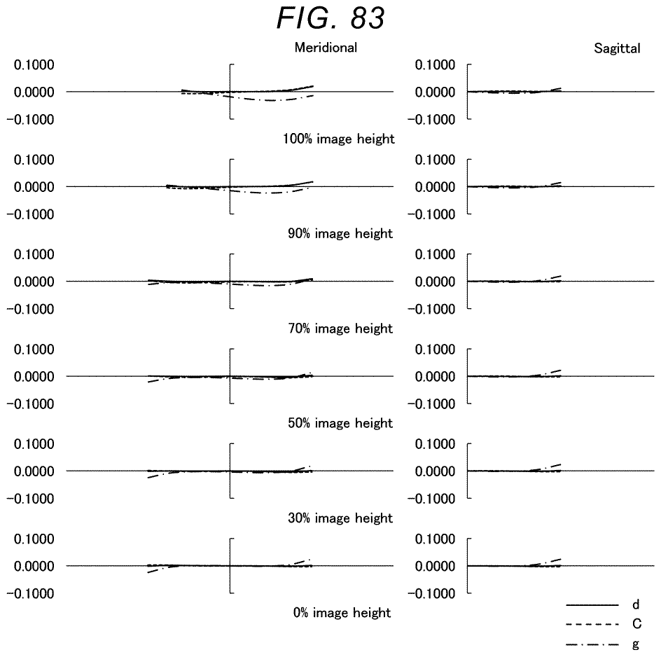

FIG. 84 is a lateral aberration diagram of the example 7 of the variable magnification imaging optical system according to the present invention at the intermediate focal length in a case of focusing on infinity.

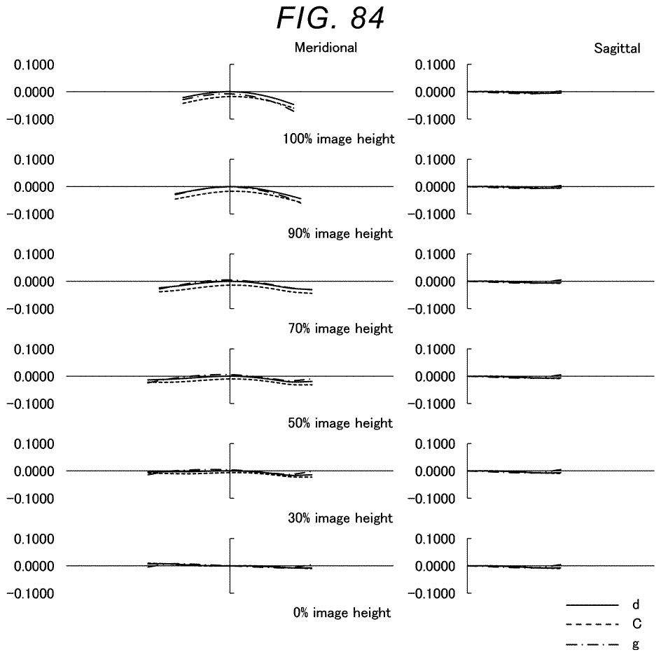

FIG. 85 is a lateral aberration diagram of the example 7 of the variable magnification imaging optical system according to the present invention at the telephoto end in a case of focusing on infinity.

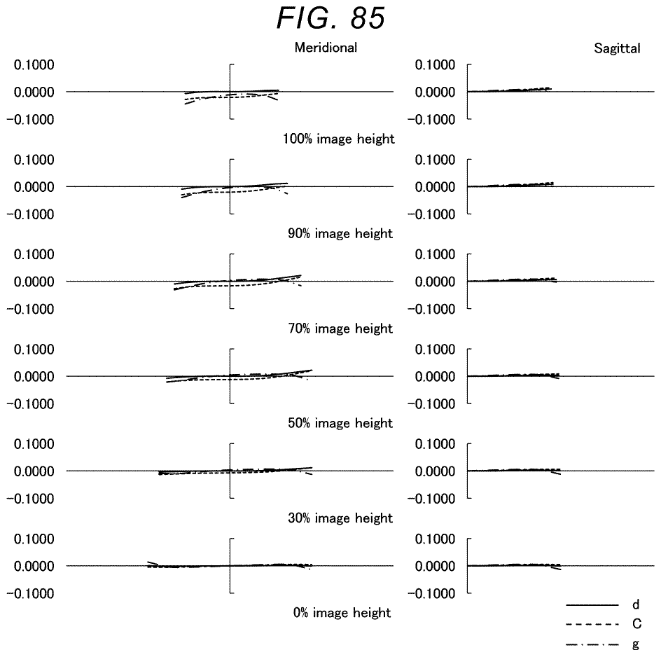

FIG. 86 is a lateral aberration diagram of the example 7 of the variable magnification imaging optical system according to the present invention at the wide-angle end in a case of focusing on an object at a distance of 4.2 m.

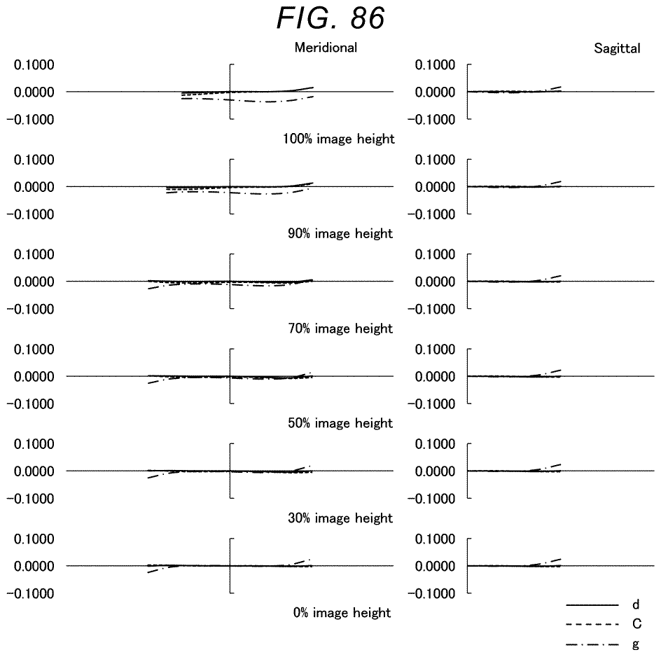

FIG. 87 is a lateral aberration diagram of the example 7 of the variable magnification imaging optical system according to the present invention at the intermediate focal length in a case of focusing on an object at a distance of 4.2 m.

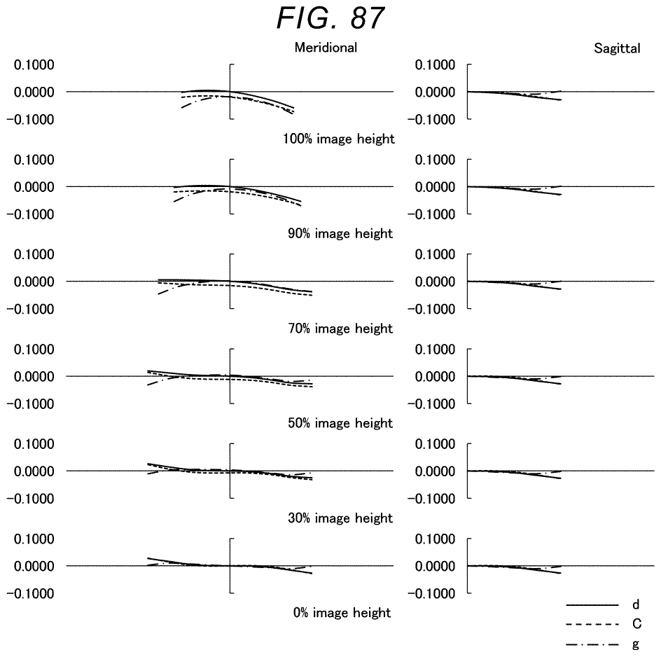

FIG. 88 is a lateral aberration diagram of the example 7 of the variable magnification imaging optical system according to the present invention at the telephoto end in a case of focusing on an object at a distance of 4.2 m.

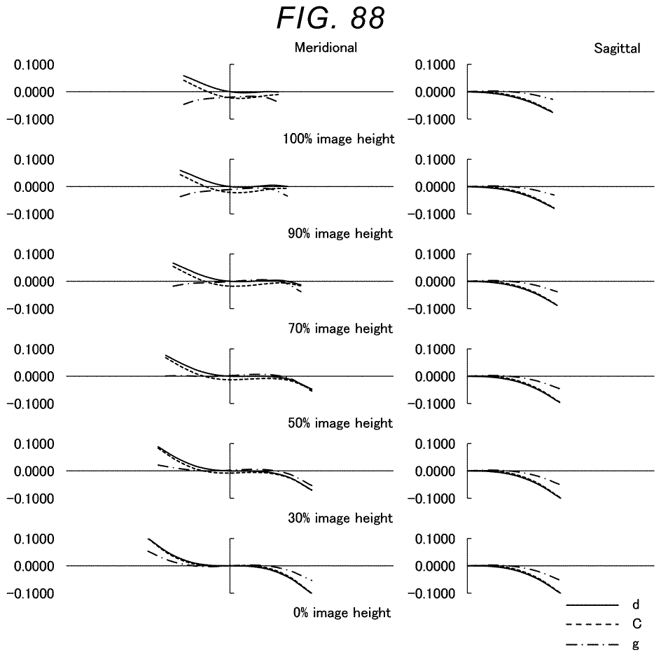

FIG. 89 is a lateral aberration diagram of the example 7 of the variable magnification imaging optical system according to the present invention at the wide-angle end in a case of vibration reduction in a case of focusing on infinity with a shake angle of 0.3 degrees.

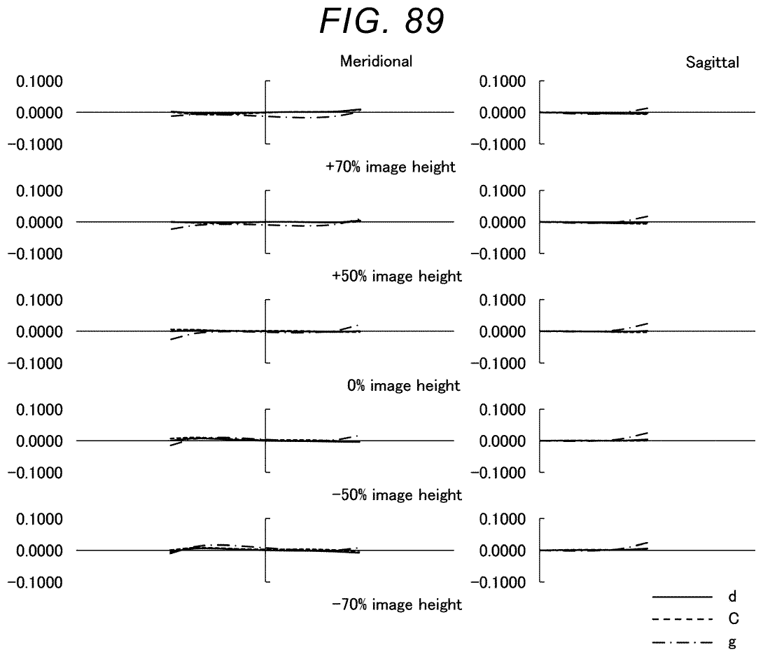

FIG. 90 is a lateral aberration diagram of the example 7 of the variable magnification imaging optical system according to the present invention at the intermediate focal length in a case of vibration reduction in a case of focusing on infinity with a shake angle of 0.3 degrees.

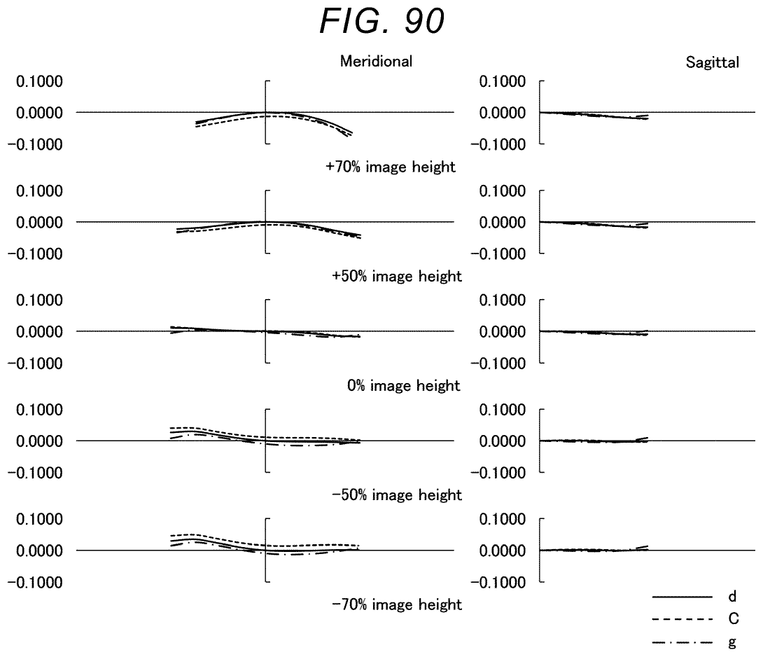

FIG. 91 is a lateral aberration diagram of the example 7 of the variable magnification imaging optical system according to the present invention at the telephoto end in a case of vibration reduction in a case of focusing on infinity with a shake angle of 0.3 degrees.

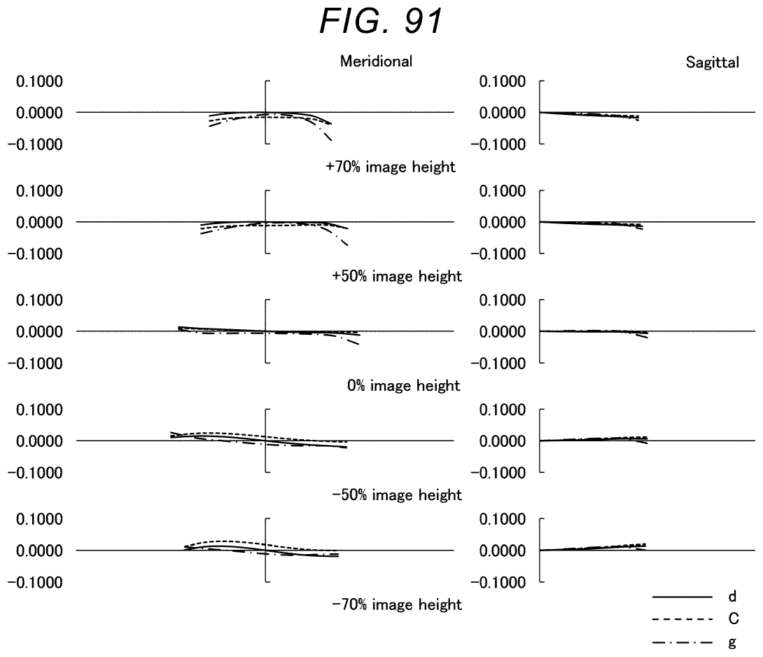

FIG. 92 is a lens configuration diagram of an example 8 of a variable magnification imaging optical system according to the present invention at a wide-angle end in a case of focusing on infinity.

FIG. 93 is a longitudinal aberration diagram of the example 8 of the variable magnification imaging optical system according to the present invention at the wide-angle end in a case of focusing on infinity.

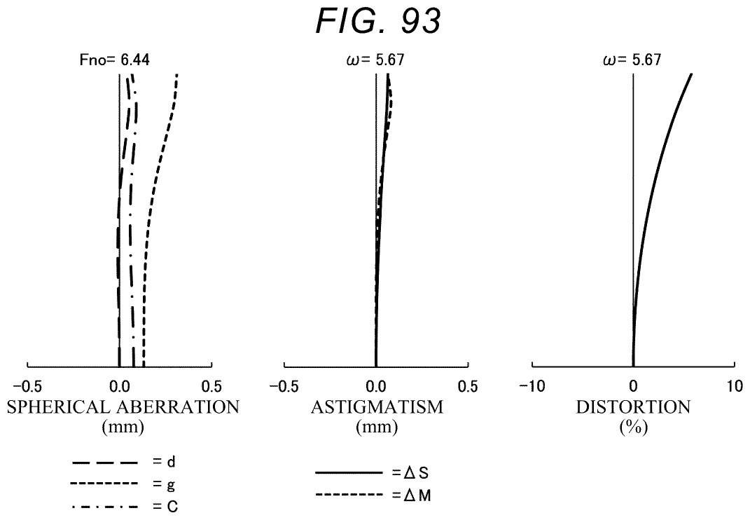

FIG. 94 is a longitudinal aberration diagram of the example 8 of the variable magnification imaging optical system according to the present invention at the intermediate focal length in a case of focusing on infinity.

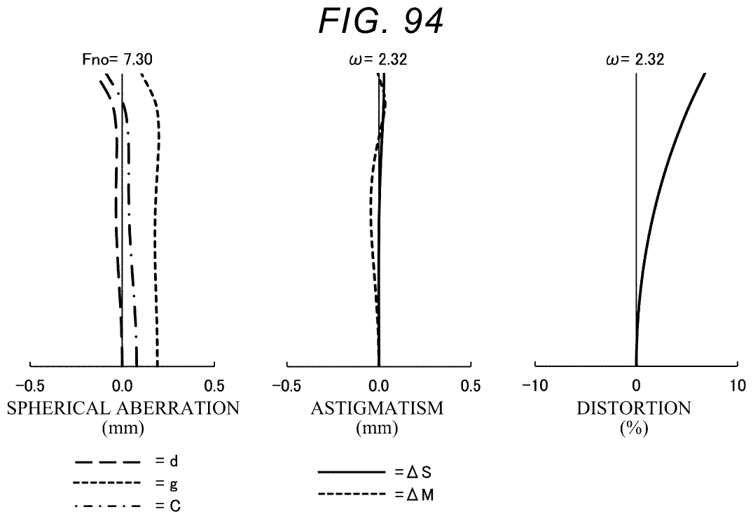

FIG. 95 is a longitudinal aberration diagram of the example 8 of the variable magnification imaging optical system according to the present invention at the telephoto end in a case of focusing on infinity.

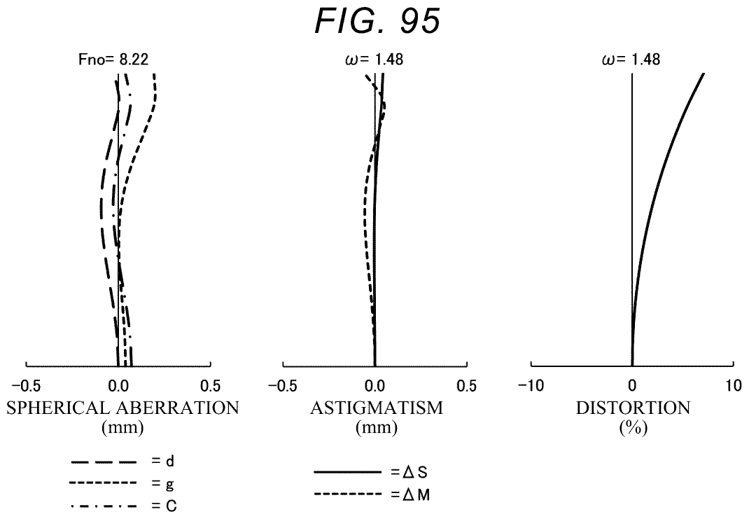

FIG. 96 is a lateral aberration diagram of the example 8 of the variable magnification imaging optical system according to the present invention at the wide-angle end in a case of focusing on infinity.

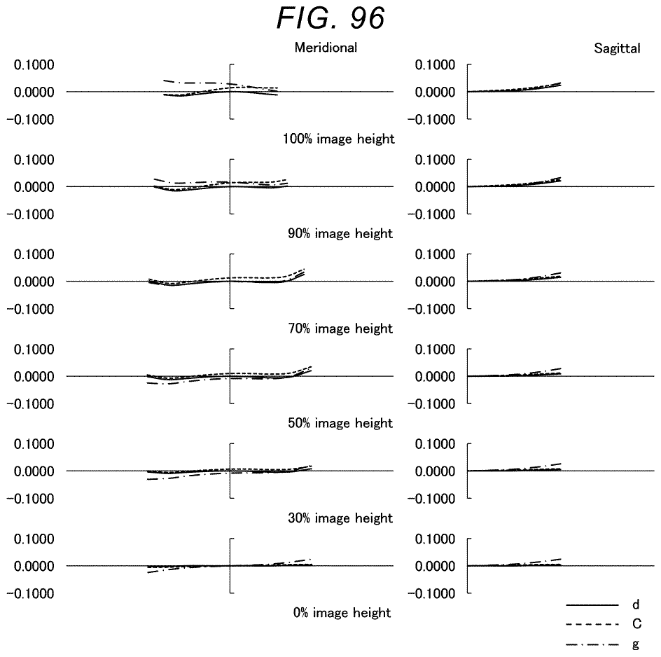

FIG. 97 is a lateral aberration diagram of the example 8 of the variable magnification imaging optical system according to the present invention at the intermediate focal length in a case of focusing on infinity.

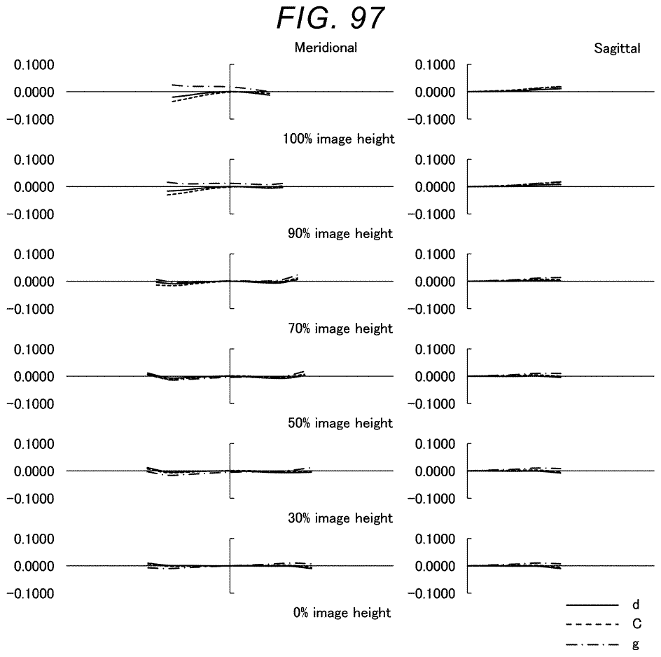

FIG. 98 is a lateral aberration diagram of the example 8 of the variable magnification imaging optical system according to the present invention at the telephoto end in a case of focusing on infinity.

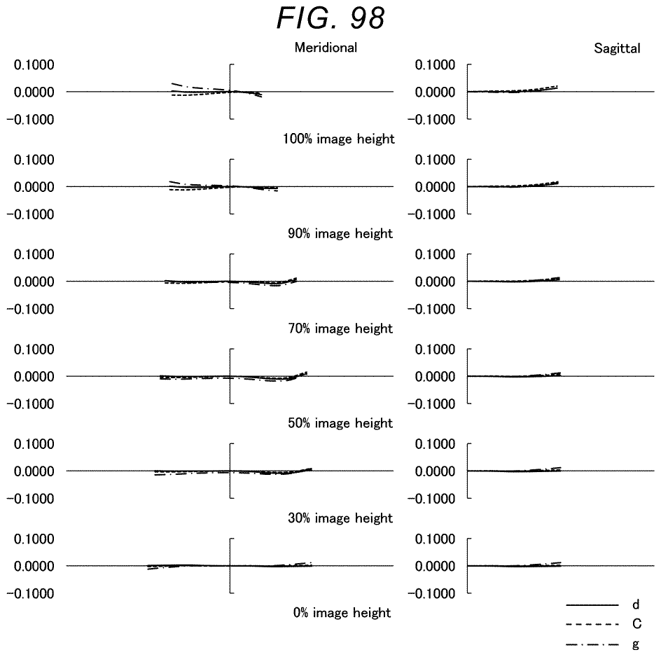

FIG. 99 is a lateral aberration diagram of the example 8 of the variable magnification imaging optical system according to the present invention at the wide-angle end in a case of focusing on an object at a distance of 3.5 m.

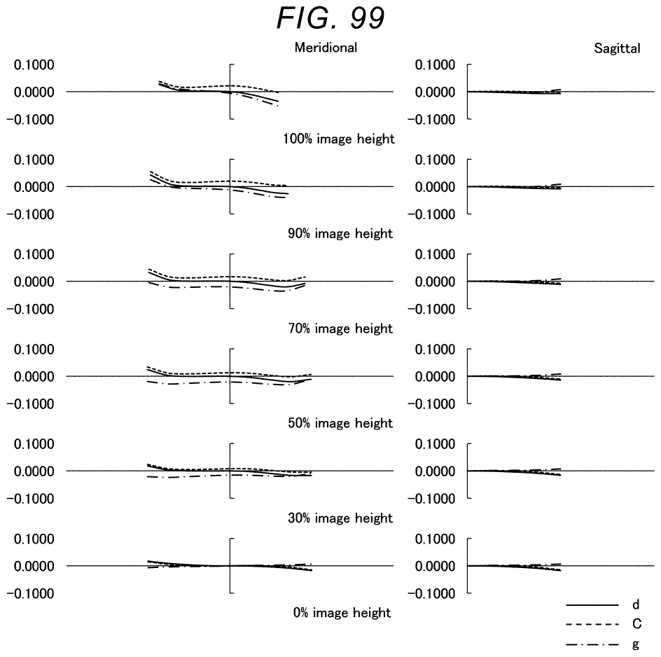

FIG. 100 is a lateral aberration diagram of the example 8 of the variable magnification imaging optical system according to the present invention at the intermediate focal length in a case of focusing on an object at a distance of 3.5 m.

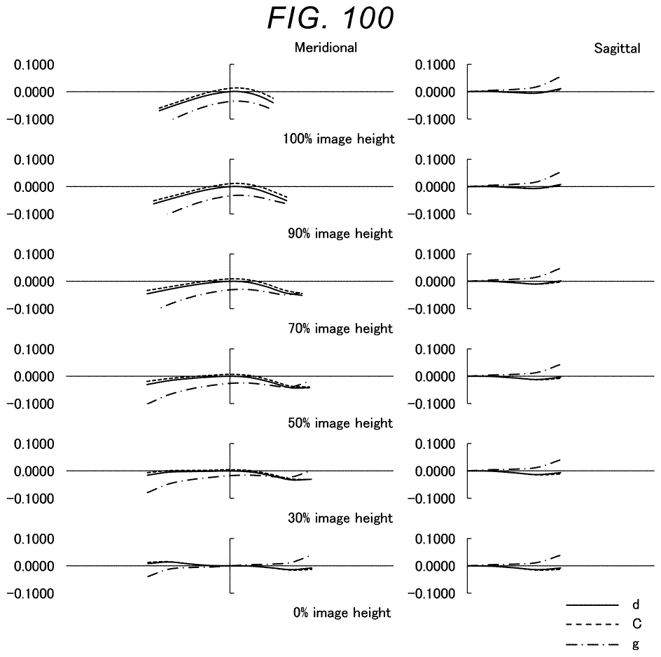

FIG. 101 is a lateral aberration diagram of the example 8 of the variable magnification imaging optical system according to the present invention at the telephoto end in a case of focusing on an object at a distance of 3.5 m.

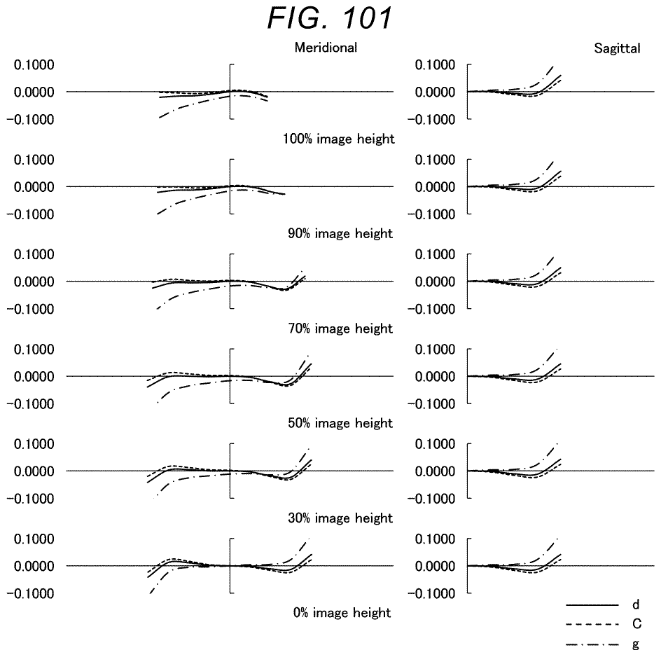

FIG. 102 is a lateral aberration diagram of the example 8 of the variable magnification imaging optical system according to the present invention at the wide-angle end in a case of vibration reduction in a case of focusing on infinity with a shake angle of 0.3 degrees.

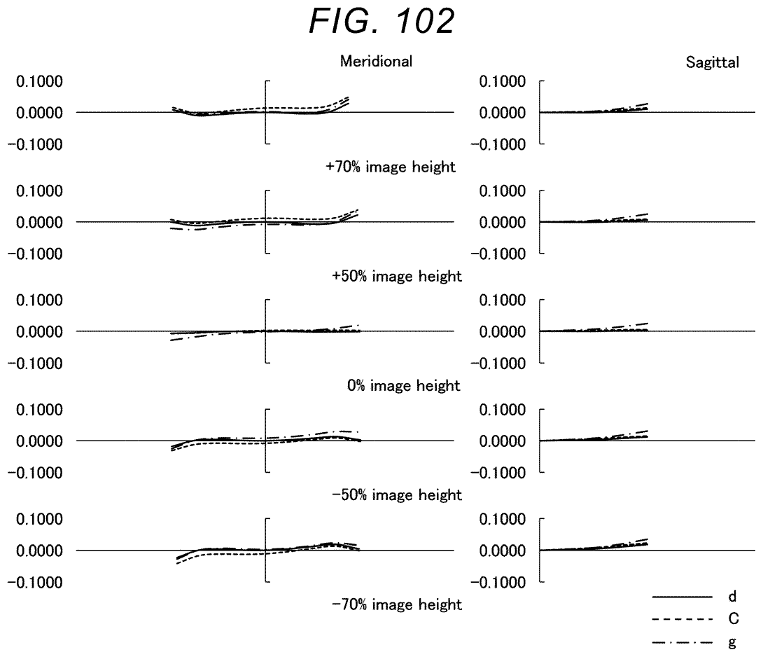

FIG. 103 is a lateral aberration diagram of the example 8 of the variable magnification imaging optical system according to the present invention at the intermediate focal length in a case of vibration reduction in a case of focusing on infinity with a shake angle of 0.3 degrees.

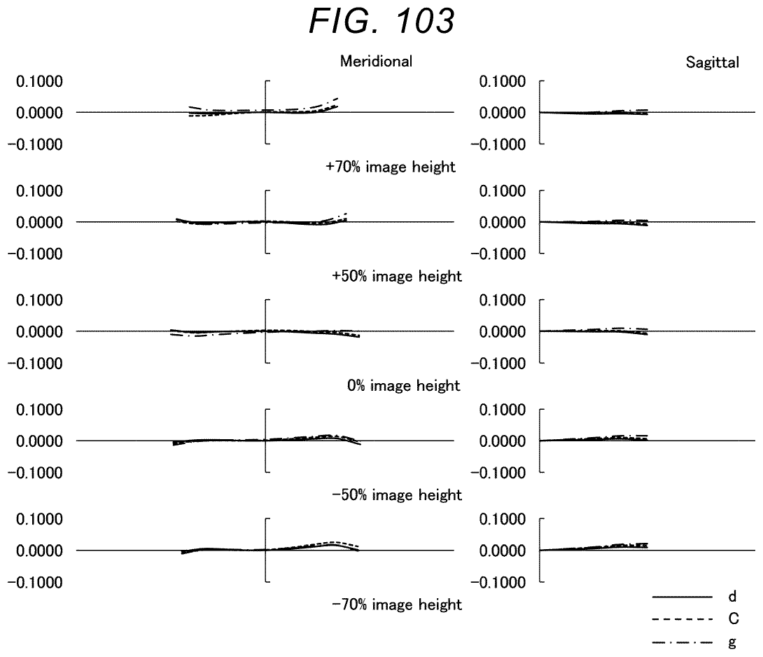

FIG. 104 is a lateral aberration diagram of the example 8 of the variable magnification imaging optical system according to the present invention at the telephoto end in a case of vibration reduction in a case of focusing on infinity with a shake angle of 0.3 degrees.

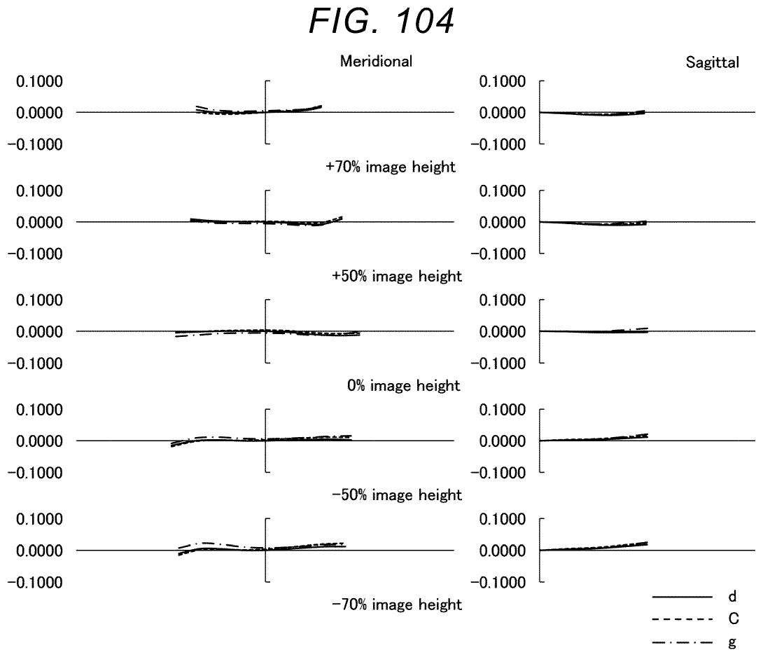

FIG. 105 is a lens configuration diagram of an example 9 of a variable magnification imaging optical system according to the present invention at a wide-angle end in a case of focusing on infinity.

FIG. 106 is a longitudinal aberration diagram of the example 9 of the variable magnification imaging optical system according to the present invention at the wide-angle end in a case of focusing on infinity.

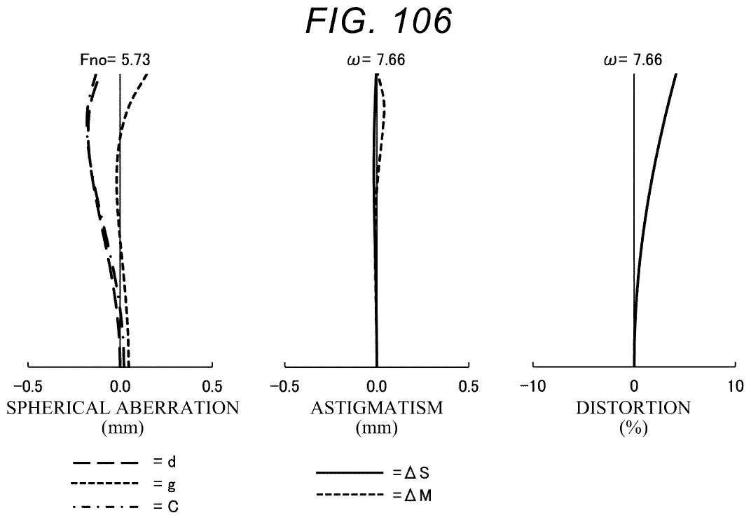

FIG. 107 is a longitudinal aberration diagram of the example 9 of the variable magnification imaging optical system according to the present invention at the intermediate focal length in a case of focusing on infinity.

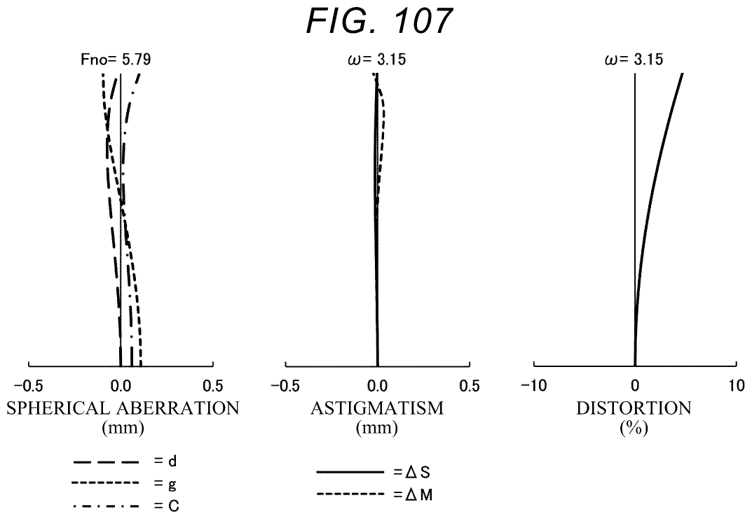

FIG. 108 is a longitudinal aberration diagram of the example 9 of the variable magnification imaging optical system according to the present invention at the telephoto end in a case of focusing on infinity.

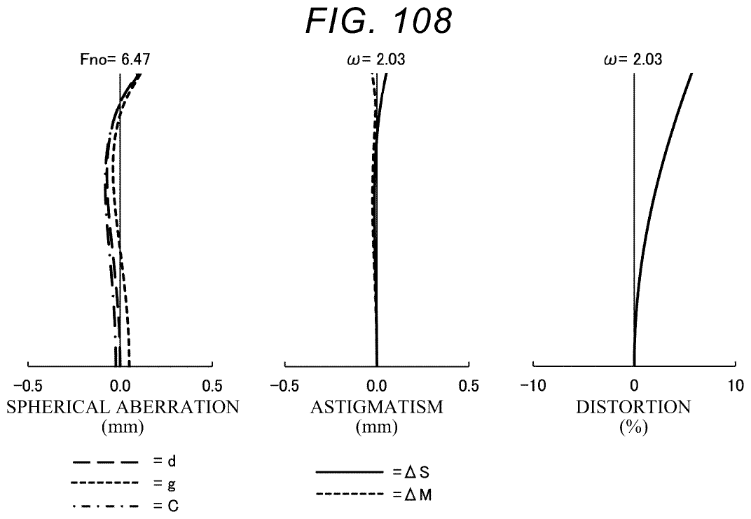

FIG. 109 is a lateral aberration diagram of the example 9 of the variable magnification imaging optical system according to the present invention at the wide-angle end in a case of focusing on infinity.

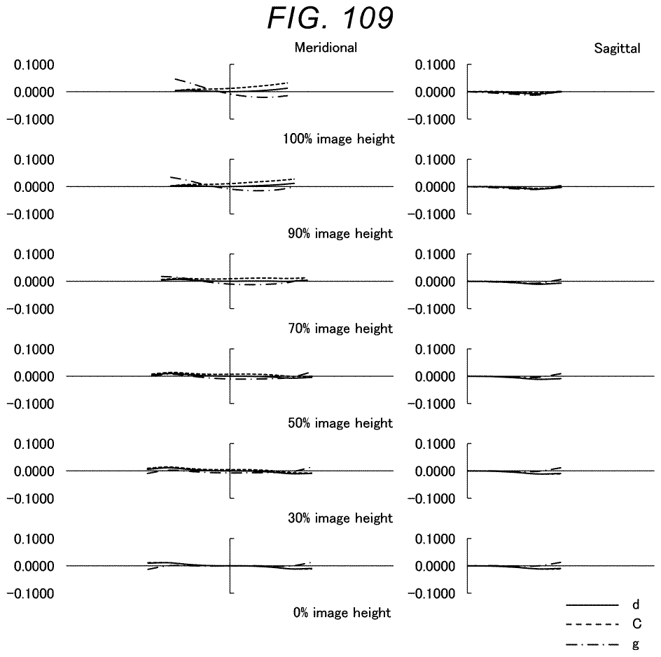

FIG. 110 is a lateral aberration diagram of the example 9 of the variable magnification imaging optical system according to the present invention at the intermediate focal length in a case of focusing on infinity.

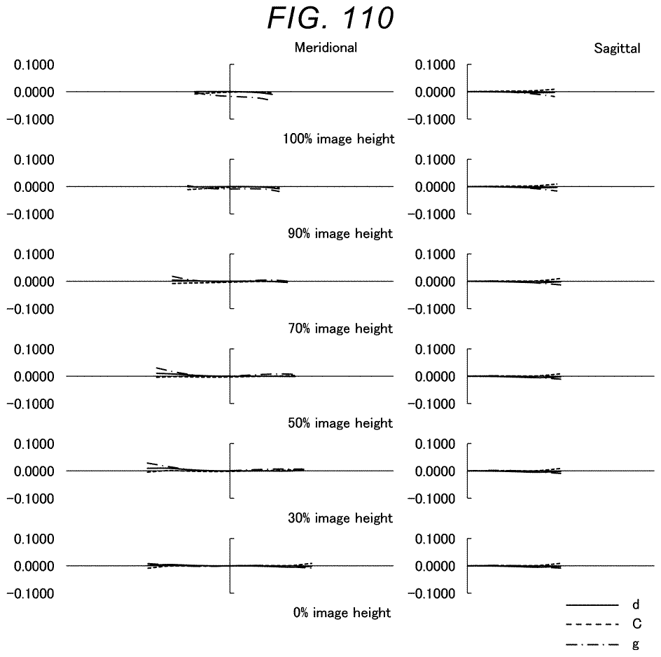

FIG. 111 is a lateral aberration diagram of the example 9 of the variable magnification imaging optical system according to the present invention at the telephoto end in a case of focusing on infinity.

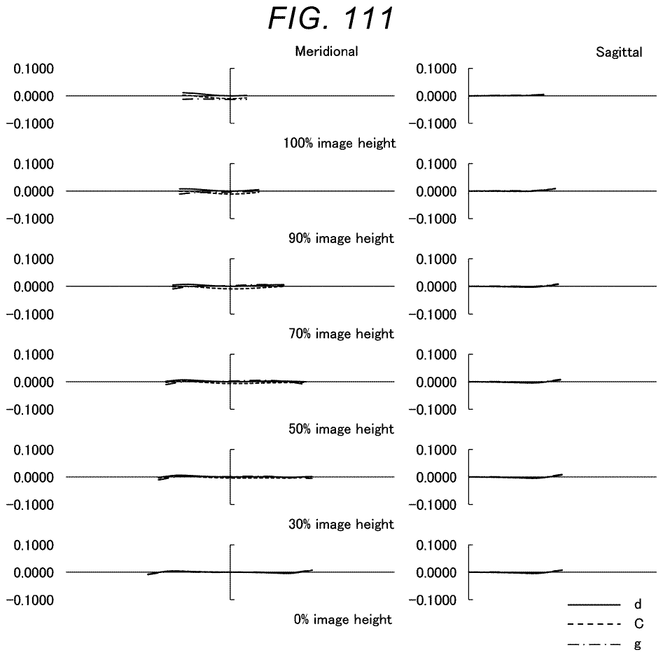

FIG. 112 is a lateral aberration diagram of the example 9 of the variable magnification imaging optical system according to the present invention at the wide-angle end in a case of focusing on an object at a distance of 2.6 m.

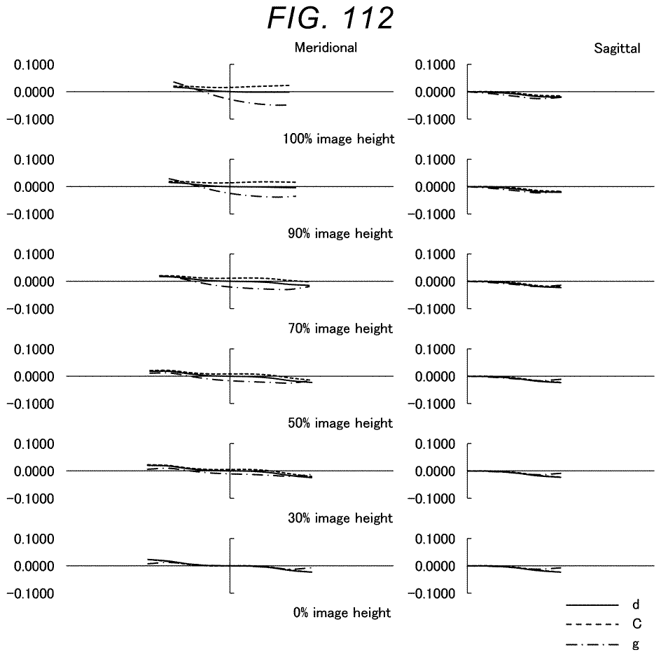

FIG. 113 is a lateral aberration diagram of the example 9 of the variable magnification imaging optical system according to the present invention at the intermediate focal length in a case of focusing on an object at a distance of 2.6 m.

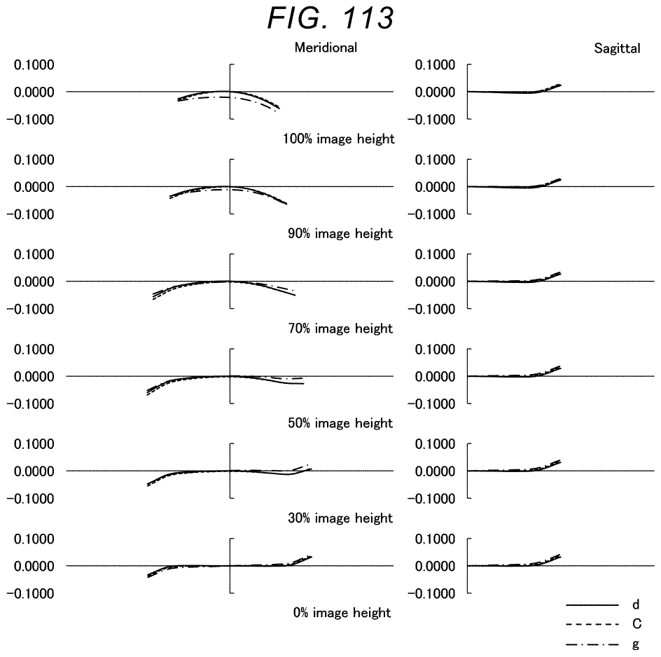

FIG. 114 is a lateral aberration diagram of the example 9 of the variable magnification imaging optical system according to the present invention at the telephoto end in a case of focusing on an object at a distance of 2.6 m.

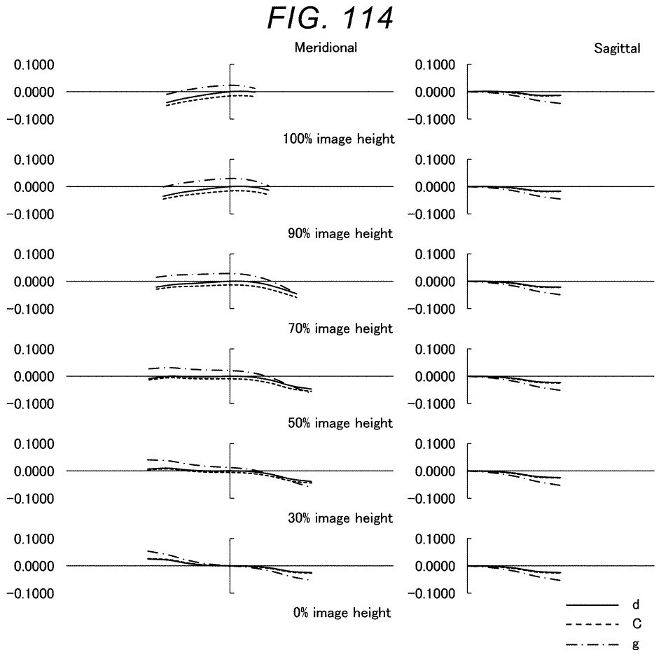

FIG. 115 is a lateral aberration diagram of the example 9 of the variable magnification imaging optical system according to the present invention at the wide-angle end in a case of vibration reduction in a case of focusing on infinity with a shake angle of 0.3 degrees.

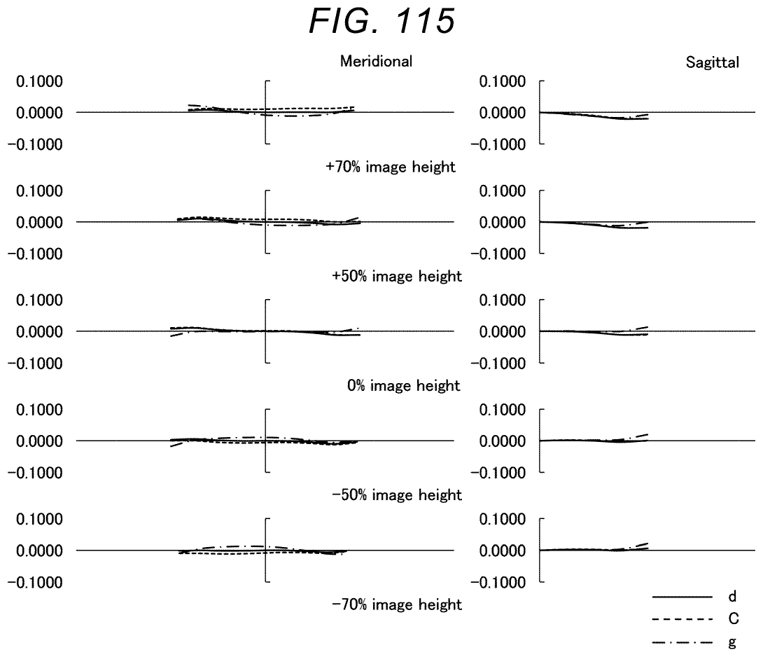

FIG. 116 is a lateral aberration diagram of the example 9 of the variable magnification imaging optical system according to the present invention at the intermediate focal length in a case of vibration reduction in a case of focusing on infinity with a shake angle of 0.3 degrees.

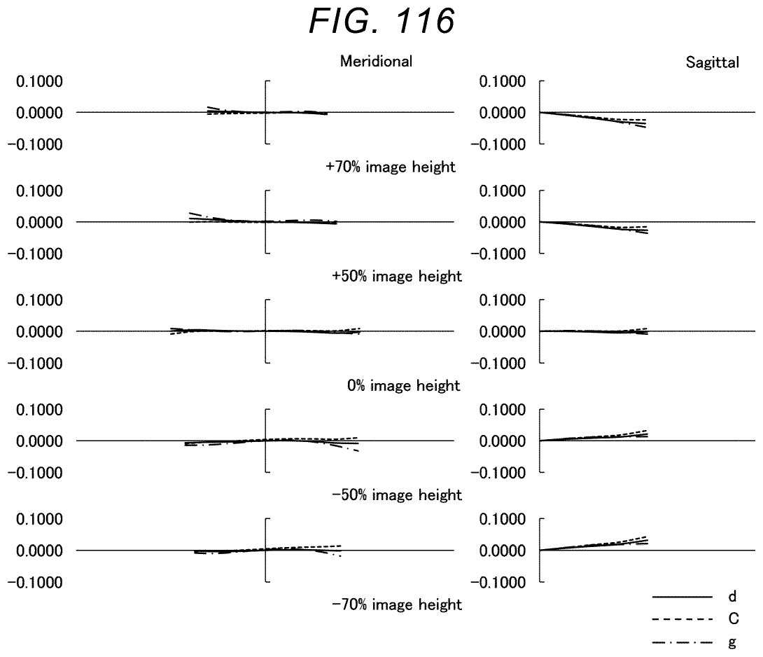

FIG. 117 is a lateral aberration diagram of the example 9 of the variable magnification imaging optical system according to the present invention at the telephoto end in a case of vibration reduction in a case of focusing on infinity with a shake angle of 0.3 degrees.

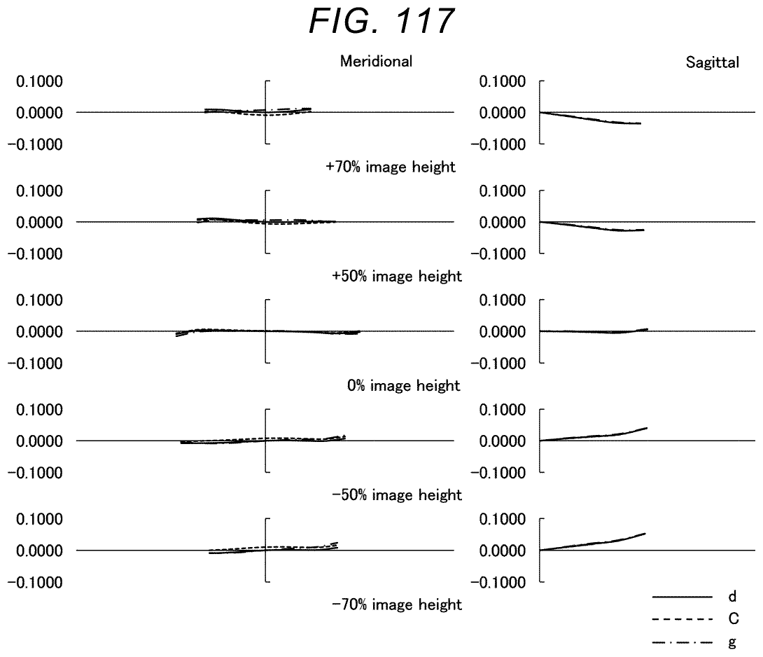

FIG. 118 is a lens configuration diagram of an example 10 of a variable magnification imaging optical system according to the present invention at a wide-angle end in a case of focusing on infinity.

FIG. 119 is a longitudinal aberration diagram of the example 10 of the variable magnification imaging optical system according to the present invention at the wide-angle end in a case of focusing on infinity.

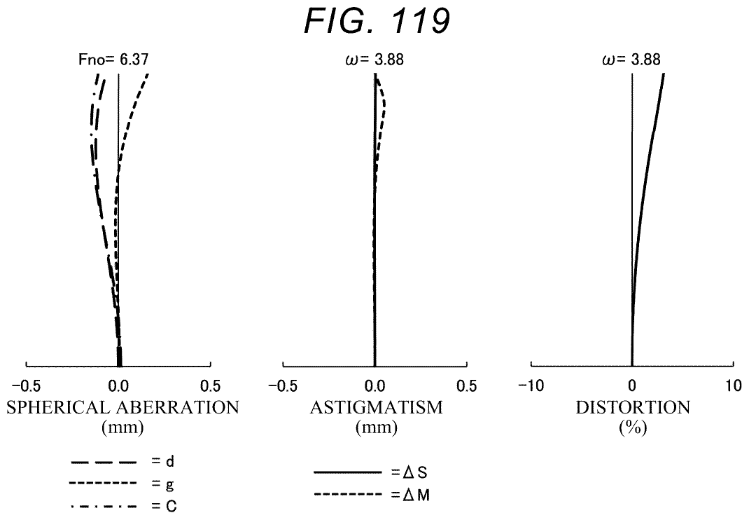

FIG. 120 is a longitudinal aberration diagram of the example 10 of the variable magnification imaging optical system according to the present invention at the intermediate focal length in a case of focusing on infinity.

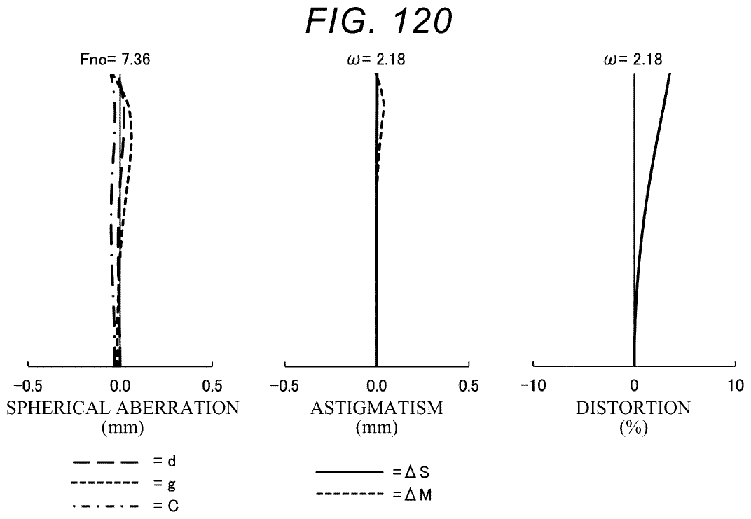

FIG. 121 is a longitudinal aberration diagram of the example 10 of the variable magnification imaging optical system according to the present invention at the telephoto end in a case of focusing on infinity.

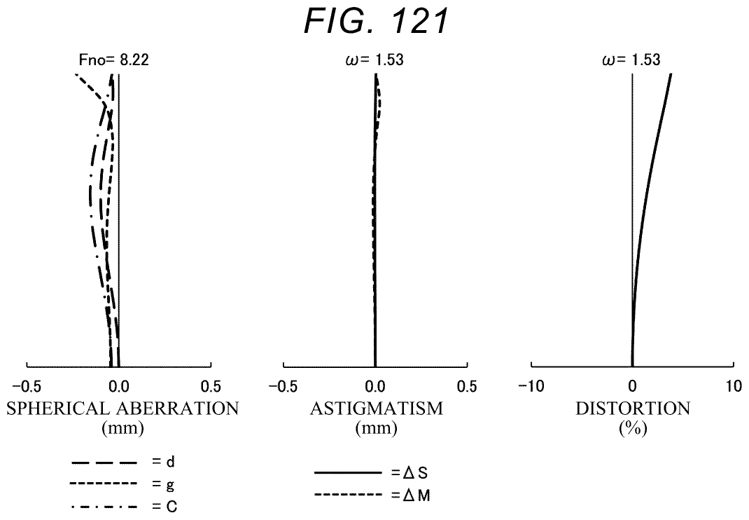

FIG. 122 is a lateral aberration diagram of the example 10 of the variable magnification imaging optical system according to the present invention at the wide-angle end in a case of focusing on infinity.

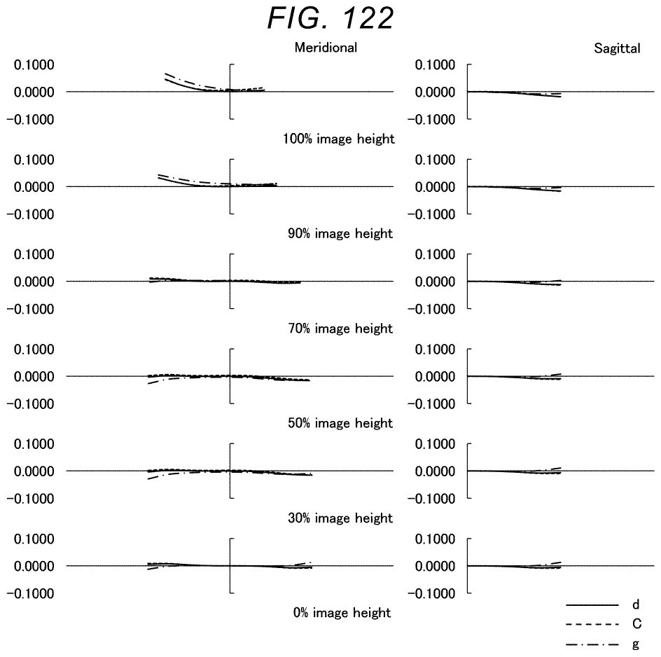

FIG. 123 is a lateral aberration diagram of the example 10 of the variable magnification imaging optical system according to the present invention at the intermediate focal length in a case of focusing on infinity.

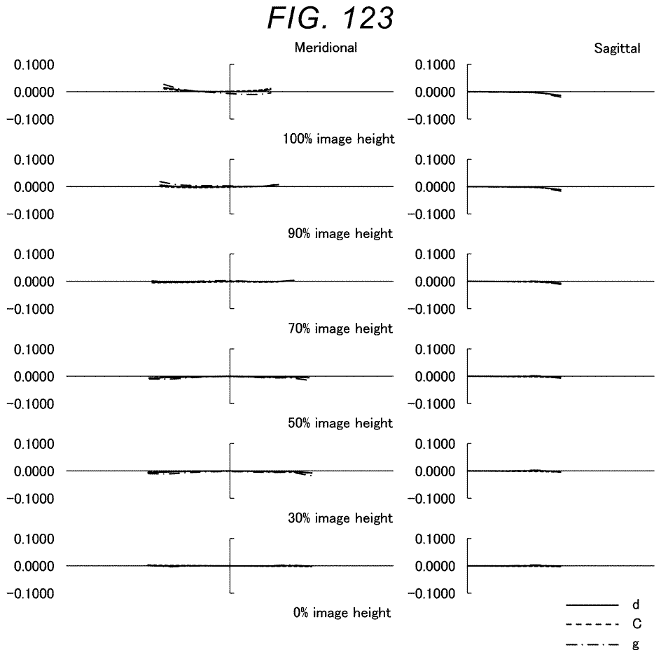

FIG. 124 is a lateral aberration diagram of the example 10 of the variable magnification imaging optical system according to the present invention at the telephoto end in a case of focusing on infinity.

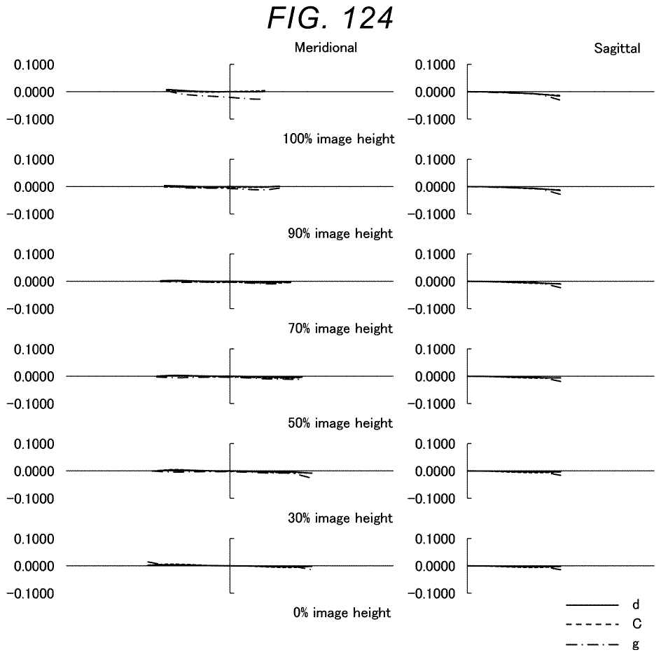

FIG. 125 is a lateral aberration diagram of the example 10 of the variable magnification imaging optical system according to the present invention at the wide-angle end in a case of focusing on an object at a distance of 3.5 m.

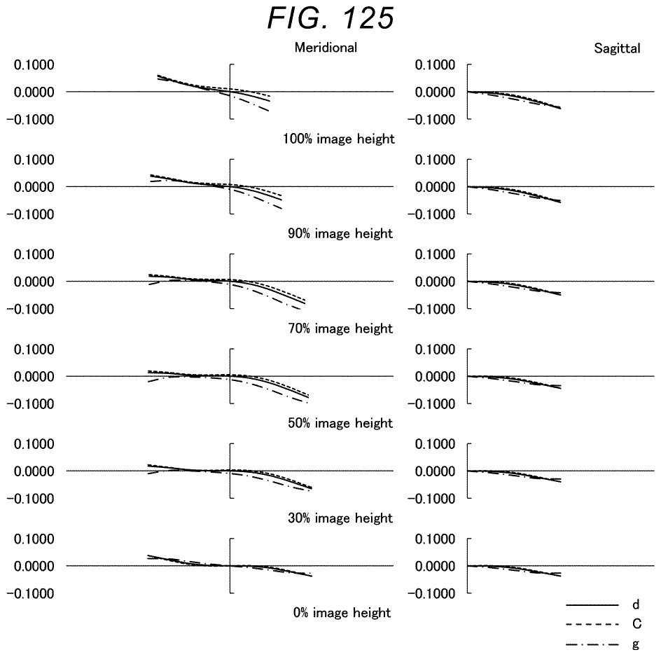

FIG. 126 is a lateral aberration diagram of the example 10 of the variable magnification imaging optical system according to the present invention at the intermediate focal length in a case of focusing on an object at a distance of 3.5 m.

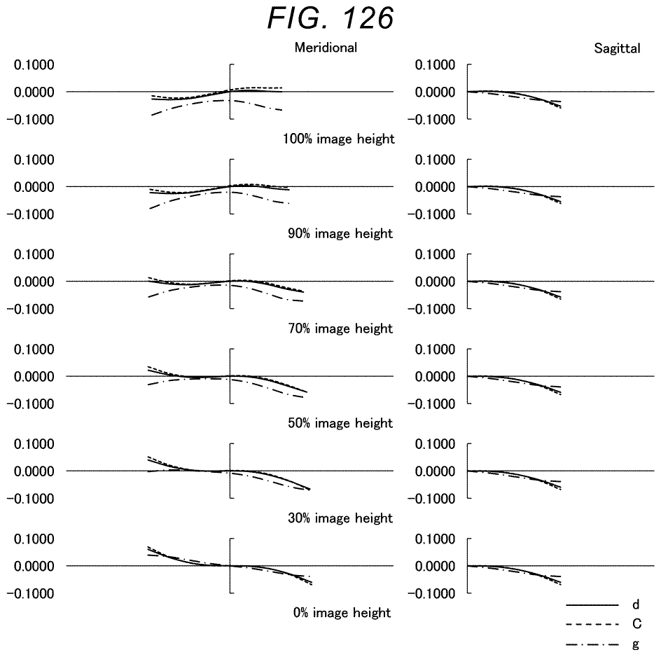

FIG. 127 is a lateral aberration diagram of the example 10 of the variable magnification imaging optical system according to the present invention at the telephoto end in a case of focusing on an object at a distance of 3.5 m.

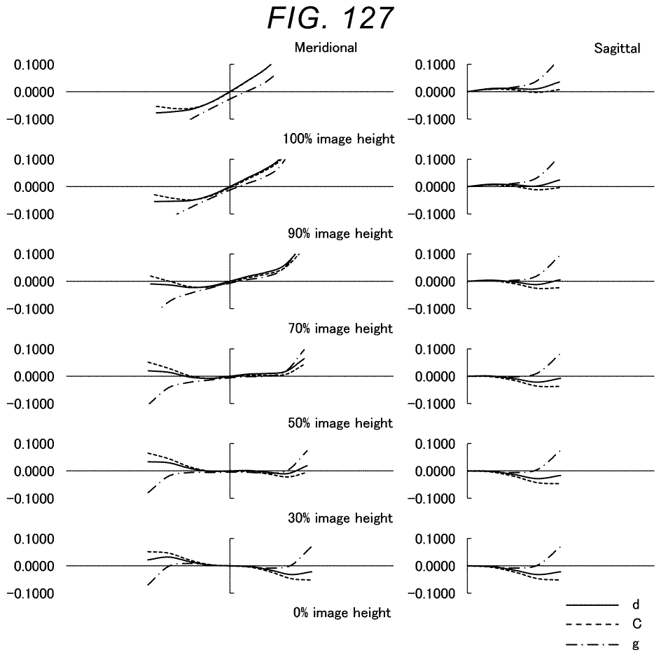

FIG. 128 is a lateral aberration diagram of the example 10 of the variable magnification imaging optical system according to the present invention at the wide-angle end in a case of vibration reduction in a case of focusing on infinity with a shake angle of 0.3 degrees.

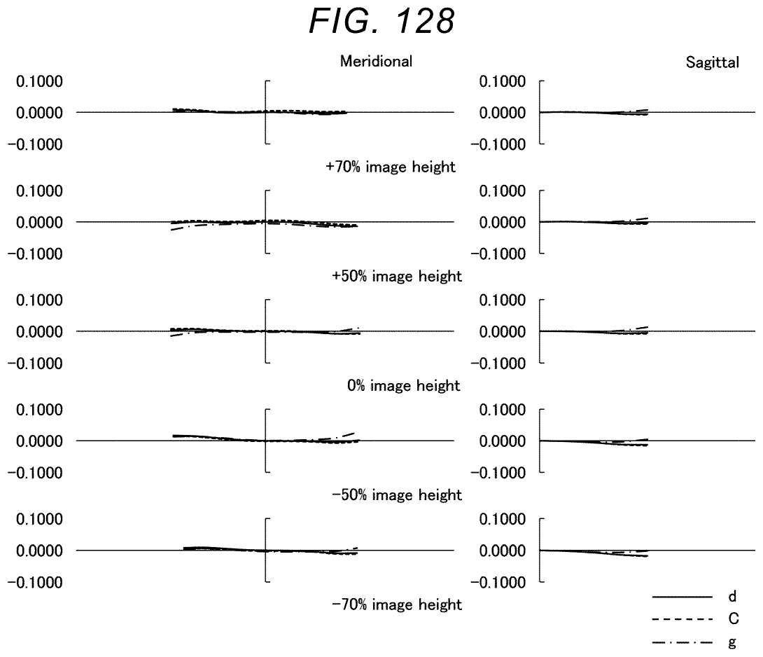

FIG. 129 is a lateral aberration diagram of the example 10 of the variable magnification imaging optical system according to the present invention at the intermediate focal length in a case of vibration reduction in a case of focusing on infinity with a shake angle of 0.3 degrees.

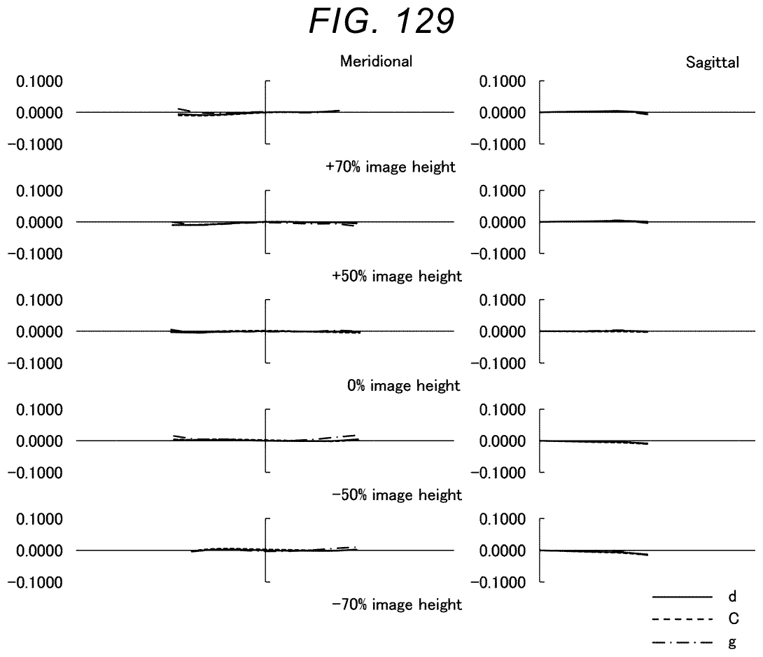

FIG. 130 is a lateral aberration diagram of the example 10 of the variable magnification imaging optical system according to the present invention at the telephoto end in a case of vibration reduction in a case of focusing on infinity with a shake angle of 0.3 degrees.

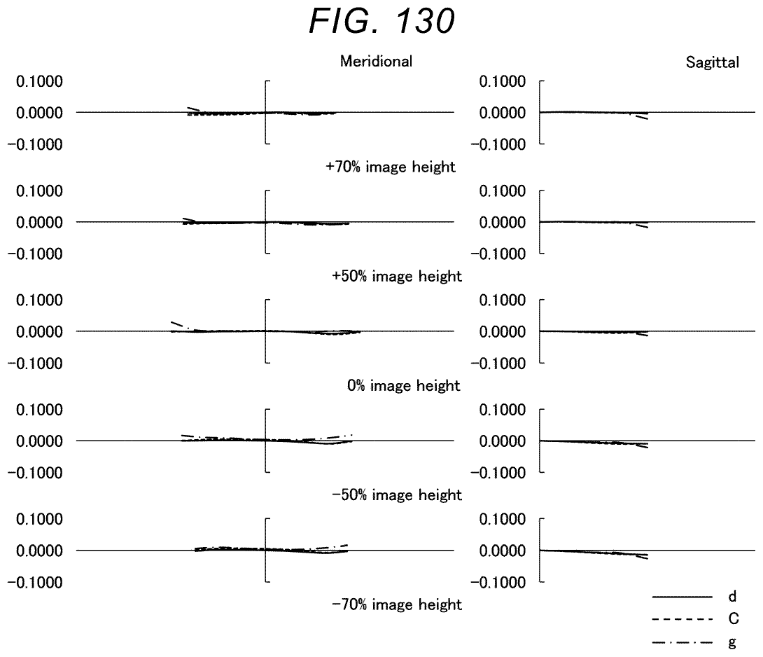

FIG. 131 is a lens configuration diagram of an example 11 of a variable magnification imaging optical system according to the present invention at a wide-angle end in a case of focusing on infinity.

FIG. 132 is a longitudinal aberration diagram of the example 11 of the variable magnification imaging optical system according to the present invention at the wide-angle end in a case of focusing on infinity.

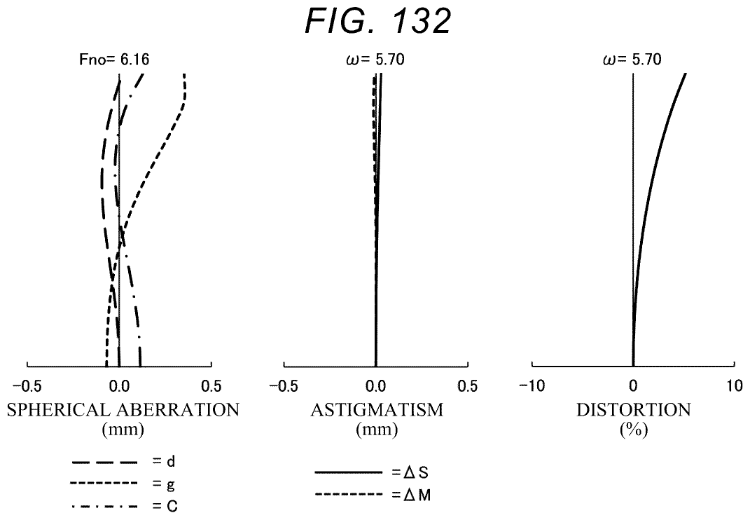

FIG. 133 is a longitudinal aberration diagram of the example 11 of the variable magnification imaging optical system according to the present invention at the intermediate focal length in a case of focusing on infinity.

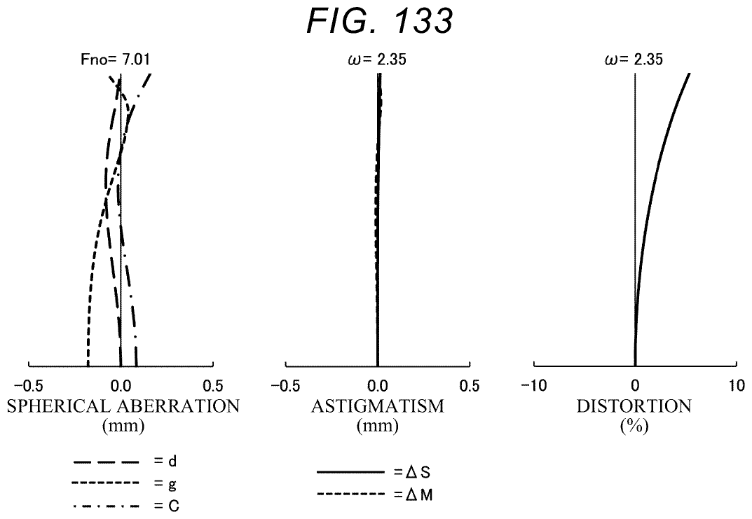

FIG. 134 is a longitudinal aberration diagram of the example 11 of the variable magnification imaging optical system according to the present invention at the telephoto end in a case of focusing on infinity.

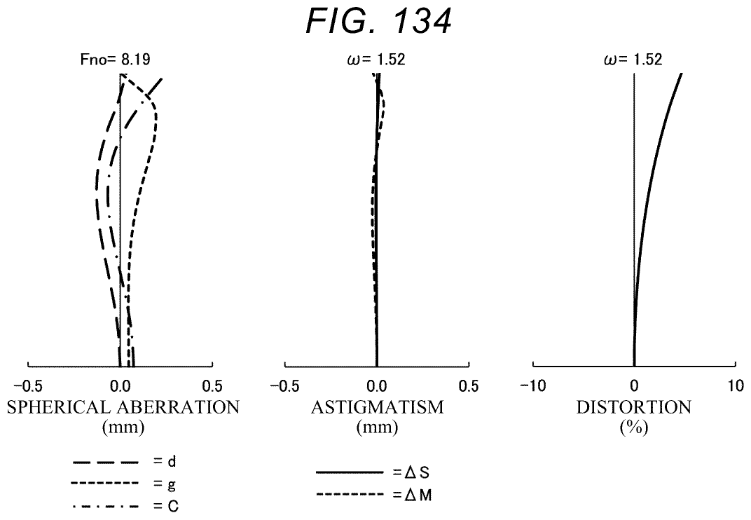

FIG. 135 is a lateral aberration diagram of the example 11 of the variable magnification imaging optical system according to the present invention at the wide-angle end in a case of focusing on infinity.

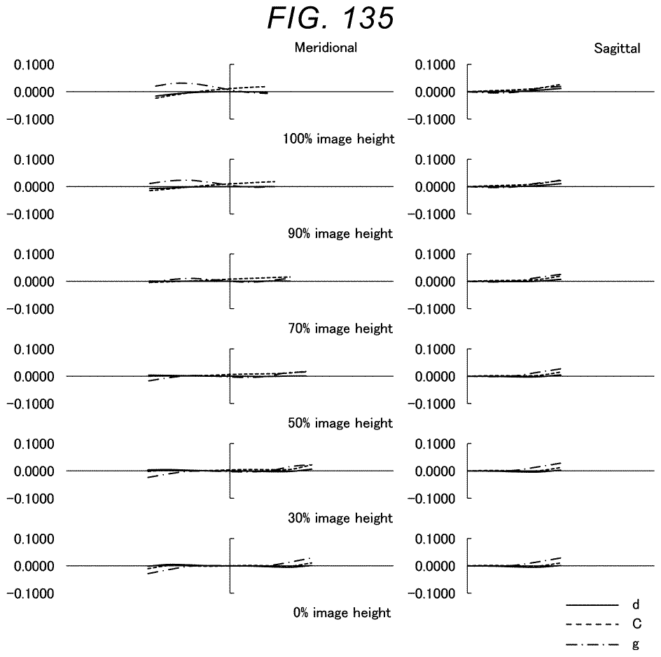

FIG. 136 is a lateral aberration diagram of the example 11 of the variable magnification imaging optical system according to the present invention at the intermediate focal length in a case of focusing on infinity.

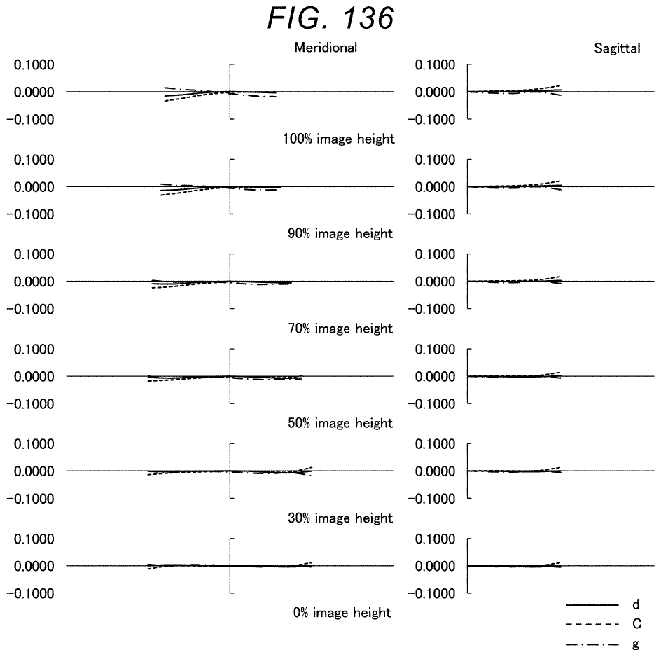

FIG. 137 is a lateral aberration diagram of the example 11 of the variable magnification imaging optical system according to the present invention at the telephoto end in a case of focusing on infinity.

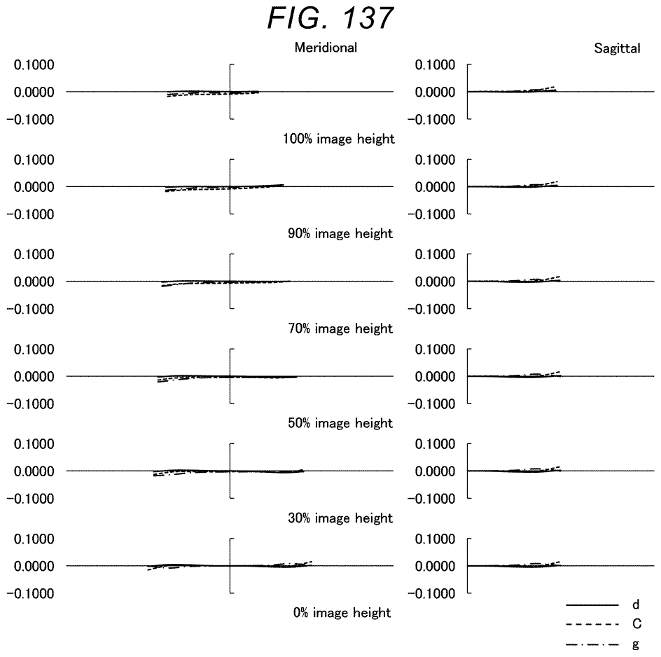

FIG. 138 is a lateral aberration diagram of the example 11 of the variable magnification imaging optical system according to the present invention at the wide-angle end in a case of focusing on an object at a distance of 3.2 m.

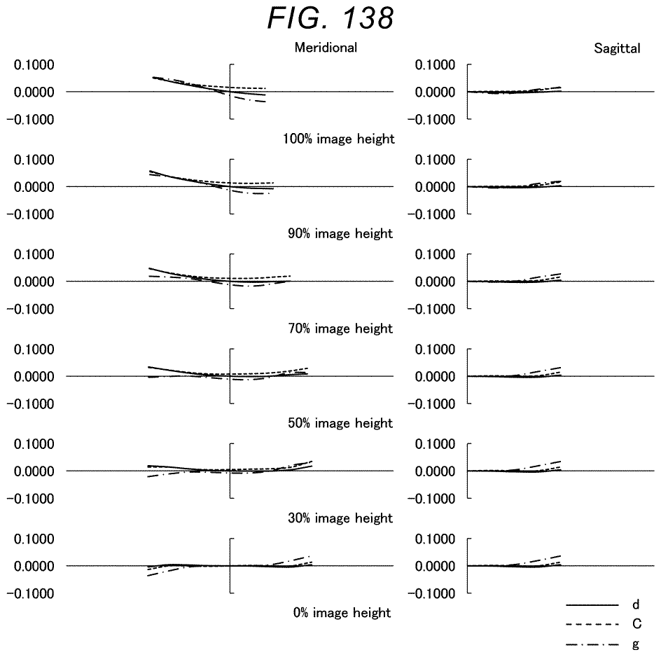

FIG. 139 is a lateral aberration diagram of the example 11 of the variable magnification imaging optical system according to the present invention at the intermediate focal length in a case of focusing on an object at a distance of 3.2 m.

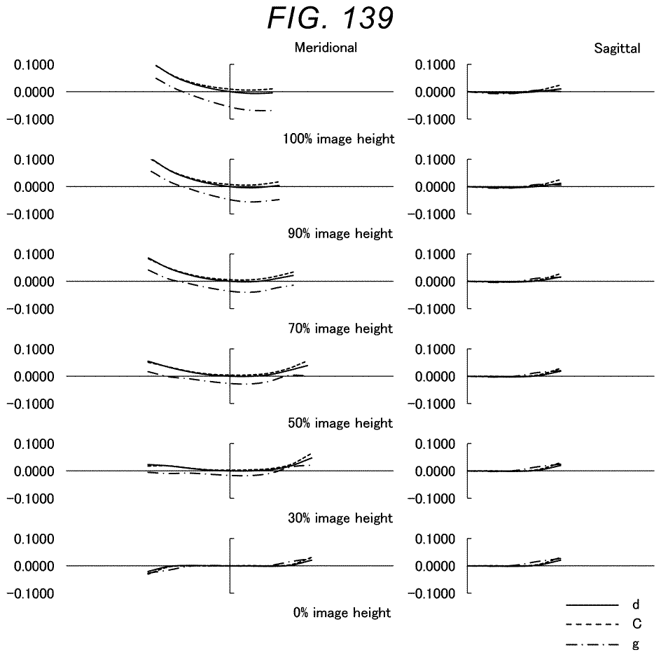

FIG. 140 is a lateral aberration diagram of the example 11 of the variable magnification imaging optical system according to the present invention at the telephoto end in a case of focusing on an object at a distance of 3.2 m.

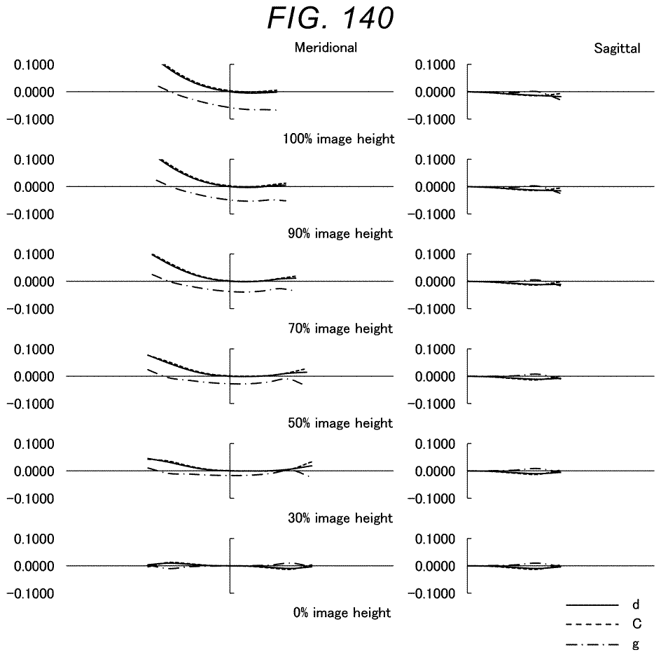

FIG. 141 is a lateral aberration diagram of the example 11 of the variable magnification imaging optical system according to the present invention at the wide-angle end in a case of vibration reduction in a case of focusing on infinity with a shake angle of 0.3 degrees.

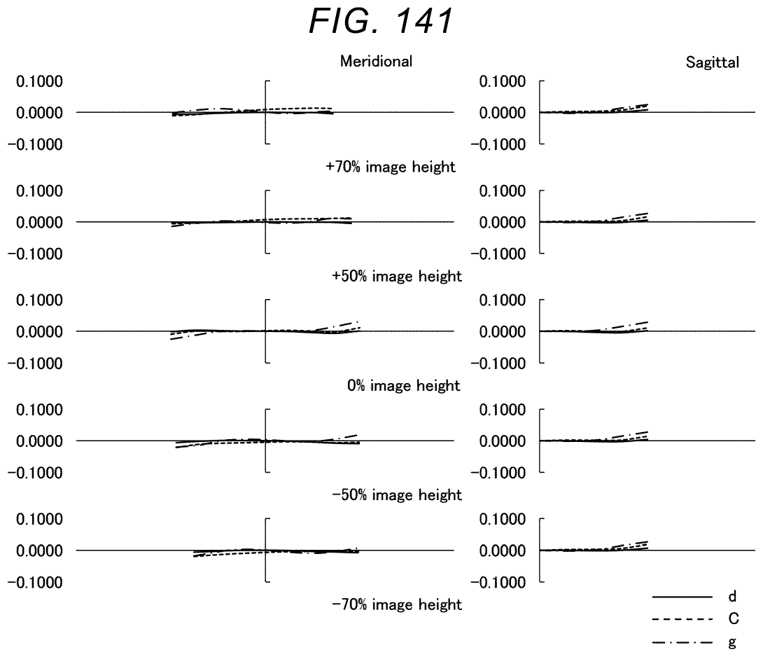

FIG. 142 is a lateral aberration diagram of the example 11 of the variable magnification imaging optical system according to the present invention at the intermediate focal length in a case of vibration reduction in a case of focusing on infinity with a shake angle of 0.3 degrees.

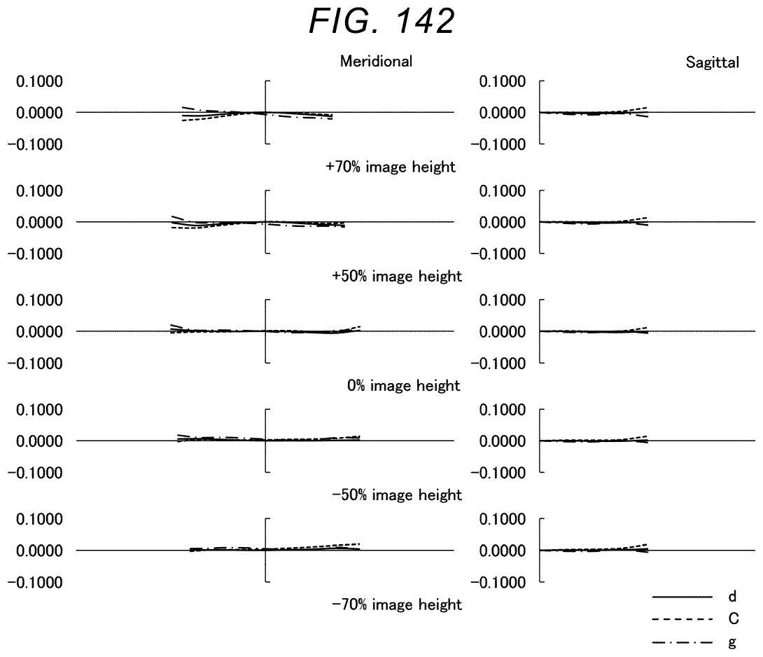

FIG. 143 is a lateral aberration diagram of the example 11 of the variable magnification imaging optical system according to the present invention at the telephoto end in a case of vibration reduction in a case of focusing on infinity with a shake angle of 0.3 degrees.

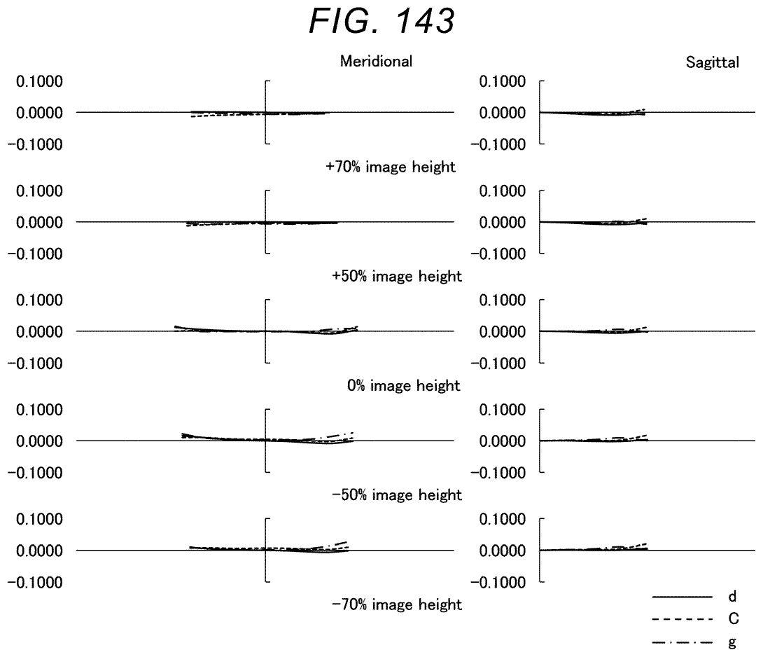

FIG. 144 is a lens configuration diagram of an example 12 of a variable magnification imaging optical system according to the present invention at a wide-angle end in a case of focusing on infinity.

FIG. 145 is a longitudinal aberration diagram of the example 12 of the variable magnification imaging optical system according to the present invention at the wide-angle end in a case of focusing on infinity.

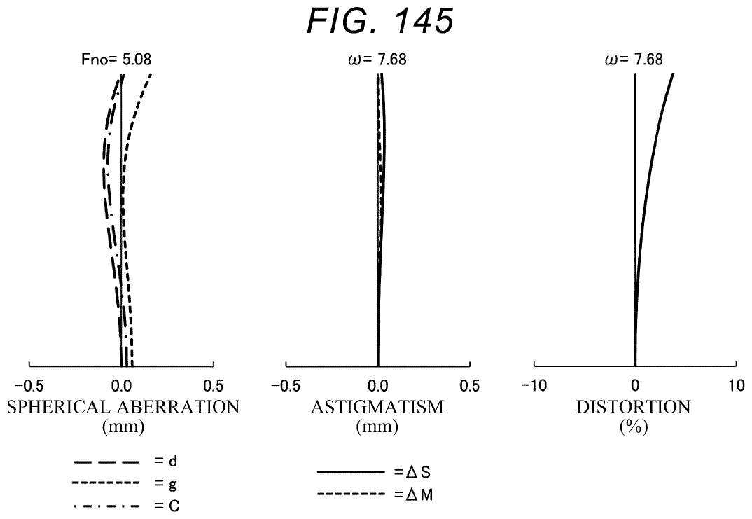

FIG. 146 is a longitudinal aberration diagram of the example 12 of the variable magnification imaging optical system according to the present invention at the intermediate focal length in a case of focusing on infinity.

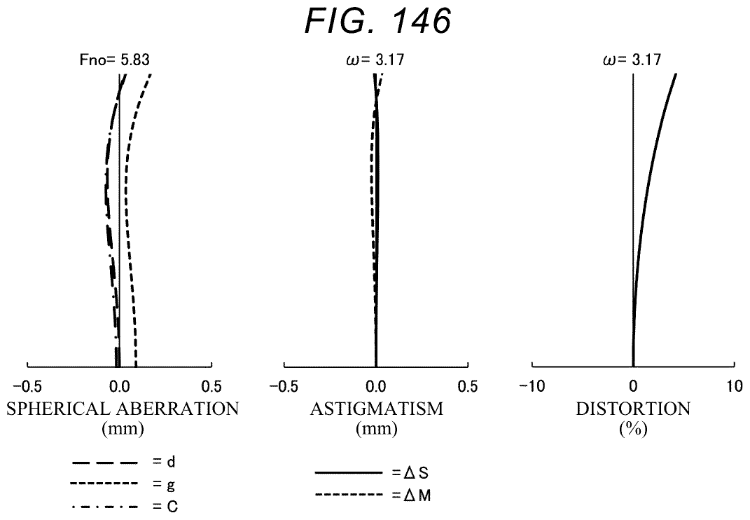

FIG. 147 is a longitudinal aberration diagram of the example 12 of the variable magnification imaging optical system according to the present invention at the telephoto end in a case of focusing on infinity.

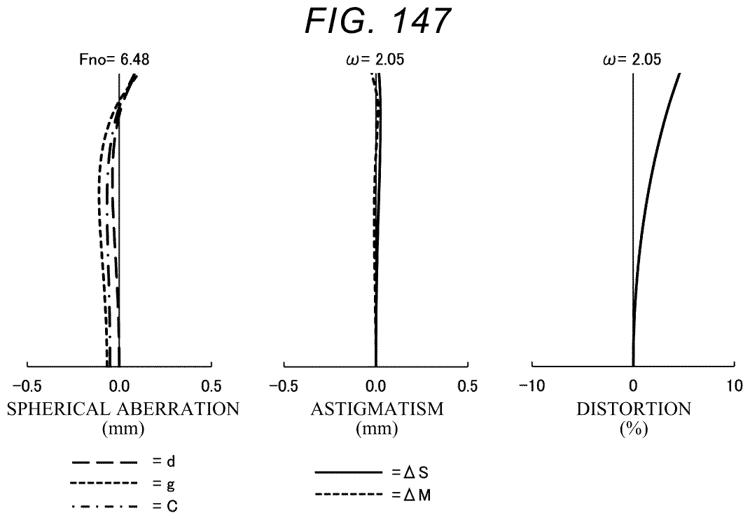

FIG. 148 is a lateral aberration diagram of the example 12 of the variable magnification imaging optical system according to the present invention at the wide-angle end in a case of focusing on infinity.

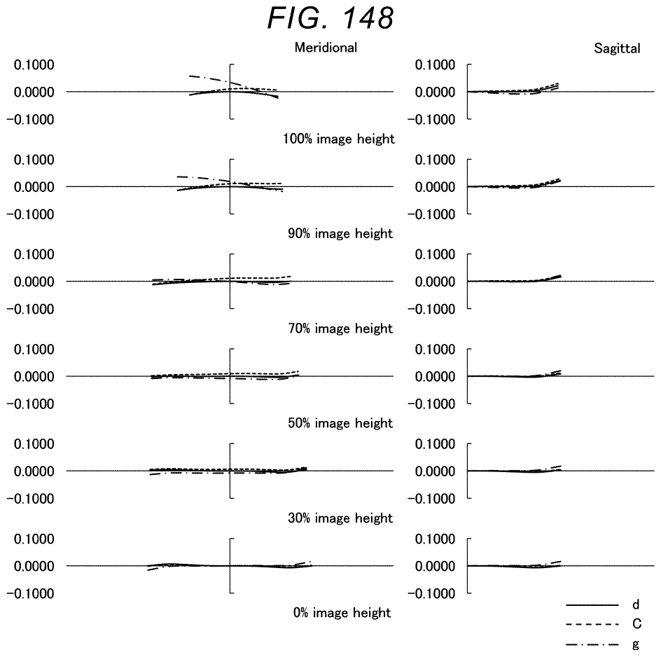

FIG. 149 is a lateral aberration diagram of the example 12 of the variable magnification imaging optical system according to the present invention at the intermediate focal length in a case of focusing on infinity.

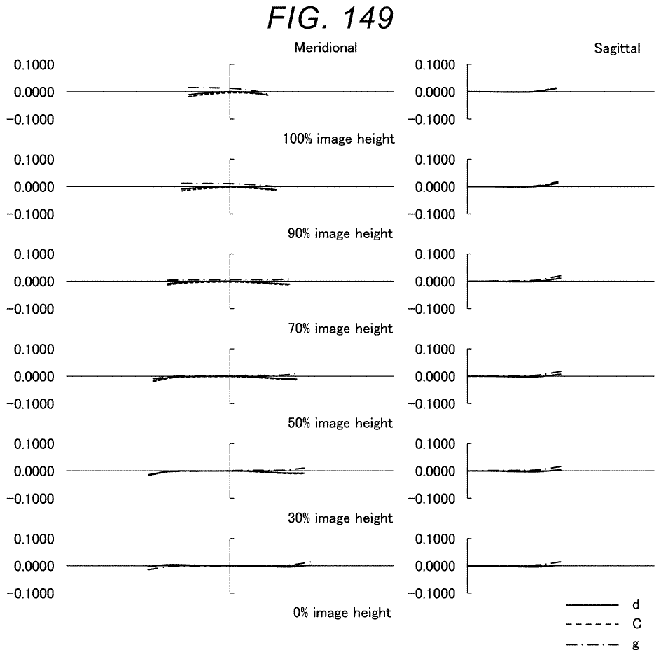

FIG. 150 is a lateral aberration diagram of the example 12 of the variable magnification imaging optical system according to the present invention at the telephoto end in a case of focusing on infinity.

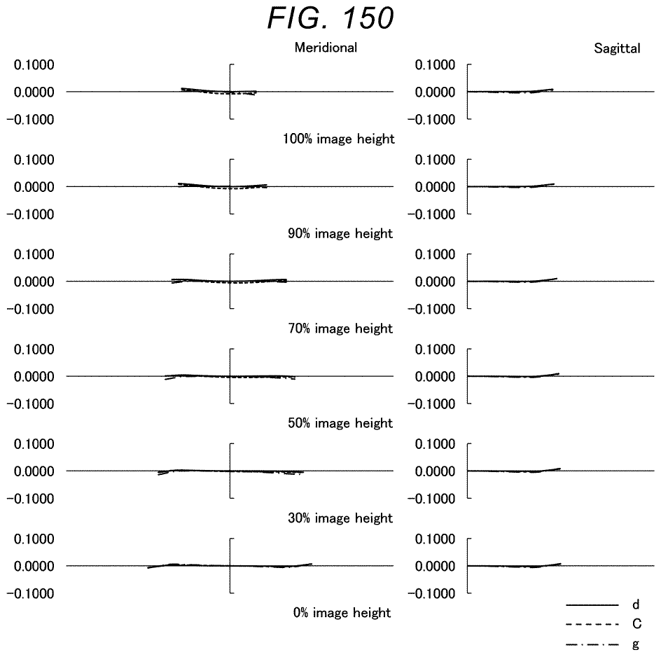

FIG. 151 is a lateral aberration diagram of the example 12 of the variable magnification imaging optical system according to the present invention at the wide-angle end in a case of focusing on an object at a distance of 2.8 m.

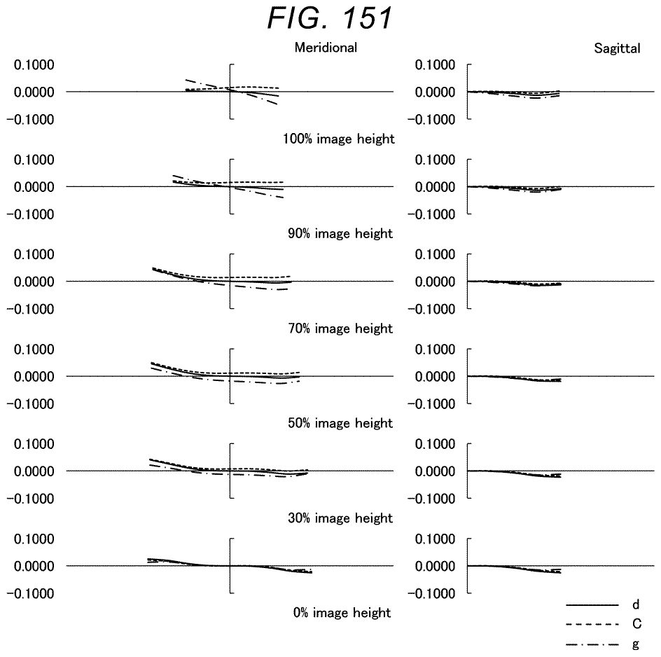

FIG. 152 is a lateral aberration diagram of the example 12 of the variable magnification imaging optical system according to the present invention at the intermediate focal length in a case of focusing on an object at a distance of 2.8 m.

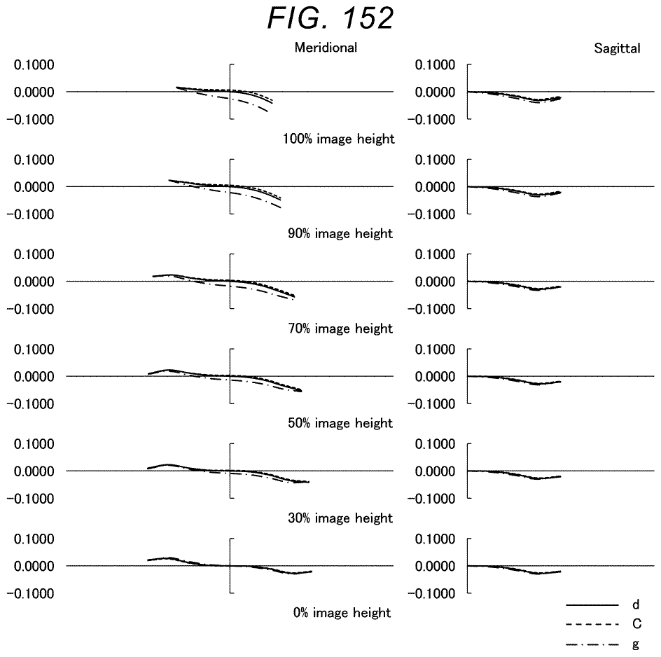

FIG. 153 is a lateral aberration diagram of the example 12 of the variable magnification imaging optical system according to the present invention at the telephoto end in a case of focusing on an object at a distance of 2.8 m.

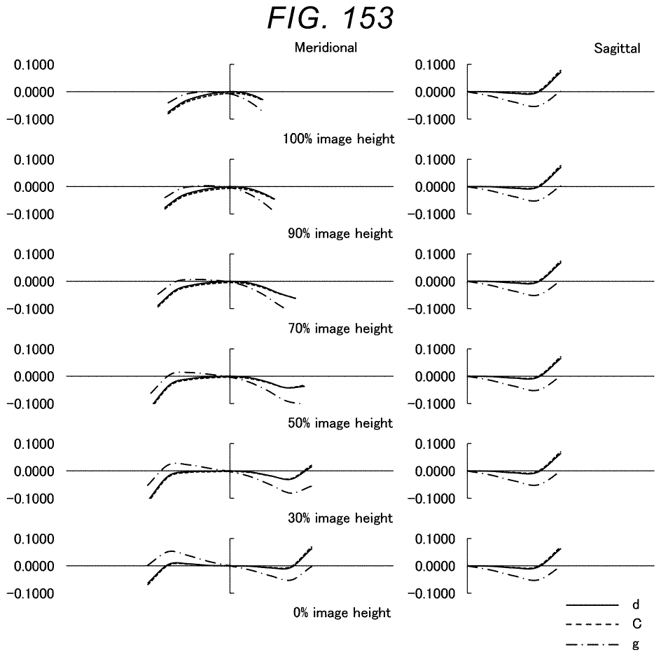

FIG. 154 is a lateral aberration diagram of the example 12 of the variable magnification imaging optical system according to the present invention at the wide-angle end in a case of vibration reduction in a case of focusing on infinity with a shake angle of 0.3 degrees.

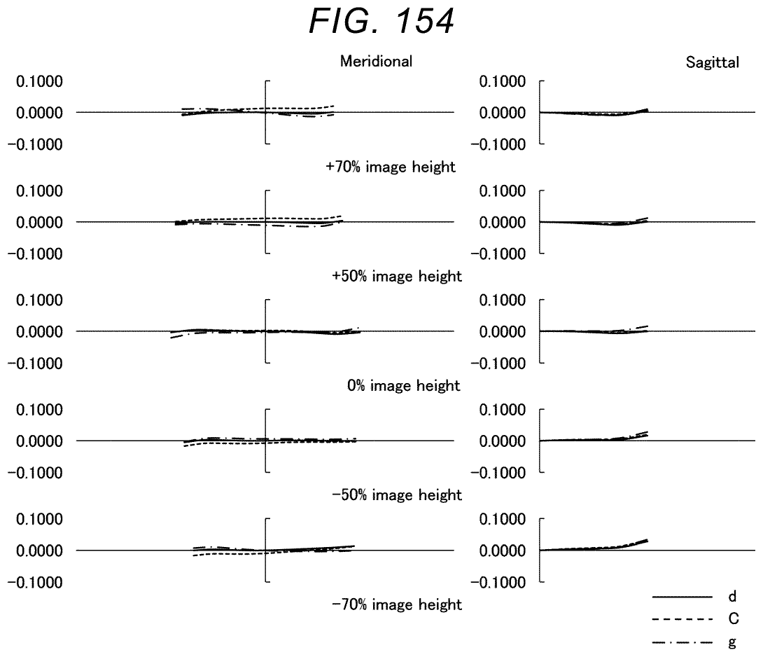

FIG. 155 is a lateral aberration diagram of the example 12 of the variable magnification imaging optical system according to the present invention at the intermediate focal length in a case of vibration reduction in a case of focusing on infinity with a shake angle of 0.3 degrees.

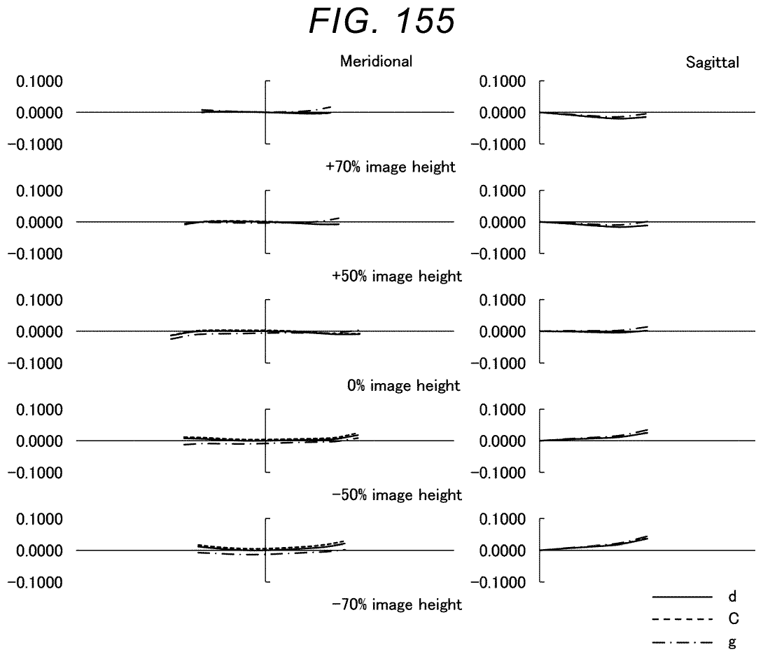

FIG. 156 is a lateral aberration diagram of the example 12 of the variable magnification imaging optical system according to the present invention at the telephoto end in a case of vibration reduction in a case of focusing on infinity with a shake angle of 0.3 degrees.

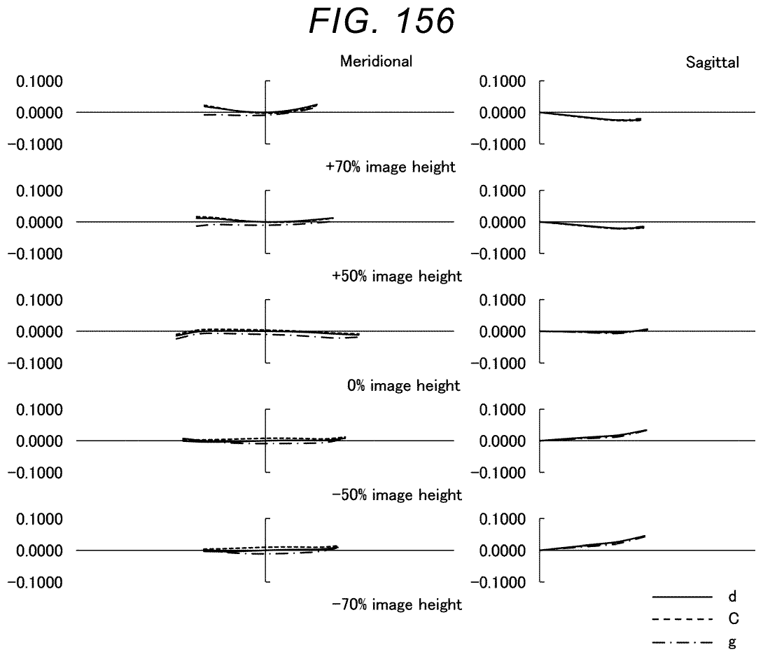

FIG. 157 is a lens configuration diagram of an example 13 of a variable magnification imaging optical system according to the present invention at a wide-angle end in a case of focusing on infinity.

FIG. 158 is a longitudinal aberration diagram of the example 13 of the variable magnification imaging optical system according to the present invention at the wide-angle end in a case of focusing on infinity.

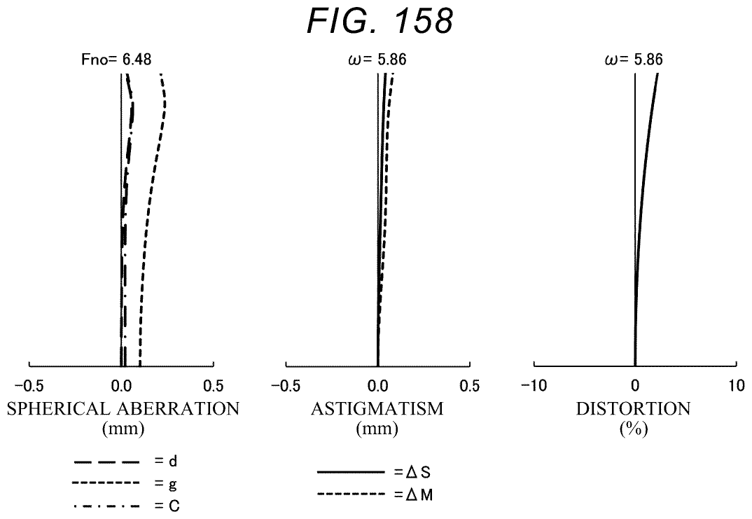

FIG. 159 is a longitudinal aberration diagram of the example 13 of the variable magnification imaging optical system according to the present invention at the intermediate focal length in a case of focusing on infinity.

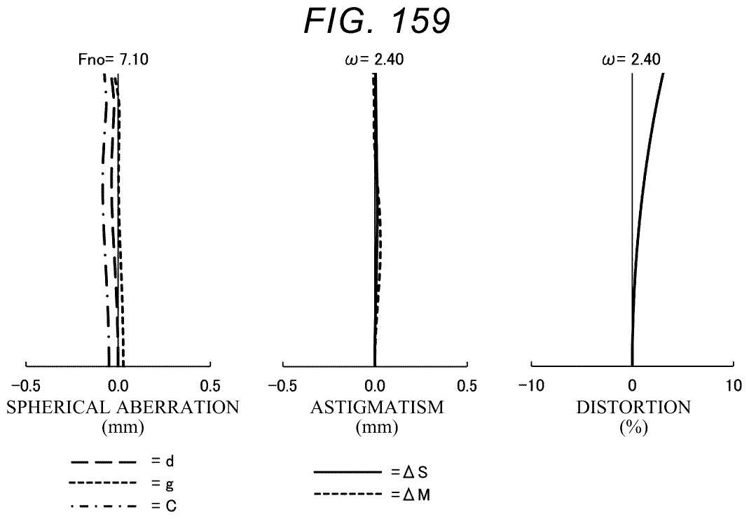

FIG. 160 is a longitudinal aberration diagram of the example 13 of the variable magnification imaging optical system according to the present invention at the telephoto end in a case of focusing on infinity.

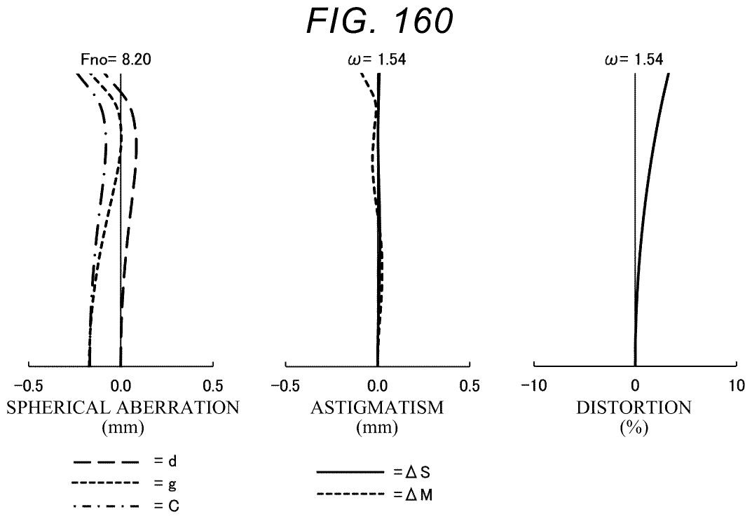

FIG. 161 is a lateral aberration diagram of the example 13 of the variable magnification imaging optical system according to the present invention at the wide-angle end in a case of focusing on infinity.

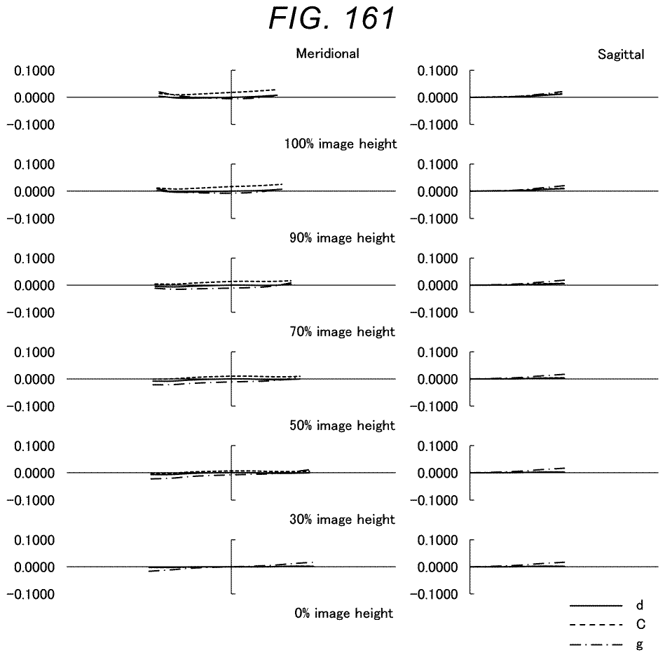

FIG. 162 is a lateral aberration diagram of the example 13 of the variable magnification imaging optical system according to the present invention at the intermediate focal length in a case of focusing on infinity.

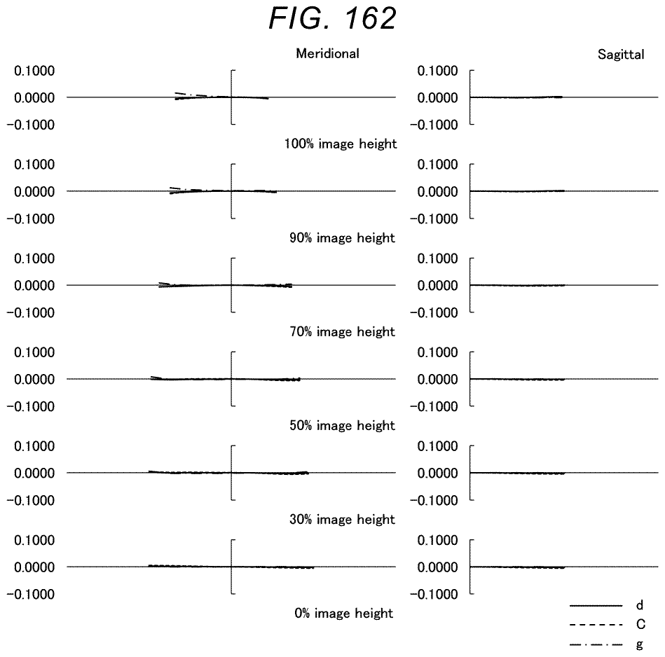

FIG. 163 is a lateral aberration diagram of the example 13 of the variable magnification imaging optical system according to the present invention at the telephoto end in a case of focusing on infinity.

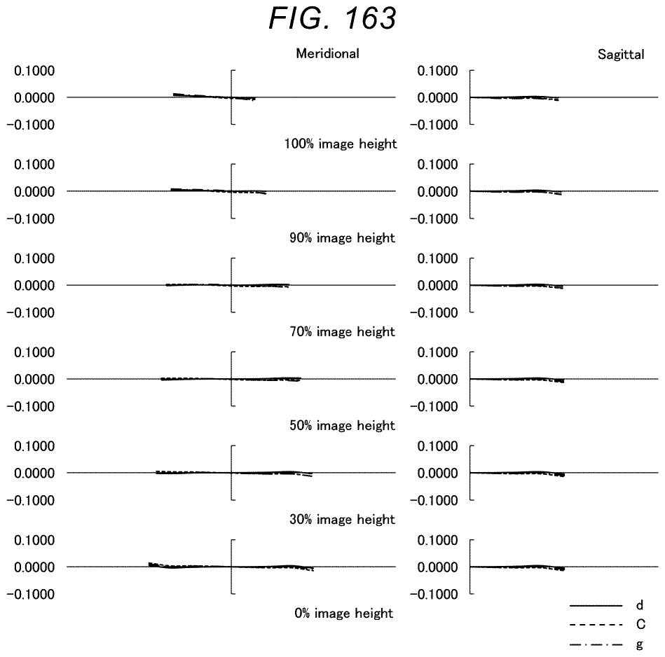

FIG. 164 is a lateral aberration diagram of the example 13 of the variable magnification imaging optical system according to the present invention at the wide-angle end in a case of focusing on an object at a distance of 3.5 m.

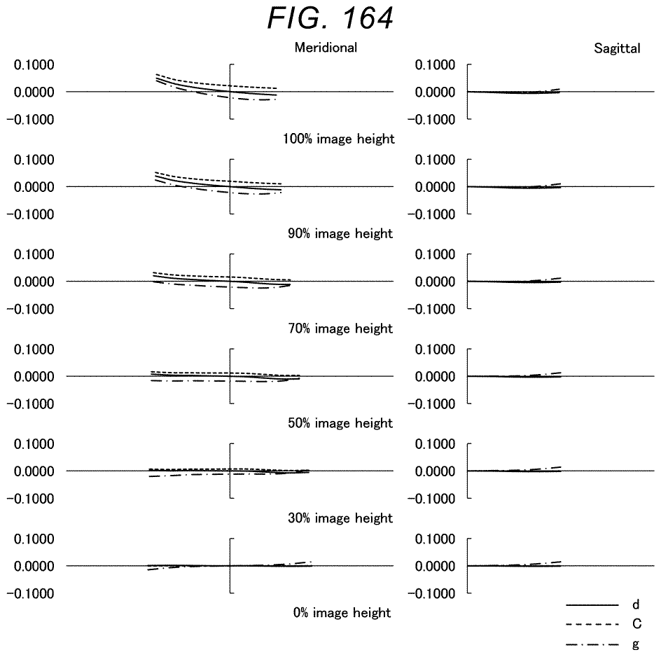

FIG. 165 is a lateral aberration diagram of the example 13 of the variable magnification imaging optical system according to the present invention at the intermediate focal length in a case of focusing on an object at a distance of 3.5 m.

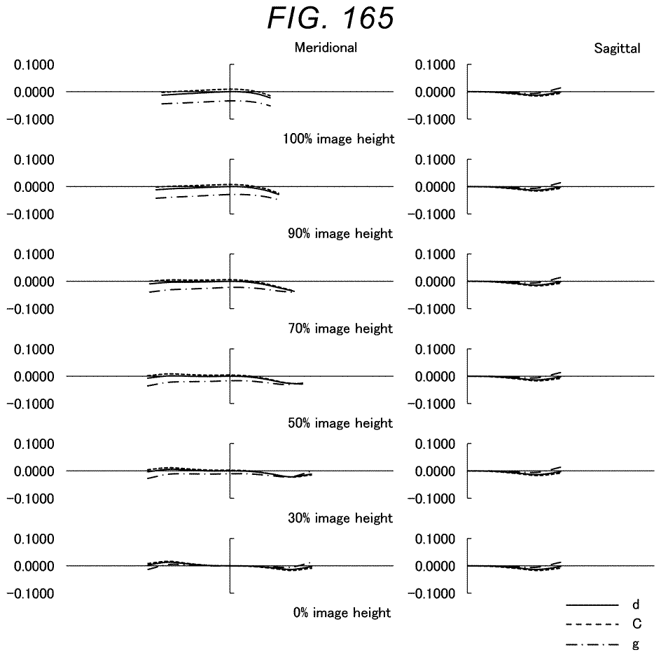

FIG. 166 is a lateral aberration diagram of the example 13 of the variable magnification imaging optical system according to the present invention at the telephoto end in a case of focusing on an object at a distance of 3.5 m.

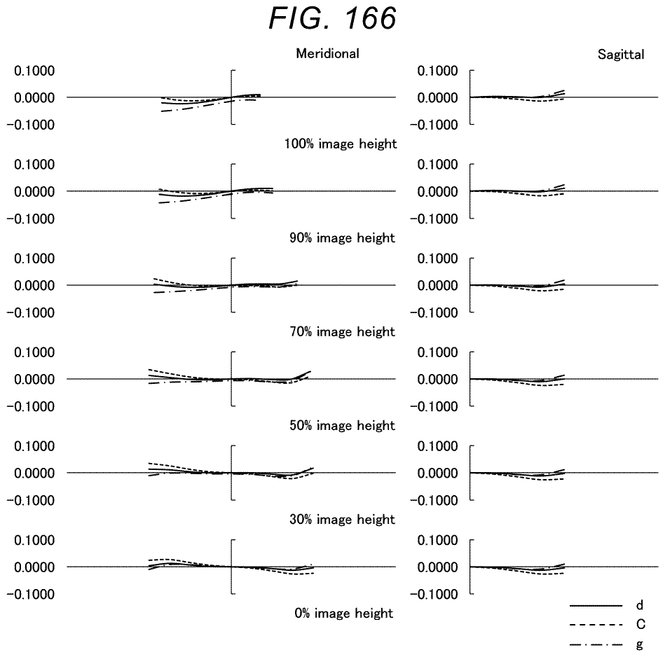

FIG. 167 is a lateral aberration diagram of the example 13 of the variable magnification imaging optical system according to the present invention at the wide-angle end in a case of vibration reduction in a case of focusing on infinity with a shake angle of 0.3 degrees.

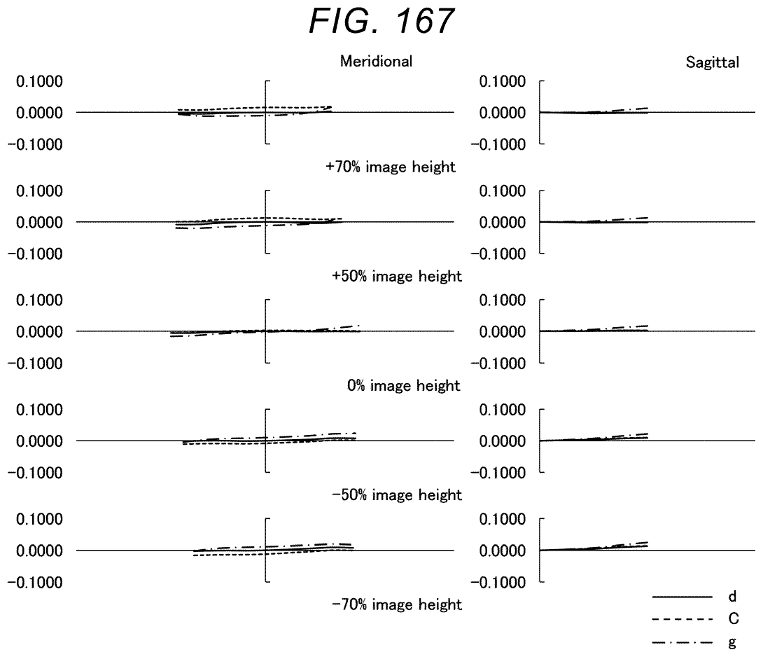

FIG. 168 is a lateral aberration diagram of the example 13 of the variable magnification imaging optical system according to the present invention at the intermediate focal length in a case of vibration reduction in a case of focusing on infinity with a shake angle of 0.3 degrees.

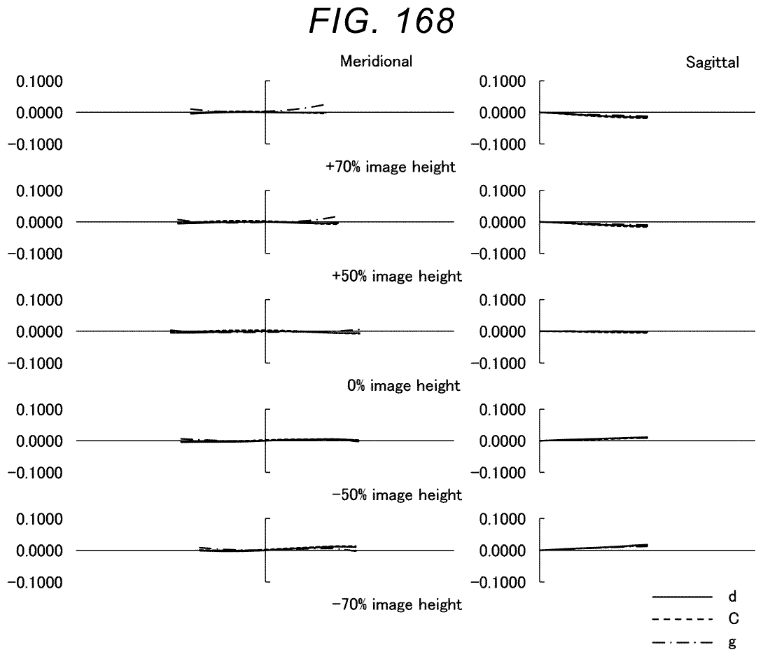

FIG. 169 is a lateral aberration diagram of the example 13 of the variable magnification imaging optical system according to the present invention at the telephoto end in a case of vibration reduction in a case of focusing on infinity with a shake angle of 0.3 degrees.

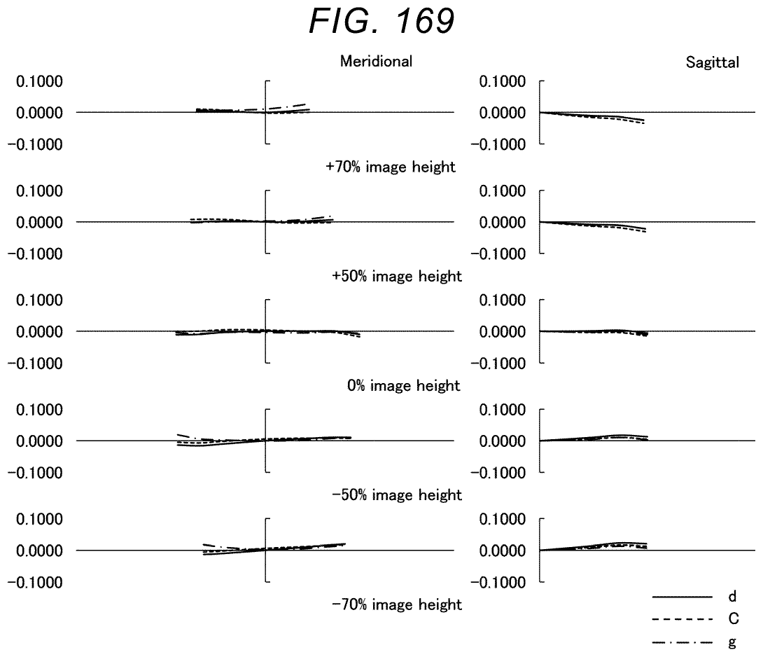

FIG. 170 is a lens configuration diagram of an example 14 of a variable magnification imaging optical system according to the present invention at a wide-angle end in a case of focusing on infinity.

FIG. 171 is a longitudinal aberration diagram of the example 14 of the variable magnification imaging optical system according to the present invention at the wide-angle end in a case of focusing on infinity.

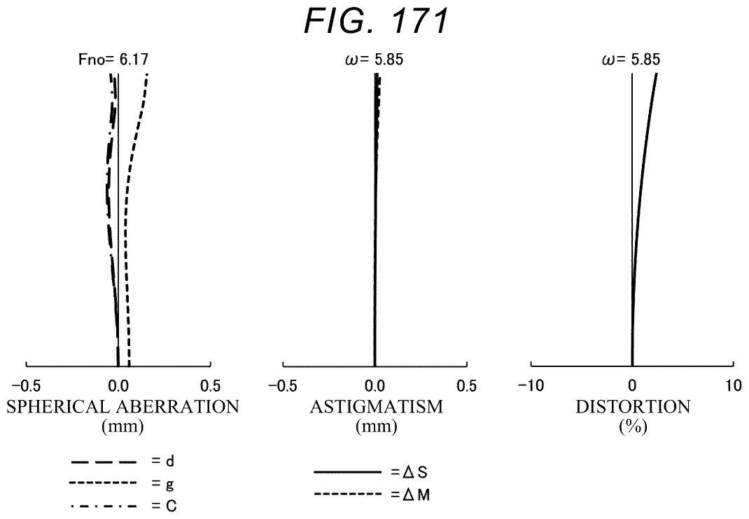

FIG. 172 is a longitudinal aberration diagram of the example 14 of the variable magnification imaging optical system according to the present invention at the intermediate focal length in a case of focusing on infinity.

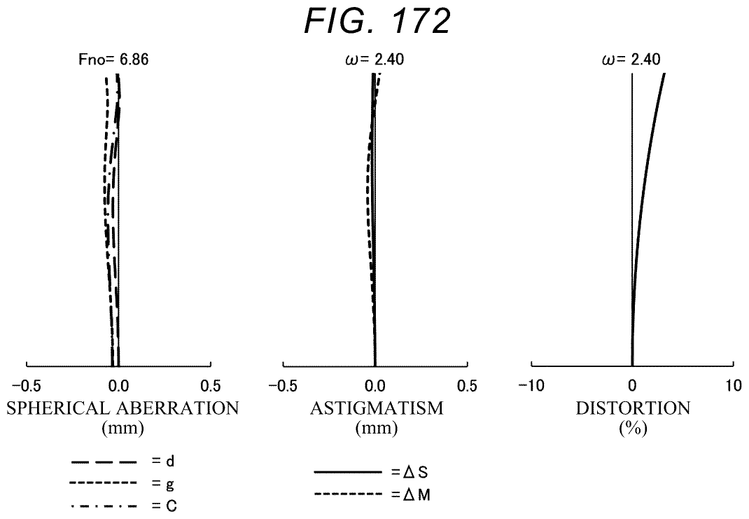

FIG. 173 is a longitudinal aberration diagram of the example 14 of the variable magnification imaging optical system according to the present invention at the telephoto end in a case of focusing on infinity.

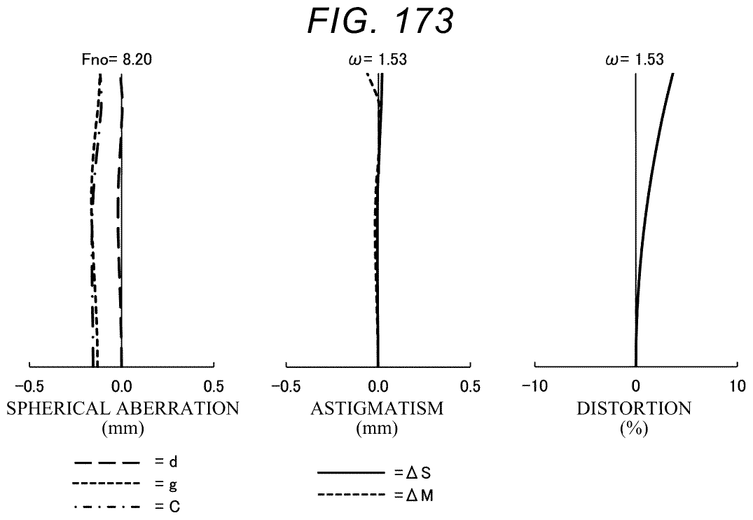

FIG. 174 is a lateral aberration diagram of the example 14 of the variable magnification imaging optical system according to the present invention at the wide-angle end in a case of focusing on infinity.

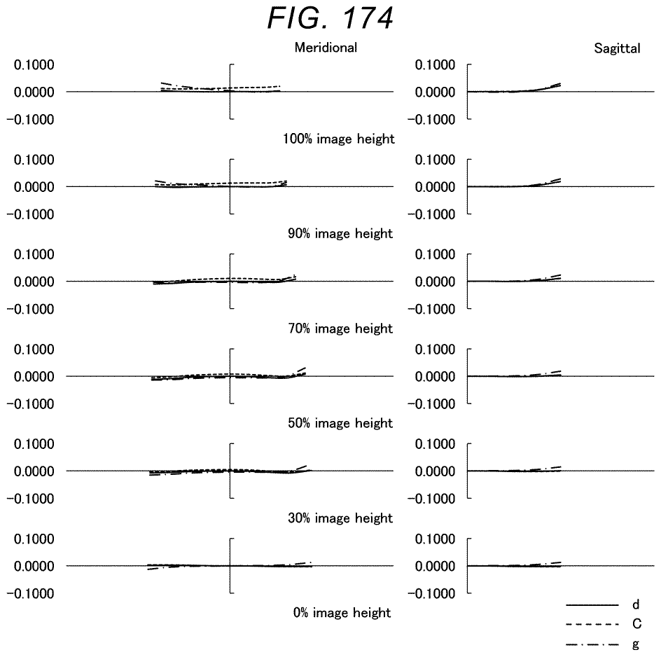

FIG. 175 is a lateral aberration diagram of the example 14 of the variable magnification imaging optical system according to the present invention at the intermediate focal length in a case of focusing on infinity.

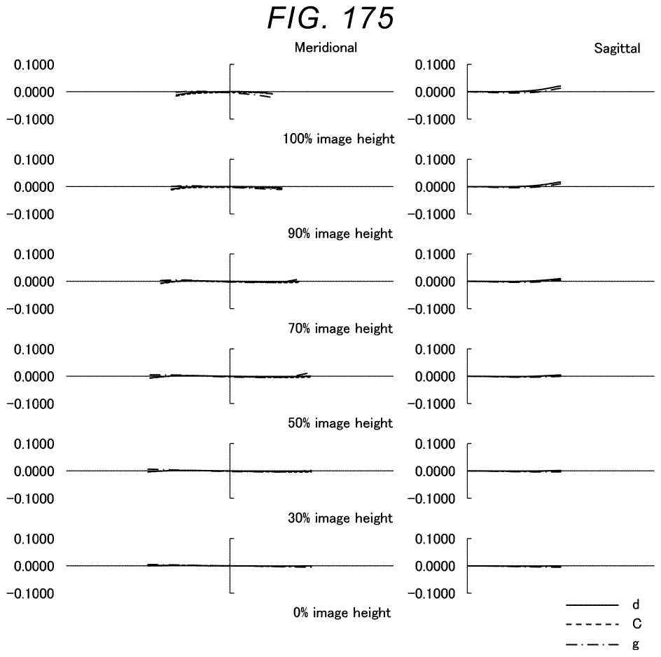

FIG. 176 is a lateral aberration diagram of the example 14 of the variable magnification imaging optical system according to the present invention at the telephoto end in a case of focusing on infinity.

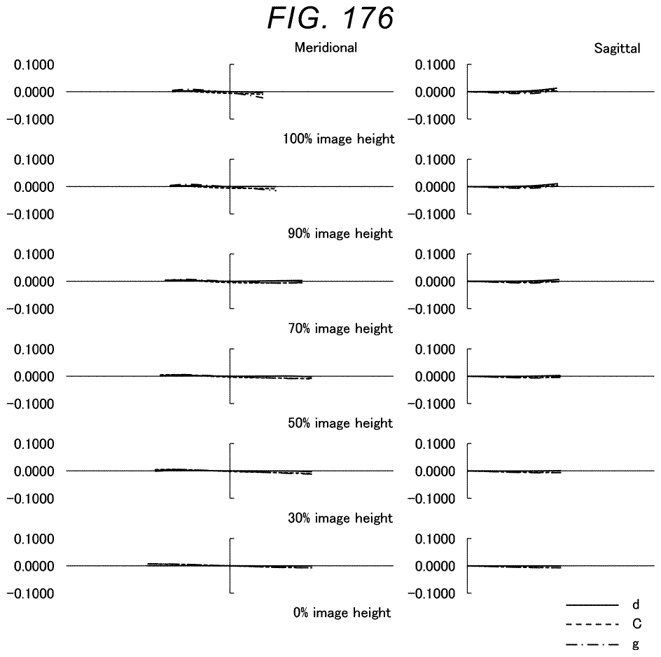

FIG. 177 is a lateral aberration diagram of the example 14 of the variable magnification imaging optical system according to the present invention at the wide-angle end in a case of focusing on an object at a distance of 3.1 m.

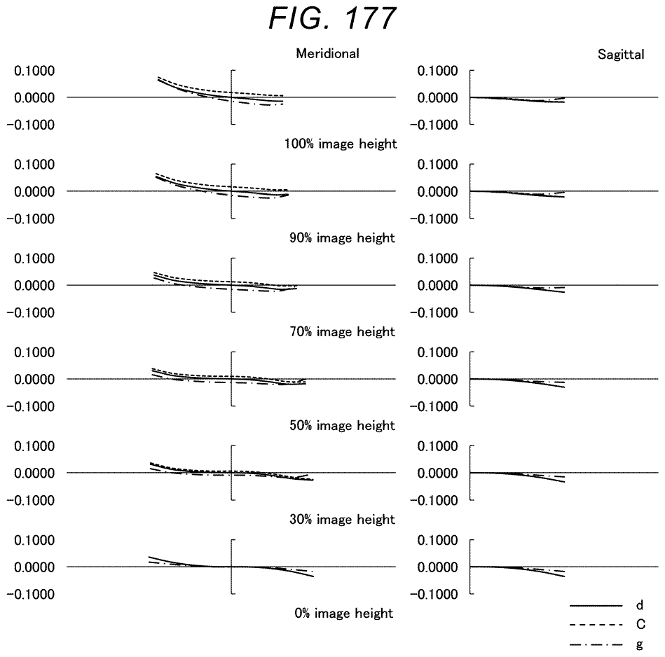

FIG. 178 is a lateral aberration diagram of the example 14 of the variable magnification imaging optical system according to the present invention at the intermediate focal length in a case of focusing on an object at a distance of 3.1 m.

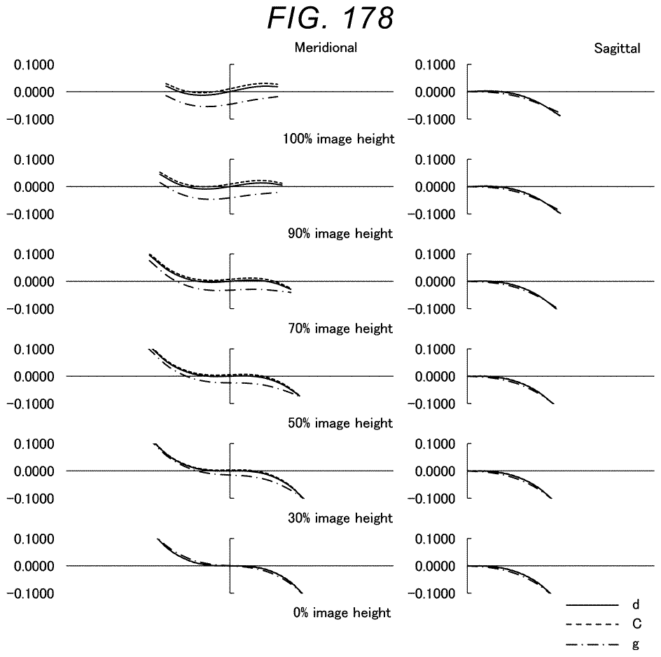

FIG. 179 is a lateral aberration diagram of the example 14 of the variable magnification imaging optical system according to the present invention at the telephoto end in a case of focusing on an object at a distance of 3.1 m.

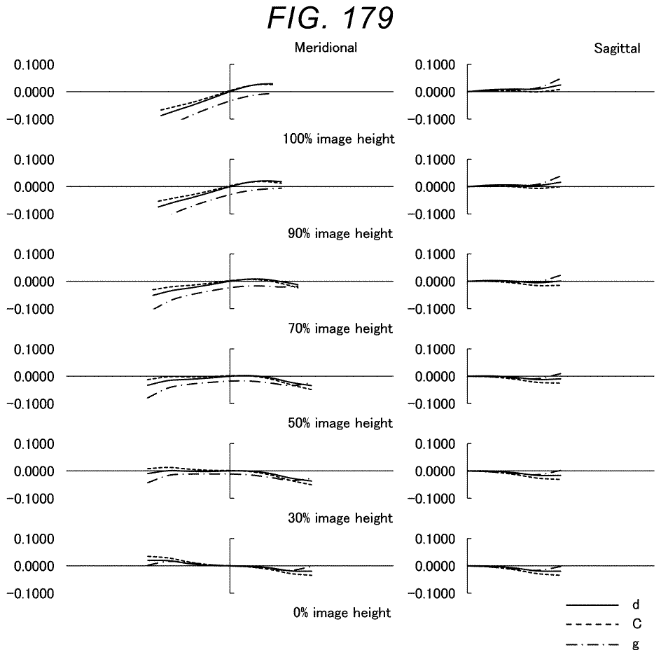

FIG. 180 is a lateral aberration diagram of the example 14 of the variable magnification imaging optical system according to the present invention at the wide-angle end in a case of vibration reduction in a case of focusing on infinity with a shake angle of 0.3 degrees.

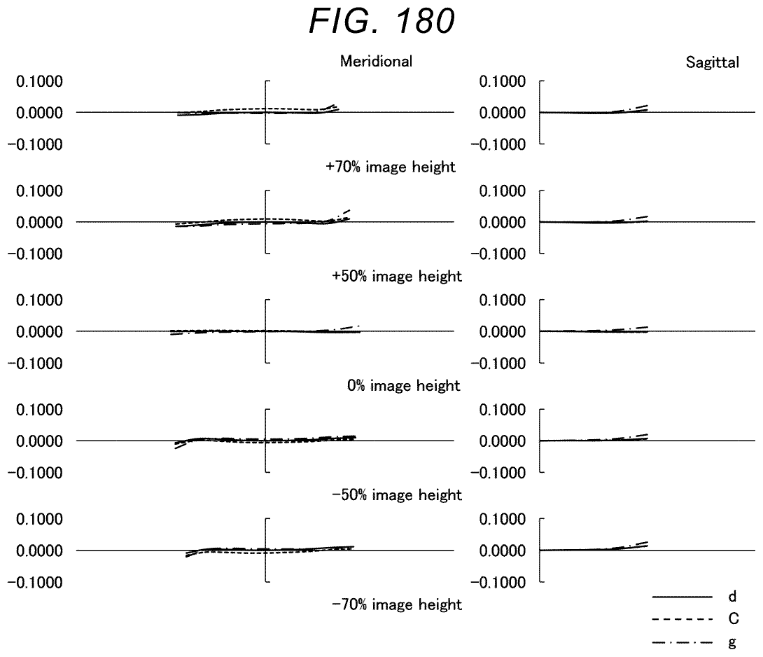

FIG. 181 is a lateral aberration diagram of the example 14 of the variable magnification imaging optical system according to the present invention at the intermediate focal length in a case of vibration reduction in a case of focusing on infinity with a shake angle of 0.3 degrees.

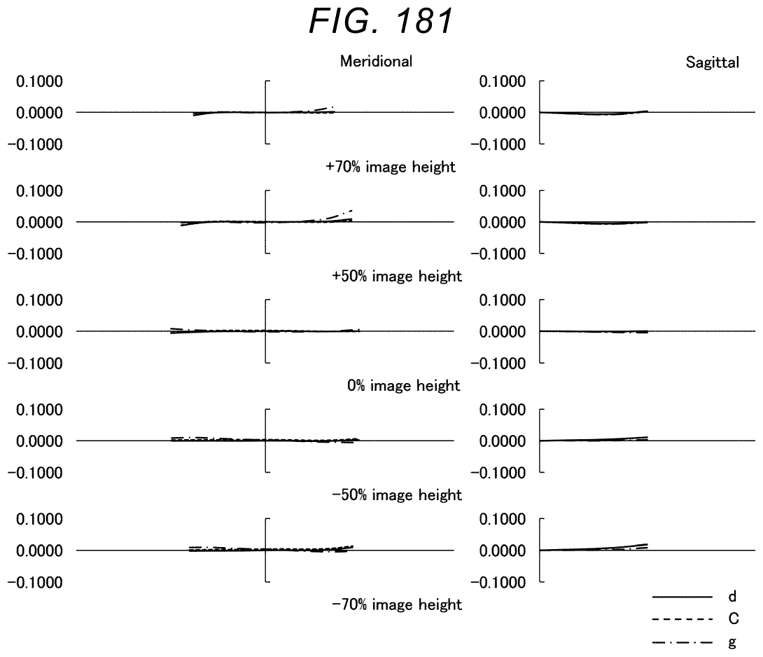

FIG. 182 is a lateral aberration diagram of the example 14 of the variable magnification imaging optical system according to the present invention at the telephoto end in a case of vibration reduction in a case of focusing on infinity with a shake angle of 0.3 degrees.

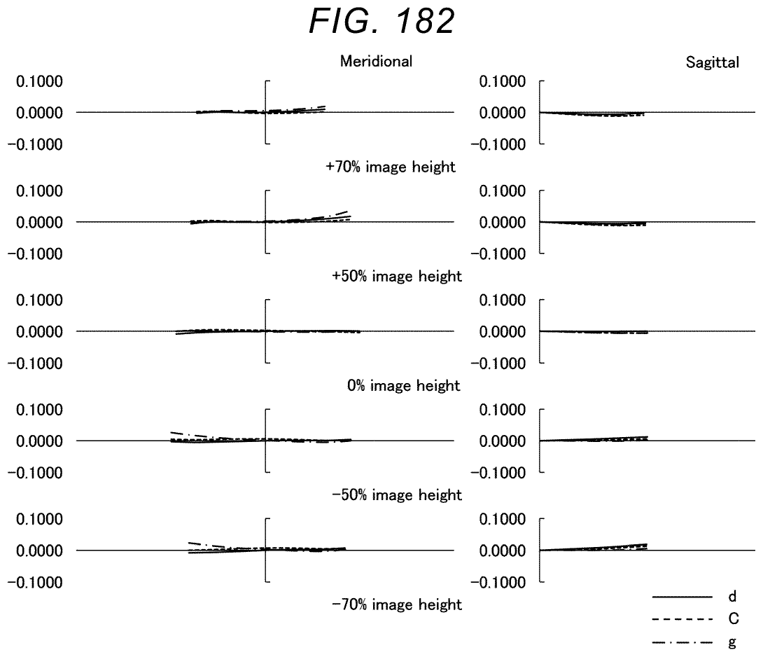

FIG. 183 is a lens configuration diagram of an example 15 of a variable magnification imaging optical system according to the present invention at a wide-angle end in a case of focusing on infinity.

FIG. 184 is a longitudinal aberration diagram of the example 15 of the variable magnification imaging optical system according to the present invention at the wide-angle end in a case of focusing on infinity.

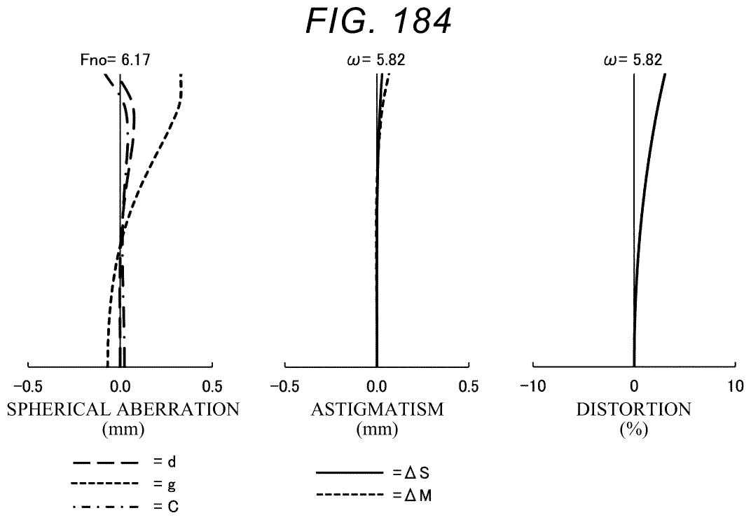

FIG. 185 is a longitudinal aberration diagram of the example 15 of the variable magnification imaging optical system according to the present invention at the intermediate focal length in a case of focusing on infinity.

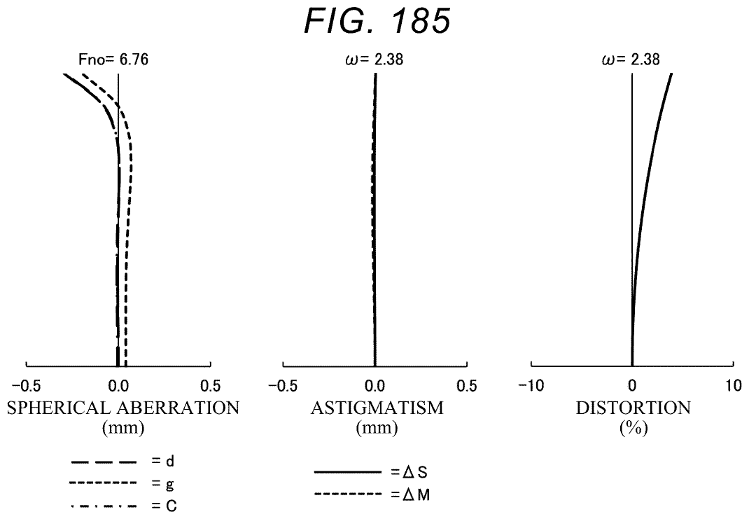

FIG. 186 is a longitudinal aberration diagram of the example 15 of the variable magnification imaging optical system according to the present invention at the telephoto end in a case of focusing on infinity.

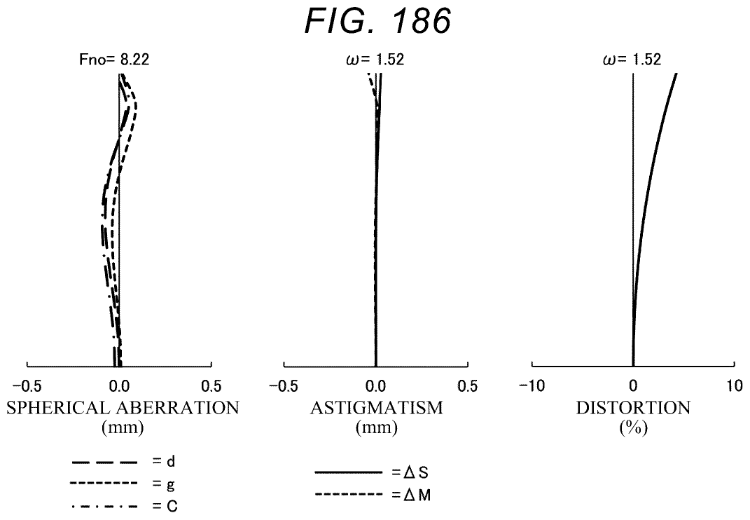

FIG. 187 is a lateral aberration diagram of the example 15 of the variable magnification imaging optical system according to the present invention at the wide-angle end in a case of focusing on infinity.

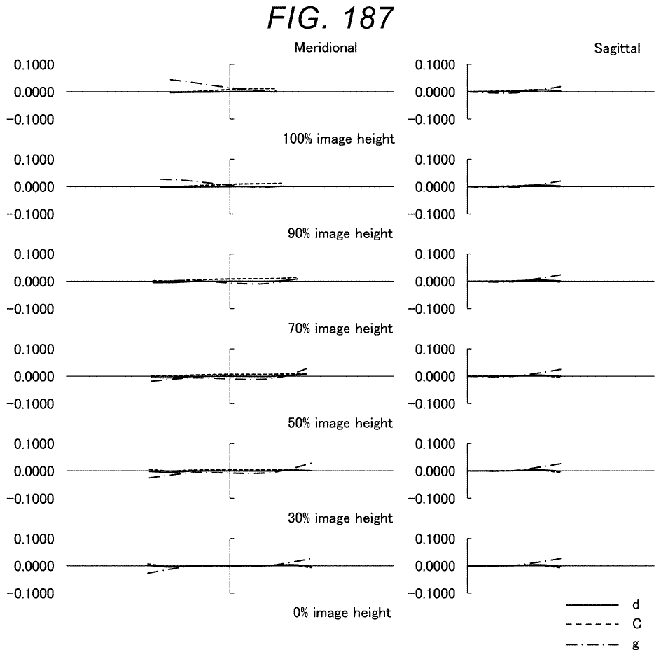

FIG. 188 is a lateral aberration diagram of the example 15 of the variable magnification imaging optical system according to the present invention at the intermediate focal length in a case of focusing on infinity.

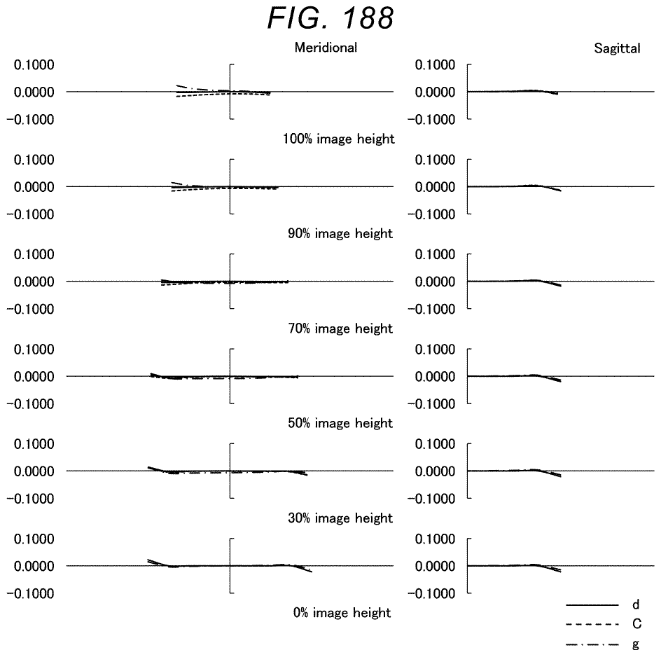

FIG. 189 is a lateral aberration diagram of the example 15 of the variable magnification imaging optical system according to the present invention at the telephoto end in a case of focusing on infinity.

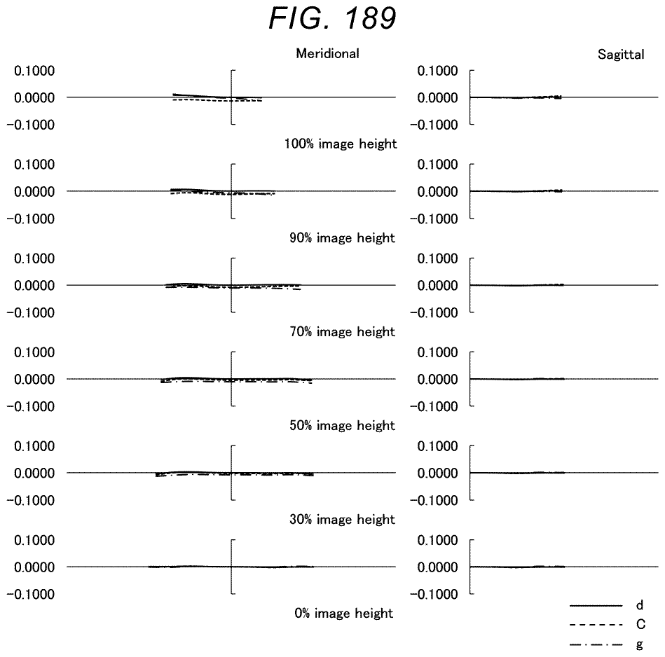

FIG. 190 is a lateral aberration diagram of the example 15 of the variable magnification imaging optical system according to the present invention at the wide-angle end in a case of focusing on an object at a distance of 3.2 m.

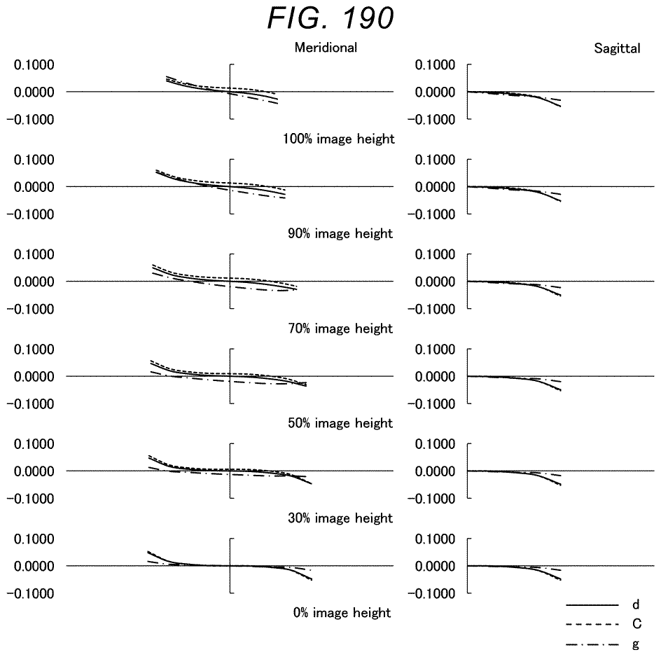

FIG. 191 is a lateral aberration diagram of the example 15 of the variable magnification imaging optical system according to the present invention at the intermediate focal length in a case of focusing on an object at a distance of 3.2 m.

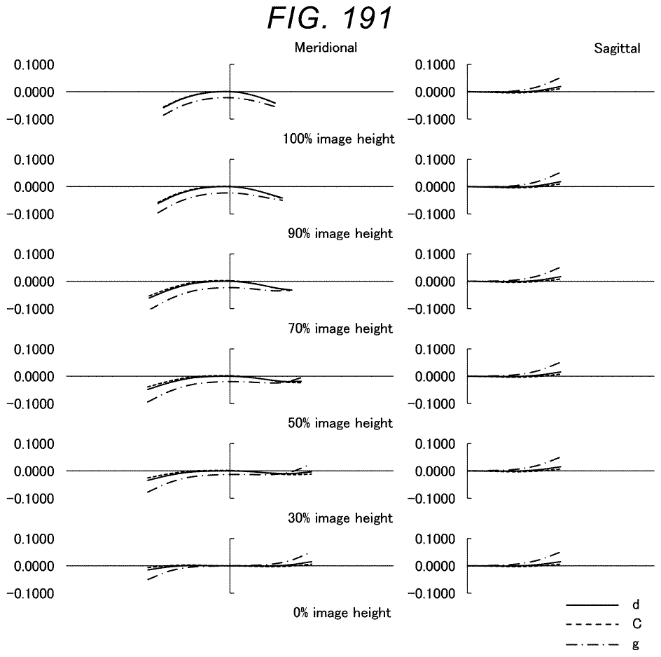

FIG. 192 is a lateral aberration diagram of the example 15 of the variable magnification imaging optical system according to the present invention at the telephoto end in a case of focusing on an object at a distance of 3.2 m.

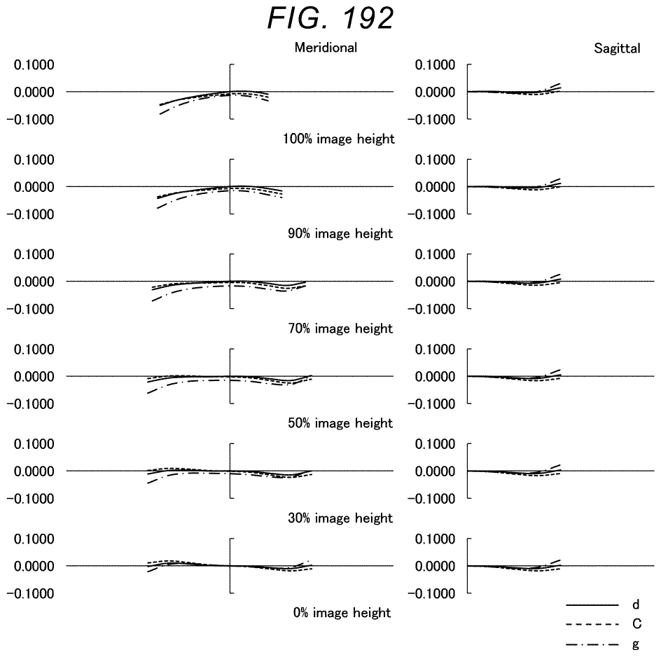

FIG. 193 is a lateral aberration diagram of the example 15 of the variable magnification imaging optical system according to the present invention at the wide-angle end in a case of vibration reduction in a case of focusing on infinity with a shake angle of 0.3 degrees.

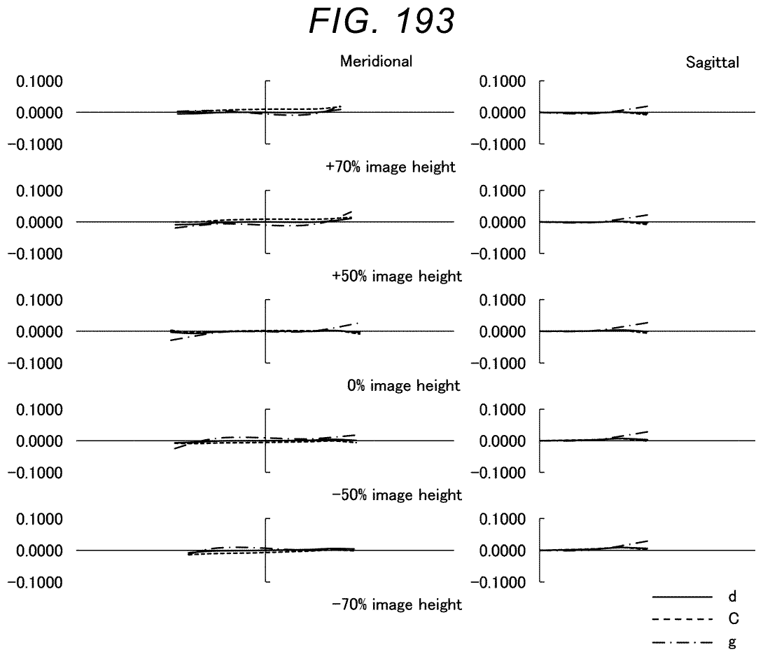

FIG. 194 is a lateral aberration diagram of the example 15 of the variable magnification imaging optical system according to the present invention at the intermediate focal length in a case of vibration reduction in a case of focusing on infinity with a shake angle of 0.3 degrees.

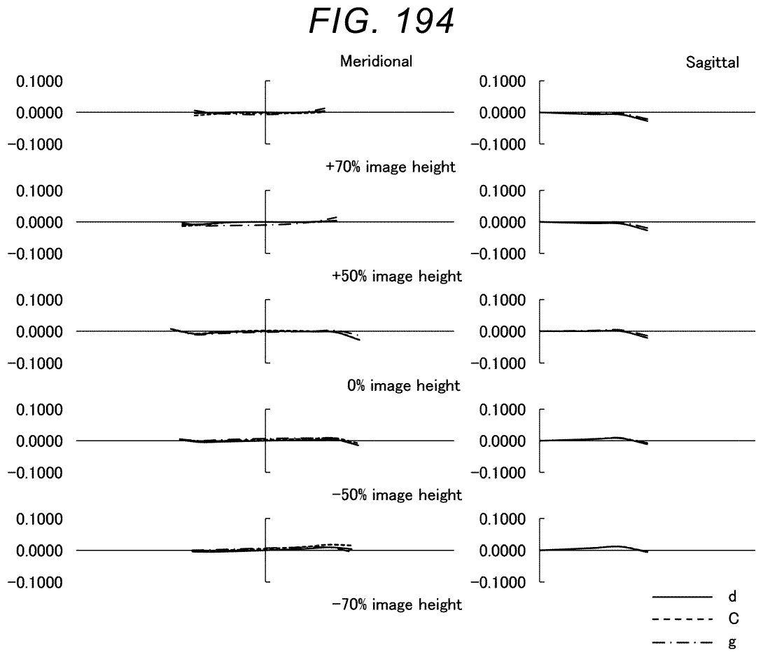

FIG. 195 is a lateral aberration diagram of the example 15 of the variable magnification imaging optical system according to the present invention at the telephoto end in a case of vibration reduction in a case of focusing on infinity with a shake angle of 0.3 degrees.

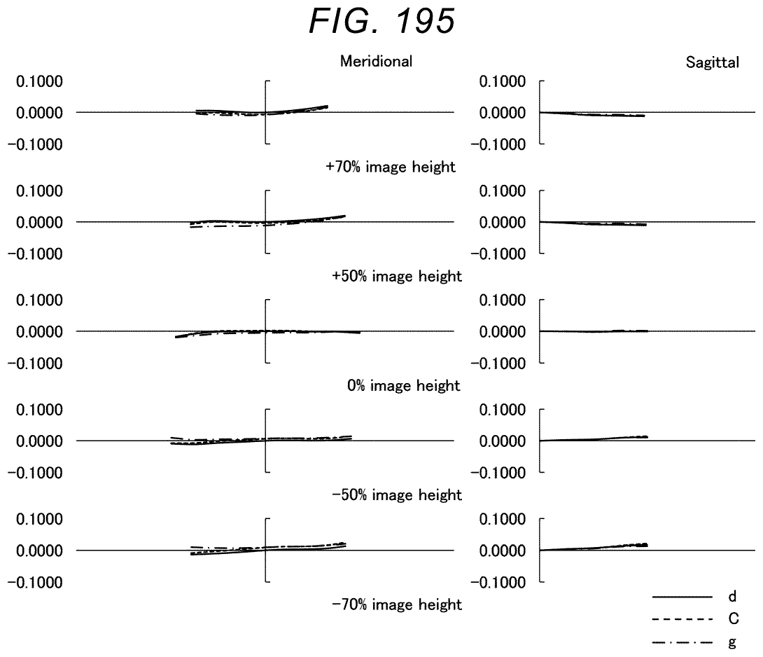

FIG. 196 is a lens configuration diagram of an example 16 of a variable magnification imaging optical system according to the present invention at a wide-angle end in a case of focusing on infinity.

FIG. 197 is a longitudinal aberration diagram of the example 16 of the variable magnification imaging optical system according to the present invention at the wide-angle end in a case of focusing on infinity.

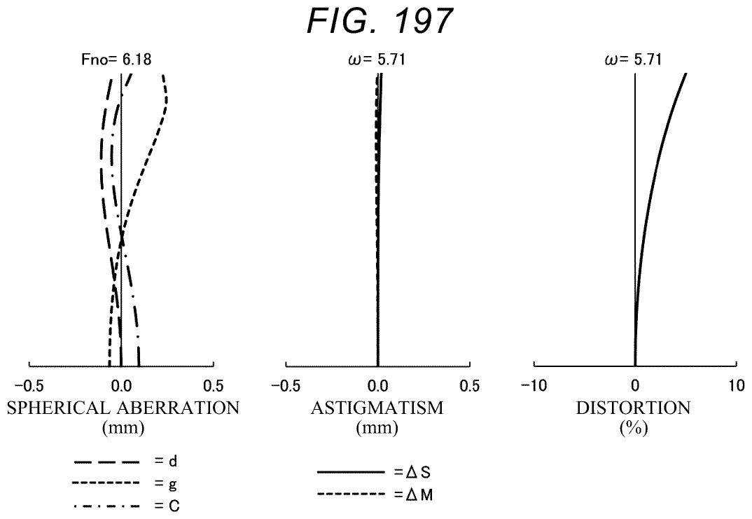

FIG. 198 is a longitudinal aberration diagram of the example 16 of the variable magnification imaging optical system according to the present invention at the intermediate focal length in a case of focusing on infinity.

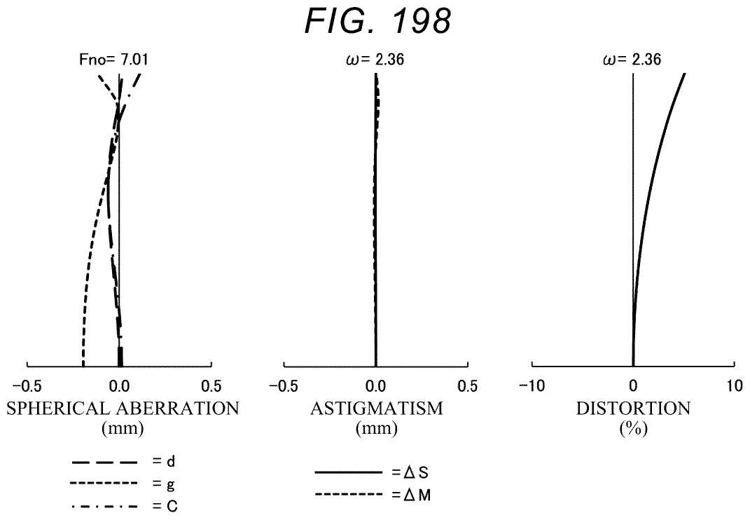

FIG. 199 is a longitudinal aberration diagram of the example 16 of the variable magnification imaging optical system according to the present invention at the telephoto end in a case of focusing on infinity.

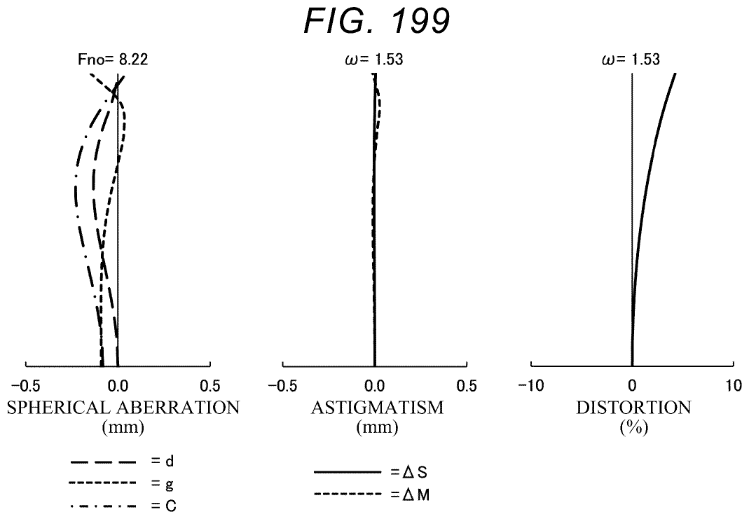

FIG. 200 is a lateral aberration diagram of the example 16 of the variable magnification imaging optical system according to the present invention at the wide-angle end in a case of focusing on infinity.

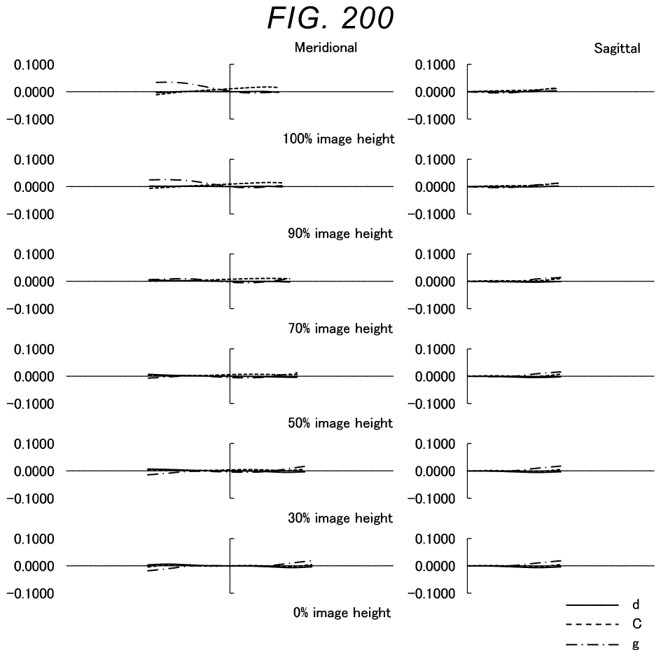

FIG. 201 is a lateral aberration diagram of the example 16 of the variable magnification imaging optical system according to the present invention at the intermediate focal length in a case of focusing on infinity.

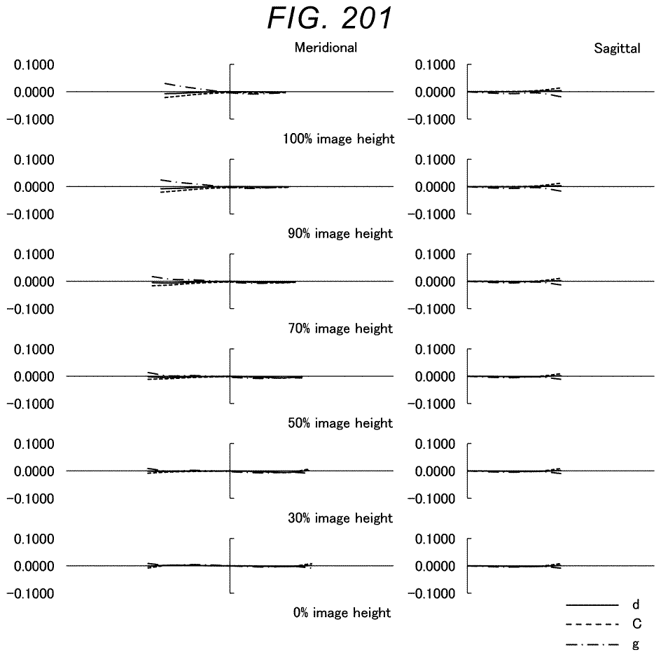

FIG. 202 is a lateral aberration diagram of the example 16 of the variable magnification imaging optical system according to the present invention at the telephoto end in a case of focusing on infinity.

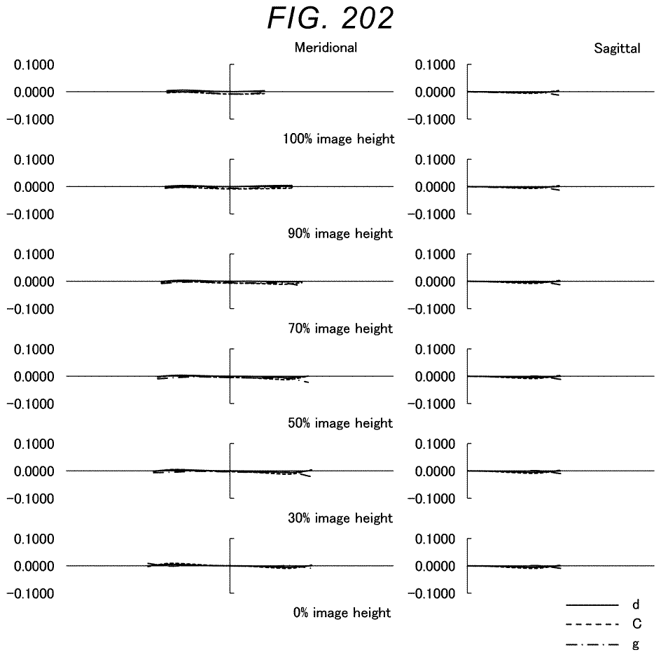

FIG. 203 is a lateral aberration diagram of the example 16 of the variable magnification imaging optical system according to the present invention at the wide-angle end in a case of focusing on an object at a distance of 3.3 m.

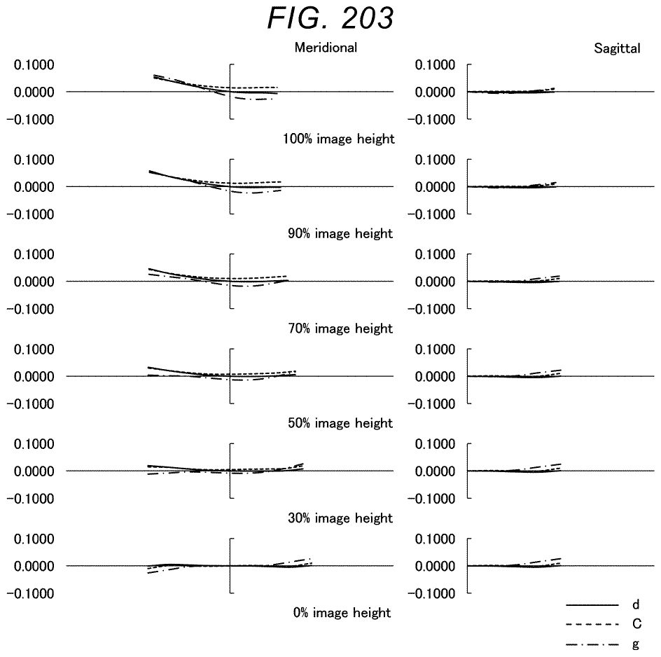

FIG. 204 is a lateral aberration diagram of the example 16 of the variable magnification imaging optical system according to the present invention at the intermediate focal length in a case of focusing on an object at a distance of 3.3 m.

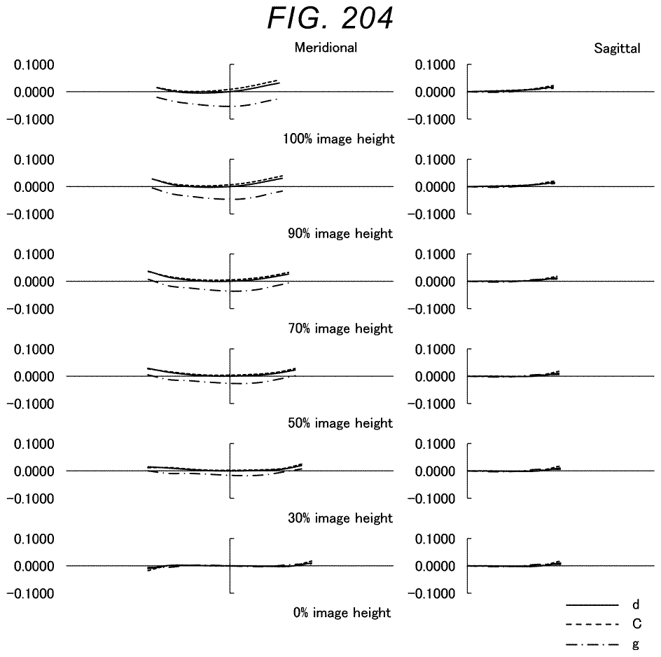

FIG. 205 is a lateral aberration diagram of the example 16 of the variable magnification imaging optical system according to the present invention at the telephoto end in a case of focusing on an object at a distance of 3.3 m.

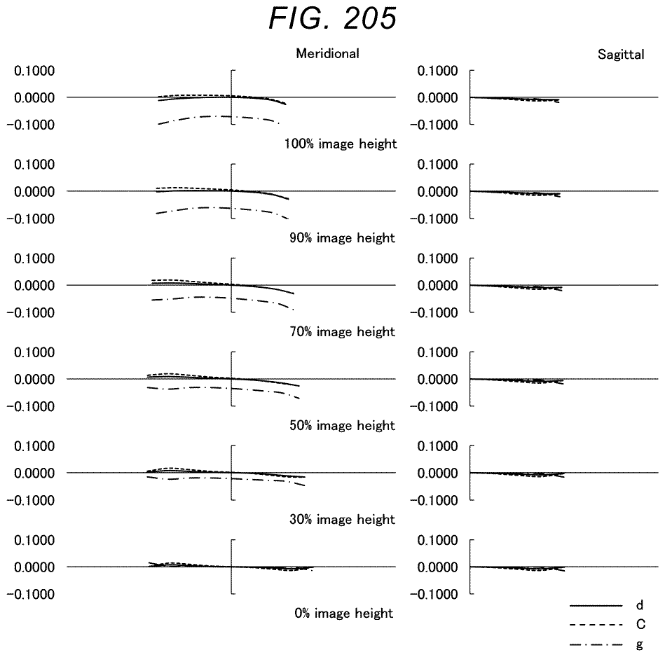

FIG. 206 is a lateral aberration diagram of the example 16 of the variable magnification imaging optical system according to the present invention at the wide-angle end in a case of vibration reduction in a case of focusing on infinity with a shake angle of 0.3 degrees.

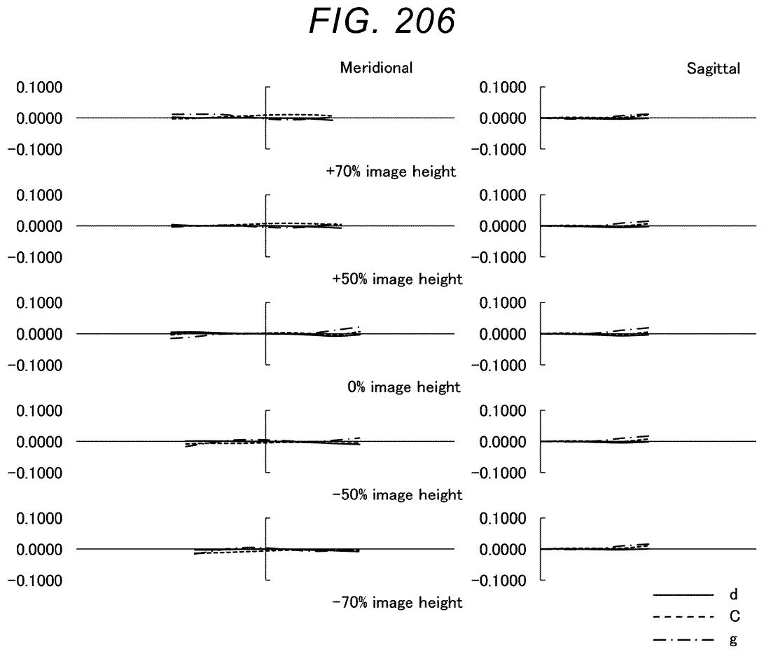

FIG. 207 is a lateral aberration diagram of the example 16 of the variable magnification imaging optical system according to the present invention at the intermediate focal length in a case of vibration reduction in a case of focusing on infinity with a shake angle of 0.3 degrees.

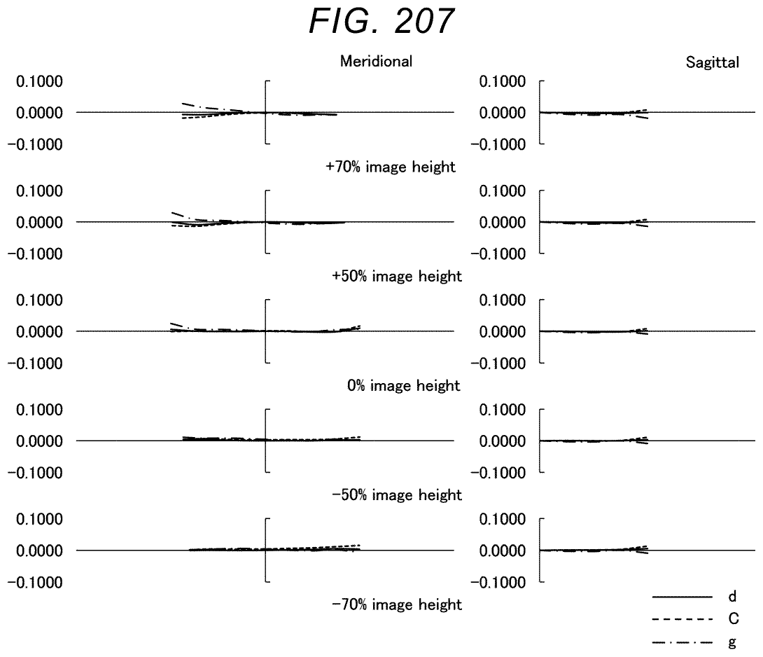

FIG. 208 is a lateral aberration diagram of the example 16 of the variable magnification imaging optical system according to the present invention at the telephoto end in a case of vibration reduction in a case of focusing on infinity with a shake angle of 0.3 degrees.

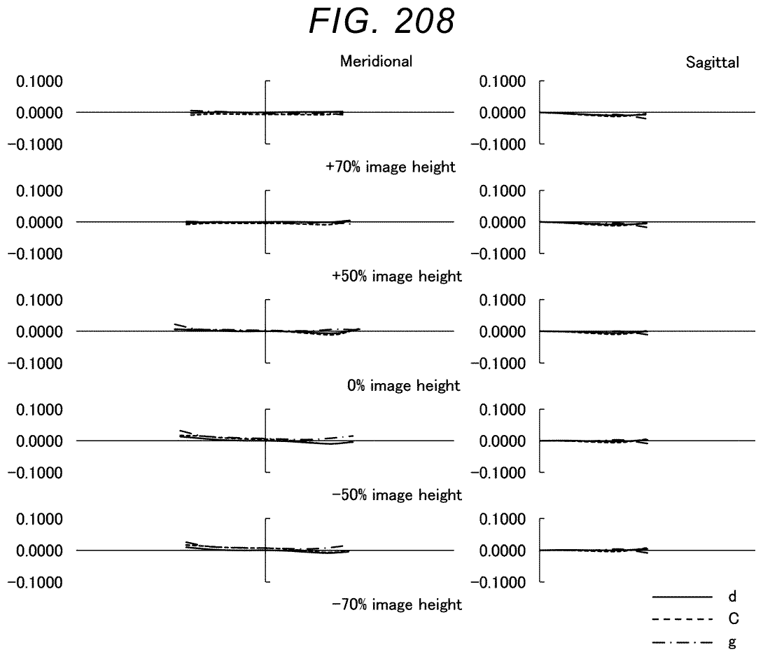

FIG. 209 is a lens configuration diagram of an example 17 of a variable magnification imaging optical system according to the present invention at a wide-angle end in a case of focusing on infinity.

FIG. 210 is a longitudinal aberration diagram of the example 17 of the variable magnification imaging optical system according to the present invention at the wide-angle end in a case of focusing on infinity.

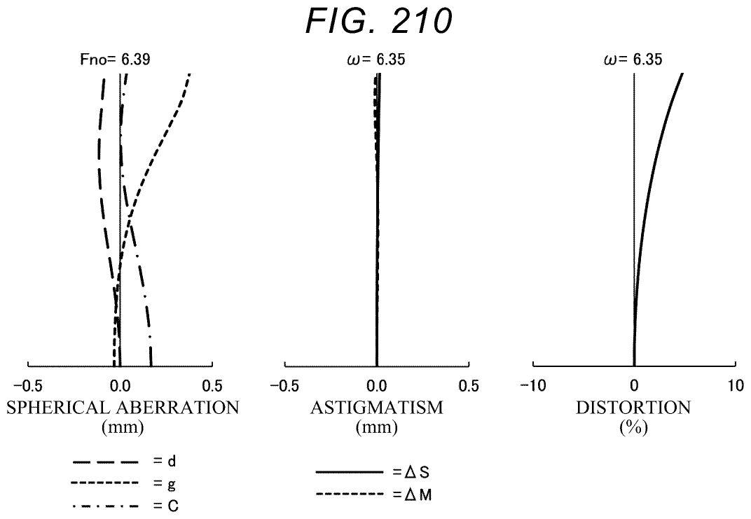

FIG. 211 is a longitudinal aberration diagram of the example 17 of the variable magnification imaging optical system according to the present invention at the intermediate focal length in a case of focusing on infinity.

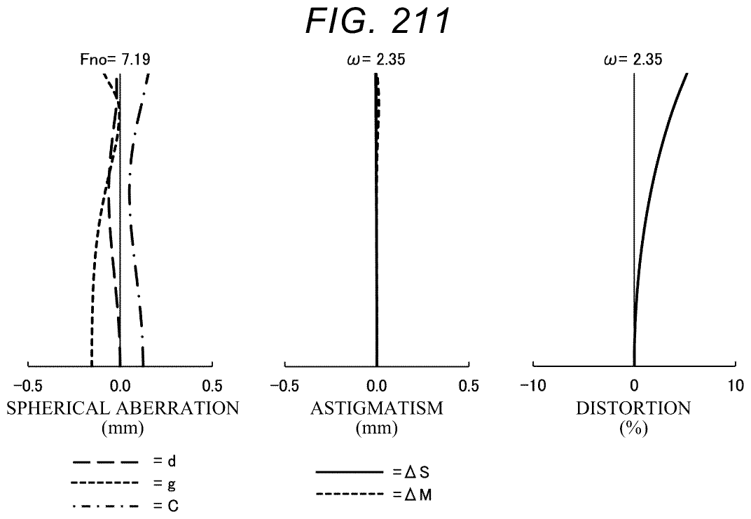

FIG. 212 is a longitudinal aberration diagram of the example 17 of the variable magnification imaging optical system according to the present invention at the telephoto end in a case of focusing on infinity.

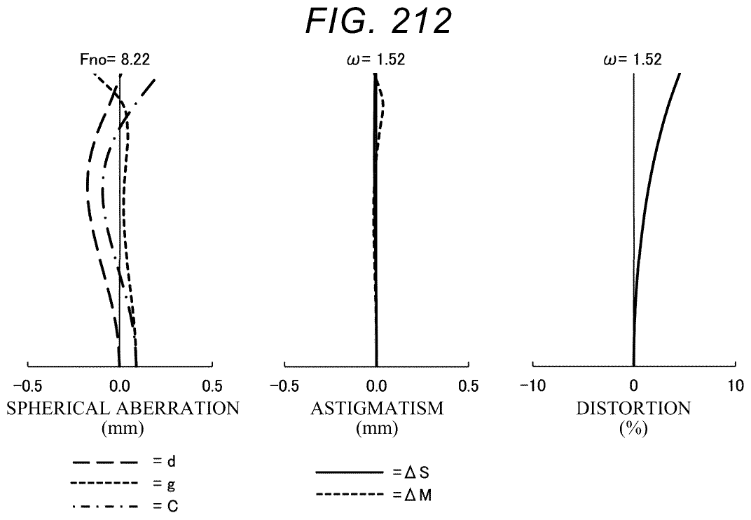

FIG. 213 is a lateral aberration diagram of the example 17 of the variable magnification imaging optical system according to the present invention at the wide-angle end in a case of focusing on infinity.

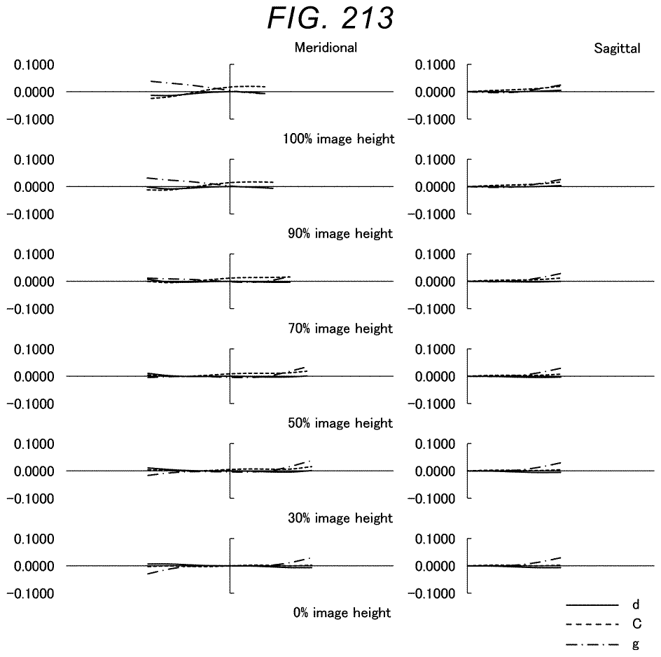

FIG. 214 is a lateral aberration diagram of the example 17 of the variable magnification imaging optical system according to the present invention at the intermediate focal length in a case of focusing on infinity.

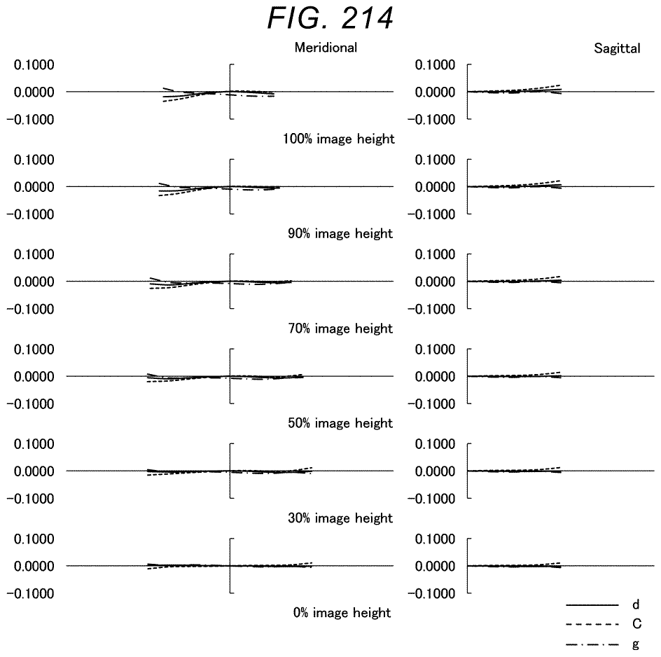

FIG. 215 is a lateral aberration diagram of the example 17 of the variable magnification imaging optical system according to the present invention at the telephoto end in a case of focusing on infinity.

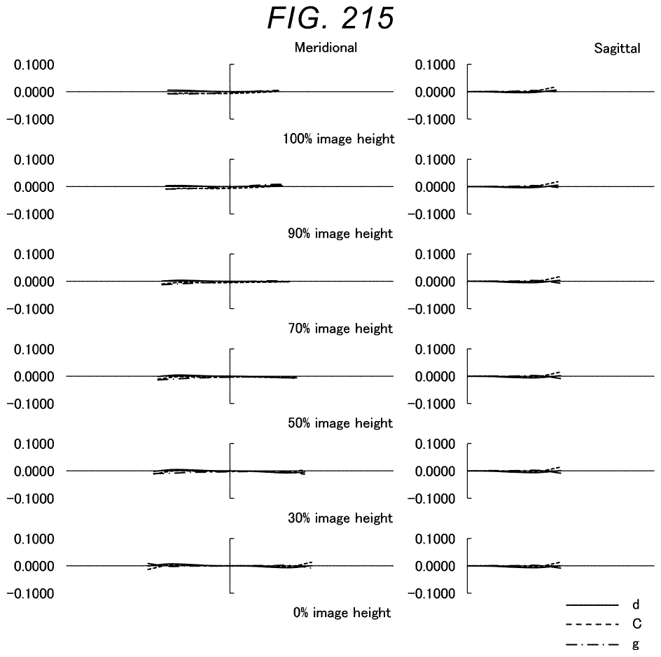

FIG. 216 is a lateral aberration diagram of the example 17 of the variable magnification imaging optical system according to the present invention at the wide-angle end in a case of focusing on an object at a distance of 3.2 m.

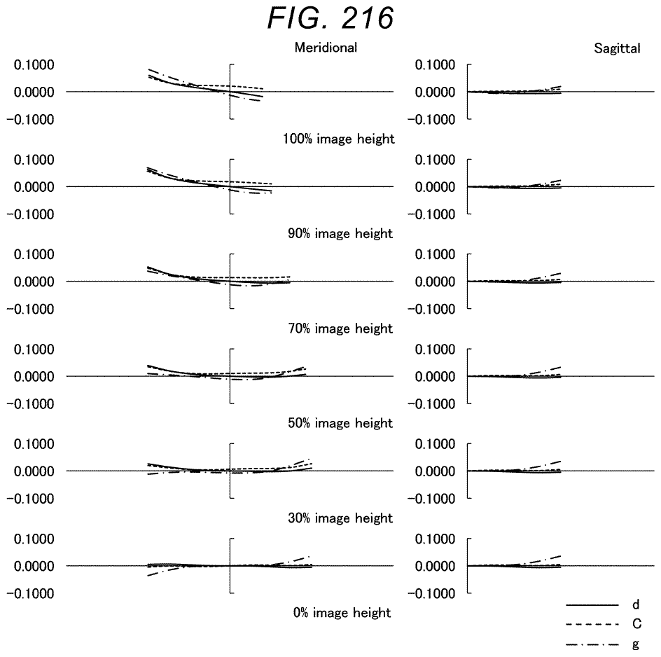

FIG. 217 is a lateral aberration diagram of the example 17 of the variable magnification imaging optical system according to the present invention at the intermediate focal length in a case of focusing on an object at a distance of 3.2 m.

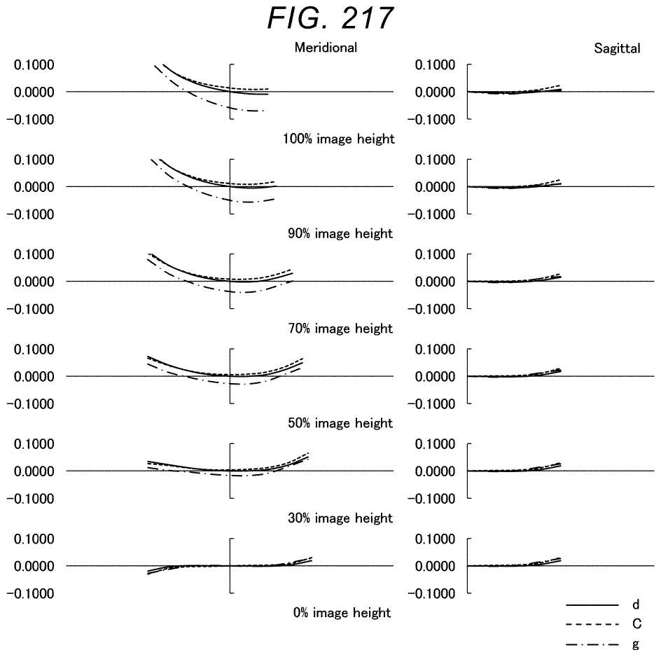

FIG. 218 is a lateral aberration diagram of the example 17 of the variable magnification imaging optical system according to the present invention at the telephoto end in a case of focusing on an object at a distance of 3.2 m.

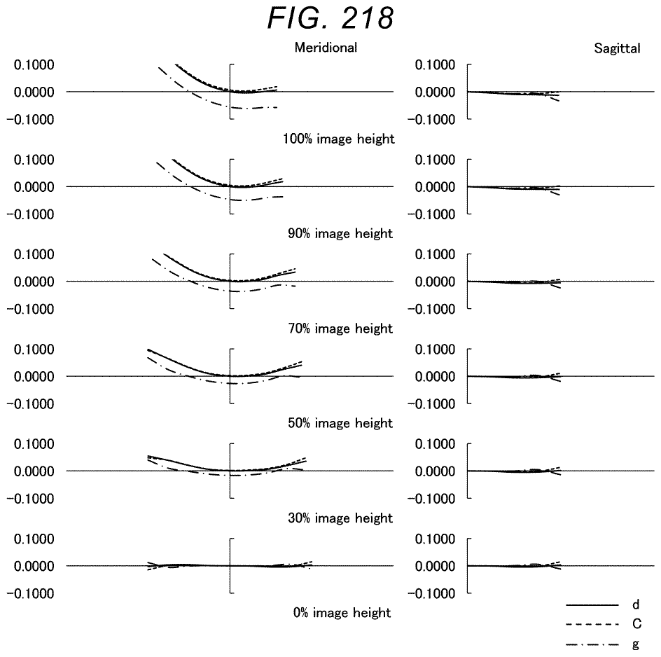

FIG. 219 is a lateral aberration diagram of the example 17 of the variable magnification imaging optical system according to the present invention at the wide-angle end in a case of vibration reduction in a case of focusing on infinity with a shake angle of 0.3 degrees.

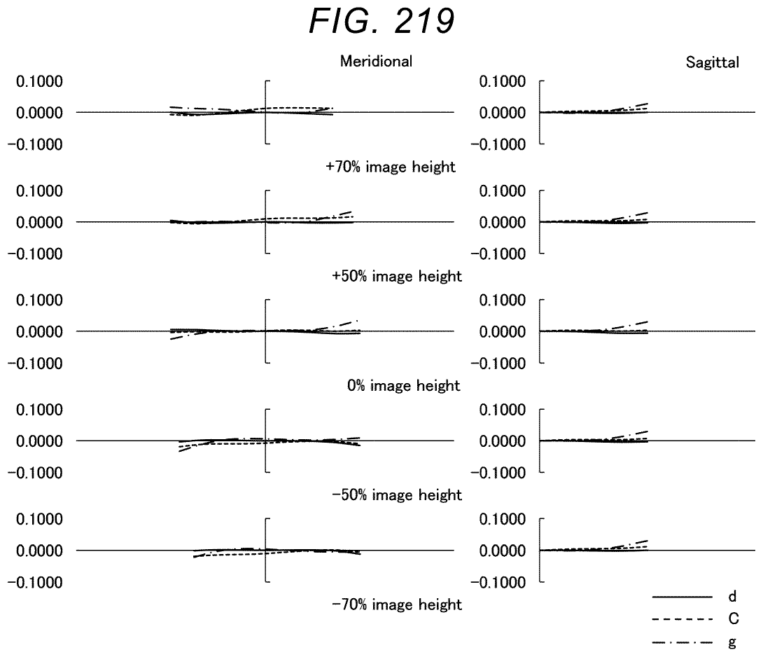

FIG. 220 is a lateral aberration diagram of the example 17 of the variable magnification imaging optical system according to the present invention at the intermediate focal length in a case of vibration reduction in a case of focusing on an infinite distance object with a shake angle of 0.3 degrees.

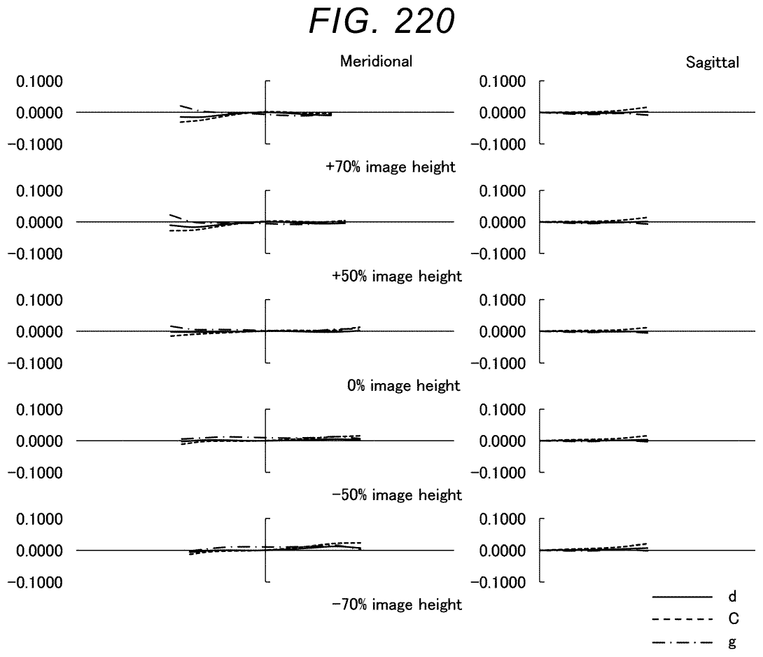

FIG. 221 is a lateral aberration diagram of the example 17 of the variable magnification imaging optical system according to the present invention at the telephoto end in a case of vibration reduction in a case of focusing on an infinite distance object with a shake angle of 0.3 degrees.

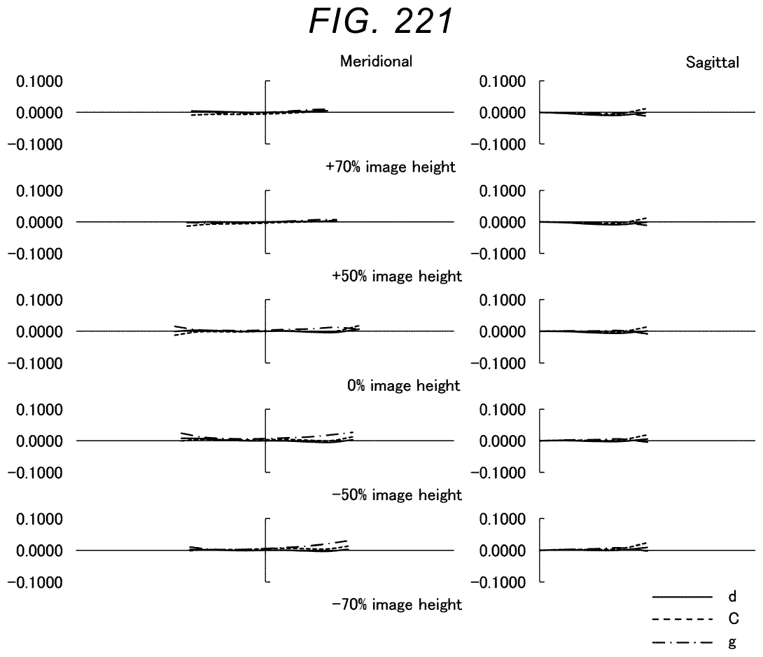

FIG. 222 is a lens configuration diagram of an example 18 of a variable magnification imaging optical system according to the present invention at a wide-angle end in a case of focusing on infinity.

FIG. 223 is a longitudinal aberration diagram of the example 18 of the variable magnification imaging optical system according to the present invention at the wide-angle end in a case of focusing on infinity.

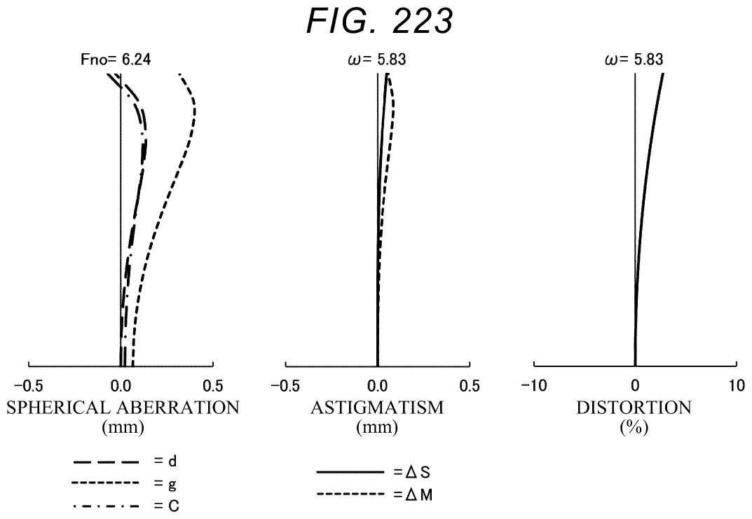

FIG. 224 is a longitudinal aberration diagram of the example 18 of the variable magnification imaging optical system according to the present invention at the intermediate focal length in a case of focusing on infinity.

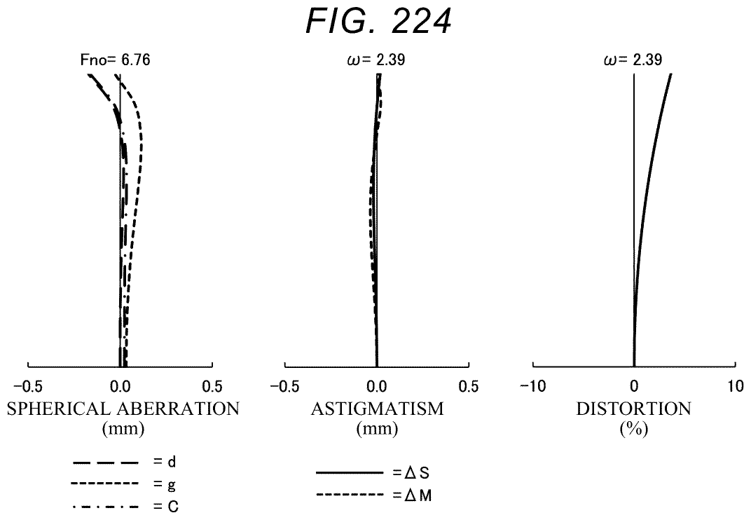

FIG. 225 is a longitudinal aberration diagram of the example 18 of the variable magnification imaging optical system according to the present invention at the telephoto end in a case of focusing on infinity.

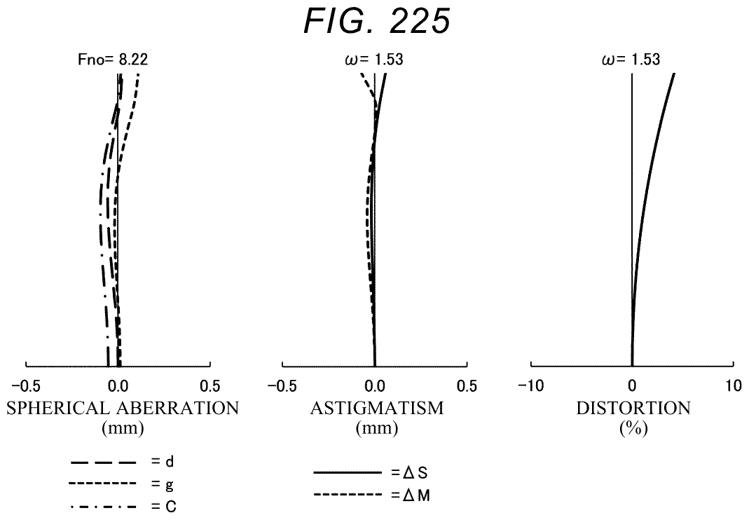

FIG. 226 is a lateral aberration diagram of the example 18 of the variable magnification imaging optical system according to the present invention at the wide-angle end in a case of focusing on infinity.

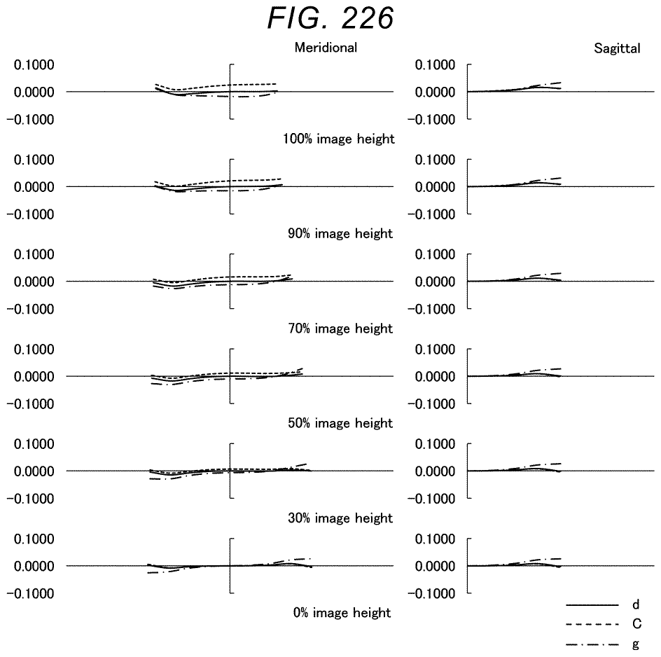

FIG. 227 is a lateral aberration diagram of the example 18 of the variable magnification imaging optical system according to the present invention at the intermediate focal length in a case of focusing on infinity.

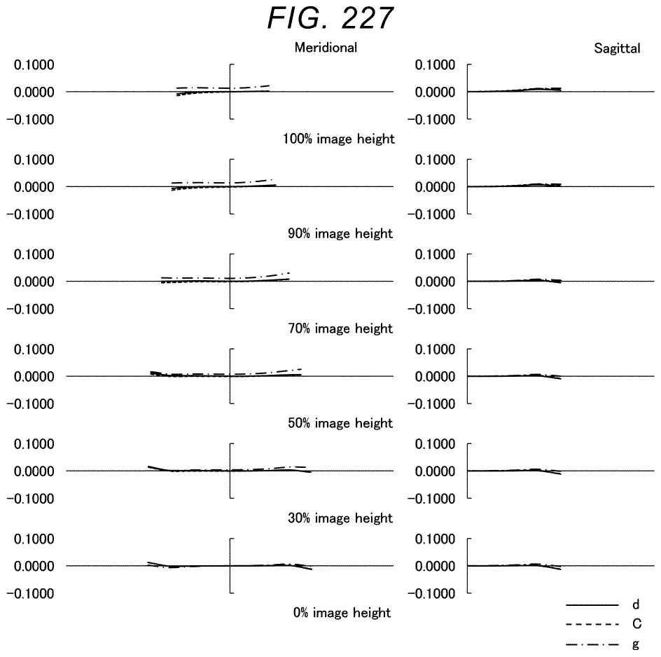

FIG. 228 is a lateral aberration diagram of the example 18 of the variable magnification imaging optical system according to the present invention at the telephoto end in a case of focusing on infinity.

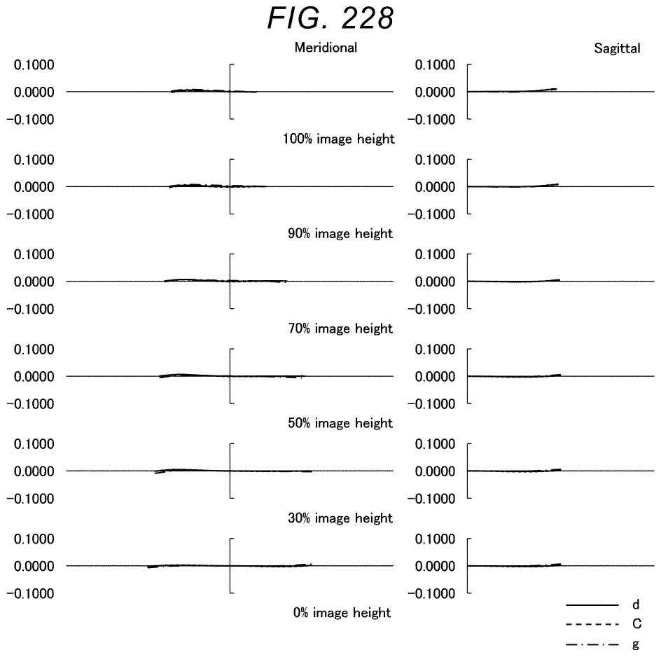

FIG. 229 is a lateral aberration diagram of the example 18 of the variable magnification imaging optical system according to the present invention at the wide-angle end in a case of focusing on an object at a distance of 3.3 m.

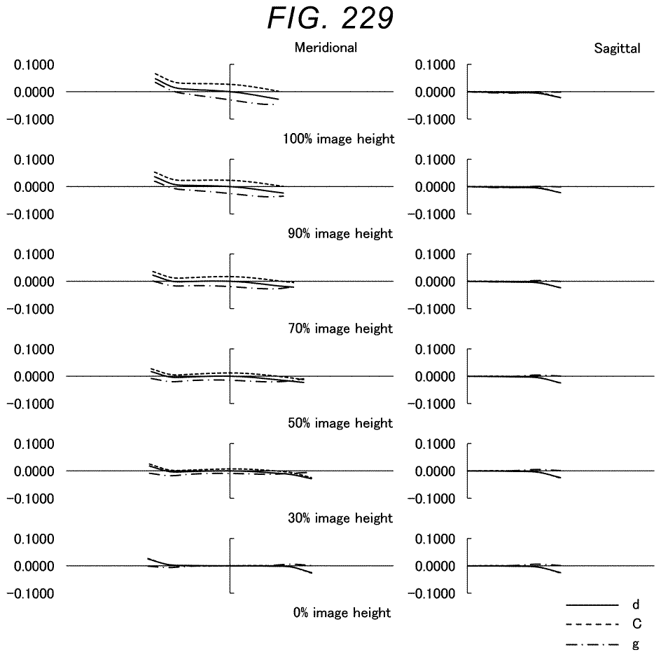

FIG. 230 is a lateral aberration diagram of the example 18 of the variable magnification imaging optical system according to the present invention at the intermediate focal length in a case of focusing on an object at a distance of 3.3 m.

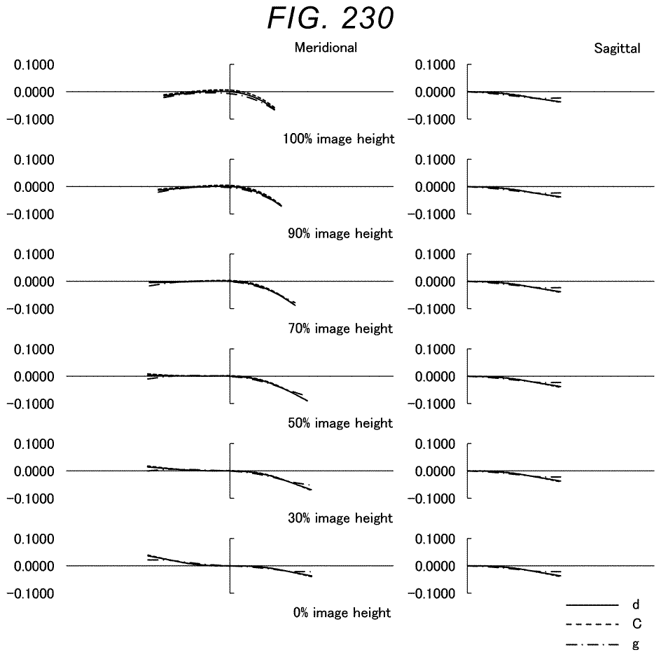

FIG. 231 is a lateral aberration diagram of the example 18 of the variable magnification imaging optical system according to the present invention at the telephoto end in a case of focusing on an object at a distance of 3.3 m.

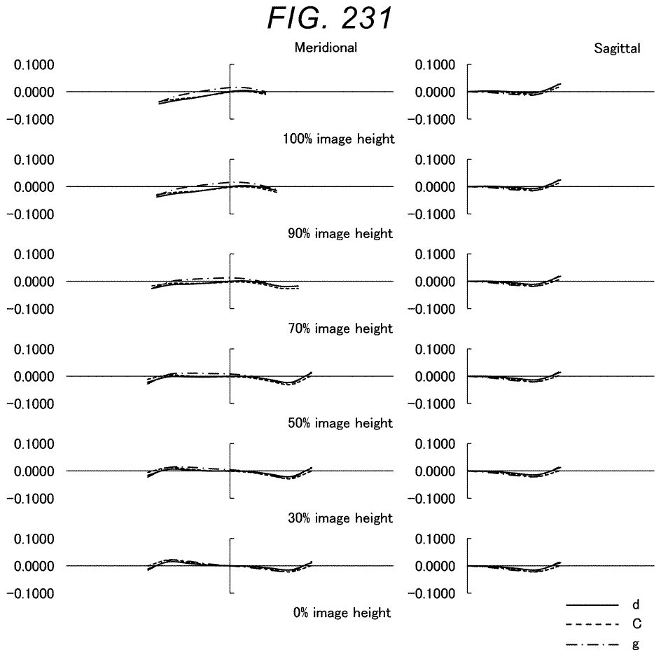

FIG. 232 is a lateral aberration diagram of the example 18 of the variable magnification imaging optical system according to the present invention at the wide-angle end in a case of vibration reduction in a case of focusing on infinity with a shake angle of 0.3 degrees.

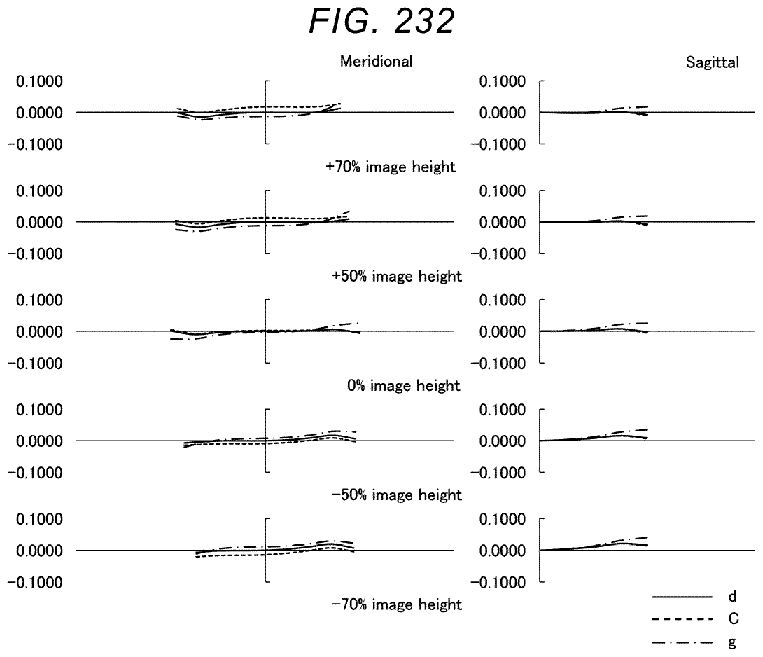

FIG. 233 is a lateral aberration diagram of the example 18 of the variable magnification imaging optical system according to the present invention at the intermediate focal length in a case of vibration reduction in a case of focusing on infinity with a shake angle of 0.3 degrees.

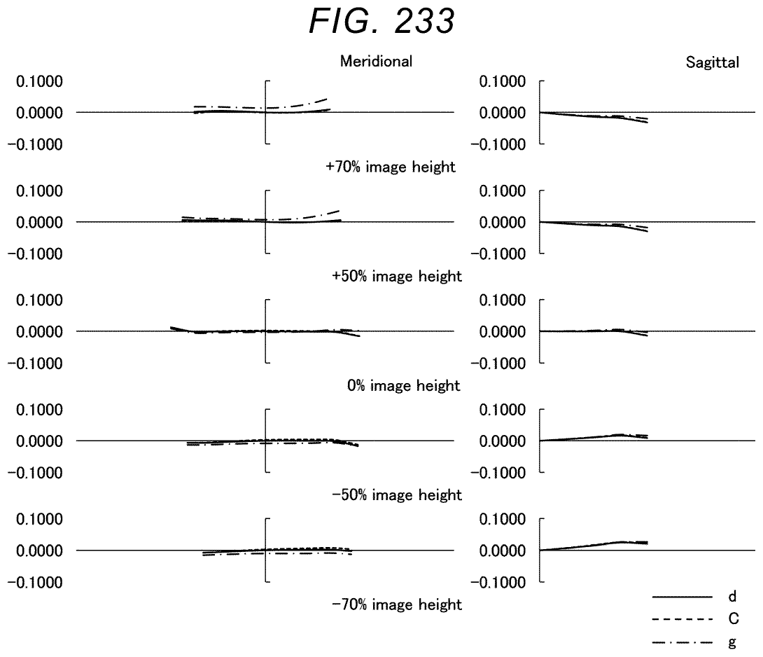

FIG. 234 is a lateral aberration diagram of the example 18 of the variable magnification imaging optical system according to the present invention at the telephoto end in a case of vibration reduction in a case of focusing on infinity with a shake angle of 0.3 degrees.

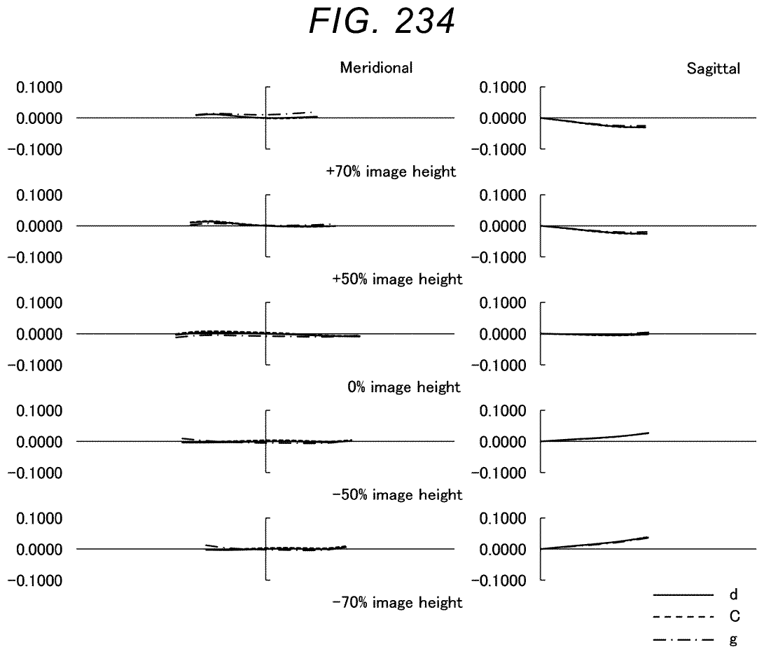

### EMBODIMENTS FOR CARRYING OUT THE INVENTION

Hereinafter, variable magnification imaging optical systems according to embodiments of the present invention will be described. The following description of examples describes examples of the optical system according to the present invention, and the present invention is not limited to the present example within the scope of the gist of the present invention. For example, a change such as aspherical conversion of a surface formed of a sphere or a plane, a change of an optical element material to a crystal material, plastic, or the like other than optical glass, or application of a functional film/structure having a function such as an antireflection film, a water-repellent and oil-repellent film, or the like to a lens surface is also possible. Here, the object side is described as a front side and the image side is described as a rear side.

In a case of counting the number of lenses in the present invention, unless otherwise specified, a single lens is counted as one lens, and in a case of a cemented lens, each single lens constituting the cemented lens is counted as one lens. For example, in a case of a cemented lens consisting of a convex lens and a concave lens, the cemented lens is counted as two lenses. In a case of a lens having a shape or a structure such that an aberration correction effect is provided with a resin or the like on a lens serving as a substrate, such as a compound aspherical surface, the shape or the structure added to the substrate is considered to be an integral part thereof, and the lens is counted as one lens. A cemented resin layer of a cemented lens is not counted as a lens. Even in a case where an aberration correction effect is provided with a cemented resin of a cemented lens, the resin portion is not counted as one lens by considering a structure added to any one of lenses to be cemented. A parallel plane plate such as a filter having no refractive power is not counted as a lens.

In addition, the meniscus that defines a shape of a lens in the present invention refers to a shape in which surfaces on the object side and the image side are composed of curved surfaces having curvature radii of the same sign. For example, a meniscus negative lens having a convex surface on the object side refers to a lens in which curvature radii of surfaces on the object side and the image side are both positive and the curvature radius of the surface on the image side is smaller. In a case of an aspherical lens, a lens shape is determined by a paraxial curvature radius.

In the present application, the lens groups are defined by using surfaces at which a distance on the optical axis changes due to magnification change or focusing as boundaries of the lens groups. Therefore, in a case where the aperture diaphragm S moves independently due to magnification change or focusing, the aperture diaphragm S is treated as one lens group.

In the following description of examples, refractive indices of a material with respect to a g line (wavelength: 435.8 nm), an F line (486.1 nm), a d line (587.6 nm), and a C line (656.3 nm) are denoted by Ng, NF, Nd, and NC, respectively. An Abbe number vd, a partial dispersion ratio PgF, and an anomalous dispersion ΔPgF are represented by

$$vd = ( Nd - 1 ) / ( NF - NC ) ,$$

$$PgF = ( Ng - NF ) / ( NF - NC ) , and$$

$$Δ PgF = PgF - 0.64833 + 0.0018 \times vd .$$

In addition, in the present specification, in a case where a refractive index is described without special definition, the refractive index of the d line is referred to.

In the description of the embodiment of the present invention, a description is made on heights of an axial marginal ray and an off-axis principal ray, but basically, the heights mean distances from the optical axis, and thus a concept of positive and negative does not occur. A direction away from the optical axis is treated as positive with the optical axis as 0, and the distances from the optical axis are represented as heights of rays. In addition, in Conditional Expressions of the present invention, unless otherwise specified, the axial marginal ray is defined as a ray that passes through the aperture diaphragm S at a maximum height from the optical axis among rays included in an on-axis light flux in a case of being stopped down. Similarly, the off-axis principal ray is defined as a ray that passes through a center of the aperture diaphragm S among off-axis rays that reach a maximum image height.

In the super telephoto zoom lens according to the present invention, it is an essential element to achieve size reduction and weight reduction to reduce the total length without reducing the magnification change ratio and the optical performance.

It is also important to reduce the weight of the first lens group G1 having a large weight and to suppress a movement amount thereof in order to suppress a change in the center of gravity due to zooming.

In addition, suppressing chromatic aberration is also an essential element for high performance in the super telephoto zoom lens according to the present invention. There are two types of chromatic aberration, that is, on-axis chromatic aberration and lateral chromatic aberration, and in a case of suppressing both types of chromatic aberration over the entire zoom range, it is important to appropriately select a glass material in accordance with a change in power arrangement.

In general, lateral chromatic aberration of an optical system composed of thin lenses is given by (Reference Expression 1) below as a sum of lenses, and can be considered as follows.

In a case where a lens having a positive refractive power is disposed on the object side with respect to the aperture diaphragm, a peripheral light flux passing through the lens passes through a quadrant opposite to an imaging position, and in a case of general optical glass, the peripheral light flux is imaged at a position of a lower image height as the wavelength is longer due to dispersion characteristics, and the C line is observed as lateral chromatic aberration in an under direction. Similarly in a case where a lens having a negative refractive power is disposed on the object side with respect to the aperture diaphragm, the opposite phenomenon to the above occurs. In addition, in a case where a lens is disposed on the image side with respect to the aperture diaphragm, the peripheral light flux passing through the lens and the imaging position pass through the same quadrant, and thus the opposite phenomenon to the case where the lens is disposed on the object side with respect to the aperture diaphragm occurs.

$$\sum ( h \cdot hb \cdot φ / v ) \qquad ( Reference Expression 1 )$$

h: axial marginal ray height
hb: height of off-axis principal ray
φ: refractive power
v: Abbe number

The axial marginal ray is defined as a ray that passes through the aperture diaphragm at a maximum height from the optical axis among rays included in the on-axis light flux, and the principal ray is defined as a ray that passes through the center of the aperture diaphragm.

Similarly, on-axis chromatic aberration of an optical system composed of thin lenses is given by (Reference Expression 2) below as a sum of lenses, and can be considered as follows.

$$\sum ( h \cdot h \cdot φ / v ) \qquad ( Reference Expression 2 )$$

h: axial marginal ray height
φ: refractive power
v: Abbe number

The axial marginal ray is defined as a ray that passes through the aperture diaphragm at a maximum height from the optical axis among rays included in the on-axis light flux.

In the reference expression 2, in a case where the axial marginal ray height is focused on, the amount of occurrence of on-axis chromatic aberration is larger as the lens through which the axial marginal ray passes at a higher position with respect to an effective diameter is larger, and the occurrence of on-axis chromatic aberration is smaller in a lens through which the axial marginal ray passes at a lower position. Therefore, in order to suppress on-axis chromatic aberration and lateral chromatic aberration over the entire zoom range, it is necessary to appropriately select a glass material in accordance with a change in ray height of the axial marginal ray and the off-axis principal ray during magnification change.

In a lens in which the first lens group G1 is fixed or has a small movement amount during magnification change, such as the present invention, in order to increase the total lens length with respect to the focal length on the wide angle side, a retrofocus type having an asymmetric refractive power arrangement with respect to the aperture diaphragm is adopted. On the other hand, in order to decrease the total lens length with respect to the focal length on the telephoto side, an asymmetric refractive power arrangement with respect to an aperture diaphragm of a telephoto type is adopted. As a result, lateral chromatic aberration of the C line occurs in an over direction on the wide angle side, and lateral chromatic aberration of the C line occurs in an under direction on the telephoto side. Therefore, in order to reduce lateral chromatic aberration over the entire wavelength range, a method of collecting the g line and the C line is often adopted, and in a case where a difference in imaging magnification between the g line and the C line and other wavelengths is large, a purple color or the like is diffused on a contour of a subject as secondary spectrum, which is not preferable. Therefore, it is effective to use a glass material having anomalous dispersion for correcting the secondary spectrum.

As can be seen from numerical examples and configuration diagrams of each example according to the present invention, the variable magnification imaging optical system according to the present invention includes, in order from the object side, a first front lens group GF1 consisting of one or two lens groups and having a positive refractive power as a whole, a second front lens group GF2 consisting of one or more lens groups and having a negative refractive power as a whole, a middle group GM consisting of one or more lens groups, and a subsequent group GR.

The first front lens group GF1 has a positive refractive power as a whole and has an effect of converging rays. Therefore, in a case where the refractive power of the first front lens group GF1 can be increased, it is possible to converge the rays at a shorter distance, which contributes to reduction in the total length. On the other hand, in a case where the refractive power is excessively increased, aberrations occurring in the first front lens group GF1 are increased, which leads to a decrease in optical performance. By appropriately setting the refractive power of the first front lens group GF1 and correcting the aberrations occurring in the first front lens group GF1 in the optical system of the second front lens group GF2 and subsequent groups, it is possible to achieve both reduction in the total length and high optical performance.

The first front lens group GF1 may be composed of one lens group, but by being composed of two lens groups and moving the lens group on the image side toward the object side during magnification change from the wide-angle end to the telephoto end, the refractive power of the first front lens group GF1 can be weakened on the telephoto side, which contributes to the magnification change effect. In a case of the super telephoto zoom lens of the total length fixed type, it is difficult to increase the magnification change ratio because a movement amount of a group (variator) having a main magnification change effect is limited, but the magnification change ratio can be increased by constituting the first front lens group GF1 of two lens groups and sharing the magnification change effect.

The second front lens group GF2 has a negative refractive power as a whole and is composed of one or more lens groups, and a lens group having the strongest negative refractive power moves toward the image side during magnification change from the wide-angle end to the telephoto end, thereby bearing a main magnification change effect. In addition, the second front lens group GF2 is composed of a plurality of lens groups which move along different trajectories during magnification change, so that it is possible to suppress fluctuation of aberrations during magnification change, particularly, fluctuation of field curvature.

The middle group GM consisting of one or more lens groups has a role of correcting fluctuation of the image surface due to magnification change. In a case where the magnification change ratio is increased, fluctuation of aberrations in a zoom intermediate range is increased, but the fluctuation can be effectively corrected by moving the plurality of lens groups along different trajectories during magnification change.

The subsequent group GR has a role of image surface compensation of imaging the rays passing through the middle group GM at a predetermined image height. From the viewpoint of size reduction of the optical system, it is preferable that the subsequent group GR has a negative refractive power. This is because the effect of moving the object side principal point position toward the object side is obtained, and thus it is possible to reduce a telephoto ratio (ratio of the focal length to the total lens length). In addition, in the subsequent group GR, by using a glass material having positive anomalous dispersion in a concave lens and using a glass material having negative anomalous dispersion in a convex lens, an effect of correcting the g line in an over direction is obtained, and it is possible to correct lateral chromatic aberration on the telephoto side. In addition, in the subsequent group GR, since the axial marginal ray passes through at a lower ray height with respect to the off-axis principal ray, the subsequent group GR has a characteristic that the correction effect of lateral chromatic aberration is increased at a higher image height while the change in on-axis chromatic aberration is minimized.

In the variable magnification imaging optical system according to the present invention, it is desirable to satisfy Conditional Expressions (1) and (2) below in order to achieve size reduction and weight reduction of the optical system:

$$2.5 < fT / fF 1 < 11. \qquad ( 1 )$$

$$0.15 < LiT / fT < 0.7 \qquad ( 2 )$$

where:
fT: focal length of entire system at telephoto end at infinity
fF1: focal length of first front lens group GF1 at telephoto end at infinity
LiT: length on optical axis from lens surface closest to object side at telephoto end at infinity to image surface.

Conditional Expression (1) specifies a ratio of the focal length of the entire system at the telephoto end at infinity to the focal length of the first front lens group GF1. In a case where the refractive power of the first front lens group GF1 is increased, the rays are converged at a shorter distance, which contributes to reduction in the total length of the optical system. In a case where the total length is the same, the diameter of the optical system behind the first front lens group GF1 is reduced, which also contributes to weight reduction. In a case where the first front lens group GF1 consists of one lens group, the first lens group G1 and the first front lens group GF1 are the same lens group.

In a case where the upper limit value of Conditional Expression (1) is exceeded and the ratio of the focal length of the entire system at the telephoto end at infinity to the focal length of the first front lens group GF1 becomes large, the focal length of the first front lens group GF1 is shorter relative to the focal length of the entire system at the telephoto end at infinity, the refractive power is excessively increased, and it is difficult to correct spherical aberration or comatic aberration, which leads to a decrease in optical performance, which is not preferable.

In a case where the ratio of the focal length of the entire system at the telephoto end at infinity to the focal length of the first front lens group GF1 becomes smaller than the lower limit value of Conditional Expression (1), the focal length of the first front lens group GF1 is longer than the focal length of the entire system at the telephoto end at infinity, the refractive power is excessively decreased, and the reduction in the total lens length is insufficient, which is not preferable.

In Conditional Expression (1), in order to more reliably obtain the above-described effect, it is desirable to define the lower limit value as 2.85 and the upper limit value as 10.00, it is more desirable to define the lower limit value as 3.15 and the upper limit value as 9.00, it is still more desirable to define the lower limit value as 3.23 and the upper limit value as 8.80, it is even more desirable to define the lower limit value as 3.27 and the upper limit value as 8.70, and it is even still more desirable to define the lower limit value as 3.30 and the upper limit value as 8.50.

Conditional Expression (2) specifies a ratio (telephoto ratio) of the length on the optical axis from the lens surface closest to the object side to the image surface (total lens length) at the telephoto end at infinity to the focal length of the entire system at the telephoto end at infinity. It is an indicator that measures to what extent the total lens length is reduced with respect to the focal length of the optical system. A parallel plane plate disposed between the lens closest to the image side and having a refractive power and the image surface is not counted as a lens. In a case of calculating LiT, LiT is calculated by an air equivalent length in which the parallel plane plate is replaced with air.

In a case where the upper limit value of Conditional Expression (2) is exceeded and the ratio of the length on the optical axis from the lens surface closest to the object side to the image surface at the telephoto end at infinity to the focal length of the entire system at the telephoto end at infinity becomes large, the length on the optical axis from the lens surface closest to the object side to the image surface at the telephoto end at infinity is excessively longer than the focal length of the entire system at the telephoto end at infinity, and the size reduction is insufficient, which is not preferable.

In a case where the ratio of the focal length from the lens surface closest to the object side to the image surface at the telephoto end at infinity to the focal length of the entire system at the telephoto end at infinity becomes smaller than the lower limit value of Conditional Expression (2), the length on the optical axis from the lens surface closest to the object side to the image surface at the telephoto end at infinity is excessively shorter relative to the focal length of the entire system at the telephoto end at infinity, and various aberrations such as spherical aberration and comatic aberration are increased, which leads to a decrease in performance of the optical system, which is not preferable.

In Conditional Expression (2), in order to more reliably obtain the above-described effect, it is desirable to define the lower limit value as 0.20 and the upper limit value as 0.60, it is more desirable to define the lower limit value as 0.22 and the upper limit value as 0.50, and it is still more desirable to define the lower limit value as 0.24 and the upper limit value as 0.48.

In addition, in the variable magnification imaging optical system according to the present invention, it is desirable to satisfy Conditional Expression (3) below in order to achieve size reduction and weight reduction of the optical system:

$$2.5 < fT / f 1 < 11. \qquad ( 3 )$$

where:
fT: focal length of entire system at telephoto end at infinity
f1: focal length of the first lens group G1.

Conditional Expression (3) specifies a ratio of the focal length of the entire system at the telephoto end at infinity to the focal length of the first lens group G1 at the telephoto end at infinity. In a case where the refractive power of the first lens group G1 is increased, the rays are converged at a shorter distance, which contributes to reduction in the total length of the optical system. In a case where the total length is the same, the diameter of the optical system behind the first lens group G1 is reduced, which also contributes to weight reduction.

In a case where the upper limit value of Conditional Expression (3) is exceeded and the ratio of the focal length of the entire system at the telephoto end at infinity to the focal length of the first lens group G1 at the telephoto end at infinity becomes large, the focal length of the first lens group G1 is shorter relative to the focal length of the entire system at the telephoto end at infinity, the refractive power is excessively increased, and it is difficult to correct spherical aberration or comatic aberration, which leads to a decrease in optical performance, which is not preferable.

In a case where the ratio of the focal length of the entire system at the telephoto end at infinity to the focal length of the first lens group G1 at the telephoto end at infinity becomes smaller than the lower limit value of Conditional Expression (3), the focal length of the first lens group G1 is longer than the focal length of the entire system at the telephoto end at infinity, the refractive power is excessively decreased, and the reduction in the total lens length is insufficient, which is not preferable.

In Conditional Expression (3), in order to more reliably obtain the above-described effect, it is desirable to define the lower limit value as 2.85 and the upper limit value as 10.00, it is more desirable to define the lower limit value as 3.15 and the upper limit value as 9.00, it is still more desirable to define the lower limit value as 3.23 and the upper limit value as 8.80, it is even more desirable to define the lower limit value as 3.27 and the upper limit value as 8.70, and it is even still more desirable to define the lower limit value as 3.30 and the upper limit value as 8.50.

In addition, in the variable magnification imaging optical system according to the present invention, it is desirable to satisfy Conditional Expression (4) below:

$$1.2 < fT / fW < 7. \qquad ( 4 )$$

where:
fT: focal length of entire system at telephoto end at infinity
fW: focal length of entire system at wide-angle end at infinity.

Conditional Expression (4) specifies a ratio (magnification change ratio) of the focal length of the entire system at the telephoto end at infinity to the focal length of the entire system at the wide-angle end at infinity.

In a case where the upper limit value of Conditional Expression (4) is exceeded and the ratio of the focal length of the entire system at the telephoto end at infinity to the focal length of the entire system at the wide-angle end at infinity becomes large, fluctuation of aberrations due to magnification change is excessively large, which leads to a decrease in optical performance, which is not preferable.

In a case where the ratio of the focal length of the entire system at the telephoto end at infinity to the focal length of the entire system at the wide-angle end at infinity becomes smaller than the lower limit value of Conditional Expression (4), a change in angle of view due to magnification change is small, which impairs usefulness of the zoom lens.

In Conditional Expression (4), in order to more reliably obtain the above-described effect, it is desirable to define the lower limit value as 1.5 and the upper limit value as 5.0, it is more desirable to define the lower limit value as 2.1 and the upper limit value as 4.7, and it is still more desirable to define the lower limit value as 2.4 and the upper limit value as 4.5.

In addition, in the variable magnification imaging optical system according to the present invention, it is desirable to satisfy Conditional Expression (5) below in order to achieve size reduction and weight reduction of the optical system:

$$60 < LiT / ( fT / fW ) < 250 \qquad ( 5 )$$

where:
LiT: length on optical axis from lens surface closest to object side at telephoto end at infinity to image surface
fW: focal length of entire system at wide-angle end at infinity
fT: focal length of entire system at telephoto end at infinity.

Conditional Expression (5) specifies a ratio of the length on the optical axis from the lens surface closest to the object side at the telephoto end at infinity to the image surface to the magnification change ratio (ratio of the focal length of the entire system at the telephoto end at infinity to the focal length of the entire system at the wide-angle end at infinity). In general, the optical system is likely to be large as the magnification change ratio is increased, but the Conditional Expression (5) indicates to what extent the optical system is reduced in size with respect to the magnification change ratio. A parallel plane plate disposed between the lens closest to the image side and having a refractive power and the image surface is not counted as a lens. In a case of calculating LiT, LiT is calculated by an air equivalent length in which the parallel plane plate is replaced with air. In addition, the unit of the value calculated by the conditional expression is mm.

In a case where the upper limit value of Conditional Expression (5) is exceeded and the ratio of the length on the optical axis from the lens surface closest to the object side to the image surface at the telephoto end at infinity to the magnification change ratio becomes large, the length on the optical axis from the lens surface closest to the object side at the telephoto end at infinity to the image surface is excessively longer with respect to the magnification change ratio, and it is difficult to reduce the size of the optical system, which is not preferable.

In a case where the ratio of the length on the optical axis from the lens surface closest to the object side at the telephoto end at infinity to the image surface to the magnification change ratio becomes smaller than the lower limit value of Conditional Expression (5), the length on the optical axis from the lens surface closest to the object side at the telephoto end at infinity to the image surface is excessively small, and various aberrations such as spherical aberration and comatic aberration are deteriorated, and fluctuation of aberrations due to magnification change is also increased, which is not preferable.

In Conditional Expression (5), in order to more reliably obtain the above-described effect, it is desirable to define the lower limit value as 80 and the upper limit value as 200, and it is more desirable to define the lower limit value as 85 and the upper limit value as 160.

In addition, in the variable magnification imaging optical system according to the present invention, it is desirable that the first lens group G1 disposed closest to the object side is fixed with respect to the image surface during magnification change from the wide-angle end to the telephoto end. In the super telephoto zoom lens according to the present invention, a lens group disposed closest to the object side has a large lens diameter and a large weight. In a case where the lens group is moved by magnification change, the movement of the center of gravity is large, and the balance of the equipment during imaging is changed, which is not preferable.

In addition, in the variable magnification imaging optical system according to the present invention, it is desirable that the first front lens group GF1 satisfies Conditional Expression (6) below in order to achieve size reduction and weight reduction of the optical system:

$$1.5 < fF 1 / Φ S 1 T < 5. \qquad ( 6 )$$

where:
fF1: focal length of first front lens group GF1 at telephoto end at infinity
ΦS1T: axial marginal ray diameter on surface closest to object side at telephoto end at infinity.

Conditional Expression (6) specifies a ratio of the focal length of the first front lens group GF1 at the telephoto end at infinity to the axial marginal ray diameter on the surface closest to the object side at the telephoto end at infinity, and corresponds to an apparent F-number of the first front lens group GF1 at the telephoto end at infinity. In a case where the ratio of the focal length of the first front lens group GF1 at the telephoto end at infinity to the axial marginal ray diameter on the surface closest to the object side at the telephoto end at infinity is small, the rays are converged at a shorter distance, which contributes to size reduction of the optical system.

In a case where the upper limit value of Conditional Expression (6) is exceeded and the ratio of the focal length of the first front lens group GF1 at the telephoto end at infinity to the axial marginal ray diameter on the surface closest to the object side at the telephoto end at infinity becomes large, the refractive power of the first front lens group GF1 is decreased, the optical system is long, and the lens diameter is enlarged because the rays incident on the second front lens group GF2 are not sufficiently converged, which makes it difficult to achieve size reduction and weight reduction, which is not preferable.

In a case where the ratio of the focal length of the first front lens group GF1 at the telephoto end at infinity to the axial marginal ray diameter on the surface closest to the object side at the telephoto end at infinity becomes smaller than the lower limit value of Conditional Expression (6), the refractive power of the first front lens group GF1 is excessively increased, and various aberrations such as spherical aberration and comatic aberration are deteriorated, which leads to a decrease in optical performance, which is not preferable.

In Conditional Expression (6), in order to more reliably obtain the above-described effect, it is desirable to define the lower limit value as 1.6 and the upper limit value as 4.0, it is more desirable to define the lower limit value as 1.7 and the upper limit value as 3.3, and it is still more desirable to define the lower limit value as 1.8 and the upper limit value as 2.9.

In addition, in the variable magnification imaging optical system according to the present invention, it is desirable that the first front lens group GF1 satisfies Conditional Expression (7) below in order to achieve size reduction and weight reduction of the optical system:

$$0.4 < Φ G 1 FrT / Φ S 1 T < 0.87 \qquad ( 7 )$$

where:
ΦG1FrT: axial marginal ray diameter on surface closest to image side in first front lens group GF1 at telephoto end at infinity
ΦS1T: axial marginal ray diameter on surface closest to object side at telephoto end at infinity.

Conditional Expression (7) specifies a ratio of the axial marginal ray diameter on the surface closest to the image side in the first front lens group GF1 at the telephoto end at infinity to the axial marginal ray diameter on the surface closest to the object side at the telephoto end at infinity, and indicates to what extent the axial marginal ray height can be lowered by passing through the first front lens group GF1.

In a case where the upper limit value of Conditional Expression (7) is exceeded and the ratio of the axial marginal ray diameter on the surface closest to the image side in the first front lens group GF1 at the telephoto end at infinity to the axial marginal ray diameter on the surface closest to the object side at the telephoto end at infinity becomes large, the axial marginal ray height is not sufficiently lowered in the first front lens group GF1, the lens diameter of the second front lens group GF2 is enlarged, and it is difficult to achieve size reduction and weight reduction, which is not preferable.

In a case where the ratio of the axial marginal ray diameter on the surface closest to the image side in the first front lens group GF1 at the telephoto end at infinity to the axial marginal ray diameter on the surface closest to the object side at the telephoto end at infinity becomes smaller than the lower limit value of Conditional Expression (7), the refractive power of the first front lens group GF1 is excessively increased, and various aberrations such as spherical aberration and comatic aberration are deteriorated, which leads to a decrease in optical performance, which is not preferable.

In Conditional Expression (7), in order to more reliably obtain the above-described effect, it is desirable to define the lower limit value as 0.50 and the upper limit value as 0.85, it is more desirable to define the lower limit value as 0.55 and the upper limit value as 0.82, and it is still more desirable to define the lower limit value as 0.57 and the upper limit value as 0.80.

In addition, in the variable magnification imaging optical system according to the present invention, it is desirable that the first front lens group GF1 satisfies Conditional Expression (8) below in order to achieve high optical performance while ensuring the magnification change ratio:

$$0.08 < LGF 1 / LrT < 0.5 \qquad ( 8 )$$

where:
LGF1: length on optical axis of first front lens group GF1 at telephoto end at infinity
LrT: length on optical axis from lens surface closest to object side to lens surface closest to image side at telephoto end at infinity.

Conditional Expression (8) specifies a ratio of the length on the optical axis of the first front lens group GF1 at the telephoto end at infinity to the length on the optical axis from the lens surface closest to the object side to the lens surface closest to the image side at the telephoto end at infinity, and indicates a proportion of the first front lens group GF1 with respect to the length of a lens portion of the optical system at the telephoto end at infinity.

In a case where the upper limit value of Conditional Expression (8) is exceeded and the ratio of the length on the optical axis of the first front lens group GF1 at the telephoto end at infinity to the length on the optical axis from the lens surface closest to the object side to the lens surface closest to the image side at the telephoto end at infinity becomes large, the proportion of the first front lens group GF1 with respect to the length of the lens portion of the optical system at the telephoto end at infinity is increased, and a movement amount of a lens group that bears a magnification change effect and is disposed on the image side with respect to the first front lens group GF1 is limited, which makes it difficult to increase the magnification change ratio, which is not preferable.

In a case where the ratio of the length on the optical axis of the first front lens group GF1 at the telephoto end at infinity to the length on the optical axis from the lens surface closest to the object side to the lens surface closest to the image side at the telephoto end at infinity becomes smaller than the lower limit value of Conditional Expression (8), the refractive power of the first front lens group GF1 is excessively increased, and various aberrations such as spherical aberration and comatic aberration are deteriorated, which leads to a decrease in optical performance, which is not preferable.

In Conditional Expression (8), in order to more reliably obtain the above-described effect, it is desirable to define the lower limit value as 0.10 and the upper limit value as 0.30, it is more desirable to define the lower limit value as 0.11 and the upper limit value as 0.28, it is still more desirable to define the lower limit value as 0.12 and the upper limit value as 0.26, and it is even more desirable to define the lower limit value as 0.13 and the upper limit value as 0.25.

In addition, in the variable magnification imaging optical system according to the present invention, it is desirable that the first front lens group GF1 satisfies Conditional Expression (9) below in order to achieve size reduction and weight reduction of the optical system:

$$0.15 < LairGF 1 / LGF 1 < 0.83 \qquad ( 9 )$$

where:
LairGF1: maximum air-space distance on optical axis in first front lens group GF1 at telephoto end at infinity
LGF1: length on optical axis of first front lens group GF1 at telephoto end at infinity.

Conditional Expression (9) specifies a ratio of the maximum air-space distance on the optical axis in the first front lens group GF1 at the telephoto end at infinity to the length on the optical axis of the first front lens group GF1 at the telephoto end at infinity. The first front lens group GF1 is divided into a lens unit on the object side and a lens unit on the image side at a maximum air-space distance in the first front lens group GF1 at the telephoto end at infinity. In a case where the air-space distance is increased, the lens diameter of the lens unit on the image side is decreased (the lens unit refers to a group of lenses in the first front lens group GF1). Therefore, the weight of the lens unit on the image side is reduced, which contributes to weight reduction of the first front lens group GF1. In a case where the air-space distance occupies a large proportion with respect to the length on the optical axis of the first front lens group GF1 at the telephoto end at infinity, the first front lens group GF1 is more effectively reduced in weight.

In a case where the upper limit value of Conditional Expression (9) is exceeded and the ratio of the maximum air-space distance on the optical axis in the first front lens group GF1 at the telephoto end at infinity to the length on the optical axis of the first front lens group GF1 at the telephoto end at infinity becomes large, the total length of the optical system is increased, and it is difficult to reduce the size (This is established in a case where a change in a portion excluding LairGF1 from LGF1 is significantly smaller than a change in LairGF1. In short, the thickness of the entire lens group is increased in a case where the air-space distance between the lenses is increased while the thickness of the lenses is not changed in a direction.).

In a case where the ratio of the maximum air-space distance on the optical axis in the first front lens group GF1 at the telephoto end at infinity to the length on the optical axis of the first front lens group GF1 at the telephoto end at infinity becomes smaller than the lower limit value of Conditional Expression (9), the lens diameter of the lens unit on the image side is not decreased, and it is difficult to reduce the weight of the first front lens group GF1, which is not preferable.

In Conditional Expression (9), in order to more reliably obtain the above-described effect, it is desirable to define the lower limit value as 0.22 and the upper limit value as 0.70, and it is more desirable to define the lower limit value as 0.30 and the upper limit value as 0.60.

In addition, in the variable magnification imaging optical system according to the present invention, it is desirable that a convex lens is disposed closest to the object side and a concave lens is disposed closest to the image side in the first front lens group GF1. The first front lens group GF1 has a role of converging rays while suppressing the occurrence of chromatic aberration. In general, in order to suppress chromatic aberration, it is necessary to combine a convex lens and a concave lens, and it is essential to dispose the concave lens. In a case where the concave lens is disposed, the rays are diverged, and thus the diameter of the lens that is disposed on the image side is inevitably increased. Therefore, by disposing the convex lens closest to the object side and disposing the concave lens closest to the image side in the first front lens group GF1, the lens diameter of the first front lens group GF1 can be efficiently suppressed.

In addition, in the variable magnification imaging optical system according to the present invention, it is desirable that the first front lens group GF1 satisfies Conditional Expression (10) in which a convex lens is disposed closest to the object side:

$$0.2 < LairGF 1 / LgGF 1 < 3.5 \qquad ( 10 )$$

where:
LairGF1: maximum air-space distance on optical axis in first front lens group GF1 at telephoto end at infinity
LgGF1: sum of thicknesses on optical axis of all lenses constituting first front lens group GF1.

Conditional Expression (10) specifies a ratio of the maximum air-space distance on the optical axis in the first front lens group GF1 at the telephoto end at infinity to the sum of the thicknesses on the optical axis of all lenses constituting the first front lens group GF1. The first front lens group GF1 is divided into a lens unit on the object side and a lens unit on the image side at a maximum air-space distance in the first front lens group GF1 at the telephoto end at infinity. In a case where the air-space distance is increased, the lens diameter of the lens unit on the image side is decreased (the lens unit refers to a group of lenses in the first front lens group GF1). Therefore, the weight of the lens unit on the image side is reduced, which contributes to weight reduction of the first front lens group GF1.

In a case where the upper limit value of Conditional Expression (10) is exceeded and the ratio of the maximum air-space distance on the optical axis in the first front lens group GF1 at the telephoto end at infinity to the sum of the thicknesses on the optical axis of all lenses constituting the first front lens group GF1 becomes large, the thickness on the optical axis of the entire first front lens group GF1 is increased, and it is difficult to reduce the size of the optical system, which is not preferable.

In a case where the ratio of the maximum air-space distance on the optical axis in the first front lens group GF1 at the telephoto end at infinity to the sum of the thicknesses on the optical axis of all lenses constituting the first front lens group GF1 becomes smaller than the lower limit value of Conditional Expression (10), the lens diameter of the lens unit on the image side is increased, which leads to an increase in the weight of the optical system, which is not preferable.

In Conditional Expression (10), in order to more reliably obtain the above-described effect, it is desirable to define the lower limit value as 0.50 and the upper limit value as 3.00, it is more desirable to define the lower limit value as 0.80 and the upper limit value as 2.80, it is still more desirable to define the lower limit value as 1.00 and the upper limit value as 2.70, and it is even more desirable to define the lower limit value as 1.03 and the upper limit value as 2.50.

In addition, in the variable magnification imaging optical system according to the present invention, it is desirable that the subsequent group GR includes one or more convex lenses satisfying Conditional Expressions (11) and (12) below in order to effectively correct lateral chromatic aberration on the telephoto side:

$$0. < ( - 0.01176 \times vdpLgr - ndpLgr + 2.2719 ) / ( ( ( - 0.01176 ) \hat{} 2 + ( 2.2719 ) \hat{} 2 ) \hat{} ( 1 / 2 ) ) \qquad ( 11 )$$

$$Δ PgFpLgr < - 0.001 \qquad ( 12 )$$

where:
vdpLgr: Abbe number of convex lens included in subsequent group GR
ndpLgr: refractive index of convex lens included in subsequent group GR
ΔPgFpLgr: anomalous dispersion of convex lens included in subsequent group GR.

Conditional Expression (11) specifies a desirable Abbe number and refractive index of the convex lens included in the subsequent group GR (in a case where an Abbe number vd is represented by a horizontal axis and a refractive index nd is represented by a vertical axis, the conditional expression represents a distance between a point of an nd and a vd of the corresponding convex lens and a straight line passing through two points of nd: 1.516798 and vd: 64.2 and nd: 1.903658 and vd: 31.31). The subsequent group GR has a role of image surface compensation, and in a case where a high refractive index material is used for the concave lens and a low refractive index glass material is used for the convex lens, a Petzval sum of the entire system is reduced, and flatness of the image surface can be secured.

In a case where the value of Conditional Expression (11) becomes below the lower limit, it becomes unavoidable to select glass materials in a direction in which the refractive index is increased in consideration of the same Abbe number, and the Petzval sum acts in a direction in which the flatness of the image surface cannot be secured, which is not preferable.

In Conditional Expression (11), in order to more reliably obtain the above-described effect, it is desirable to define the lower limit value as 0.02.

Conditional Expression (12) specifies a desirable range of the anomalous dispersion of the convex lens included in the subsequent group GR. In the subsequent group GR, by using a glass material having negative anomalous dispersion in the convex lens, an effect of correcting the g line in an over direction is obtained, and it is possible to correct lateral chromatic aberration on the telephoto side.

In a case where the upper limit value of Conditional Expression (12) is exceeded and the anomalous dispersion of the convex lens included in the subsequent group GR becomes large, the effect of correcting the g line in the over direction is insufficient, and it is difficult to correct lateral chromatic aberration on the telephoto side, which is not preferable.

In Conditional Expression (12), in order to more reliably obtain the above-described effect, it is desirable to define the upper limit value as −0.0020, it is more desirable to define the upper limit value as −0.0030, and it is still more desirable to define the upper limit value as −0.0040.

In addition, in the variable magnification imaging optical system according to the present invention, it is desirable that one or more concave lenses satisfying Conditional Expression (13) are included from the lens Lb toward the image side in order to effectively correct lateral chromatic aberration on the telephoto side:

$$Δ PgFnLbr > 0.009 \qquad ( 13 )$$

where:
ΔPgFnLbr: anomalous dispersion of concave lens disposed from lens Lb toward image side.

The lens Lb is defined, at the telephoto end at infinity, as a lens that is disposed closest to the object side among lenses that are disposed on the image side with respect to the aperture diaphragm S and in which an off-axis principal ray is incident on a lens surface on the object side at a position higher than an axial marginal ray.

Conditional Expression (13) specifies a desirable range of the anomalous dispersion of at least one concave lens disposed on the image side with respect to the lens Lb. The lenses on the image side with respect to the lens Lb are lenses through which, at the telephoto end at infinity, an off-axis principal ray passes at a higher position than the axial marginal ray. From Reference Expressions 1 and 2, the lenses on the image side with respect to the lens Lb are lenses that are advantageous in correcting lateral chromatic aberration as compared with on-axis chromatic aberration. Therefore, by using a glass material having positive anomalous dispersion in the concave lens on the image side with respect to the lens Lb, an effect of correcting the g line in the over direction is obtained, and it is possible to effectively correct lateral chromatic aberration on the telephoto side.

In a case where the anomalous dispersion of the concave lens on the image side with respect to the lens Lb becomes smaller than the lower limit value of Conditional Expression (13), the effect of correcting the g line in the over direction is insufficient, and it is difficult to correct lateral chromatic aberration on the telephoto side, which is not preferable.

In Conditional Expression (13), in order to more reliably obtain the above-described effect, it is desirable to define the lower limit value as 0.010, it is more desirable to define the lower limit value as 0.013, and it is still more desirable to define the lower limit value as 0.017.

In addition, in the variable magnification imaging optical system according to the present invention, it is desirable that one or more concave lenses satisfying Conditional Expression (14) are disposed from the lens Lb toward the image side:

$$vdnLbr \times Δ PgFnLbr > 0.8 \qquad ( 14 )$$

where:
vdnLbr: Abbe number of concave lens disposed from lens Lb toward image side
ΔPgFnLbr: anomalous dispersion of concave lens disposed from lens Lb toward image side.

Conditional Expression (14) specifies a desirable range of a relationship between the Abbe number and the anomalous dispersion of the concave lens on the image side with respect to the lens Lb. In the concave lens on the image side with respect to the lens Lb, by using a glass material having positive anomalous dispersion, an effect of correcting the g line in the over direction is obtained, and it is possible to correct lateral chromatic aberration on the telephoto side. In addition, many of the glass materials satisfying Conditional Expression (14) are glass materials having a low refractive index and low dispersion, and it is easy to achieve both the effect of correcting lateral chromatic aberration and the effect of image surface compensation.

In a case where the anomalous dispersion of the concave lens on the image side with respect to the lens Lb becomes smaller than the lower limit value of Conditional Expression (14), the effect of correcting the g line in the over direction is insufficient, and it is difficult to correct lateral chromatic aberration on the telephoto side, which is not preferable.

In Conditional Expression (14), in order to more reliably obtain the above-described effect, it is desirable to define the lower limit value as 0.9, and it is more desirable to define the lower limit value as 1.2.

In addition, in the variable magnification imaging optical system according to the present invention, it is desirable that the subsequent group GR includes one or more concave lenses satisfying Conditional Expression (15):

$$vdnLgr \times Δ PgFnLgr > 0.8 \qquad ( 15 )$$

where:
vdnLgr: Abbe number of concave lens included in subsequent group GR
ΔPgFnLgr: anomalous dispersion of concave lens included in subsequent group GR.

Conditional Expression (15) specifies a desirable range of a relationship between the Abbe number and the anomalous dispersion of the concave lens included in the subsequent group GR. Since the subsequent group GR is a lens group disposed closest to the image side, the subsequent group GR is inevitably a lens group through which an off-axis principal ray tends to pass at a higher position than the axial marginal ray. Therefore, in order to effectively correct lateral chromatic aberration at the telephoto end, it is preferable to dispose the concave lens satisfying Conditional Expression (15) in the subsequent group GR.

In a case where the anomalous dispersion of the concave lens included in the subsequent group GR becomes smaller than the lower limit value of Conditional Expression (15), the effect of correcting the g line in the over direction is insufficient, and it is difficult to correct lateral chromatic aberration on the telephoto side, which is not preferable.

In Conditional Expression (15), in order to more reliably obtain the above-described effect, it is desirable to define the lower limit value as 0.9, and it is more desirable to define the lower limit value as 1.2.

In addition, in the variable magnification imaging optical system according to the present invention, it is desirable to satisfy Conditional Expression (16) below in order to achieve size reduction of the optical system:

$$4.5 < fT / BFT < 130. \qquad ( 16 )$$

where:
fT: focal length of entire system at telephoto end at infinity
BFT: length on optical axis from lens surface closest to image side at telephoto end at infinity to image surface.

Conditional Expression (16) specifies a ratio of the focal length of the entire system at the telephoto end at infinity to the length on the optical axis from the lens surface closest to the image side at the telephoto end at infinity to the image surface. The conditional expression indicates that the back focus is shortened and the optical system is reduced in size, and it is possible to achieve size reduction of the optical system by satisfying the conditional expression (16). A parallel plane plate disposed between the lens closest to the image side and having a refractive power and the image surface is not counted as a lens. In a case of calculating BFT, BFT is calculated by an air equivalent length in which the parallel plane plate is replaced with air.

In a case where the upper limit value of Conditional Expression (16) is exceeded and the ratio of the focal length of the entire system at the telephoto end at infinity to the length on the optical axis from the lens surface closest to the image side at the telephoto end at infinity to the image surface becomes large, the length on the optical axis from the lens surface closest to the image side at the telephoto end at infinity to the image surface is excessively small, which causes an inconvenience in connection with an imaging apparatus, which is not preferable.

In a case where the ratio of the focal length of the entire system at the telephoto end at infinity to the length on the optical axis from the lens surface closest to the image side at the telephoto end at infinity to the image surface becomes smaller than the lower limit value of Conditional Expression (16), the length on the optical axis from the lens surface closest to the image side at the telephoto end at infinity to the image surface is excessively large, and the optical system is enlarged, which is not preferable.

In Conditional Expression (16), in order to more reliably obtain the above-described effect, it is desirable to define the lower limit value as 6.5 and the upper limit value as 120.0, it is more desirable to define the lower limit value as 8.0 and the upper limit value as 110.0, and it is still more desirable to define the lower limit value as 10.0 and the upper limit value as 35.0.

In addition, in the variable magnification imaging optical system according to the present invention, it is desirable to satisfy Conditional Expression (17) below in order to achieve size reduction of the optical system:

$$4. < LiT / BFT < 35. \qquad ( 17 )$$

where:
LiT: length on optical axis from lens closest to object side at telephoto end at infinity to image surface
BFT: length on optical axis from lens surface closest to image side at telephoto end at infinity to image surface.

Conditional Expression (17) specifies a ratio of the length on the optical axis from the lens closest to the object side at the telephoto end at infinity to the image surface (total lens length) to the length on the optical axis from the lens surface closest to the image side to the image surface. The conditional expression indicates that the back focus is shortened and the optical system is reduced in size, and it is possible to achieve size reduction of the optical system by satisfying the conditional expression (17). A parallel plane plate disposed between the lens closest to the image side and having a refractive power and the image surface is not counted as a lens. In a case of calculating LiT and BFT, LiT and BFT are calculated by an air equivalent length in which the parallel plane plate is replaced with air.

In a case where the upper limit value of Conditional Expression (17) is exceeded and the ratio of the length on the optical axis from the lens closest to the object side at the telephoto end at infinity to the image surface to the length on the optical axis from the lens surface closest to the image side to the image surface becomes large, LiT is increased, and it is difficult to reduce the size of the optical system, which is not preferable.

In a case where the ratio of the length on the optical axis from the lens closest to the object side at the telephoto end at infinity to the image surface to the length on the optical axis from the lens surface closest to the image side to the image surface becomes smaller than the lower limit value of Conditional Expression (17), it is necessary to reduce LiT, and it is difficult to correct various aberrations such as spherical aberration and field curvature while maintaining the magnification change ratio, which is not preferable.

In Conditional Expression (17), in order to more reliably obtain the above-described effect, it is desirable to define the lower limit value as 4.5 and the upper limit value as 30.0, and it is more desirable to define the lower limit value as 5.0 and the upper limit value as 27.0.

In addition, in the variable magnification imaging optical system according to the present invention, it is desirable that all convex lenses constituting the first front lens group GF1 satisfy Conditional Expression (18):

$$Δ PgFpGF 1 > 0. \qquad ( 18 )$$

where:
ΔPgFpGF1: anomalous dispersion of convex lens included in front lens group GF1.

Conditional Expression (18) specifies the anomalous dispersion that should be satisfied by all convex lenses constituting the first front lens group GF1. In the super telephoto zoom lens of the telephoto type according to the present invention, by using a material having positive anomalous dispersion in the convex lens on the object side, it is possible to effectively correct on-axis chromatic aberration and lateral chromatic aberration on the telephoto side.

In a case where the anomalous dispersion that should be satisfied by all convex lenses constituting the first front lens group GF1 becomes smaller than the lower limit value of Conditional Expression (18), the correction of on-axis chromatic aberration and lateral chromatic aberration on the telephoto side is insufficient, which is not preferable.

In Conditional Expression (18), in order to more reliably obtain the above-described effect, it is desirable to define the lower limit value as 0.002, it is more desirable to define the lower limit value as 0.005, and it is still more desirable to define the lower limit value as 0.007.

In addition, in the variable magnification imaging optical system according to the present invention, it is desirable that all convex lenses constituting the first front lens group GF1 satisfy Conditional Expression (19):

$$ndpGF 1 < 1.68 \qquad ( 19 )$$

where:
ndpGF1: refractive index of convex lens included in front lens group GF1.

Conditional Expression (19) specifies the refractive index that should be satisfied by all convex lenses constituting the first front lens group GF1. In general, as the refractive index of the glass material is higher, the Abbe number is smaller and the dispersion is higher, and in a case where such a glass material is used in the convex lens on the object side, it is difficult to correct on-axis chromatic aberration and lateral chromatic aberration on the telephoto side, which is not preferable.

In a case where the upper limit value of Conditional Expression (19) is exceeded and the refractive index that should be satisfied by all convex lenses constituting the first front lens group GF1 becomes high, the correction of on-axis chromatic aberration and lateral chromatic aberration on the telephoto side is insufficient, which is not preferable.

In Conditional Expression (19), in order to more reliably obtain the above-described effect, it is desirable to define the upper limit value as 1.65, it is still more desirable to define the upper limit value as 1.63, and it is even more desirable to define the upper limit value as 1.60.

In addition, in the variable magnification imaging optical system according to the present invention, it is desirable to satisfy Conditional Expression (20):

$$- 75. < fT / fF 2 < - 5. \qquad ( 20 )$$

where
fT: focal length of entire system at telephoto end at infinity
fF2: focal length of second front lens group GF2 at telephoto end at infinity.

Conditional Expression (20) specifies a ratio of the focal length of the entire system at the telephoto end at infinity to the focal length of the second front lens group GF2. The second front lens group GF2 is a group that bears a main magnification change effect, and by appropriately setting the refractive power of the second front lens group GF2, it is possible to ensure the magnification change ratio and contribute to size reduction of the optical system.

In a case where the upper limit value of Conditional Expression (20) is exceeded and the ratio of the focal length of the entire system at the telephoto end at infinity to the focal length of the second front lens group GF2 becomes large, the negative refractive power of the second front lens group GF2 is weakened, a movement amount of the second front lens group GF2 for magnification change is increased, and the total length of the optical system is increased, which is not preferable. In addition, in a case where a magnification change action of a lens group disposed on the image side with respect to the second front lens group GF2 is increased, the total length of the optical system is increased or the number of lenses is increased, which is not preferable.

In a case where the lower limit value of Conditional Expression (20), the negative refractive power of the second front lens group GF2 is excessively increased, and various aberrations such as field curvature are deteriorated, which is not preferable.

In Conditional Expression (20), in order to more reliably obtain the above-described effect, it is desirable to define the lower limit value as −60.0 and the upper limit value as −6.0, it is more desirable to define the lower limit value as −45.0 and the upper limit value as −7.0, and it is still more desirable to define the lower limit value as −30.0 and the upper limit value as −10.9.

In addition, in the variable magnification imaging optical system according to the present invention, it is desirable to satisfy Conditional Expression (21):

$$- 7.0 < fF 1 / fF 2 < - 2. \qquad ( 21 )$$

where:
fF1: focal length of first front lens group GF1 at telephoto end at infinity
fF2: focal length of second front lens group GF2 at telephoto end at infinity.

Conditional Expression (21) specifies a ratio of the focal length of the first front lens group GF1 to the focal length of the second front lens group GF2 at the telephoto end at infinity. By appropriately setting Conditional Expression (21), it is possible to ensure the magnification change ratio and contribute to size reduction of the optical system.

In a case where the upper limit value of Conditional Expression (21) is exceeded and the ratio of the focal length of the first front lens group GF1 to the focal length of the second front lens group GF2 at the telephoto end at infinity becomes large, the refractive power of the second front lens group GF2 is excessively increased, and spherical aberration and field curvature are deteriorated, which is not preferable.

In a case where the ratio of the focal length of the first front lens group GF1 to the focal length of the second front lens group GF2 at the telephoto end at infinity becomes smaller than the lower limit value of Conditional Expression (21), the refractive power of the first front lens group GF1 is insufficient with respect to the focal length at the telephoto end, and the total length of the optical system is increased, which is not preferable.

In Conditional Expression (21), in order to more reliably obtain the above-described effect, it is desirable to define the lower limit value as −6.0 and the upper limit value as −2.5, and it is more desirable to define the lower limit value as −5.5 and the upper limit value as −3.0.

In addition, in the variable magnification imaging optical system according to the present invention, it is desirable that the first front lens group GF1 and the second front lens group GF2 satisfy Conditional Expression (22) in order to achieve size reduction and weight reduction of the optical system:

$$0.20 < Φ G 2 FfT / Φ S 1 T < 0.60 \qquad ( 22 )$$

where:
ΦG2FfT: axial marginal ray diameter on surface closest to object side in second front lens group GF2 at telephoto end at infinity
ΦS1T: axial marginal ray diameter on surface closest to object side at telephoto end at infinity.

Conditional Expression (22) specifies a ratio of the axial marginal ray diameter on the surface closest to the object side in the second front lens group GF2 at the telephoto end at infinity to the axial marginal ray diameter on the surface closest to the object side in the first front lens group GF1 at the telephoto end at infinity, and indicates to what extent the axial marginal ray height incident on the second front lens group GF2 can be lowered in the first front lens group GF1.

In a case where the upper limit value of Conditional Expression (22) is exceeded the ratio of the axial marginal ray diameter on the surface closest to the object side in the second front lens group GF2 at the telephoto end at infinity to the axial marginal ray diameter on the surface closest to the object side in the first front lens group GF1 at the telephoto end at infinity becomes large, the axial marginal ray height is not sufficiently lowered in the first front lens group GF1, the lens diameter of the second front lens group GF2 is enlarged, and it is difficult to achieve size reduction and weight reduction, which is not preferable.

In a case where the ratio of the axial marginal ray diameter on the surface closest to the object side in the second front lens group GF2 at the telephoto end at infinity to the axial marginal ray diameter on the surface closest to the object side in the first front lens group GF1 at the telephoto end at infinity becomes smaller than the lower limit value of Conditional Expression (22), the refractive power of the first front lens group GF1 is excessively increased, and various aberrations such as spherical aberration and comatic aberration are deteriorated, which leads to a decrease in optical performance, which is not preferable.

In Conditional Expression (22), in order to more reliably obtain the above-described effect, it is desirable to define the lower limit value as 0.25 and the upper limit value as 0.55, it is more desirable to define the lower limit value as 0.30 and the upper limit value as 0.51, and it is still more desirable to define the lower limit value as 0.33 and the upper limit value as 0.45.

In addition, in the variable magnification imaging optical system according to the present invention, in a case where the first front lens group GF1 consists of two lens groups, it is preferable that the lens group on the image side moves toward the object side during magnification change from the wide-angle end to the telephoto end.

In a case where the lens group on the image side in the first front lens group GF1 moves toward the image side during magnification change from the wide-angle end to the telephoto end, the focal length of the first front lens group GF1 is reduced on the telephoto side, and the action is in a direction of canceling the magnification change effect of the second front lens group GF2 and subsequent groups, which is disadvantageous in ensuring the magnification change ratio and is not preferable.

In addition, in the variable magnification imaging optical system according to the present invention, in a case where the first front lens group GF1 consists of two lens groups, it is desirable that the lens group on the image side has a reduced distance with the first lens group G1 disposed on the object side during magnification change from the wide-angle end to the telephoto end and has an increased distance with the second front lens group GF2 disposed on the image side.

In a case where the distance with the first lens group G1 disposed on the object side is increased and the distance with the second front lens group GF2 disposed on the image side is reduced during magnification change from the wide-angle end to the telephoto end, the focal length of the first front lens group GF1 is reduced on the telephoto side, and the action is in a direction of canceling the magnification change effect of the second front lens group GF2 and subsequent groups, which is disadvantageous in ensuring the magnification change ratio and is not preferable.

In addition, in the variable magnification imaging optical system according to the present invention, there is an advantage in that a size of an actuator can be reduced by performing focusing with a lens group having a small lens diameter as much as possible. Therefore, it is desirable that at least one lens group of the lens groups constituting the middle group GM moves along the optical axis during focusing from the infinite distance object to the close distance object.

In addition, in the variable magnification imaging optical system according to the present invention, it is desirable not to use a diffractive optical element. The diffractive optical element can have a chromatic aberration correction effect and an aspherical effect on a diffraction surface, but unnecessary diffracted light or flare and ghost caused by rays outside an angle of view due to the shape are generated, which is not preferable.

In addition, in the variable magnification imaging optical system according to the present invention, the second front lens group GF2 having a negative refractive power as a whole bears a main magnification change effect, and it is desirable that all lens groups constituting the second front lens group GF2 move toward the image side during magnification change from the wide-angle end to the telephoto end.

In addition, in the variable magnification imaging optical system according to the present invention, in order to prevent the mechanical mechanism from being complicated, it is desirable that the subsequent group GR is fixed with respect to the image surface during magnification change from the wide-angle end to the telephoto end.

Next, lens configurations of examples according to the imaging optical system of the present invention will be described. In the following description, the lens configuration will be described in order from the object side to the image side.

In [surface data], a surface number is a number of a lens surface or an aperture diaphragm S counted from the object side, r is a curvature radius of each lens surface, d is a distance between each lens surface, nd is a refractive index with respect to a d line (wavelength: 587.56 nm), vd is an Abbe number with respect to the d line, and ΔPgF is a numerical value calculated from an expression of PgF−0.64833+0.00180×vd. In addition, for the corresponding glass materials, as an example of a glass corresponding to the refractive index, the Abbe number, and ΔPgF described in [surface data], glass material names of optical glass of HOYA Corporation, OHARA Inc., and Hikari Glass Co., Ltd. are described.

An asterisk (*) attached to a surface number indicates that the lens surface shape is an aspherical surface shape. In addition, BF is a back focus, and a distance of an object surface is a distance from a subject to a first lens surface.

The (diaphragm) attached to the surface number indicates that the aperture diaphragm S is located at that position. An infinite number oc is filled in a curvature radius with respect to a plane or the aperture diaphragm S.

[Aspherical surface data] shows values of each coefficient for giving the aspherical shape of the lens surface denoted by * in [Surface data]. The shape of the aspherical surface is expressed by the following equation. In the following equation, the displacement from the optical axis in the direction perpendicular to the optical axis is represented by y, the displacement (sag) from the intersection of the aspherical surface and the optical axis in the optical axis direction is represented by z, the curvature radius of the reference spherical surface is represented by r, and the conic constant is represented by K. In addition, aspherical coefficients of the fourth order, the sixth order, the eighth order, the tenth order, and the twelfth order are represented by A4, A6, A8, A10, and A12, respectively.

$$z = \frac{( 1 / r ) {y}^{2}}{1 + \sqrt{1 - ( 1 + K ) {( y / r )}^{2}}} + A 4 {y}^{4} + A 6 {y}^{6} + A 8 {y}^{8} + A 10 {y}^{10} + A 12 {y}^{12}$$

[Various types of data] indicate values such as a focal length in each focusing state at each shooting distance.

[Variable distance data] shows a value of BF from a variable distance in each focusing state at each shooting distance.

The [Lens group data] shows the surface number closest to the object side in each lens group and the combined focal length of the entire group.

In addition, in the aberration diagrams corresponding to the respective examples, d, g, and C represent a d line, a g line, and a C line, respectively, and ΔS and Δ M represent a sagittal image surface and a meridional image surface, respectively.

In addition, in all the values of the specifications described below, unless otherwise noted, the units of the focal length f, the curvature radius r, the lens surface distance d, and other lengths are millimeters (mm), but the present invention is not limited thereto since the same optical performance can be obtained in both the proportional magnification and the proportional reduction in the optical system.

In addition, as for lens designations, the lens disposed closest to the object side is referred to as L1, the second lens toward the image side is referred to as L2, the third lens is referred to as L3, and so on in order.

In addition, in the lens configuration diagram of each example, an arrow is a trajectory of a lens group during magnification change from the wide-angle end to the telephoto end, S is an aperture diaphragm, I is an image surface, F is a filter, and a one-dot chain line passing through a center is an optical axis.

Next, lens configurations of examples according to the variable magnification imaging optical system of the present invention will be described.

In the following description, the lens configuration will be described in order from the object side to the image side.

### Example 1

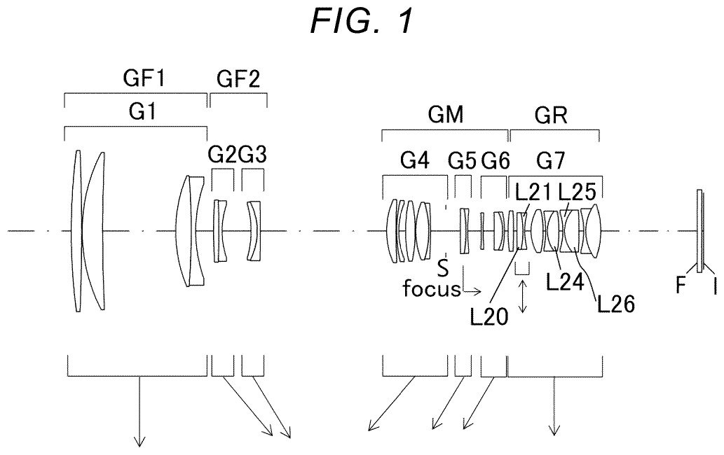

FIG. 1 is a lens configuration diagram of a variable magnification imaging optical system according to Example 1 at a wide-angle end in a case of focusing on infinity.

The variable magnification imaging optical system of FIG. 1 is composed of, in order from the object side: a first front lens group GF1 consisting of a first lens group G1 having a positive refractive power, a second lens group G2 having a negative refractive power, a third lens group G3 having a negative refractive power; a second front lens group GF2 having a negative refractive power as a whole; a middle group GM consisting of a fourth lens group G4 having a positive refractive power, a fifth lens group G5 having a negative refractive power, and a sixth lens group G6 having a positive refractive power; and a subsequent group GR consisting of a seventh lens group G7 having a negative refractive power.

The first lens group G1 is composed of, in order from the object side, a biconvex lens, a meniscus positive lens having a convex surface on the object side, and a cemented lens of a biconvex lens and a biconcave lens. The second lens group G2 is composed of a cemented lens of a biconvex lens and a biconcave lens. The third lens group G3 is composed of a cemented lens of a meniscus positive lens having a convex surface on the image side and a meniscus negative lens having a convex surface on the image side. The fourth lens group G4 is composed of a meniscus positive lens having a convex surface on the object side, a meniscus negative lens having a convex surface on the object side, a biconvex lens, a cemented lens of a biconvex lens and a meniscus negative lens having a convex surface on the image side, and an aperture diaphragm S. The fifth lens group G5 is composed of a cemented lens of a meniscus positive lens having a convex surface on the image side and a biconcave lens. The sixth lens group G6 is composed of a biconcave lens, and a cemented lens of a meniscus positive lens having a convex surface on the image side and a meniscus negative lens having a convex surface on the image side. The seventh lens group G7 is composed of a biconvex lens, a cemented lens of a meniscus positive lens L20 having a convex surface on the image side and a biconcave lens L21, a biconvex lens, a cemented lens of a biconvex lens and a biconcave lens L24, a cemented lens of a biconcave lens L25 and a biconvex lens L26, and a cemented lens of a biconcave lens and a biconvex lens. In addition, the seventh lens group can also function as a vibration reduction group by moving L20 and L21 as one body in a direction substantially perpendicular to the optical axis, but lenses other than L20 and L21 may also function as a vibration reduction group.

During magnification change from the wide-angle end to the telephoto end, the first lens group G1 and the seventh lens group G7 are fixed with respect to the image surface, the second lens group G2 and the third lens group G3 move toward the image side, the fourth lens group G4 to the sixth lens group G6 move toward the object side along different trajectories, a distance between the first lens group G1 and the second lens group G2 increases, a distance between the second lens group G2 and the third lens group G3 decreases, a distance between the third lens group G3 and the fourth lens group G4 decreases, a distance between the fourth lens group G4 and the fifth lens group G5 increases and then decreases, and the distance is smaller at the telephoto end than at the wide-angle end, a distance between the fifth lens group G5 and the sixth lens group G6 increases, a distance between the sixth lens group G6 and the seventh lens group G7 increases and then decreases, and the distance is larger at the telephoto end than at the wide-angle end, and during focusing from the infinite distance object to the close distance object, the fifth lens group G5 moves toward the image side along the optical axis.

The lenses on the image side from L20 of the seventh lens group G7 are lenses that are incident on a higher position than an axial marginal ray incident on the lens surface on the object side among off-axis principal rays at the telephoto end at infinity. Therefore, in the variable magnification imaging optical system according to Example 1, Lb is L20.
L24 and L26 are lenses satisfying Conditional Expressions (11) and (12).
L25 is a lens satisfying Conditional Expression (13).
L25 is a lens satisfying Conditional Expression (14).
L25 is a lens satisfying Conditional Expression (15).

The following shows numerical values of the variable magnification imaging optical system according to Example 1.

### Numerical Example 1

Unit: mm
[Surface data]

| | | | | | | Corresponding |
|---|---|---|---|---|---|---|
| Surface number | r | d | nd | vd | ΔPgF | glass material |
| Object surface | ∞ | (d0) | | | | |
| 1 | 354.4414 | 5.7515 | 1.48749 | 70.44 | 0.0090 | FC5 |
| 2 | −1077.2332 | 0.3000 | | | | |
| 3 | 95.3670 | 11.3351 | 1.43700 | 95.10 | 0.0564 | FCD100 |
| 4 | 944.7848 | 40.3370 | | | | |
| 5 | 79.8074 | 8.5880 | 1.43700 | 95.10 | 0.0564 | FCD100 |
| 6 | −399.9675 | 2.5001 | 1.62205 | 41.08 | −0.0051 | S-NBM52 |
| 7 | 79.0060 | (d7) | | | | |
| 8 | 287.0604 | 2.9270 | 1.85451 | 25.15 | 0.0071 | NBFD25 |
| 9 | −401.0671 | 1.7977 | 1.57144 | 71.61 | 0.0224 | FCD615 |
| 10 | 45.9226 | (d10) | | | | |
| 11 | −53.4077 | 3.3666 | 1.85451 | 25.15 | 0.0071 | NBFD25 |
| 12 | −34.8924 | 1.7887 | 1.74320 | 49.34 | −0.0065 | S-LAM60 |
| 13 | −822.2876 | (d13) | | | | |
| 14 | 43.5542 | 5.2181 | 1.59282 | 68.62 | 0.0192 | FCD515 |
| 15 | 450.1962 | 0.3000 | | | | |
| 16 | 73.0854 | 1.1937 | 1.80420 | 46.50 | −0.0075 | TAF3D |
| 17 | 38.1724 | 3.9550 | | | | |
| 18 | 81.4770 | 5.3209 | 1.45860 | 90.19 | 0.0491 | FCD10A |
| 19 | −80.3740 | 0.3000 | | | | |
| 20 | 43.3415 | 7.1568 | 1.43700 | 95.10 | 0.0564 | FCD100 |
| 21 | −53.3854 | 0.9994 | 1.77250 | 49.63 | −0.0088 | TAF1 |
| 22 | −245.4702 | 8.4332 | | | | |
| 23 (diaphragm) | ∞ | (d23) | | | | |
| 24 | −4941.2309 | 3.1177 | 1.72825 | 28.32 | 0.0101 | E-FD10L |
| 25 | −71.8255 | 0.9973 | 1.88300 | 40.81 | −0.0094 | TAFD30 |
| 26 | 108.5696 | (d26) | | | | |
| 27 | −136.5449 | 0.9980 | 1.86966 | 20.02 | 0.0310 | FDS20-W |
| 28 | 125.3712 | 6.1114 | | | | |
| 29 | −442.0437 | 4.6318 | 1.65253 | 39.48 | −0.0042 | NBFD38 |
| 30 | −24.1347 | 1.0000 | 1.55032 | 75.50 | 0.0274 | FCD705 |
| 31 | −48.2886 | (d31) | | | | |
| 32 | 87.6678 | 2.9698 | 1.49700 | 81.61 | 0.0373 | FCD1 |
| 33 | −370.2669 | 2.0000 | | | | |
| 34 | −677.9282 | 3.2694 | 1.85451 | 25.15 | 0.0071 | NBFD25 |
| 35 | −47.1616 | 1.0000 | 1.76385 | 48.49 | −0.0022 | S-LAH96 |
| 36 | 36.8106 | 3.5000 | | | | |
| 37 | 23.8075 | 6.6706 | 1.60342 | 38.01 | 0.0028 | E-F5 |
| 38 | −51.6563 | 1.4237 | | | | |
| 39 | −51.9739 | 1.0000 | 1.95375 | 32.32 | 0.0003 | S-LAH98 |
| 40 | 18.5856 | 6.3678 | 1.62205 | 41.08 | −0.0051 | S-NBM52 |
| 41 | −63.9618 | 2.1805 | | | | |
| 42 | −32.9425 | 1.0000 | 1.43700 | 95.10 | 0.0564 | FCD100 |
| 43 | 18.1886 | 7.9265 | 1.62205 | 41.08 | −0.0051 | S-NBM52 |
| 44 | −201.8802 | 2.6090 | | | | |
| 45 | −37.8756 | 1.1994 | 2.05090 | 26.94 | 0.0052 | TAFD65 |
| 46 | 25.6729 | 8.1088 | 1.85451 | 25.15 | 0.0071 | NBFD25 |
| 47 | −47.2415 | (d47) | | | | |
| 48 | ∞ | 2.5000 | 1.51633 | 64.14 | 0.0023 | S-BSL7 |
| 49 | ∞ | (BF) | | | | |
| Image surface | ∞ | | | | | |

[Various types of data]

| | |
|---|---|
| Zoom ratio | 3.78 |

| | Wide angle | Middle | Telephoto |
|---|---|---|---|
| Focal length | 206.00 | 500.00 | 778.00 |
| F number | 7.23 | 8.30 | 9.21 |
| Total angle of view 2ω | 11.71 | 4.80 | 3.08 |
| Image height Y | 21.63 | 21.63 | 21.63 |
| Total lens length | 350.00 | 350.00 | 350.00 |

[Variable distance data]

| | Wide angle | Middle | Telephoto |
|---|---|---|---|
| d0 | ∞ | ∞ | ∞ |
| d7 | 9.9162 | 44.3542 | 56.5886 |
| d10 | 16.0367 | 12.7421 | 5.8922 |
| d13 | 69.8408 | 24.1802 | 1.5000 |
| d23 | 8.0000 | 8.5334 | 3.0128 |
| d26 | 7.5173 | 10.7629 | 35.3373 |
| d31 | 2.0120 | 12.7502 | 10.9922 |
| d47 | 53.5280 | 53.5280 | 53.5280 |
| BF | 1.0000 | 1.0000 | 1.0000 |
| d0 | 4000.0000 | 4000.0000 | 4000.0000 |
| d7 | 9.9162 | 44.3542 | 56.5886 |
| d10 | 16.0367 | 12.7421 | 5.8922 |
| d13 | 69.8408 | 24.1802 | 1.5000 |
| d23 | 9.3813 | 15.4520 | 16.3083 |
| d26 | 6.1360 | 3.8443 | 22.0418 |
| d31 | 2.0120 | 12.7502 | 10.9922 |
| d47 | 53.5280 | 53.5280 | 53.5280 |
| BF | 1.0000 | 1.0000 | 1.0000 |

[Lens group data]

| Group | Starting surface | Focal length |
|---|---|---|
| G1 | 1 | 220.55 |
| G2 | 8 | −115.56 |
| G3 | 11 | −84.92 |
| G4 | 14 | 50.26 |
| G5 | 24 | −95.72 |
| G6 | 27 | 362.87 |
| G7 | 32 | −74.98 |

### Example 2

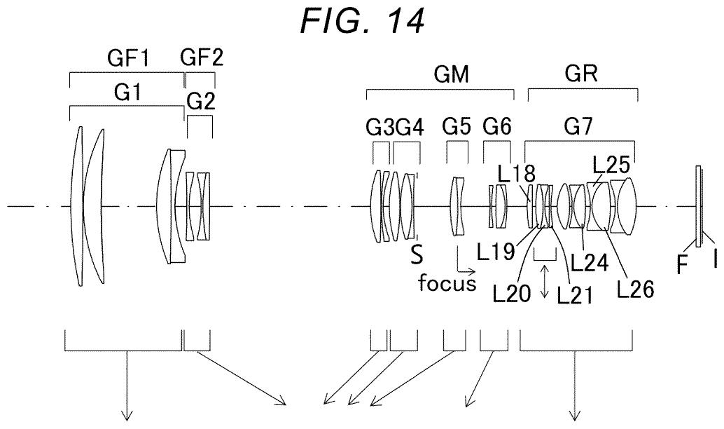

FIG. 14 is a lens configuration diagram of a variable magnification imaging optical system according to Example 2 at a wide-angle end in a case of focusing on infinity.

The variable magnification imaging optical system of FIG. 14 is composed of, in order from the object side: a first front lens group GF1 consisting of a first lens group G1 having a positive refractive power; a second front lens group GF2 consisting of a second lens group G2 having a negative refractive power; a middle group GM consisting of a third lens group G3 having a positive refractive power, a fourth lens group G4 having a positive refractive power, a fifth lens group G5 having a negative refractive power, and a sixth lens group G6 having a positive refractive power; and a subsequent group GR consisting of a seventh lens group G7 having a negative refractive power.

The first lens group G1 is composed of, in order from the object side, a biconvex lens, a meniscus positive lens having a convex surface on the object side, and a cemented lens of a biconvex lens and a biconcave lens. The second lens group G2 is composed of a biconcave lens and a cemented lens of a biconcave lens and a biconvex lens. The third lens group G3 is composed of a biconvex lens and a meniscus positive lens having a convex surface on the object side. The fourth lens group G4 is composed of a biconvex lens, a cemented lens of a biconvex lens and a biconcave lens, and an aperture diaphragm S. The fifth lens group G5 is composed of a cemented lens of a biconvex lens and a biconcave lens. The sixth lens group G6 is composed of a biconcave lens, and a cemented lens of a biconvex lens and a meniscus negative lens having a convex surface on the image side. The seventh lens group G7 is composed of a meniscus positive lens L18 having a convex surface on the object side, a cemented lens of a biconvex lens L19 and a biconcave lens L20, a meniscus negative lens L21 having a convex surface on the object side, a biconvex lens, a cemented lens of a biconcave lens and a biconvex lens L24, a cemented lens of a biconcave lens L25 and a biconvex lens L26, and a cemented lens of a biconcave lens and a biconvex lens. In addition, the seventh lens group G7 can also function as a vibration reduction group by moving L19 to L21 as one body in a direction substantially perpendicular to the optical axis, but lenses other than L19 to L21 may also function as a vibration reduction group.

During magnification change from the wide-angle end to the telephoto end, the first lens group G1 and the seventh lens group G7 are fixed with respect to the image surface, the second lens group G2 moves toward the image side, the third lens group G3 to the sixth lens group G6 move toward the object side along different trajectories, a distance between the first lens group G1 and the second lens group G2 increases, a distance between the second lens group G2 and the third lens group G3 decreases, a distance between the third lens group G3 and the fourth lens group G4 increases and then decreases, and the spacing is slightly smaller at the telephoto end than at the wide-angle end, a distance between the fourth lens group G4 and the fifth lens group G5 decreases, a distance between the fifth lens group G5 and the sixth lens group G6 increases, a distance between the sixth lens group G6 and the seventh lens group G7 increases, and during focusing from the infinite distance object to the close distance object, the fifth lens group G5 moves toward the image side along the optical axis.

The lenses on the image side from L18 of the seventh lens group G7 are lenses that are incident on a higher position than an axial marginal ray incident on the lens surface on the object side among off-axis principal rays at the telephoto end at infinity. Therefore, in the variable magnification imaging optical system according to Example 2, Lb is L18.
L24 and L26 are lenses satisfying Conditional Expressions (11) and (12).
L21 and L25 are lenses satisfying Conditional Expression (13).
L25 is a lens satisfying Conditional Expression (14).
L25 is a lens satisfying Conditional Expression (15).

The following shows numerical values of the variable magnification imaging optical system according to Example 2.

### Numerical Example 2

Unit: mm
[Surface data]

| | | | | | | Corresponding |
|---|---|---|---|---|---|---|
| Surface number | r | d | nd | vd | ΔPgF | glass material |
| Object surface | ∞ | (d0) | | | | |
| 1 | 213.7700 | 6.7632 | 1.48749 | 70.44 | 0.0090 | FC5 |
| 2 | −1823.3797 | 0.3000 | | | | |
| 3 | 94.3062 | 9.9927 | 1.43700 | 95.10 | 0.0564 | FCD100 |
| 4 | 592.8341 | 31.0000 | | | | |
| 5 | 83.1441 | 8.1078 | 1.43700 | 95.10 | 0.0564 | FCD100 |
| 6 | −1508.5980 | 2.1950 | 1.62205 | 41.08 | −0.0051 | S-NBM52 |
| 7 | 71.6334 | (d7) | | | | |
| 8 | −495.5220 | 1.2983 | 1.61800 | 63.32 | 0.0082 | S-PHM52Q |
| 9 | 60.5171 | 6.7689 | | | | |
| 10 | −72.0622 | 1.0000 | 1.64000 | 60.08 | −0.0033 | S-BSM81 |
| 11 | 100.5531 | 3.7573 | 1.84666 | 23.84 | 0.0145 | FDS90-SGP |
| 12 | −740.4797 | (d12) | | | | |
| 13 | 58.1115 | 5.7684 | 1.55032 | 75.50 | 0.0274 | FCD705 |
| 14 | −524.4633 | 0.3000 | | | | |
| 15 | 123.8772 | 1.0000 | 1.77250 | 49.63 | −0.0088 | TAF1 |
| 16 | 49.0573 | (d16) | | | | |
| 17 | 69.5258 | 5.9223 | 1.55397 | 71.76 | 0.0200 | FCD500 |
| 18 | −105.4525 | 0.3000 | | | | |
| 19 | 63.7515 | 6.5149 | 1.43700 | 95.10 | 0.0564 | FCD100 |
| 20 | −67.5305 | 0.9990 | 1.78800 | 47.37 | −0.0072 | S-LAH64 |
| 21 | 1044.1177 | 2.1278 | | | | |
| 22 (diaphragm) | ∞ | (d22) | | | | |
| 23 | 69.9934 | 4.1812 | 1.77047 | 29.74 | 0.0002 | NBFD29 |
| 24 | −135.2237 | 1.7401 | 1.90525 | 35.04 | −0.0005 | S-LAH93 |
| 25 | 58.0350 | (d25) | | | | |
| 26 | −175.9685 | 0.9949 | 1.92286 | 20.88 | 0.0281 | E-FDS1-W |
| 27 | 89.7503 | 2.3775 | | | | |
| 28 | 181.6220 | 5.1425 | 1.64769 | 33.84 | 0.0049 | E-FD2 |
| 29 | −28.7188 | 0.9956 | 1.43700 | 95.10 | 0.0564 | FCD100 |
| 30 | −82.3322 | (d30) | | | | |
| 31 | 71.8972 | 2.8108 | 1.48749 | 70.44 | 0.0090 | FC5 |
| 32 | 1121.6152 | 2.0000 | | | | |
| 33 | 72.8141 | 4.0532 | 1.69895 | 30.05 | 0.0084 | E-FD15L |
| 34 | −50.5370 | 1.0000 | 1.81600 | 46.62 | −0.0077 | S-LAH59 |
| 35 | 33.6834 | 2.4301 | | | | |
| 36 | 1112.0530 | 1.0000 | 1.59282 | 68.62 | 0.0192 | FCD515 |
| 37 | 55.3052 | 3.5000 | | | | |
| 38 | 23.5090 | 6.9488 | 1.56732 | 42.84 | 0.0030 | E-FL6 |
| 39 | −41.5525 | 1.3540 | | | | |
| 40 | −42.4345 | 1.0000 | 1.95375 | 32.32 | 0.0003 | S-LAH98 |
| 41 | 20.3420 | 6.5128 | 1.62205 | 41.08 | −0.0051 | S-NBM52 |
| 42 | −72.6200 | 2.6983 | | | | |
| 43 | −37.2005 | 0.9999 | 1.43700 | 95.10 | 0.0564 | FCD 100 |
| 44 | 18.4433 | 10.2886 | 1.62205 | 41.08 | −0.0051 | S-NBM52 |
| 45 | −66.3303 | 2.7798 | | | | |
| 46 | −31.4379 | 1.1989 | 2.05090 | 26.94 | 0.0052 | TAFD65 |
| 47 | 25.5827 | 10.8265 | 1.85451 | 25.15 | 0.0071 | NBFD25 |
| 48 | −39.5473 | (d48) | | | | |
| 49 | ∞ | 2.5000 | 1.51633 | 64.14 | 0.0023 | S-BSL7 |
| 50 | ∞ | (BF) | | | | |
| Image surface | ∞ | | | | | |

[Various types of data]

| | |
|---|---|
| Zoom ratio | 3.78 |

| | Wide angle | Middle | Telephoto |
|---|---|---|---|
| Focal length | 206.00 | 500.00 | 778.00 |
| F-number | 7.21 | 7.94 | 9.18 |
| Total angle of view 2ω | 11.66 | 4.77 | 3.06 |
| Image height Y | 21.63 | 21.63 | 21.63 |
| Total lens length | 355.00 | 355.00 | 355.00 |

[Variable distance data]

| | Wide angle | Middle | Telephoto |
|---|---|---|---|
| d0 | ∞ | ∞ | ∞ |
| d7 | 6.5612 | 49.3697 | 57.7733 |
| d12 | 90.5846 | 33.4680 | 1.5000 |
| d16 | 3.4806 | 4.7652 | 3.4356 |
| d22 | 18.4852 | 13.7581 | 3.0000 |
| d25 | 16.3209 | 24.2785 | 49.7089 |
| d30 | 11.4778 | 21.2709 | 31.4926 |
| d48 | 33.6427 | 33.6427 | 33.6427 |
| BF | 1.0000 | 1.0000 | 1.0000 |
| d0 | 4500.0000 | 4500.0000 | 4500.0000 |
| d7 | 6.5612 | 49.3697 | 57.7733 |
| d12 | 90.5846 | 33.4680 | 1.5000 |
| d16 | 3.4806 | 4.7652 | 3.4356 |
| d22 | 21.1242 | 26.6418 | 26.3722 |
| d25 | 13.6820 | 11.3947 | 26.3367 |
| d30 | 11.4778 | 21.2709 | 31.4926 |
| d48 | 33.6427 | 33.6427 | 33.6427 |
| BF | 1.0000 | 1.0000 | 1.0000 |

[Lens group data]

| Group | Starting surface | Focal length |
|---|---|---|
| G1 | 1 | 225.15 |
| G2 | 8 | −57.10 |
| G3 | 13 | 674.30 |
| G4 | 17 | 69.11 |
| G5 | 23 | −199.48 |
| G6 | 26 | 561.54 |
| G7 | 31 | −61.84 |

### Example 3

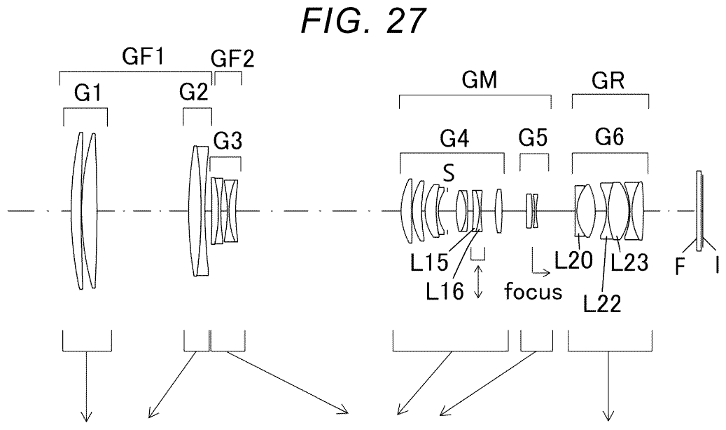

FIG. 27 is a lens configuration diagram of a variable magnification imaging optical system according to Example 3 at a wide-angle end in a case of focusing on infinity.

The variable magnification imaging optical system of FIG. 27 is composed of, in order from the object side: a first front lens group GF1 consisting of a first lens group G1 having a positive refractive power and a second lens group G2 having a negative refractive power and having a positive refractive power as a whole; a second front lens group GF2 consisting of a third lens group G3 having a negative refractive power; a middle group GM consisting of a fourth lens group G4 having a positive refractive power and a fifth lens group G5 having a negative refractive power; and a subsequent group GR consisting of a sixth lens group G6 having a negative refractive power.

The first lens group G1 is composed of, in order from the object side, a meniscus positive lens having a convex surface on the object side and a biconvex lens. The second lens group G2 is composed of a cemented lens of a biconvex lens and a biconcave lens. The third lens group G3 is composed of a cemented lens of a meniscus positive lens having a convex surface on the image side and a biconcave lens, and a cemented lens of a biconcave lens and a meniscus positive lens having a convex surface on the object side. The fourth lens group G4 is composed of: a meniscus positive lens having a convex surface on the object side, a meniscus positive lens having a convex surface on the object side, a cemented lens of a meniscus positive lens having a convex surface on the object side and a meniscus negative lens having a convex surface on the object side, an aperture diaphragm S, a cemented lens of a biconvex lens and a meniscus negative lens having a convex surface on the image side, a cemented lens of a meniscus positive lens L15 having a convex surface on the image side and a biconcave lens L16, and a biconvex lens. In addition, the fourth lens group G4 can also function as a vibration reduction group by moving L15 and L16 as one body in a direction substantially perpendicular to the optical axis, but lenses other than L15 and L16 may also function as a vibration reduction group. The fifth lens group G5 is configured by a biconcave lens and a biconvex lens. The sixth lens group G6 is composed of a cemented lens of a biconcave lens L20 and a biconvex lens, a cemented lens of a biconcave lens L22 and a biconvex lens L23, and a cemented lens of a biconcave lens and a biconvex lens.

During magnification change from the wide-angle end to the telephoto end, the first lens group G1 and the sixth lens group G6 are fixed with respect to the image surface, the second lens group G2 moves toward the object side, the third lens group G3 moves toward the image side, the fourth lens group G4 and the fifth lens group G5 move toward the object side along different trajectories, a distance between the first lens group G1 and the second lens group G2 decreases, a distance between the second lens group G2 and the third lens group G3 increases, a distance between the third lens group G3 and the fourth lens group G4 decreases, a distance between the fourth lens group G4 and the fifth lens group G5 decreases, a distance between the fifth lens group G5 and the sixth lens group G6 increases, and during focusing from the infinite distance object to the close distance object, the fifth lens group G5 moves toward the image side along the optical axis.

The lenses on the image side from L20 of the sixth lens group G6 are lenses that are incident on a higher position than an axial marginal ray incident on the lens surface on the object side among off-axis principal rays at the telephoto end at infinity. Therefore, in the variable magnification imaging optical system according to Example 3, Lb is L20.
L23 is a lens satisfying Conditional Expressions (11) and (12).
L22 is a lens satisfying Conditional Expression (13).
L22 is a lens satisfying Conditional Expression (14).
L22 is a lens satisfying Conditional Expression (15).

The following shows numerical values of the variable magnification imaging optical system according to Example 3.

### Numerical Example 3

Unit: mm
[Surface data]

| | | | | | | Corresponding |
|---|---|---|---|---|---|---|
| Surface number | r | d | nd | vd | ΔPgF | glass material |
| Object surface | ∞ | (d0) | | | | |
| 1 | 212.5387 | 5.6520 | 1.49700 | 81.61 | 0.0373 | FCD1 |
| 2 | 954.6693 | 0.3000 | | | | |
| 3 | 160.9766 | 8.7148 | 1.43700 | 95.10 | 0.0564 | FCD100 |
| 4 | −891.1739 | (d4) | | | | |
| 5 | 233.2145 | 7.0763 | 1.43700 | 95.10 | 0.0564 | FCD100 |
| 6 | −275.1331 | 2.1986 | 1.62205 | 41.08 | 0.0051 | S-NBM52 |
| 7 | 298.1709 | (d7) | | | | |
| 8 | −374.8388 | 3.7098 | 1.85451 | 25.15 | 0.0071 | NBFD25 |
| 9 | −83.4659 | 1.2978 | 1.49700 | 81.61 | 0.0373 | FCD1 |
| 10 | 120.5030 | 3.7178 | | | | |
| 11 | −84.1498 | 1.0000 | 1.74400 | 44.78 | −0.0023 | S-LAM2 |
| 12 | 47.5094 | 3.8139 | 1.85150 | 40.78 | −0.0055 | S-LAH89 |
| 13 | 118.8178 | (d13) | | | | |
| 14 | 38.7048 | 6.0381 | 1.49700 | 81.61 | 0.0373 | FCD1 |
| 15 | 1011.1217 | 0.3000 | | | | |
| 16 | 33.5148 | 5.3226 | 1.43700 | 95.10 | 0.0564 | CD100 |
| 17 | 87.1379 | 2.0000 | | | | |
| 18 | 25.9299 | 6.3206 | 1.43700 | 95.10 | 0.0564 | FCD100 |
| 19 | 62.7380 | 1.2001 | 1.90043 | 37.37 | −0.0045 | TAFD37A |
| 20 | 20.7324 | 5.2508 | | | | |
| 21 (diaphragm) | ∞ | 5.0000 | | | | |
| 22 | 45.0501 | 5.5992 | 1.51742 | 52.15 | 0.0044 | E-CF6 |
| 23 | −25.1706 | 0.9999 | 1.91082 | 35.25 | −0.0017 | TAFD35L |
| 24 | −119.7585 | 3.1756 | | | | |
| 25 | −105.3349 | 3.3373 | 1.90366 | 31.32 | 0.0027 | TAFD25 |
| 26 | −36.0255 | 0.9995 | 1.76385 | 48.49 | −0.0022 | S-LAH96 |
| 27 | 88.2720 | 8.1607 | | | | |
| 28 | 64.4230 | 3.8779 | 1.73037 | 32.23 | −0.0005 | NBFD32 |
| 29 | −113.0792 | (d29) | | | | |
| 30 | 363.0751 | 3.1725 | 1.84666 | 23.84 | 0.0145 | FDS90-SGP |
| 31 | −76.3462 | 1.3451 | | | | |
| 32 | 67.8986 | 0.9997 | 1.78590 | 44.20 | −0.0057 | S-LAH51 |
| 33 | 50.2244 | (d33) | | | | |
| 34 | −1258.5232 | 0.9999 | 2.00100 | 29.13 | 0.0035 | TAFD55-W |
| 35 | 23.2077 | 10.4025 | 1.73037 | 32.23 | −0.0005 | NBFD32 |
| 36 | −34.9852 | 6.2325 | | | | |
| 37 | −30.7846 | 1.0001 | 1.43700 | 95.10 | 0.0564 | FCD100 |
| 38 | 47.1551 | 12.0000 | 1.62205 | 41.08 | −0.0051 | S-NBM52 |
| 39 | −28.5439 | 0.5000 | | | | |
| 40 | −39.5094 | 1.2001 | 2.00100 | 29.13 | 0.0035 | TAFD55-W |
| 41 | 34.9956 | 6.5878 | 1.77047 | 29.74 | 0.0002 | NBFD29 |
| 42 | −157.6212 | (d42) | | | | |
| 43 | ∞ | 2.5000 | 1.51680 | 64.20 | 0.0014 | BSC7 |
| 44 | ∞ | (BF) | | | | |
| Image surface | ∞ | | | | | |

[Various types of data]

| | |
|---|---|
| Zoom ratio | 3.78 |

| | Wide angle | Middle | Telephoto |
|---|---|---|---|
| Focal length | 206.00 | 500.00 | 778.00 |
| F number | 7.20 | 7.76 | 9.18 |
| Total angle of view 2ω | 11.45 | 4.70 | 3.03 |
| Image height Y | 21.63 | 21.63 | 21.63 |
| Total lens length | 360.00 | 360.00 | 360.00 |

[Variable distance data]

| | Wide angle | Middle | Telephoto |
|---|---|---|---|
| d0 | ∞ | ∞ | ∞ |
| d4 | 52.2184 | 29.0000 | 25.0000 |
| d7 | 3.9998 | 75.8875 | 89.4787 |
| d13 | 94.2527 | 36.7494 | 3.0000 |
| d29 | 14.1785 | 9.5966 | 3.0000 |
| d33 | 22.0879 | 35.5038 | 66.2586 |
| d42 | 30.2594 | 30.2594 | 30.2594 |
| BF | 1.0000 | 1.0000 | 1.0000 |
| d0 | 6000.0000 | 6000.0000 | 6000.0000 |
| d4 | 52.2184 | 29.0000 | 25.0000 |
| d7 | 3.9998 | 75.8875 | 89.4787 |
| d13 | 94.2527 | 36.7494 | 3.0000 |
| d29 | 15.8680 | 17.5724 | 16.1036 |
| d33 | 20.3984 | 27.5280 | 53.1550 |
| d42 | 30.2594 | 30.2594 | 30.2594 |
| BF | 1.0000 | 1.0000 | 1.0000 |

[Lens group data]

| Group | Starting surface | Focal length |
|---|---|---|
| G1 | 1 | 200.64 |
| G2 | 5 | −1168.07 |
| G3 | 8 | −61.86 |
| G4 | 14 | 72.79 |
| G5 | 30 | −75.60 |
| G6 | 34 | −189.81 |

### Example 4

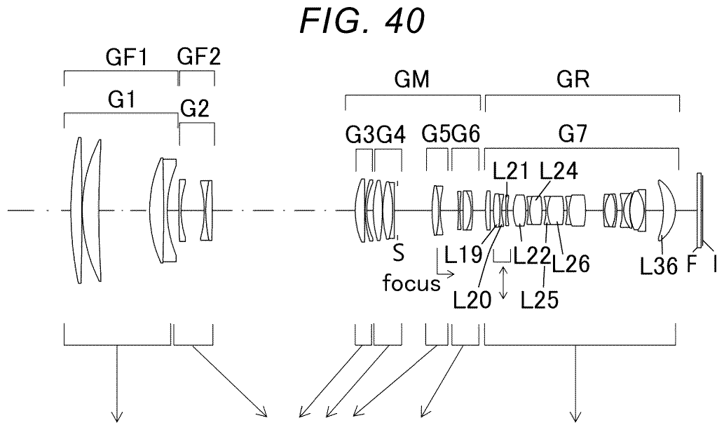

FIG. 40 is a lens configuration diagram of a variable magnification imaging optical system according to Example 4 at a wide-angle end in a case of focusing on infinity.

The variable magnification imaging optical system of FIG. 40 is composed of, in order from the object side: a first front lens group GF1 consisting of a first lens group G1 having a positive refractive power; a second front lens group GF2 consisting of a second lens group G2 having a negative refractive power; a middle group GM consisting of a third lens group G3 having a positive refractive power, a fourth lens group G4 having a positive refractive power, a fifth lens group G5 having a negative refractive power, and a sixth lens group G6 having a positive refractive power; and a subsequent group GR consisting of a seventh lens group G7 having a negative refractive power.

The first lens group G1 is composed of, in order from the object side, a biconvex lens, a meniscus positive lens having a convex surface on the object side, and a cemented lens of a biconvex lens and a biconcave lens. The second lens group G2 is composed of a meniscus negative lens having a convex surface facing the object side, and a cemented lens of a biconcave lens and a biconvex lens. The third lens group G3 is composed of a biconvex lens and a meniscus negative lens having a convex surface on the object side. The fourth lens group G4 is composed of a biconvex lens, a cemented lens of a biconvex lens and a biconcave lens, and an aperture diaphragm S. The fifth lens group G5 is composed of a cemented lens of a biconvex lens and a biconcave lens. The sixth lens group G6 is composed of a biconcave lens, a biconvex lens, and a cemented lens of a meniscus negative lens having a convex surface on the image side. The seventh lens group G7 is composed of a biconvex lens, a cemented lens of a biconvex lens L19 and a biconcave lens L20, a biconcave lens L21, a biconvex lens L22, a cemented lens of a biconcave lens and a biconvex lens L24, a cemented lens of a biconcave lens L25 and a biconvex lens L26, a cemented lens of a biconcave lens and a biconvex lens, a cemented lens of a meniscus negative lens having a convex surface on the object side and a biconvex lens, a cemented lens of a biconcave lens and a meniscus positive lens having a convex surface on the object side, a cemented lens of a biconvex lens and a biconcave lens, and a meniscus positive lens L36 having a convex surface on the image side. In addition, the seventh lens group G7 can also function as a vibration reduction group by moving L19 to L21 as one body in a direction substantially perpendicular to the optical axis, but lenses other than L19 to L21 may also function as a vibration reduction group.

During magnification change from the wide-angle end to the telephoto end, the first lens group G1 and the seventh lens group G7 are fixed with respect to the image surface, the second lens group G2 moves toward the image side, the third lens group G3 to the sixth lens group G6 move toward the object side along different trajectories, a distance between the first lens group G1 and the second lens group G2 increases, a distance between the second lens group G2 and the third lens group G3 decreases, a distance between the third lens group G3 and the fourth lens group G4 increases and then decreases, and the spacing is slightly smaller at the telephoto end than at the wide-angle end, a distance between the fourth lens group G4 and the fifth lens group G5 decreases, a distance between the fifth lens group G5 and the sixth lens group G6 increases, a distance between the sixth lens group G6 and the seventh lens group G7 increases, and during focusing from the infinite distance object to the close distance object, the fifth lens group G5 moves toward the image side along the optical axis.

The lenses on the image side from L22 of the seventh lens group G7 are lenses that are incident on a higher position than an axial marginal ray incident on the lens surface on the object side among off-axis principal rays at the telephoto end at infinity. Therefore, in the variable magnification imaging optical system according to Example 4, Lb is L22.
L24, L26, and L36 are lenses satisfying Conditional Expressions (11) and (12).
L25 is a lens satisfying Conditional Expression (13).
L25 is a lens satisfying Conditional Expression (14).
L25 is a lens satisfying Conditional Expression (15).

The following shows numerical values of the variable magnification imaging optical system according to Example 4.

### Numerical Example 4

Unit: mm
[Surface data]

| | | | | | | Corresponding |
|---|---|---|---|---|---|---|
| Surface number | r | d | nd | vd | ΔPgF | glass material |
| Object surface | ∞ | (d0) | | | | |
| 1 | 220.8523 | 6.6787 | 1.48749 | 70.23 | 0.0080 | S-FSL5 |
| 2 | −1638.9360 | 0.3000 | | | | |
| 3 | 95.2005 | 10.1242 | 1.43700 | 95.10 | 0.0564 | FCD100 |
| 4 | 692.8588 | 31.0506 | | | | |
| 5 | 78.3175 | 8.5345 | 1.43700 | 95.10 | 0.0564 | FCD100 |
| 6 | −1158.9749 | 2.1895 | 1.62205 | 41.08 | −0.0051 | S-NBM52 |
| 7 | 71.2609 | (d7) | | | | |
| 8 | 510.9274 | 1.2946 | 1.61800 | 63.32 | 0.0082 | S-PHM52Q |
| 9 | 53.2207 | 14.1563 | | | | |
| 10 | −65.6651 | 1.0000 | 1.65160 | 58.54 | −0.0041 | S-LAL7Q |
| 11 | 91.7742 | 3.8760 | 1.84666 | 23.84 | 0.0145 | FDS90-SGP |
| 12 | −886.8767 | (d12) | | | | |
| 13 | 49.9987 | 5.7791 | 1.43700 | 95.10 | 0.0564 | FCD100 |
| 14 | −1344.7027 | 0.2914 | | | | |
| 15 | 64.1817 | 0.9958 | 1.77250 | 49.63 | −0.0088 | TAF1 |
| 16 | 41.7663 | (d16) | | | | |
| 17 | 67.9823 | 5.5758 | 1.55032 | 75.50 | 0.0274 | FCD705 |
| 18 | −114.5061 | 0.3000 | | | | |
| 19 | 69.6873 | 5.9995 | 1.43700 | 95.10 | 0.0564 | FCD100 |
| 20 | −66.5699 | 1.0019 | 1.78800 | 47.37 | −0.0072 | S-LAH64 |
| 21 | 12072.0262 | 2.0129 | | | | |
| 22 (diaphragm) | ∞ | (d22) | | | | |
| 23 | 86.8661 | 4.0682 | 1.77047 | 29.74 | 0.0002 | NBFD29 |
| 24 | −71.3602 | 0.9109 | 1.89190 | 37.13 | −0.0035 | S-LAH92 |
| 25 | 61.1383 | (d25) | | | | |
| 26 | −125.7609 | 0.9859 | 1.94594 | 17.98 | 0.0385 | FDS18-W |
| 27 | 115.9811 | 1.8840 | | | | |
| 28 | 816.8880 | 4.8798 | 1.67270 | 32.17 | 0.0058 | E-FD5 |
| 29 | −26.2600 | 0.9907 | 1.43700 | 95.10 | 0.0564 | FCD100 |
| 30 | −85.9175 | (d30) | | | | |
| 31 | 75.1959 | 2.8833 | 1.48749 | 70.23 | 0.0080 | S-FSL5 |
| 32 | −1050.0192 | 2.0008 | | | | |
| 33 | 55.3965 | 4.0340 | 1.69895 | 30.05 | 0.0084 | E-FD15L |
| 34 | −68.8810 | 1.0000 | 1.81600 | 46.62 | −0.0077 | S-LAH59 |
| 35 | 32.7086 | 2.5972 | | | | |
| 36 | −320.7717 | 1.0000 | 1.59282 | 68.62 | 0.0192 | FCD515 |
| 37 | 52.5777 | 3.5000 | | | | |
| 38 | 26.2628 | 7.8422 | 1.62004 | 36.30 | 0.0042 | E-F2 |
| 39 | −39.8534 | 1.4520 | | | | |
| 40 | −38.1406 | 1.0000 | 2.00100 | 29.13 | 0.0035 | TAFD55-W |
| 41 | 26.3971 | 7.3695 | 1.62205 | 41.08 | −0.0051 | S-NBM52 |
| 42 | −48.4579 | 2.4668 | | | | |
| 43 | −28.4018 | 0.9989 | 1.43700 | 95.10 | 0.0564 | FCD100 |
| 44 | 21.7597 | 9.7259 | 1.62205 | 41.08 | −0.0051 | S-NBM52 |
| 45 | −56.8951 | 2.1193 | | | | |
| 46 | −39.2755 | 1.1967 | 2.05090 | 26.94 | 0.0052 | TAFD65 |
| 47 | 26.4846 | 10.1044 | 1.85451 | 25.15 | 0.0071 | NBFD25 |
| 48 | −47.6002 | 10.8614 | | | | |
| 49 | 81.1154 | 0.9000 | 2.00100 | 29.13 | 0.0035 | TAFD55 |
| 50 | 18.2486 | 6.4044 | 1.72825 | 28.32 | 0.0084 | E-FD10 |
| 51 | −25.7296 | 0.9000 | 1.72916 | 54.67 | −0.0047 | TAC8 |
| 52 | −43.7989 | 3.3171 | | | | |
| 53 | −37.6858 | 0.9000 | 1.88100 | 40.14 | −0.0061 | TAFD33 |
| 54 | 16.4802 | 3.6012 | 1.72825 | 28.32 | 0.0084 | E-FD10 |
| 55 | 35.6916 | 0.1500 | | | | |
| 56 | 27.8690 | 8.6614 | 1.62004 | 36.30 | 0.0042 | E-F2 |
| 57 | −20.8884 | 0.9000 | 2.05090 | 26.94 | 0.0052 | TAFD65 |
| 58 | 454.5122 | 10.9345 | | | | |
| 59 | −47.1308 | 7.3567 | 1.61340 | 44.27 | −0.0054 | S-NBM51 |
| 60 | −23.0000 | 13.2004 | | | | |
| 61 | ∞ | 2.5000 | 1.51633 | 64.14 | 0.0023 | S-BSL7 |
| 62 | ∞ | (BF) | | | | |
| Image surface | ∞ | | | | | |

[Various types of data]

| | |
|---|---|
| Zoom ratio | 3.78 |

| | Wide angle | Middle | Telephoto |
|---|---|---|---|
| Focal length | 411.98 | 999.96 | 1555.93 |
| F-number | 14.45 | 16.01 | 18.39 |
| Total angle of view 2ω | 5.97 | 2.45 | 1.58 |
| Image height Y | 21.63 | 21.63 | 21.63 |
| Total lens length | 386.18 | 386.18 | 386.18 |

[Variable distance data]

| | Wide angle | Middle | Telephoto |
|---|---|---|---|
| d0 | ∞ | ∞ | ∞ |
| d7 | 7.1687 | 45.6341 | 54.0879 |
| d12 | 87.3609 | 32.4780 | 1.5000 |
| d16 | 3.9383 | 6.2629 | 3.9118 |
| d22 | 21.2392 | 15.2321 | 4.7660 |
| d25 | 10.9930 | 19.1679 | 41.1250 |
| d30 | 7.7210 | 19.6460 | 33.0303 |
| BF | 1.0000 | 1.0000 | 1.0000 |
| d0 | 5000.0000 | 5000.0000 | 5000.0000 |
| d7 | 7.1687 | 45.6341 | 54.0879 |
| d12 | 87.3609 | 32.4780 | 1.5000 |
| d16 | 3.9383 | 6.2629 | 3.9118 |
| d22 | 23.0205 | 23.2495 | 18.4748 |
| d25 | 9.2117 | 11.1505 | 27.4162 |
| d30 | 7.7210 | 19.6460 | 33.0303 |
| BF | 1.0000 | 1.0000 | 1.0000 |

[Lens group data]

| Group | Starting surface | Focal length |
|---|---|---|
| G1 | 1 | 213.43 |
| G2 | 8 | −55.08 |
| G3 | 13 | 327.58 |
| G4 | 17 | 71.01 |
| G5 | 23 | −142.09 |
| G6 | 26 | 3317.09 |
| G7 | 31 | −35.67 |

### Example 5

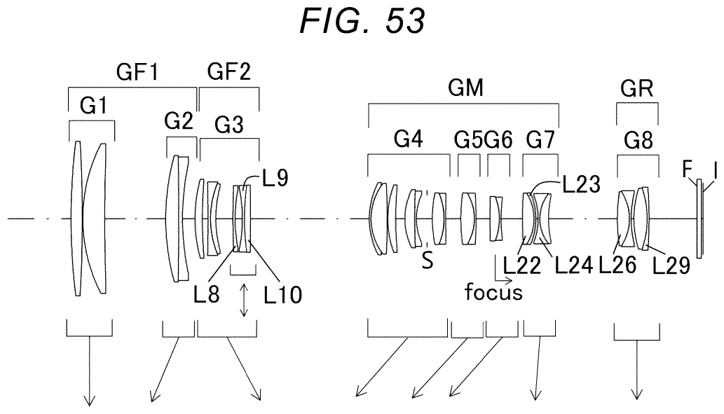

FIG. 53 is a lens configuration diagram of a variable magnification imaging optical system according to Example 5 at a wide-angle end in a case of focusing on infinity.

The variable magnification imaging optical system of FIG. 53 is composed of, in order from the object side: a first front lens group GF1 consisting of a first lens group G1 having a positive refractive power and a second lens group G2 having a negative refractive power and having a positive refractive power as a whole; a second front lens group GF2 consisting of a third lens group G3 having a negative refractive power; a middle group GM consisting of a fourth lens group G4 having a positive refractive power, a fifth lens group G5 having a positive refractive power, a sixth lens group G6 having a negative refractive power, and a seventh lens group G7 having a positive refractive power; and a subsequent group GR consisting of an eighth lens group G8 having a negative refractive power.

The first lens group G1 is composed of, in order from the object side, a biconvex lens and a meniscus positive lens having a convex surface on the object side. The second lens group G2 is composed of a cemented lens of a biconvex lens and a biconcave lens. The third lens group G3 is composed of a meniscus positive lens having a convex surface on the object side, a cemented lens of a biconcave lens and a meniscus positive lens having a convex surface on the object side, a meniscus negative lens L8 having a convex surface on the object side, a cemented lens of a biconcave lens L9 and a biconvex lens L10, and a cemented lens of a biconcave lens and a biconvex lens. In addition, the third lens group G3 can also function as a vibration reduction group by moving L8 to L10 as one body in a direction substantially perpendicular to the optical axis, but lenses other than L8 to L10 may also function as a vibration reduction group. The fourth lens group G4 is composed of a cemented lens of a meniscus negative lens having a convex surface on the object side and a biconvex lens, a meniscus positive lens having a convex surface on the object side, a cemented lens of a meniscus positive lens having a convex surface on the object side and a meniscus negative lens having a convex surface on the object side, an aperture diaphragm S, and a cemented lens of a biconvex lens and a biconcave lens. The fifth lens group G5 is composed of a cemented lens of a biconvex lens and a meniscus negative lens having a convex surface on the image side. The sixth lens group G6 is composed of a cemented lens of a biconvex lens and a biconcave lens. The seventh lens group G7 is composed of a cemented lens of a biconvex lens L22 and a meniscus negative lens L23 having a convex surface on the image side, and a cemented lens of a biconcave lens L24 and a meniscus positive lens having a convex surface on the object side. The eighth lens group G8 is composed of a cemented lens of a biconvex lens L26 and a biconcave lens, and a cemented lens of a biconvex lens and a meniscus negative lens L29 having a convex surface on the image side.

During magnification change from the wide-angle end to the telephoto end, the first lens group G1 and the eighth lens group G8 are fixed with respect to the image surface, the second lens group G2 moves toward the object side, the third lens group G3 moves toward the image side, the fourth lens group G4 to the seventh lens group G7 move toward the object side along different trajectories, a distance between the first lens group G1 and the second lens group G2 decreases, a distance between the second lens group G2 and the third lens group G3 increases, a distance between the third lens group G3 and the fourth lens group G4 decreases, a distance between the fourth lens group G4 and the fifth lens group G5 decreases, a distance between the fifth lens group G5 and the sixth lens group G6 decreases and then increases, and the spacing is smaller at the telephoto end than at the wide-angle end, a distance between the sixth lens group G6 and the seventh lens group G7 increases, a distance between the seventh lens group G7 and the eighth lens group G8 increases, and during focusing from the infinite distance object to the close distance object, the sixth lens group G6 moves toward the image side along the optical axis.

The lenses on the image side from L22 of the seventh lens group G7 are lenses that are incident on a higher position than an axial marginal ray incident on the lens surface on the object side among off-axis principal rays at the telephoto end at infinity. Therefore, in the variable magnification imaging optical system according to Example 5, Lb is L22.
L26 is a lens satisfying Conditional Expressions (11) and (12).
L23, L24, and L29 are lenses satisfying Conditional Expression (13).
L24 and L29 are lenses satisfying Conditional Expression (14).
L29 is a lens satisfying Conditional Expression (15).

The following shows numerical values of the variable magnification imaging optical system according to Example 5.

### Numerical Example 5

Unit: mm
[Surface data]

| | | | | | | Corresponding |
|---|---|---|---|---|---|---|
| Surface number | r | d | nd | vd | ΔPgF | glass material |
| Object surface | ∞ | (d0) | | | | |
| 1 | 373.8407 | 6.4945 | 1.59349 | 67.00 | 0.0088 | PCD51 |
| 2 | −785.1621 | 0.3000 | | | | |
| 3 | 95.2151 | 12.6733 | 1.43700 | 95.10 | 0.0564 | FCD100 |
| 4 | 1348.1160 | (d4) | | | | |
| 5 | 138.8555 | 7.5259 | 1.43700 | 95.10 | 0.0564 | FCD100 |
| 6 | −1741.3735 | 2.2003 | 1.61396 | 44.29 | −0.0055 | LAF45 |
| 7 | 153.8115 | (d7) | | | | |
| 8 | 88.9251 | 4.2529 | 1.64769 | 33.84 | 0.0049 | E-FD2 |
| 9 | 277.5278 | 3.2007 | | | | |
| 10 | −1050.8447 | 1.4995 | 1.76385 | 48.49 | −0.0022 | S-LAH96 |
| 11 | 55.3712 | 3.0564 | 1.57144 | 71.61 | 0.0224 | FCD615 |
| 12 | 70.5384 | 9.9188 | | | | |
| 13 | 685.0408 | 1.2493 | 1.79952 | 42.24 | −0.0049 | S-LAH52Q |
| 14 | 95.2161 | 4.1527 | | | | |
| 15 | −88.6047 | 1.2449 | 1.77250 | 49.63 | −0.0088 | TAF1 |
| 16 | 134.6003 | 3.7212 | 1.85451 | 25.15 | 0.0071 | NBFD25 |
| 17 | −706.3453 | (d17) | | | | |
| 18 | 46.1839 | 1.0000 | 1.88300 | 40.81 | −0.0094 | TAFD30 |
| 19 | 33.9926 | 9.3762 | 1.59282 | 68.62 | 0.0192 | FCD515 |
| 20 | −371.1920 | 0.3000 | | | | |
| 21 | 57.3501 | 4.5944 | 1.43700 | 95.10 | 0.0564 | FCD100 |
| 22 | 210.0433 | 5.2849 | | | | |
| 23 | 38.3939 | 5.6463 | 1.43700 | 95.10 | 0.0564 | FCD100 |
| 24 | 385.3826 | 1.0000 | 1.91082 | 35.25 | −0.0017 | TAFD35L |
| 25 | 34.0817 | 6.2323 | | | | |
| 26(diaphragm) | ∞ | 3.0000 | | | | |
| 27 | 77.6525 | 6.7355 | 1.68376 | 37.64 | −0.0025 | J-KZFH6 |
| 28 | −39.2001 | 1.0000 | 2.00100 | 29.13 | 0.0035 | TAFD55-W |
| 29 | 837.3171 | (d29) | | | | |
| 30 | 117.4692 | 7.7481 | 1.77047 | 29.74 | 0.0002 | NBFD29 |
| 31 | −29.1577 | 1.0000 | 1.76385 | 48.49 | −0.0022 | S-LAH96 |
| 32 | −288.5640 | (d32) | | | | |
| 33 | 648.0538 | 5.3648 | 1.90366 | 31.32 | 0.0027 | TAFD25 |
| 34 | −35.3017 | 1.0000 | 1.90525 | 35.04 | −0.0005 | S-LAH93 |
| 35 | 93.6820 | (d35) | | | | |
| 36 | 224.4108 | 6.6414 | 1.73037 | 32.23 | −0.0005 | NBFD32 |
| 37 | −27.9737 | 1.0000 | 1.98612 | 16.48 | 0.0468 | FDS16-W |
| 38 | −38.2894 | 1.3598 | | | | |
| 39 | −38.0167 | 1.0000 | 1.57144 | 71.61 | 0.0224 | FCD615 |
| 40 | 23.7828 | 5.0381 | 1.73037 | 32.23 | −0.0005 | NBFD32 |
| 41 | 60.8616 | (d41) | | | | |
| 42 | 119.8390 | 6.9001 | 1.61396 | 44.29 | −0.0055 | LAF45 |
| 43 | −29.0828 | 1.0000 | 2.00100 | 29.13 | 0.0035 | TAFD55-W |
| 44 | 62.7294 | 1.6389 | | | | |
| 45 | 59.6924 | 7.5973 | 1.64769 | 33.84 | 0.0049 | E-FD2 |
| 46 | −55.0188 | 1.1997 | 1.49700 | 81.61 | 0.0373 | FCD1 |
| 47 | −216.3101 | (d47) | | | | |
| 48 | ∞ | 2.5000 | 1.51680 | 64.20 | 0.0014 | BSC7 |
| 49 | ∞ | (BF) | | | | |
| Image surface | ∞ | | | | | |

[Various types of data]

| | |
|---|---|
| Zoom ratio | 2.52 |

| | Wide angle | Middle | Telephoto |
|---|---|---|---|
| Focal length | 309.00 | 550.00 | 780.00 |
| F number | 6.50 | 7.63 | 9.21 |
| Total angle of view 2ω | 7.71 | 4.32 | 3.04 |
| Image height Y | 21.63 | 21.63 | 21.63 |
| Total lens length | 365.00 | 365.00 | 365.00 |

[Variable distance data]

| | Wide angle | Middle | Telephoto |
|---|---|---|---|
| d0 | ∞ | ∞ | ∞ |
| d4 | 35.2247 | 18.8071 | 15.3996 |
| d7 | 7.1966 | 35.8211 | 41.6966 |
| d17 | 68.2265 | 30.5975 | 3.0000 |
| d29 | 8.7420 | 5.3558 | 2.0000 |
| d32 | 8.2667 | 3.0000 | 7.1132 |
| d35 | 12.3017 | 39.7947 | 61.8418 |
| d41 | 39.7273 | 46.3092 | 48.6341 |
| d47 | 27.6673 | 27.6673 | 27.6673 |
| BF | 1.0000 | 1.0000 | 1.0000 |
| d0 | 4000.0000 | 4000.0000 | 4000.0000 |
| d4 | 35.2247 | 18.8071 | 15.3996 |
| d7 | 7.1966 | 35.8211 | 41.6966 |
| d17 | 68.2265 | 30.5975 | 3.0000 |
| d29 | 8.7420 | 5.3558 | 2.0000 |
| d32 | 14.7945 | 18.0005 | 33.8476 |
| d35 | 5.7738 | 24.7943 | 35.1073 |
| d41 | 39.7273 | 46.3092 | 48.6341 |
| d47 | 27.6673 | 27.6673 | 27.6673 |
| BF | 1.0000 | 1.0000 | 1.0000 |

[Lens group data]

| Group | Starting surface | Focal length |
|---|---|---|
| G1 | 1 | 151.67 |
| G2 | 5 | −1160.05 |
| G3 | 8 | −46.03 |
| G4 | 18 | 102.11 |
| G5 | 30 | 107.06 |
| G6 | 33 | −120.94 |
| G7 | 36 | 1814.58 |
| G8 | 42 | −142.01 |

### Example 6

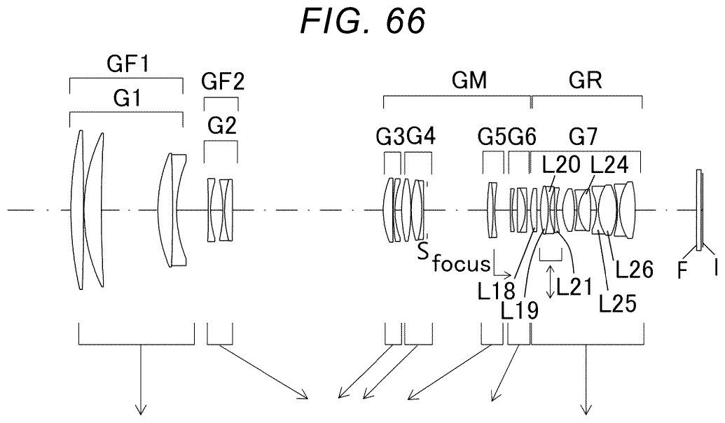

FIG. 66 is a lens configuration diagram of a variable magnification imaging optical system according to Example 6 at a wide-angle end in a case of focusing on infinity.

The variable magnification imaging optical system of FIG. 66 is composed of, in order from the object side: a first front lens group GF1 consisting of a first lens group G1 having a positive refractive power; a second front lens group GF2 consisting of a second lens group G2 having a negative refractive power; a middle group GM consisting of a third lens group G3 having a positive refractive power, a fourth lens group G4 having a positive refractive power, a fifth lens group G5 having a negative refractive power, and a sixth lens group G6 having a negative refractive power; and a subsequent group GR consisting of a seventh lens group G7 having a negative refractive power.

The first lens group G1 is composed of, in order from the object side, a biconvex lens, a meniscus positive lens having a convex surface on the object side, and a cemented lens of a biconvex lens and a biconcave lens. The second lens group G2 is composed of a biconcave lens and a cemented lens of a biconcave lens and a biconvex lens. The third lens group G3 is composed of a meniscus positive lens having a convex surface on the object side and a meniscus negative lens having a convex surface on the object side. The fourth lens group G4 is composed of a biconvex lens, a cemented lens of a biconvex lens and a meniscus negative lens having a convex surface on the image side, and an aperture diaphragm S. The fifth lens group G5 is composed of a cemented lens of a biconvex lens and a biconcave lens. The sixth lens group G6 is composed of a meniscus negative lens having a convex surface on the object side, and a cemented lens of a biconvex lens, and a meniscus positive lens having a convex surface on the image side. The seventh lens group G7 is composed of a biconvex lens L18, a cemented lens of a biconvex lens L19 and a biconcave lens L20, a biconcave lens L21, a biconvex lens, a cemented lens of a biconcave lens and a biconvex lens L24, a cemented lens of a biconcave lens L25 and a biconvex lens L26, and a cemented lens of a biconcave lens and a biconvex lens. In addition, the seventh lens group G7 can also function as a vibration reduction group by moving L19 to L21 as one body in a direction substantially perpendicular to the optical axis, but lenses other than L19 to L21 may also function as a vibration reduction group.

During magnification change from the wide-angle end to the telephoto end, the first lens group G1 and the seventh lens group G7 are fixed with respect to the image surface, the second lens group G2 moves toward the image side, the third lens group G3 to the sixth lens group G6 move toward the object side along different trajectories, a distance between the first lens group G1 and the second lens group G2 increases, a distance between the second lens group G2 and the third lens group G3 decreases, a distance between the third lens group G3 and the fourth lens group G4 increases and then decreases, and the spacing is slightly smaller at the telephoto end than at the wide-angle end, a distance between the fourth lens group G4 and the fifth lens group G5 decreases, a distance between the fifth lens group G5 and the sixth lens group G6 increases, a distance between the sixth lens group G6 and the seventh lens group G7 increases, and during focusing from the infinite distance object to the close distance object, the fifth lens group G5 moves toward the image side along the optical axis.

The lenses on the image side from L18 of the seventh lens group G7 are lenses that are incident on a higher position than an axial marginal ray incident on the lens surface on the object side among off-axis principal rays at the telephoto end at infinity. Therefore, in the variable magnification imaging optical system according to Example 6, Lb is L18.
L24 and L26 are lenses satisfying Conditional Expressions (11) and (12).
L21 and L25 are lenses satisfying Conditional Expression (13).
L21 and L25 are lenses satisfying Conditional Expression (14).
L21 and L25 are lenses satisfying Conditional Expression (15).

### Numerical Example 6

Unit: mm
[Surface data]

| | | | | | | Corresponding |
|---|---|---|---|---|---|---|
| Surface number | r | d | nd | vd | ΔPgF | glass material |
| Object surface | ∞ | (d0) | | | | |
| 1 | 203.5952 | 7.1026 | 1.48749 | 70.44 | 0.0090 | FC5 |
| 2 | −1557.0357 | 0.3000 | | | | |
| 3 | 99.1466 | 9.7140 | 1.43700 | 95.10 | 0.0564 | FCD100 |
| 4 | 701.9323 | 31.6471 | | | | |
| 5 | 82.6980 | 8.3333 | 1.43700 | 95.10 | 0.0564 | FCD100 |
| 6 | −760.4261 | 2.1980 | 1.62205 | 41.08 | −0.0051 | S-NBM52 |
| 7 | 73.0370 | (d7) | | | | |
| 8 | −521.6935 | 1.2939 | 1.65100 | 56.24 | −0.0051 | S-LAL54Q |
| 9 | 54.6608 | 6.8904 | | | | |
| 10 | −70.1283 | 1.0000 | 1.65100 | 56.24 | −0.0051 | S-LAL54Q |
| 11 | 67.1044 | 4.4582 | 1.83401 | 25.97 | 0.0061 | NBFD26 |
| 12 | −664.8230 | (d12) | | | | |
| 13 | 47.9296 | 5.2604 | 1.55032 | 75.50 | 0.0274 | FCD705 |
| 14 | 1009.5915 | 0.3000 | | | | |
| 15 | 129.2323 | 1.0000 | 1.77250 | 49.63 | −0.0088 | TAF1 |
| 16 | 44.6762 | (d16) | | | | |
| 17 | 78.2244 | 5.1107 | 1.55397 | 71.76 | 0.0200 | FCD500 |
| 18 | −97.7680 | 0.3000 | | | | |
| 19 | 62.4719 | 5.8692 | 1.43700 | 95.10 | 0.0564 | FCD100 |
| 20 | −67.6706 | 0.9984 | 1.78800 | 47.37 | −0.0072 | S-LAH64 |
| 21 | −1435.5482 | 2.0000 | | | | |
| 22 (diaphragm) | ∞ | (d22) | | | | |
| 23 | 112.4449 | 3.3898 | 1.77047 | 29.74 | 0.0002 | NBFD29 |
| 24 | −124.0716 | 1.0000 | 1.91082 | 35.25 | −0.0017 | TAFD35L |
| 25 | 95.1061 | (d25) | | | | |
| 26 | 259.2353 | 0.9905 | 1.98611 | 17.25 | 0.0430 | FDS165-W |
| 27 | 54.5424 | 2.9119 | | | | |
| 28 | 514.2904 | 4.4558 | 1.67270 | 32.10 | 0.0082 | S-TIM25 |
| 29 | −26.3701 | 0.9909 | 1.43700 | 95.10 | 0.0564 | FCD100 |
| 30 | −245.8447 | (d30) | | | | |
| 31 | 49.4945 | 3.5041 | 1.48749 | 70.44 | 0.0090 | FC5 |
| 32 | −584.0756 | 2.0000 | | | | |
| 33 | 54.0254 | 4.3696 | 1.69895 | 30.05 | 0.0084 | E-FD15L |
| 34 | −54.3042 | 1.0000 | 1.81600 | 46.62 | −0.0077 | S-LAH59 |
| 35 | 31.8677 | 2.5700 | | | | |
| 36 | −756.1530 | 1.0000 | 1.59282 | 68.62 | 0.0192 | FCD515 |
| 37 | 43.9815 | 3.5000 | | | | |
| 38 | 25.0374 | 6.5663 | 1.62004 | 36.30 | 0.0042 | E-F2 |
| 39 | −50.2606 | 1.4437 | | | | |
| 40 | −49.2327 | 1.0000 | 1.95375 | 32.32 | 0.0003 | S-LAH98 |
| 41 | 18.0135 | 6.7690 | 1.62205 | 41.08 | −0.0051 | S-NBM52 |
| 42 | −77.4078 | 3.1732 | | | | |
| 43 | −25.7191 | 0.9977 | 1.43700 | 95.10 | 0.0564 | FCD100 |
| 44 | 26.8768 | 10.3502 | 1.62205 | 41.08 | −0.0051 | S-NBM52 |
| 45 | −32.9460 | 0.4917 | | | | |
| 46 | −51.2143 | 1.1980 | 2.05090 | 26.94 | 0.0052 | TAFD65 |
| 47 | 30.6085 | 8.7761 | 1.83401 | 25.97 | 0.0061 | NBFD26 |
| 48 | −78.4746 | (d48) | | | | |
| 49 | ∞ | 2.5000 | 1.51633 | 64.14 | 0.0023 | S-BSL7 |
| 50 | ∞ | (BF) | | | | |
| Image surface | ∞ | | | | | |

[Various types of data]

| | |
|---|---|
| Zoom ratio | 3.78 |

| | Wide angle | Middle | Telephoto |
|---|---|---|---|
| Focal length | 206.00 | 500.00 | 778.00 |
| F number | 7.99 | 8.01 | 9.16 |
| Total angle of view 2ω | 11.61 | 4.75 | 3.05 |
| Image height Y | 21.63 | 21.63 | 21.63 |
| Total lens length | 355.00 | 355.00 | 355.00 |

[Variable distance data]

| | Wide angle | Middle | Telephoto |
|---|---|---|---|
| d0 | ∞ | ∞ | ∞ |
| d7 | 17.8491 | 55.7780 | 63.2462 |
| d12 | 84.7631 | 30.4517 | 1.5000 |
| d16 | 3.7701 | 6.9092 | 3.7442 |
| d22 | 33.7765 | 21.6456 | 3.0000 |
| d25 | 8.6926 | 26.9499 | 67.0694 |
| d30 | 2.0000 | 9.1168 | 12.2914 |
| d48 | 34.4282 | 34.4282 | 34.4282 |
| BF | 1.0000 | 1.0000 | 1.0000 |
| d0 | 4300.0000 | 4300.0000 | 4300.0000 |
| d7 | 17.8491 | 55.7780 | 63.2462 |
| d12 | 84.7631 | 30.4517 | 1.5000 |
| d16 | 3.7701 | 6.9092 | 3.7442 |
| d22 | 39.1231 | 45.2313 | 41.9776 |
| d25 | 3.3460 | 3.3643 | 28.0918 |
| d30 | 2.0000 | 9.1168 | 12.2914 |
| d48 | 34.4282 | 34.4282 | 34.4282 |
| BF | 0.9999 | 1.0000 | 1.0000 |

[Lens group data]

| Group | Starting surface | Focal length |
|---|---|---|
| G1 | 1 | 219.27 |
| G2 | 8 | −53.08 |
| G3 | 13 | 3505.37 |
| G4 | 17 | 65.48 |
| G5 | 23 | −271.24 |
| G6 | 26 | −729.80 |
| G7 | 31 | −86.80 |

### Example 7

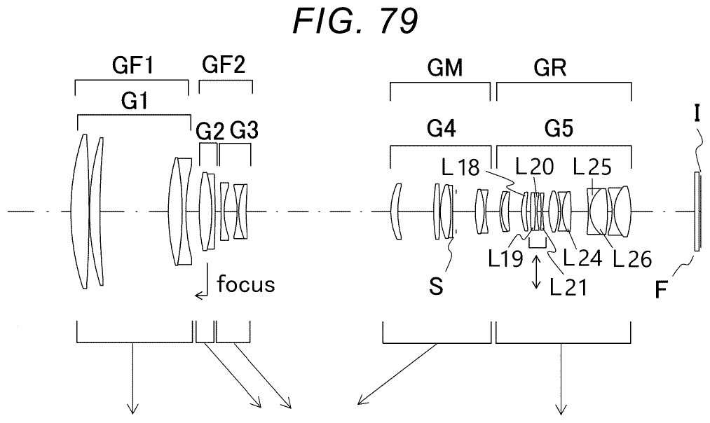

FIG. 79 is a lens configuration diagram of a variable magnification imaging optical system according to Example 7 at a wide-angle end in a case of focusing on infinity.

The variable magnification imaging optical system of FIG. 79 is composed of, in order from the object side: a first front lens group GF1 consisting of a first lens group G1 having a positive refractive power; a second front lens group GF2 consisting of a second lens group G2 having a positive refractive power, a third lens group G3 having a negative refractive power, and having a negative refractive power as a whole; a middle group GM consisting of a fourth lens group G4 having a positive refractive power; and a subsequent group GR consisting of a fifth lens group G5 having a negative refractive power.

The first lens group G1 is composed of, in order from the object side, a biconvex lens, a meniscus positive lens having a convex surface on the object side, and a cemented lens of a biconvex lens and a biconcave lens. The second lens group G2 is composed of a cemented lens of a biconvex lens and a meniscus negative lens having a convex surface on the image side. The third lens group G3 is composed of a biconcave lens and a cemented lens of a biconcave lens and a meniscus positive lens having a convex surface on the object side. The fourth lens group G4 is composed of a meniscus positive lens having a convex surface on the object side, a biconvex lens, a cemented lens of a biconvex lens and a meniscus negative lens having a convex surface on the image side, an aperture diaphragm S, and a cemented lens of a biconvex lens and a biconcave lens. The fifth lens group G5 is composed of a cemented lens of a meniscus negative lens having a convex surface on the object side and a meniscus positive lens having a convex surface on the object side, a meniscus positive lens L18 having a convex surface on the object side, a cemented lens of a biconvex lens L19 and a biconcave lens L20, a biconcave lens L21, a biconvex lens, a cemented lens of a biconcave lens and a biconvex lens L24, a cemented lens of a biconcave lens L25 and a biconvex lens L26, and a cemented lens of a biconcave lens and a biconvex lens. In addition, the fifth lens group G5 can also function as a vibration reduction group by moving L19 to L21 as one body in a direction substantially perpendicular to the optical axis, but lenses other than L19 to L21 may also function as a vibration reduction group.

During magnification change from the wide-angle end to the telephoto end, the first lens group G1 and the fifth lens group G5 are fixed with respect to the image surface, the second lens group G2 and the third lens group G3 move toward the image side along different trajectories, the fourth lens group G4 moves toward the object side, a distance between the first lens group G1 and the second lens group G2 increases, a distance between the second lens group G2 and the third lens group G3 increases and then decreases, and the spacing is smaller at the telephoto end than at the wide-angle end, a distance between the third lens group G3 and the fourth lens group G4 decreases, a distance between the fourth lens group G4 and the fifth lens group G5 increases, and during focusing from the infinite distance object to the close distance object, the second lens group G2 moves toward the object side.

The lenses on the image side from L18 of the fifth lens group G5 are lenses that are incident on a higher position than an axial marginal ray incident on the lens surface on the object side among off-axis principal rays at the telephoto end at infinity. Therefore, in the variable magnification imaging optical system according to Example 7, Lb is L18.
L24 and L26 are lenses satisfying Conditional Expressions (11) and (12).
L25 is a lens satisfying Conditional Expression (13).
L25 is a lens satisfying Conditional Expression (14).
L25 is a lens satisfying Conditional Expression (15).

The following shows numerical values of the variable magnification imaging optical system according to Example 7.

### Numerical Example 7

Unit: mm
[Surface data]

| | | | | | | Corresponding |
|---|---|---|---|---|---|---|
| Surface number | r | d | nd | vd | ΔPgF | glass material |
| Object surface | ∞ | (d0) | | | | |
| 1 | 144.8510 | 10.5248 | 1.49700 | 81.54 | 0.0358 | S-FPL51 |
| 2 | −675.7419 | 0.3000 | | | | |
| 3 | 151.4636 | 5.9948 | 1.43700 | 95.10 | 0.0564 | FCD100 |
| 4 | 438.1797 | 39.6764 | | | | |
| 5 | 120.5228 | 7.9856 | 1.43700 | 95.10 | 0.0564 | FCD100 |
| 6 | −178.8992 | 2.1769 | 1.62205 | 41.08 | −0.0051 | S-NBM52 |
| 7 | 115.4750 | (d7) | | | | |
| 8 | 120.1578 | 7.2218 | 1.61340 | 44.27 | −0.0054 | S-NBM51 |
| 9 | −90.1319 | 1.9636 | 1.72825 | 28.46 | 0.0105 | S-TIH10 |
| 10 | −393.3935 | (d10) | | | | |
| 11 | −303.6208 | 1.7555 | 1.49700 | 81.54 | 0.0358 | S-FPL51 |
| 12 | 42.2264 | 7.4803 | | | | |
| 13 | −56.3090 | 1.0000 | 1.65844 | 50.86 | 0.0006 | BACED5 |
| 14 | 41.8986 | 4.2905 | 1.85478 | 24.80 | 0.0085 | S-NBH56 |
| 15 | 155.3261 | (d15) | | | | |
| 16 | 39.2413 | 4.0367 | 1.59282 | 68.62 | 0.0192 | FCD515 |
| 17 | 57.3409 | 20.6627 | | | | |
| 18 | 111.7776 | 3.3660 | 1.59282 | 68.62 | 0.0192 | FCD515 |
| 19 | −398.1717 | 0.5030 | | | | |
| 20 | 42.3579 | 6.1210 | 1.43700 | 95.10 | 0.0564 | FCD100 |
| 21 | −74.2521 | 1.0001 | 1.85451 | 25.15 | 0.0071 | NBFD25 |
| 22 | −925.9611 | 2.0000 | | | | |
| 23(diaphragm) | ∞ | 11.0968 | | | | |
| 24 | 55.4158 | 5.0461 | 1.68430 | 26.81 | 0.0230 | FD270 |
| 25 | −40.0050 | 1.0000 | 1.90043 | 37.37 | −0.0045 | TAFD37A |
| 26 | 51.6351 | (d26) | | | | |
| 27 | 41.2981 | 0.9952 | 1.85451 | 25.15 | 0.0071 | NBFD25 |
| 28 | 22.0499 | 3.9610 | 1.65253 | 39.48 | −0.0042 | NBFD38 |
| 29 | 91.0273 | 7.6058 | | | | |
| 30 | 33.9895 | 2.8008 | 1.43700 | 95.10 | 0.0564 | FCD100 |
| 31 | 67.8287 | 2.2901 | | | | |
| 32 | 122.6442 | 2.8242 | 1.83401 | 25.97 | 0.0059 | NBFD26 |
| 33 | −108.2727 | 1.0000 | 1.76385 | 48.49 | −0.0022 | S-LAH96 |
| 34 | 43.0358 | 2.3755 | | | | |
| 35 | −170.5845 | 1.0000 | 1.69680 | 55.46 | −0.0060 | LAC14 |
| 36 | 74.3622 | 3.5000 | | | | |
| 37 | 36.0283 | 5.5000 | 1.69895 | 30.05 | 0.0084 | E-FD15L |
| 38 | −35.2219 | 1.3347 | | | | |
| 39 | −36.9026 | 1.0000 | 1.95375 | 32.32 | 0.0003 | S-LAH98 |
| 40 | 25.3084 | 5.0173 | 1.62205 | 41.08 | −0.0051 | S-NBM52 |
| 41 | −110.7203 | 10.0000 | | | | |
| 42 | −108.5313 | 1.0059 | 1.43700 | 95.10 | 0.0564 | FCD100 |
| 43 | 16.9064 | 10.1035 | 1.62205 | 41.08 | −0.0051 | S-NBM52 |
| 44 | −83.9751 | 2.6593 | | | | |
| 45 | −33.9606 | 1.2042 | 2.05090 | 26.94 | 0.0052 | TAFD65 |
| 46 | 22.2873 | 9.7142 | 1.83401 | 25.97 | 0.0059 | NBFD26 |
| 47 | −50.5556 | (d47) | | | | |
| 48 | ∞ | 2.5400 | 1.51633 | 64.14 | 0.0023 | S-BSL7 |
| 49 | ∞ | (BF) | | | | |
| Image surface | ∞ | | | | | |

[Various types of data]

| | |
|---|---|
| Zoom ratio | 3.78 |

| | Wide angle | Middle | Telephoto |
|---|---|---|---|
| Focal length | 206.00 | 500.00 | 778.00 |
| F number | 9.20 | 9.22 | 9.22 |
| Total angle of view 2ω | 11.59 | 4.75 | 3.06 |
| Image height Y | 21.63 | 21.63 | 21.63 |
| Total lens length | 365.00 | 365.00 | 365.00 |

[Variable distance data]

| | Wide angle | Middle | Telephoto |
|---|---|---|---|
| d0 | ∞ | ∞ | ∞ |
| d7 | 7.7365 | 37.2421 | 53.7589 |
| d10 | 3.4550 | 5.5399 | 2.0654 |
| d15 | 83.9723 | 32.1701 | 1.5000 |
| d26 | 8.2019 | 28.4134 | 46.0412 |
| d47 | 37.0000 | 37.0001 | 37.0000 |
| BF | 1.0000 | 1.0000 | 1.0000 |
| d0 | 4200.0000 | 4200.0000 | 4200.0000 |
| d7 | 2.2218 | 29.9848 | 45.0973 |
| d10 | 8.9697 | 12.7972 | 10.7270 |
| d15 | 83.9723 | 32.1701 | 1.5000 |
| d26 | 8.2019 | 28.4134 | 46.0412 |
| d47 | 37.0000 | 37.0001 | 37.0000 |
| BF | 1.0000 | 1.0000 | 1.0000 |

[Lens group data]

| Group | Starting surface | Focal length |
|---|---|---|
| G1 | 1 | 227.00 |
| G2 | 8 | 176.66 |
| G3 | 11 | −36.36 |
| G4 | 16 | 82.24 |
| G5 | 27 | −140.43 |

### Example 8

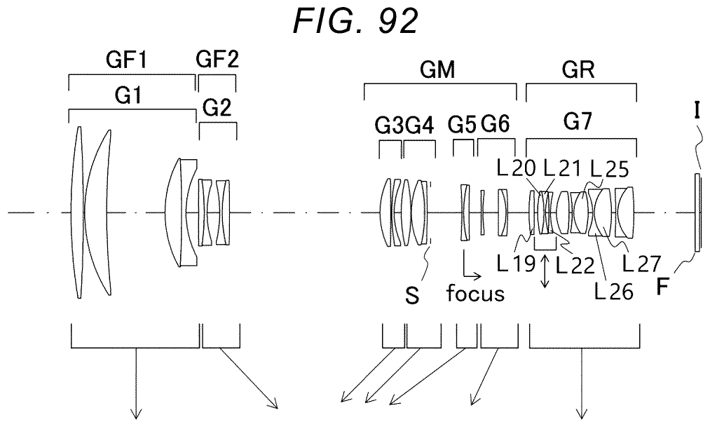

FIG. 92 is a lens configuration diagram of a variable magnification imaging optical system according to Example 8 at a wide-angle end in a case of focusing on infinity.

The variable magnification imaging optical system of FIG. 92 is composed of, in order from the object side: a first front lens group GF1 consisting of a first lens group G1 having a positive refractive power; a second front lens group GF2 consisting of a second lens group G2 having a negative refractive power; a middle group GM consisting of a third lens group G3 having a positive refractive power, a fourth lens group G4 having a positive refractive power, a fifth lens group G5 having a negative refractive power, and a sixth lens group G6 having a positive refractive power; and a subsequent group GR consisting of a seventh lens group G7 having a negative refractive power.

The first lens group G1 is composed of, in order from the object side, a biconvex lens, a meniscus positive lens having a convex surface on the object side, and a cemented lens of a biconvex lens and a biconcave lens. The second lens group G2 is composed of a cemented lens of a meniscus positive lens having a convex surface on the image side and a biconcave lens, and a cemented lens of a biconcave lens and a biconvex lens. The third lens group G3 is composed of a biconvex lens and a meniscus negative lens having a convex surface on the object side. The fourth lens group G4 is composed of a biconvex lens, a cemented lens of a biconvex lens and a meniscus negative lens having a convex surface on the image side, and an aperture diaphragm S. The fifth lens group G5 is composed of a cemented lens of a biconcave lens and a meniscus positive lens having a convex surface on the object side. The sixth lens group G6 is composed of a biconcave lens, and a cemented lens of a meniscus positive lens having a convex surface on the image side and a meniscus negative lens having a convex surface on the image side. The seventh lens group G7 is composed of a biconvex lens L19, a cemented lens of a biconvex lens L20 and a biconcave lens L21, a biconcave lens L22, a biconvex lens, a cemented lens of a biconcave lens and a biconvex lens L25, a cemented lens of a biconcave lens L26 and a biconvex lens L27, and a cemented lens of a biconcave lens and a biconvex lens. In addition, the seventh lens group G7 can also function as a vibration reduction group by moving L20 to L22 as one body in a direction substantially perpendicular to the optical axis, but lenses other than L20 to L22 may also function as a vibration reduction group.

During magnification change from the wide-angle end to the telephoto end, the first lens group G1 and the seventh lens group G7 are fixed with respect to the image surface, the second lens group G2 moves toward the image side, the third lens group G3 to the sixth lens group G6 move toward the object side along different trajectories, a distance between the first lens group G1 and the second lens group G2 increases, a distance between the second lens group G2 and the third lens group G3 decreases, a distance between the third lens group G3 and the fourth lens group G4 increases and then decreases, and the spacing is larger at the telephoto end than at the wide-angle end, a distance between the fourth lens group G4 and the fifth lens group G5 decreases, a distance between the fifth lens group G5 and the sixth lens group G6 increases, a distance between the sixth lens group G6 and the seventh lens group G7 increases, and during focusing from the infinite distance object to the close distance object, the fifth lens group G5 moves toward the image side.

The lenses on the image side from L19 of the seventh lens group G7 are lenses that are incident on a higher position than an axial marginal ray incident on the lens surface on the object side among off-axis principal rays at the telephoto end at infinity. Therefore, in the variable magnification imaging optical system according to Example 8, Lb is L19.
L25 and L27 are lenses satisfying Conditional Expressions (11) and (12).
L19 and L26 are lenses satisfying Conditional Expression (13).
L19 and L26 are lenses satisfying Conditional Expression (14).
L19 and L26 are lenses satisfying Conditional Expression (15).

The following shows numerical values of the variable magnification imaging optical system according to Example 8.

### Numerical Example 8

Unit: mm
[Surface data]

| | | | | | | Corresponding |
|---|---|---|---|---|---|---|
| Surface number | r | d | nd | vd | ΔPgF | glass material |
| Object surface | ∞ | (d0) | | | | |
| 1 | 309.1213 | 7.1734 | 1.49700 | 81.61 | 0.0373 | FCD1 |
| 2 | −868.9809 | 0.8159 | | | | |
| 3 | 89.8083 | 12.8489 | 1.59282 | 68.62 | 0.0192 | FCD515 |
| 4 | 437.7989 | 34.0536 | | | | |
| 5 | 66.4480 | 9.7141 | 1.43700 | 95.10 | 0.0564 | FCD100 |
| 6 | −604.9106 | 2.5620 | 1.68376 | 37.64 | −0.0025 | J-KZFH6 |
| 7 | 56.4115 | (d7) | | | | |
| 8 | −21146.2802 | 3.2477 | 1.85883 | 30.00 | 0.0035 | NBFD30 |
| 9 | −138.7543 | 1.6500 | 1.77250 | 49.63 | −0.0088 | TAF1 |
| 10 | 55.2325 | 7.3628 | | | | |
| 11 | −74.9130 | 1.5367 | 1.72000 | 50.23 | −0.0059 | S-LAL10 |
| 12 | 85.4075 | 4.2660 | 1.85451 | 25.15 | 0.0071 | NBFD25 |
| 13 | −584.5526 | (d13) | | | | |
| 14 | 46.9419 | 6.1990 | 1.43700 | 95.10 | 0.0564 | FCD100 |
| 15 | −1033.4296 | 0.5500 | | | | |
| 16 | 107.0143 | 1.4206 | 1.74330 | 49.22 | −0.0104 | NBF1 |
| 17 | 43.2204 | (d17) | | | | |
| 18 | 88.6584 | 5.5835 | 1.49700 | 81.61 | 0.0373 | FCD1 |
| 19 | −98.6767 | 0.3000 | | | | |
| 20 | 46.0191 | 7.7370 | 1.43700 | 95.10 | 0.0564 | FCD100 |
| 21 | −84.1121 | 1.4845 | 1.77250 | 49.63 | −0.0088 | TAF1 |
| 22 | −399.1194 | 2.0000 | | | | |
| 23 (diaphragm) | ∞ | (d23) | | | | |
| 24 | −242.4784 | 0.9929 | 1.90043 | 37.37 | −0.0045 | TAFD37A |
| 25 | 69.1872 | 3.2261 | 1.77047 | 29.74 | 0.0002 | NBFD29 |
| 26 | 557.9269 | (d26) | | | | |
| 27 | −444.9742 | 0.9886 | 1.98611 | 17.25 | 0.0429 | FDS165-W |
| 28 | 91.8883 | 9.0339 | | | | |
| 29 | −4839.1901 | 4.4333 | 1.78880 | 28.43 | 0.0036 | S-NBH58 |
| 30 | −34.3279 | 0.9901 | 1.45860 | 90.19 | 0.0491 | FCD10A |
| 31 | −160.4769 | (d31) | | | | |
| 32 | 97.4017 | 3.0819 | 1.43700 | 95.10 | 0.0564 | FCD100 |
| 33 | −380.6030 | 2.0000 | | | | |
| 34 | 61.2801 | 3.6181 | 1.83401 | 25.97 | 0.0059 | NBFD26 |
| 35 | −57.6888 | 1.0000 | 1.81600 | 46.62 | −0.0077 | S-LAH59 |
| 36 | 44.3884 | 1.9265 | | | | |
| 37 | −190.3855 | 0.9187 | 1.80420 | 46.50 | −0.0075 | TAF3D |
| 38 | 45.8060 | 3.5000 | | | | |
| 39 | 27.2076 | 7.3750 | 1.77047 | 29.74 | 0.0002 | NBFD29 |
| 40 | −84.2520 | 1.8062 | | | | |
| 41 | −64.6116 | 0.9463 | 2.05090 | 26.94 | 0.0052 | TAFD65 |
| 42 | 20.2347 | 8.3873 | 1.62205 | 41.08 | −0.0051 | S-NBM52 |
| 43 | −48.2366 | 2.6089 | | | | |
| 44 | −27.3064 | 1.0002 | 1.43700 | 95.10 | 0.0564 | FCD100 |
| 45 | 21.9873 | 9.9704 | 1.62205 | 41.08 | −0.0051 | S-NBM52 |
| 46 | −74.5485 | 2.5177 | | | | |
| 47 | −240.2050 | 1.1908 | 2.10200 | 23.39 | 0.0139 | TAFD75-W |
| 48 | 21.7618 | 9.4376 | 1.83401 | 25.97 | 0.0059 | NBFD26 |
| 49 | −135.0131 | (d49) | | | | |
| 50 | ∞ | 2.5400 | 1.51633 | 64.14 | 0.0023 | S-BSL7 |
| 51 | ∞ | (BF) | | | | |
| Image surface | ∞ | | | | | |

[Various types of data]

| | |
|---|---|
| Zoom ratio | 3.79 |

| | Wide angle | Middle | Telephoto |
|---|---|---|---|
| Focal length | 206.00 | 500.00 | 780.00 |
| F number | 6.44 | 7.30 | 8.22 |
| Total angle of view 2ω | 11.34 | 4.64 | 2.97 |
| Image height Y | 21.63 | 21.63 | 21.63 |
| Total lens length | 368.00 | 368.00 | 368.00 |

[Variable distance data]

| | Wide angle | Middle | Telephoto |
|---|---|---|---|
| d0 | ∞ | ∞ | ∞ |
| d7 | 7.3873 | 35.3098 | 40.7151 |
| d13 | 87.9053 | 33.7232 | 2.5000 |
| d17 | 4.1392 | 4.7883 | 4.2762 |
| d23 | 18.2125 | 10.7103 | 6.7506 |
| d26 | 7.0983 | 22.4100 | 51.2938 |
| d31 | 12.4467 | 30.2477 | 31.6538 |
| d49 | 35.8145 | 35.8145 | 35.8144 |
| BF | 1.0000 | 1.0000 | 1.0000 |
| d0 | 3500.0000 | 3500.0000 | 3500.0000 |
| d7 | 7.3873 | 35.3098 | 40.7151 |
| d13 | 87.9053 | 33.7232 | 2.5000 |
| d17 | 4.1392 | 4.7883 | 4.2762 |
| d23 | 20.7711 | 21.2915 | 27.6442 |
| d26 | 4.5399 | 11.8289 | 30.4002 |
| d31 | 12.4467 | 30.2477 | 31.6538 |
| d49 | 35.8145 | 35.8145 | 35.8144 |
| BF | 0.9999 | 1.0000 | 1.0000 |

[Lens group data]

| Group | Starting surface | Focal length |
|---|---|---|
| G1 | 1 | 211.81 |
| G2 | 8 | −48.83 |
| G3 | 14 | 6299.66 |
| G4 | 18 | 55.58 |
| G5 | 24 | −143.00 |
| G6 | 27 | 819.76 |
| G7 | 32 | −81.55 |

### Example 9

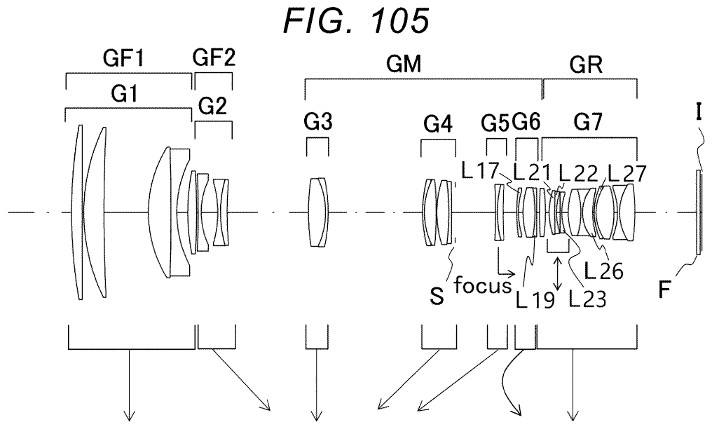

FIG. 105 is a lens configuration diagram of a variable magnification imaging optical system according to Example 9 at a wide-angle end in a case of focusing on infinity.

The variable magnification imaging optical system of FIG. 105 is composed of, in order from the object side: a first front lens group GF1 consisting of a first lens group G1 having a positive refractive power; a second front lens group GF2 consisting of a second lens group G2 having a negative refractive power; a middle group GM consisting of a third lens group G3 having a positive refractive power, a fourth lens group G4 having a positive refractive power, a fifth lens group G5 having a negative refractive power, and a sixth lens group G6 having a positive refractive power; and a subsequent group GR consisting of a seventh lens group G7 having a negative refractive power.

The first lens group G1 is composed of, in order from the object side, a biconvex lens, a meniscus positive lens having a convex surface on the object side, and a cemented lens of a biconvex lens and a biconcave lens. The second lens group G2 is composed of a biconvex lens, a biconcave lens, and a meniscus positive lens having a convex surface on the object side. The third lens group G3 is composed of a cemented lens of a biconvex lens and a meniscus negative lens having a convex surface on the image side. The fourth lens group G4 is composed of a cemented lens of a meniscus negative lens having a convex surface on the object side and a biconvex lens, a cemented lens of a biconvex lens and a meniscus negative lens having a convex surface on the image side, and an aperture diaphragm S. The fifth lens group G5 is composed of a cemented lens of a biconcave lens and a meniscus positive lens having a convex surface on the object side. The sixth lens group G6 is composed of a meniscus negative lens L17 having a convex surface on the object side, and a cemented lens of a biconvex lens and a meniscus negative lens L19 having a convex surface on the image side. The seventh lens group G7 is composed of: a biconvex lens; a cemented lens of a meniscus positive lens L21 having a convex surface on the object side and a meniscus negative lens L22 having a convex surface on the object side; a meniscus negative lens L23 having a convex surface on the object side; a cemented lens of a biconvex lens, a biconcave lens, and a meniscus positive lens L26 having a convex surface on the object side; a cemented lens of a meniscus negative lens L27 having a convex surface on the object side and a biconvex lens, and a cemented lens of a biconcave lens and a biconvex lens. In addition, the seventh lens group G7 can also function as a vibration reduction group by moving L21 to L23 as one body in a direction substantially perpendicular to the optical axis, but lenses other than L21 to L23 may also function as a vibration reduction group.

During magnification change from the wide-angle end to the telephoto end, the first lens group G1, the third lens group G3, and the seventh lens group G7 are fixed with respect to the image surface, the second lens group G2 moves toward the image side, the fourth lens group G4 and the fifth lens group G5 move toward the object side along different trajectories, the sixth lens group G6 moves toward the object side and then moves toward the image side, a distance between the first lens group G1 and the second lens group G2 increases, a distance between the second lens group G2 and the third lens group G3 decreases, a distance between the third lens group G3 and the fourth lens group G4 decreases, a distance between the fourth lens group G4 and the fifth lens group G5 decreases and then increases, and the spacing is smaller at the telephoto end than at the wide-angle end, a distance between the fifth lens group G5 and the sixth lens group G6 increases, a distance between the sixth lens group G6 and the seventh lens group G7 increases and then decreases, and the spacings at the wide-angle end and the telephoto end are equal, and during focusing from the infinite distance object to the close distance object, the fifth lens group G5 moves toward the image side.

The lenses on the image side from L17 of the sixth lens group G6 are lenses that are incident on a higher position than an axial marginal ray incident on the lens surface on the object side among off-axis principal rays at the telephoto end at infinity. Therefore, in the variable magnification imaging optical system according to Example 9, Lb is L17.
L26 is a lens satisfying Conditional Expressions (11) and (12).
L17, L19, and L27 are lenses satisfying Conditional Expression (13).
L19 and L27 are lenses satisfying Conditional Expression (14).
L27 is a lens satisfying Conditional Expression (15).

The following shows numerical values of the variable magnification imaging optical system according to Example 9.

### Numerical Example 9

Unit: mm
[Surface data]

| | | | | | | Corresponding |
|---|---|---|---|---|---|---|
| Surface number | r | d | nd | vd | ΔPgF | glass material |
| Object surface | ∞ | (d0) | | | | |
| 1 | 279.8048 | 5.7974 | 1.48749 | 70.23 | 0.0080 | S-FSL5 |
| 2 | 309429.5119 | 0.8207 | | | | |
| 3 | 105.5074 | 10.8893 | 1.55032 | 75.50 | 0.0274 | FCD705 |
| 4 | 936.4672 | 23.9802 | | | | |
| 5 | 67.4213 | 12.2168 | 1.49700 | 81.61 | 0.0373 | FCD1 |
| 6 | −1004.1784 | 3.1068 | 1.62205 | 41.08 | −0.0051 | S-NBM52 |
| 7 | 62.8995 | (d7) | | | | |
| 8 | 122.4774 | 4.6983 | 1.90110 | 27.06 | 0.0074 | NBFD27 |
| 9 | −376.7572 | 0.8611 | | | | |
| 10 | −457.6120 | 1.6500 | 1.72916 | 54.54 | −0.0049 | TAC8P |
| 11 | 41.7465 | 8.8918 | | | | |
| 12 | −60.9658 | 1.5464 | 1.76385 | 48.49 | −0.0022 | S-LAH96 |
| 13 | 68.8763 | 3.5758 | 1.83401 | 25.97 | 0.0059 | NBFD26 |
| 14 | 207.9474 | (d14) | | | | |
| 15 | 126.6742 | 9.1665 | 1.43700 | 95.10 | 0.0564 | FCD100 |
| 16 | −43.4723 | 1.4083 | 1.55298 | 55.07 | −0.0046 | J-KZFH4 |
| 17 | −89.7651 | (d17) | | | | |
| 18 | 71.6144 | 1.0000 | 1.77250 | 49.63 | −0.0088 | TAF1 |
| 19 | 41.3505 | 6.3682 | 1.49700 | 81.61 | 0.0373 | FCD1 |
| 20 | −179.3354 | 0.3000 | | | | |
| 21 | 58.5205 | 6.4572 | 1.43700 | 95.10 | 0.0564 | FCD100 |
| 22 | −131.1592 | 1.4820 | 1.77250 | 49.63 | −0.0088 | TAF1 |
| 23 | −745.2553 | 2.0000 | | | | |
| 24 (diaphragm) | ∞ | (d24) | | | | |
| 25 | −354.0061 | 1.0000 | 1.95375 | 32.32 | −0.0002 | TAFD45 |
| 26 | 63.5232 | 3.1935 | 1.78880 | 28.43 | 0.0036 | S-NBH58 |
| 27 | 246.7411 | (d27) | | | | |
| 28 | 95.6342 | 0.9675 | 1.98611 | 17.25 | 0.0429 | FDS165-W |
| 29 | 43.4943 | 2.4344 | | | | |
| 30 | 46.0415 | 6.4072 | 1.77047 | 29.74 | 0.0002 | NBFD29 |
| 31 | −71.3253 | 0.9802 | 1.45860 | 90.19 | 0.0491 | FCD10A |
| 32 | −524.5695 | (d32) | | | | |
| 33 | 244.8111 | 3.1664 | 1.43700 | 95.10 | 0.0564 | FCD100 |
| 34 | −97.2553 | 2.0000 | | | | |
| 35 | 37.9648 | 2.9341 | 1.85451 | 25.15 | 0.0071 | NBFD25 |
| 36 | 293.6146 | 1.0000 | 1.77250 | 49.63 | −0.0088 | TAF1 |
| 37 | 34.1644 | 1.9486 | | | | |
| 38 | 13178.5863 | 0.9017 | 1.85150 | 40.78 | −0.0055 | SLAH89 |
| 39 | 30.4388 | 3.5000 | | | | |
| 40 | 40.2490 | 6.7652 | 1.64769 | 33.84 | 0.0049 | E-FD2 |
| 41 | −43.4944 | 0.9424 | 1.90525 | 35.04 | −0.0005 | S-LAH93 |
| 42 | 22.7594 | 5.2688 | 1.65253 | 39.48 | −0.0042 | NBFD38 |
| 43 | 45.0029 | 0.8095 | | | | |
| 44 | 34.8984 | 1.0000 | 1.43700 | 95.10 | 0.0564 | FCD100 |
| 45 | 25.5255 | 9.8507 | 1.73037 | 32.23 | −0.0005 | NBFD32 |
| 46 | −43.6746 | 1.8161 | | | | |
| 47 | −36.0529 | 1.1920 | 2.05090 | 26.94 | 0.0052 | TAFD65 |
| 48 | 28.5325 | 8.2094 | 1.85451 | 25.15 | 0.0071 | NBFD25 |
| 49 | −113.8406 | (d49) | | | | |
| 50 | ∞ | 1.8750 | 1.51633 | 64.14 | 0.0023 | S-BSL7 |
| 51 | ∞ | (BF) | | | | |
| Image surface | ∞ | | | | | |

[Various types of data]
Zoom ratio 3.74

| | Wide angle | Middle | Telephoto |
|---|---|---|---|
| Focal length | 154.50 | 375.00 | 577.80 |
| F number | 5.73 | 5.79 | 6.47 |
| Total angle of view 2ω | 15.31 | 6.31 | 4.06 |
| Image height Y | 21.63 | 21.63 | 21.63 |
| Total lens length | 340.00 | 340.00 | 340.00 |

[Variable distance data]

| | Wide angle | Middle | Telephoto |
|---|---|---|---|
| d0 | ∞ | ∞ | ∞ |
| d7 | 5.9865 | 39.7556 | 47.4036 |
| d14 | 43.9172 | 10.1482 | 2.5000 |
| d17 | 50.9746 | 27.8162 | 2.3500 |
| d24 | 21.6439 | 4.5886 | 7.0152 |
| d27 | 7.3895 | 30.9543 | 70.6428 |
| d32 | 1.5000 | 18.1487 | 1.5000 |
| d49 | 33.2087 | 33.2089 | 33.2088 |
| BF | 1.0000 | 1.0000 | 1.0000 |
| d0 | 2600.0000 | 2600.0000 | 2600.0000 |
| d7 | 5.9865 | 39.7556 | 47.4036 |
| d14 | 43.9172 | 10.1482 | 2.5000 |
| d17 | 50.9746 | 27.8162 | 2.3500 |
| d24 | 24.7336 | 19.3906 | 33.6994 |
| d27 | 4.3000 | 16.1522 | 43.9585 |
| d32 | 1.5000 | 18.1487 | 1.5000 |
| d49 | 33.2087 | 33.2089 | 33.2088 |
| BF | 0.9999 | 1.0000 | 1.0001 |

[Lens group data]

| Group | Starting surface | Focal length |
|---|---|---|
| G1 | 1 | 181.98 |
| G2 | 8 | −39.81 |
| G3 | 15 | 145.76 |
| G4 | 18 | 78.44 |
| G5 | 25 | −117.29 |
| G6 | 28 | 98.23 |
| G7 | 33 | −49.57 |

### Example 10

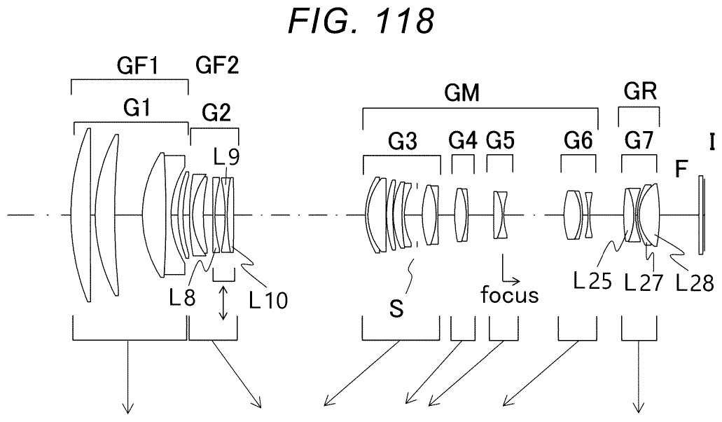

FIG. 118 is a lens configuration diagram of a variable magnification imaging optical system according to Example 10 at a wide-angle end in a case of focusing on infinity.

The variable magnification imaging optical system of FIG. 118 is composed of, in order from the object side: a first front lens group GF1 consisting of a first lens group G1 having a positive refractive power; a second front lens group GF2 consisting of a second lens group G2 having a negative refractive power; a middle group GM consisting of a third lens group G3 having a positive refractive power, a fourth lens group G4 having a positive refractive power, a fifth lens group G5 having a negative refractive power, and a sixth lens group G6 having a positive refractive power; and a subsequent group GR consisting of a seventh lens group G7 having a negative refractive power.

The first lens group G1 is composed of, in order from the object side, a meniscus positive lens having a convex surface on the object side, a meniscus positive lens having a convex surface on the object side, and a cemented lens of a biconvex lens and a biconcave lens. The second lens group G2 is composed of a meniscus positive lens having a convex surface on the object side, a meniscus negative lens having a convex surface on the object side, a cemented lens of a meniscus positive lens having a convex surface on the object side and a meniscus negative lens having a convex surface on the object side, a meniscus negative lens L8 having a convex surface on the object side, and a cemented lens of a biconcave lens L9 and a biconvex lens L10. In addition, the second lens group G2 can also function as a vibration reduction group by moving L8 to L10 as one body in a direction substantially perpendicular to the optical axis, but lenses other than L8 to L10 may also function as a vibration reduction group. The third lens group G3 is composed of a cemented lens of a meniscus negative lens having a convex surface on the object side and a biconvex lens, a meniscus positive lens having a convex surface on the object side, a cemented lens of a meniscus positive lens having a convex surface on the object side and a meniscus negative lens having a convex surface on the object side, an aperture diaphragm S, and a cemented lens of a biconvex lens and a biconcave lens. The fourth lens group G4 is composed of a cemented lens of a biconvex lens and a meniscus negative lens having a convex surface on the image side. The fifth lens group G5 is composed of a cemented lens of a biconvex lens and a biconcave lens. The sixth lens group G6 is composed of a cemented lens of a biconvex lens and a meniscus negative lens having a convex surface on the image side, and a biconcave lens. The seventh lens group G7 is composed of a cemented lens of a biconvex lens L25 and a biconcave lens, a cemented lens of a meniscus negative lens L27 having a convex surface on the object side and a biconvex lens L28.

During magnification change from the wide-angle end to the telephoto end, the first lens group G1 and the seventh lens group G7 are fixed with respect to the image surface, the second lens group G2 moves toward the image side, the third lens group G3 to the sixth lens group G6 move toward the object side along different trajectories, a distance between the first lens group G1 and the second lens group G2 increases, a distance between the second lens group G2 and the third lens group G3 decreases, a distance between the third lens group G3 and the fourth lens group G4 increases, a distance between the fourth lens group G4 and the fifth lens group G5 decreases, a distance between the fifth lens group G5 and the sixth lens group G6 increases and then decreases, and the spacing is larger at the telephoto end than at the wide-angle end, a distance between the sixth lens group G6 and the seventh lens group G7 increases, and during focusing from the infinite distance object to the close distance object, the fifth lens group G5 moves toward the image side.

The lenses on the image side from L25 of the seventh lens group G7 are lenses that are incident on a higher position than an axial marginal ray incident on the lens surface on the object side among off-axis principal rays at the telephoto end at infinity. Therefore, in the variable magnification imaging optical system according to Example 10, Lb is L25.
L25 and L28 are lenses satisfying Conditional Expressions (11) and (12).
L27 is a lens satisfying Conditional Expression (13).
L27 is a lens satisfying Conditional Expression (14).
L27 is a lens satisfying Conditional Expression (15).

The following shows numerical values of the variable magnification imaging optical system according to Example 10.

### Numerical Example 10

Unit: mm
[Surface data]

| | | | | | | Corresponding |
|---|---|---|---|---|---|---|
| Surface number | r | d | nd | vd | ΔPgF | glass material |
| Object surface | ∞ | (d0) | | | | |
| 1 | 136.3087 | 11.3082 | 1.59349 | 67.00 | 0.0088 | PCD51 |
| 2 | 10335.6078 | 2.8833 | | | | |
| 3 | 99.6684 | 11.3720 | 1.43700 | 95.10 | 0.0564 | FCD100 |
| 4 | 446.0673 | 16.1872 | | | | |
| 5 | 67.0849 | 13.7184 | 1.43700 | 95.10 | 0.0564 | FCD100 |
| 6 | −573.6097 | 3.0033 | 1.61396 | 44.29 | −0.0055 | LAF45 |
| 7 | 53.4021 | (d7) | | | | |
| 8 | 70.0247 | 2.9521 | 1.60738 | 56.81 | 0.0022 | S-BSM2 |
| 9 | 81.0821 | 3.7742 | | | | |
| 10 | 135.7381 | 1.8694 | 1.77250 | 49.60 | −0.0071 | S-LAH66 |
| 11 | 39.8101 | 6.2618 | 1.58267 | 46.42 | 0.0023 | S-BAM3 |
| 12 | 95.1909 | 5.5181 | | | | |
| 13 | 7010.8053 | 1.2493 | 1.59349 | 67.00 | 0.0088 | PCD51 |
| 14 | 78.1153 | 5.9348 | | | | |
| 15 | −96.1889 | 1.2479 | 1.75700 | 47.82 | −0.0058 | S-LAM54 |
| 16 | 134.7524 | 3.7318 | 1.83401 | 25.97 | 0.0059 | NBFD26 |
| 17 | −1083.8288 | (d17) | | | | |
| 18 | 43.5288 | 1.4481 | 1.78800 | 47.37 | −0.0072 | S-LAH64 |
| 19 | 33.1707 | 10.5418 | 1.55397 | 71.76 | 0.0200 | FCD500 |
| 20 | −3941.9432 | 0.3000 | | | | |
| 21 | 63.0915 | 3.6382 | 1.43700 | 95.10 | 0.0564 | FCD100 |
| 22 | 108.4078 | 0.3000 | | | | |
| 23 | 44.7794 | 5.0884 | 1.43700 | 95.10 | 0.0564 | FCD100 |
| 24 | 123.7045 | 1.3697 | 1.85883 | 30.00 | 0.0035 | NBFD30 |
| 25 | 35.6559 | 7.4508 | | | | |
| 26(diaphragm) | ∞ | 3.0000 | | | | |
| 27 | 54.0747 | 8.0960 | 1.62004 | 36.30 | 0.0042 | E-F2 |
| 28 | −46.4236 | 1.0000 | 1.91082 | 35.25 | −0.0017 | TAFD35L |
| 29 | 457.4376 | (d29) | | | | |
| 30 | 79.2028 | 6.6819 | 1.60342 | 38.01 | 0.0028 | E-F5 |
| 31 | −43.3523 | 1.1301 | 1.74100 | 52.64 | −0.0070 | S-LAL61 |
| 32 | −157.5083 | (d32) | | | | |
| 33 | 835.1136 | 4.8882 | 1.77047 | 29.74 | 0.0002 | NBFD29 |
| 34 | −32.2025 | 1.0000 | 1.75500 | 52.32 | −0.0069 | TAC6 |
| 35 | 39.5585 | (d35) | | | | |
| 36 | 47.3599 | 9.5722 | 1.67300 | 38.26 | −0.0038 | S-NBH52V |
| 37 | −29.9048 | 1.1976 | 1.86074 | 23.08 | 0.0189 | J-SFH2 |
| 38 | −48.1910 | 3.1890 | | | | |
| 39 | −51.1964 | 1.0000 | 1.59282 | 68.62 | 0.0192 | FCD515 |
| 40 | 55.7269 | (d40) | | | | |
| 41 | 105.1339 | 5.8951 | 1.61396 | 44.29 | −0.0055 | LAF45 |
| 42 | −39.6385 | 1.0000 | 2.00100 | 29.14 | 0.0037 | S-LAH99W |
| 43 | 39.9290 | 1.1293 | | | | |
| 44 | 37.0648 | 1.0000 | 1.59522 | 67.74 | 0.0177 | S-FPM2 |
| 45 | 23.1373 | 11.7705 | 1.55298 | 55.07 | −0.0046 | J-KZFH4 |
| 46 | −105.8797 | (d46) | | | | |
| 47 | ∞ | 2.3300 | 1.51633 | 64.14 | 0.0023 | S-BSL7 |
| 48 | ∞ | (BF) | | | | |
| Image surface | ∞ | | | | | |

[Various types of data]
Zoom ratio 2.52

| | Wide angle | Middle | Telephoto |
|---|---|---|---|
| Focal length | 309.00 | 550.00 | 780.00 |
| F number | 6.37 | 7.36 | 8.22 |
| Total angle of view 2ω | 7.77 | 4.35 | 3.06 |
| Image height Y | 21.63 | 21.63 | 21.63 |
| Total lens length | 370.00 | 370.00 | 370.00 |

[Variable distance data]

| | Wide angle | Middle | Telephoto |
|---|---|---|---|
| d0 | ∞ | ∞ | ∞ |
| d7 | 4.0007 | 16.3822 | 20.9451 |
| d17 | 76.9842 | 34.0939 | 3.0000 |
| d29 | 9.8748 | 17.3034 | 23.3080 |
| d32 | 15.1269 | 8.0290 | 3.4060 |
| d35 | 35.0169 | 36.4722 | 35.7207 |
| d40 | 20.0000 | 48.7230 | 74.6239 |
| d46 | 22.9682 | 22.9682 | 22.9682 |
| BF | 1.0000 | 1.0000 | 0.9999 |
| d0 | 3500.0000 | 3500.0000 | 3500.0000 |
| d7 | 4.0007 | 16.3822 | 20.9451 |
| d17 | 76.9842 | 34.0939 | 3.0000 |
| d29 | 9.8748 | 17.3034 | 23.3080 |
| d32 | 19.0045 | 17.1863 | 18.9926 |
| d35 | 31.1393 | 27.3150 | 20.1342 |
| d40 | 20.0000 | 48.7230 | 74.6239 |
| d46 | 22.9682 | 22.9682 | 22.9682 |
| BF | 1.0000 | 1.0000 | 0.9999 |

[Lens group data]

| Group | Starting surface | Focal length |
|---|---|---|
| G1 | 1 | 190.30 |
| G2 | 8 | −55.93 |
| G3 | 18 | 103.77 |
| G4 | 30 | 110.05 |
| G5 | 33 | −56.75 |
| G6 | 36 | 158.25 |
| G7 | 41 | −124.64 |

### Example 11

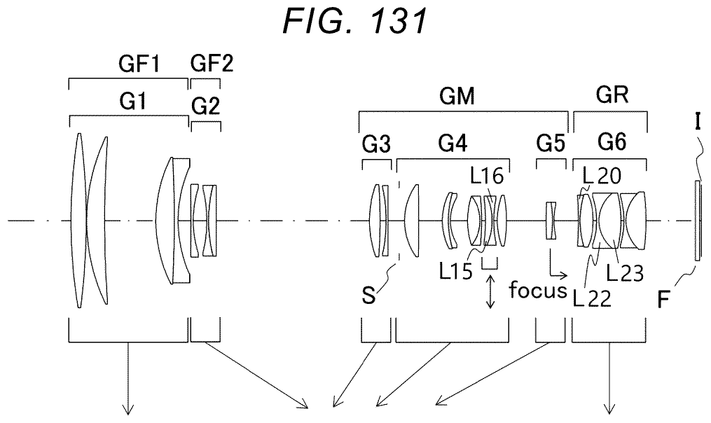

FIG. 131 is a lens configuration diagram of a variable magnification imaging optical system according to Example 11 at a wide-angle end in a case of focusing on infinity.

The variable magnification imaging optical system of FIG. 131 is composed of, in order from the object side: a first front lens group GF1 consisting of a first lens group G1 having a positive refractive power; a second front lens group GF2 consisting of a second lens group G2 having a negative refractive power; a middle group GM consisting of a third lens group G3 having a positive refractive power, a fourth lens group G4 having a positive refractive power, and a fifth lens group G5 having a negative refractive power; and a subsequent group GR consisting of a sixth lens group G6 having a negative refractive power.

The first lens group G1 is composed of, in order from the object side, a biconvex lens, a meniscus positive lens having a convex surface on the object side, and a cemented lens of a biconvex lens and a biconcave lens. The second lens group G2 is composed of a plano-concave lens having a plane surface facing the object side, and a cemented lens of a biconcave lens and a meniscus positive lens having a convex surface facing the object side. The third lens group G3 is composed of a biconvex lens, and a plano-concave lens having a plane facing the image side. The fourth lens group G4 is composed of an aperture diaphragm S, a biconvex lens, a cemented lens of a meniscus positive lens having a convex surface on the object side and a meniscus negative lens having a convex surface on the object side, a cemented lens of a biconvex lens and a meniscus negative lens having a convex surface on the image side, a cemented lens of a meniscus positive lens L15 having a convex surface on the image side and a biconcave lens L16, and a biconvex lens. In addition, the fourth lens group G4 can also function as a vibration reduction group by moving L15 to L16 as one body in a direction substantially perpendicular to the optical axis, but lenses other than L15 to L16 may also function as a vibration reduction group. The fifth lens group G5 is composed of a cemented lens of a biconvex lens and a biconcave lens. The sixth lens group G6 is composed of a cemented lens of a biconcave lens L20 and a biconvex lens, a cemented lens of a biconcave lens L22 and a biconvex lens L23, and a cemented lens of a biconcave lens and a biconvex lens.

During magnification change from the wide-angle end to the telephoto end, the first lens group G1 and the sixth lens group G6 are fixed with respect to the image surface, the second lens group G2 moves toward the image side, the third lens group G3 to the fifth lens group G5 move toward the object side along different trajectories, a distance between the first lens group G1 and the second lens group G2 increases, a distance between the second lens group G2 and the third lens group G3 decreases, a distance between the third lens group G3 and the fourth lens group G4 decreases, a distance between the fourth lens group G4 and the fifth lens group G5 decreases, a distance between the fifth lens group G5 and the sixth lens group G6 increases, and during focusing from the infinite distance object to the close distance object, the fifth lens group G5 moves toward the image side.

The lenses on the image side from L20 of the sixth lens group G6 are lenses that are incident on a higher position than an axial marginal ray incident on the lens surface on the object side among off-axis principal rays at the telephoto end at infinity. Therefore, in the variable magnification imaging optical system according to Example 11, Lb is L20.
L23 is a lens satisfying Conditional Expressions (11) and (12).
L22 is a lens satisfying Conditional Expression (13).
L22 is a lens satisfying Conditional Expression (14).
L22 is a lens satisfying Conditional Expression (15).

The following shows numerical values of the variable magnification imaging optical system according to Example 11.

### Numerical Example 11

Unit: mm
[Surface data]

| | | | | | | Corresponding |
|---|---|---|---|---|---|---|
| Surface number | r | d | nd | vd | ΔPgF | glass material |
| Object surface | ∞ | (d0) | | | | |
| 1 | 310.9575 | 8.6573 | 1.48749 | 70.44 | 0.0090 | FC5 |
| 2 | −395.6109 | 0.3000 | | | | |
| 3 | 110.9472 | 10.2433 | 1.43700 | 95.10 | 0.0564 | FCD100 |
| 4 | 662.1609 | 29.2865 | | | | |
| 5 | 81.4378 | 10.5019 | 1.43700 | 95.10 | 0.0564 | FCD100 |
| 6 | −695.8227 | 2.2006 | 1.62205 | 41.08 | −0.0051 | S-NBM52 |
| 7 | 75.9984 | (d7) | | | | |
| 8 | ∞ | 1.2954 | 1.59349 | 67.00 | 0.0088 | PCD51 |
| 9 | 62.2566 | 7.7361 | | | | |
| 10 | −78.1643 | 1.0000 | 1.64000 | 60.08 | −0.0033 | S-BSM81 |
| 11 | 82.0257 | 4.3370 | 1.90110 | 27.06 | 0.0074 | NBFD27 |
| 12 | 2440.1304 | (d12) | | | | |
| 13 | 62.4455 | 6.0194 | 1.59410 | 60.47 | 0.0156 | FCD600 |
| 14 | −280.0447 | 3.4089 | | | | |
| 15 | −90.7342 | 1.1855 | 1.80440 | 39.58 | −0.0010 | S-LAH63Q |
| 16 | ∞ | (d16) | | | | |
| 17(diaphragm) | ∞ | 3.0000 | | | | |
| 18 | 36.1229 | 8.0687 | 1.45860 | 90.19 | 0.0491 | FCD10A |
| 19 | −1105.6516 | 13.4720 | | | | |
| 20 | 35.5502 | 3.4158 | 1.50137 | 56.42 | 0.0064 | S-FTL10 |
| 21 | 56.8132 | 1.1949 | 1.91650 | 31.60 | −0.0004 | S-LAH88 |
| 22 | 26.6211 | 9.7970 | | | | |
| 23 | 47.3046 | 7.1937 | 1.60342 | 38.01 | 0.0028 | E-F5 |
| 24 | −22.3770 | 0.9996 | 1.95375 | 32.32 | 0.0003 | S-LAH98 |
| 25 | −140.9779 | 2.1780 | | | | |
| 26 | −101.6730 | 3.7424 | 1.79360 | 37.09 | 0.0011 | S-LAM73 |
| 27 | −35.2877 | 0.9971 | 1.65160 | 58.54 | −0.0041 | S-LAL7Q |
| 28 | 66.5819 | 2.0000 | | | | |
| 29 | 43.5738 | 5.2229 | 1.54814 | 45.82 | 0.0040 | E-FEL1 |
| 30 | −76.6843 | (d30) | | | | |
| 31 | 257.7943 | 3.6174 | 1.71736 | 29.50 | 0.0087 | E-FD1L |
| 32 | −66.7231 | 0.8985 | 1.72916 | 54.68 | −0.0055 | S-LAL18 |
| 33 | 42.1740 | (d33) | | | | |
| 34 | −191.3918 | 0.9493 | 2.10200 | 23.38 | 0.0139 | TAFD75-W |
| 35 | 52.5040 | 7.6105 | 1.77047 | 29.74 | 0.0002 | NBFD29 |
| 36 | −38.1071 | 2.0000 | | | | |
| 37 | −42.4202 | 1.3797 | 1.43700 | 95.10 | 0.0564 | FCD100 |
| 38 | 20.2530 | 12.5202 | 1.62205 | 41.08 | −0.0051 | S-NBM52 |
| 39 | −65.7975 | 1.6982 | | | | |
| 40 | −49.8807 | 1.2001 | 2.00100 | 29.13 | 0.0035 | TAFD55-W |
| 41 | 21.9871 | 11.4671 | 1.77047 | 29.74 | 0.0002 | NBFD29 |
| 42 | −122.7330 | (d42) | | | | |
| 43 | ∞ | 2.3700 | 1.51633 | 64.14 | 0.0023 | S-BSL7 |
| 44 | ∞ | (BF) | | | | |
| Image surface | ∞ | | | | | |

[Various types of data]
Zoom ratio 3.78

| | Wide angle | Middle | Telephoto |
|---|---|---|---|
| Focal length | 206.00 | 500.00 | 778.00 |
| F number | 6.16 | 7.01 | 8.19 |
| Total angle of view 2ω | 11.40 | 4.70 | 3.04 |
| Image height Y | 21.63 | 21.63 | 21.63 |
| Total lens length | 360.00 | 360.00 | 360.00 |

[Variable distance data]

| | Wide angle | Middle | Telephoto |
|---|---|---|---|
| d0 | ∞ | ∞ | ∞ |
| d7 | 7.1377 | 50.1624 | 61.3669 |
| d12 | 87.6599 | 33.2788 | 1.5000 |
| d16 | 6.3072 | 4.0947 | 1.5000 |
| d30 | 22.5625 | 13.6852 | 3.0000 |
| d33 | 13.9114 | 36.3576 | 70.2118 |
| d42 | 28.2592 | 28.2592 | 28.2592 |
| BF | 1.0000 | 1.0000 | 1.0000 |
| d0 | 3200.0000 | 3200.0000 | 3200.0000 |
| d7 | 7.1377 | 50.1624 | 61.3669 |
| d12 | 87.6599 | 33.2788 | 1.5000 |
| d16 | 6.3072 | 4.0947 | 1.5000 |
| d30 | 25.9487 | 27.0446 | 24.5000 |
| d33 | 10.5252 | 22.9982 | 48.7118 |
| d42 | 28.2592 | 28.2592 | 28.2592 |
| BF | 1.0000 | 1.0000 | 1.0000 |

[Lens group data]

| Group | Starting surface | Focal length |
|---|---|---|
| G1 | 1 | 224.90 |
| G2 | 8 | −65.43 |
| G3 | 13 | 297.48 |
| G4 | 17 | 88.44 |
| G5 | 31 | −68.69 |
| G6 | 34 | −190.95 |

### Example 12

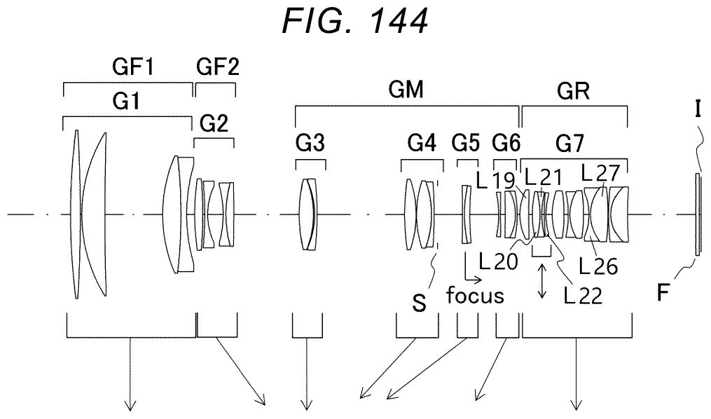

FIG. 144 is a lens configuration diagram of a variable magnification imaging optical system according to Example 12 at a wide-angle end in a case of focusing on infinity.

The variable magnification imaging optical system of FIG. 144 is composed of, in order from the object side: a first front lens group GF1 consisting of a first lens group G1 having a positive refractive power; a second front lens group GF2 consisting of a second lens group G2 having a negative refractive power; a middle group GM consisting of a third lens group G3 having a positive refractive power, a fourth lens group G4 having a positive refractive power, a fifth lens group G5 having a negative refractive power, and a sixth lens group G6 having a negative refractive power; and a subsequent group GR consisting of a seventh lens group G7 having a negative refractive power.

The first lens group G1 is composed of, in order from the object side, a biconvex lens, a meniscus positive lens having a convex surface on the object side, and a cemented lens of a biconvex lens and a biconcave lens. The second lens group G2 is composed of a biconvex lens, a biconcave lens, and a cemented lens of a biconcave lens and a biconvex lens. The third lens group G3 is composed of a biconvex lens and a meniscus negative lens having a convex surface on the image side. The fourth lens group G4 is composed of a biconvex lens, a cemented lens of a biconvex lens and a meniscus negative lens having a convex surface on the image side, and an aperture diaphragm S. The fifth lens group G5 is composed of a cemented lens of a biconcave lens and a meniscus positive lens having a convex surface on the object side. The sixth lens group G6 is composed of a biconcave lens, a biconvex lens, and a cemented lens of a meniscus negative lens having a convex surface on the image side. The seventh lens group G7 is composed of a meniscus positive lens L19 having a convex surface on the object side, a cemented lens of a biconvex lens L20 and a biconcave lens L21, a meniscus negative lens L22 having a convex surface on the object side, a biconvex lens, a cemented lens of a biconcave lens and a biconvex lens, a cemented lens of a biconcave lens L26 and a biconvex lens L27, and a cemented lens of a meniscus negative lens having a convex surface on the object side and a meniscus positive lens having a convex surface on the object side. In addition, the seventh lens group G7 can also function as a vibration reduction group by moving L20 to L22 as one body in a direction substantially perpendicular to the optical axis, but lenses other than L20 to L22 may also function as a vibration reduction group.

During magnification change from the wide-angle end to the telephoto end, the first lens group G1, the third lens group G3, and the seventh lens group G7 are fixed with respect to the image surface, the second lens group G2 moves toward the image side, the fourth lens group G4 to the sixth lens group G6 move toward the object side along different trajectories, a distance between the first lens group G1 and the second lens group G2 increases, a distance between the second lens group G2 and the third lens group G3 decreases, a distance between the third lens group G3 and the fourth lens group G4 decreases, a distance between the fourth lens group G4 and the fifth lens group G5 decreases, a distance between the fifth lens group G5 and the sixth lens group G6 increases, a distance between the sixth lens group G6 and the seventh lens group G7 increases, and during focusing from the infinite distance object to the close distance object, the fifth lens group G5 moves toward the image side.

The lenses on the image side from L19 of the seventh lens group G7 are lenses that are incident on a higher position than an axial marginal ray incident on the lens surface on the object side among off-axis principal rays at the telephoto end at infinity. Therefore, in the variable magnification imaging optical system according to Example 12, Lb is L19.
L27 is a lens satisfying Conditional Expressions (11) and (12).
L26 is a lens satisfying Conditional Expression (13).
L26 is a lens satisfying Conditional Expression (14).
L26 is a lens satisfying Conditional Expression (15).

The following shows numerical values of the variable magnification imaging optical system according to Example 12.

### Numerical Example 12

Unit: mm
[Surface data]

| | | | | | | Corresponding |
|---|---|---|---|---|---|---|
| Surface number | r | d | nd | vd | ΔPgF | glass material |
| Object surface | ∞ | (d0) | | | | |
| 1 | 381.6937 | 5.4208 | 1.48749 | 70.23 | 0.0080 | S-FSL5 |
| 2 | −768.7037 | 0.8164 | | | | |
| 3 | 87.0104 | 12.8059 | 1.43700 | 95.10 | 0.0564 | FCD100 |
| 4 | 1327.4238 | 31.9490 | | | | |
| 5 | 82.5286 | 10.1990 | 1.43700 | 95.10 | 0.0564 | FCD100 |
| 6 | −278.3691 | 3.1486 | 1.65412 | 39.68 | −0.0033 | S-NBH5 |
| 7 | 98.8473 | (d7) | | | | |
| 8 | 141.3170 | 4.4507 | 1.85451 | 25.15 | 0.0071 | NBFD25 |
| 9 | −250.6183 | 1.0980 | | | | |
| 10 | −206.6007 | 1.6500 | 1.76385 | 48.49 | −0.0022 | S-LAH96 |
| 11 | 37.4153 | 8.5912 | | | | |
| 12 | −59.9735 | 1.5647 | 1.77250 | 49.63 | −0.0088 | TAF1 |
| 13 | 67.2418 | 4.3493 | 1.83401 | 25.97 | 0.0059 | NBFD26 |
| 14 | −944.6871 | (d14) | | | | |
| 15 | 92.3843 | 7.7061 | 1.43700 | 95.10 | 0.0564 | FCD100 |
| 16 | −53.5530 | 0.6240 | | | | |
| 17 | −46.5671 | 1.4297 | 1.55298 | 55.07 | −0.0046 | J-KZFH4 |
| 18 | −181.4996 | (d18) | | | | |
| 19 | 138.2342 | 6.3284 | 1.49700 | 81.61 | 0.0373 | FCD1 |
| 20 | −61.4583 | 0.3000 | | | | |
| 21 | 61.1461 | 8.2882 | 1.43700 | 95.10 | 0.0564 | FCD100 |
| 22 | −53.5504 | 1.4912 | 1.77250 | 49.63 | −0.0088 | TAF1 |
| 23 | −235.8931 | 2.0000 | | | | |
| 24 (diaphragm) | ∞ | (d24) | | | | |
| 25 | −759.8681 | 1.1013 | 1.90043 | 37.37 | −0.0045 | TAFD37A |
| 26 | 78.4480 | 3.0069 | 1.78880 | 28.43 | 0.0036 | S-NBH58 |
| 27 | 189.5489 | (d27) | | | | |
| 28 | −54.0139 | 0.9728 | 1.94594 | 17.98 | 0.0385 | FDS18-W |
| 29 | 565.7354 | 2.6619 | | | | |
| 30 | −378.7107 | 5.6158 | 1.77047 | 29.74 | 0.0002 | NBFD29 |
| 31 | −27.6787 | 0.9784 | 1.45860 | 90.19 | 0.0491 | FCD10A |
| 32 | −68.4666 | (d32) | | | | |
| 33 | 30.8953 | 4.8936 | 1.43700 | 95.10 | 0.0564 | FCD100 |
| 34 | 447.2740 | 2.0000 | | | | |
| 35 | 60.5133 | 4.2089 | 1.83401 | 25.97 | 0.0059 | NBFD26 |
| 36 | −51.9498 | 1.0000 | 1.90525 | 35.04 | −0.0005 | S-LAH93 |
| 37 | 46.4061 | 1.4174 | | | | |
| 38 | 167.8024 | 0.9055 | 1.77250 | 49.63 | −0.0088 | TAF1 |
| 39 | 39.2287 | 3.5000 | | | | |
| 40 | 39.9406 | 6.5423 | 1.62423 | 30.05 | 0.0284 | FD300 |
| 41 | −87.5491 | 2.3492 | | | | |
| 42 | −57.8731 | 0.9423 | 1.95375 | 32.32 | −0.0002 | TAFD45 |
| 43 | 25.3631 | 7.5489 | 1.68960 | 31.14 | 0.0108 | E-FD80 |
| 44 | −87.0461 | 3.0430 | | | | |
| 45 | −31.3583 | 1.0000 | 1.43700 | 95.10 | 0.0564 | FCD100 |
| 46 | 24.1054 | 9.7118 | 1.62205 | 41.08 | −0.0051 | S-NBM52 |
| 47 | −121.0552 | 0.3000 | | | | |
| 48 | 134.8331 | 1.1954 | 2.10200 | 23.38 | 0.0139 | TAFD75W |
| 49 | 20.5031 | 9.1687 | 1.90110 | 27.06 | 0.0074 | NBFD27 |
| 50 | 217.0457 | (d50) | | | | |
| 51 | ∞ | 1.8750 | 1.51633 | 64.14 | 0.0023 | S-BSL7 |
| 52 | ∞ | (BF) | | | | |
| Image surface | ∞ | | | | | |

[Various types of data]
Zoom ratio 3.74

| | Wide angle | Middle | Telephoto |
|---|---|---|---|
| Focal length | 154.50 | 375.00 | 577.80 |
| F number | 5.08 | 5.83 | 6.48 |
| Total angle of view 2ω | 15.37 | 6.34 | 4.10 |
| Image height Y | 21.63 | 21.63 | 21.63 |
| Total lens length | 350.00 | 350.00 | 350.00 |

[Variable distance data]

| | Wide angle | Middle | Telephoto |
|---|---|---|---|
| d0 | ∞ | ∞ | ∞ |
| d7 | 4.4868 | 31.3565 | 38.4356 |
| d14 | 36.4489 | 9.5795 | 2.5000 |
| d18 | 48.6674 | 26.6260 | 2.3500 |
| d24 | 13.7390 | 13.0457 | 4.4537 |
| d27 | 16.1572 | 18.8716 | 40.7292 |
| d32 | 1.5000 | 21.5202 | 32.5307 |
| d50 | 37.8500 | 37.8500 | 37.8500 |
| BF | 1.0000 | 1.0000 | 1.0000 |
| d0 | 2800.0000 | 2800.0000 | 2800.0000 |
| d7 | 4.4868 | 31.3565 | 38.4356 |
| d14 | 36.4489 | 9.5795 | 2.5000 |
| d18 | 48.6674 | 26.6260 | 2.3500 |
| d24 | 16.3757 | 25.7692 | 29.0159 |
| d27 | 13.5205 | 6.1484 | 16.1669 |
| d32 | 1.5000 | 21.5202 | 32.5307 |
| d50 | 37.8500 | 37.8500 | 37.8500 |
| BF | 1.0000 | 0.9999 | 1.0001 |

[Lens group data]

| Group | Starting surface | Focal length |
|---|---|---|
| G1 | 1 | 174.00 |
| G2 | 8 | −38.50 |
| G3 | 15 | 241.22 |
| G4 | 19 | 62.80 |
| G5 | 25 | −147.24 |
| G6 | 28 | −944.39 |
| G7 | 33 | −184.34 |

### Example 13

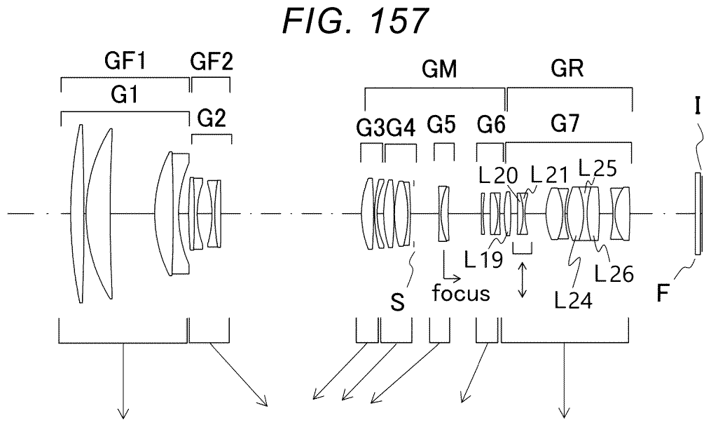

FIG. 157 is a lens configuration diagram of a variable magnification imaging optical system according to Example 13 at a wide-angle end in a case of focusing on infinity.

The variable magnification imaging optical system of FIG. 157 is composed of, in order from the object side: a first front lens group GF1 consisting of a first lens group G1 having a positive refractive power; a second front lens group GF2 consisting of a second lens group G2 having a negative refractive power; a middle group GM consisting of a third lens group G3 having a positive refractive power, a fourth lens group G4 having a positive refractive power, a fifth lens group G5 having a negative refractive power, and a sixth lens group G6 having a negative refractive power; and a subsequent group GR consisting of a seventh lens group G7 having a negative refractive power.

The first lens group G1 is composed of, in order from the object side, a biconvex lens, a meniscus positive lens having a convex surface on the object side, and a cemented lens of a biconvex lens and a biconcave lens. The second lens group G2 is composed of a cemented lens of a biconvex lens and a biconcave lens, and a cemented lens of a biconcave lens and a biconvex lens. The third lens group G3 is composed of a biconvex lens and a meniscus negative lens having a convex surface on the object side. The fourth lens group G4 is composed of a biconvex lens, a cemented lens of a biconvex lens and a meniscus negative lens having a convex surface on the image side, and an aperture diaphragm S. The fifth lens group G5 is composed of a cemented lens of a biconcave lens and a meniscus positive lens having a convex surface on the object side. The sixth lens group G6 is composed of a meniscus negative lens having a convex surface on the object side, and a cemented lens of a biconvex lens and a biconcave lens. The seventh lens group G7 is composed of: a biconvex lens L19; a cemented lens of a meniscus positive lens L20 having a convex surface on the image side and a biconcave lens L21; a cemented lens of a biconvex lens and a biconcave lens; a cemented lens of a biconvex lens L24, a biconcave lens L25, and a biconvex lens L26; and a cemented lens of a biconcave lens and a biconvex lens. In addition, the seventh lens group G7 can also function as a vibration reduction group by moving L20 to L21 as one body in a direction substantially perpendicular to the optical axis, but lenses other than L20 to L21 may also function as a vibration reduction group.

During magnification change from the wide-angle end to the telephoto end, the first lens group G1 and the seventh lens group G7 are fixed with respect to the image surface, the second lens group G2 moves toward the image side, the third lens group G3 to the sixth lens group G6 move toward the object side along different trajectories, a distance between the first lens group G1 and the second lens group G2 increases, a distance between the second lens group G2 and the third lens group G3 decreases, a distance between the third lens group G3 and the fourth lens group G4 increases and then decreases, and the spacing is smaller at the telephoto end than at the wide-angle end, a distance between the fourth lens group G4 and the fifth lens group G5 decreases, a distance between the fifth lens group G5 and the sixth lens group G6 increases, a distance between the sixth lens group G6 and the seventh lens group G7 increases, and during focusing from the infinite distance object to the close distance object, the fifth lens group G5 moves toward the image side.

The lenses on the image side from L19 of the seventh lens group G7 are lenses that are incident on a higher position than an axial marginal ray incident on the lens surface on the object side among off-axis principal rays at the telephoto end at infinity. Therefore, in the variable magnification imaging optical system according to Example 13, Lb is L19.
L24 and L26 are lenses satisfying Conditional Expressions (11) and (12).
L25 is a lens satisfying Conditional Expression (13).
L25 is a lens satisfying Conditional Expression (14).
L25 is a lens satisfying Conditional Expression (15).

The following shows numerical values of the variable magnification imaging optical system according to Example 13.

### Numerical Example 13

Unit: mm
[Surface data]

| | | | | | | Corresponding |
|---|---|---|---|---|---|---|
| Surface number | r | d | nd | vd | ΔPgF | glass material |
| Object surface | ∞ | (d0) | | | | |
| 1 | 240.3189 | 7.5527 | 1.57144 | 71.61 | 0.0224 | FCD615 |
| 2 | −1480.0000 | 1.2894 | | | | |
| 3 | 88.3711 | 13.9382 | 1.43700 | 95.10 | 0.0564 | FCD100 |
| 4 | 861.1506 | 25.8000 | | | | |
| 5 | 74.6913 | 10.6979 | 1.43700 | 95.10 | 0.0564 | FCD100 |
| 6 | −776.9633 | 3.1367 | 1.65253 | 39.48 | −0.0042 | NBFD38 |
| 7 | 70.3987 | (d7) | | | | |
| 8 | 225.7329 | 3.3344 | 1.85478 | 24.80 | 0.0085 | S-NBH56 |
| 9 | −390.7451 | 1.6500 | 1.72916 | 54.54 | −0.0049 | TAC8P |
| 10 | 48.8097 | 8.5007 | | | | |
| 11 | −59.5780 | 1.6240 | 1.73400 | 51.47 | −0.0071 | S-LAL59 |
| 12 | 106.1632 | 3.4787 | 1.85478 | 24.80 | 0.0085 | S-NBH56 |
| 13 | −1255.8573 | (d13) | | | | |
| 14 | 52.1885 | 6.9811 | 1.43700 | 95.10 | 0.0564 | FCD100 |
| 15 | −248.4709 | 0.5500 | | | | |
| 16 | 73.8236 | 1.4772 | 1.74330 | 49.22 | −0.0104 | NBF1 |
| 17 | 41.4434 | (d17) | | | | |
| 18 | 62.4893 | 5.9761 | 1.49700 | 81.61 | 0.0373 | FCD1 |
| 19 | −192.2067 | 0.3000 | | | | |
| 20 | 66.2570 | 7.6502 | 1.43700 | 95.10 | 0.0564 | FCD100 |
| 21 | −64.1845 | 1.4908 | 1.77250 | 49.63 | −0.0088 | TAF1 |
| 22 | −202.1357 | 2.0000 | | | | |
| 23 (diaphragm) | ∞ | (d23) | | | | |
| 24 | −538.8661 | 1.1463 | 1.91082 | 35.25 | −0.0017 | TAFD35L |
| 25 | 38.0233 | 4.1533 | 1.78880 | 28.43 | 0.0036 | S-NBH58 |
| 26 | 242.5528 | (d26) | | | | |
| 27 | 628.7949 | 0.9972 | 1.98612 | 16.48 | 0.0468 | FDS16-W |
| 28 | 68.6193 | 4.0720 | | | | |
| 29 | 292.1745 | 4.4504 | 1.73037 | 32.23 | −0.0005 | NBFD32 |
| 30 | −32.4677 | 0.9991 | 1.43700 | 95.10 | 0.0564 | FCD100 |
| 31 | 152.2088 | (d31) | | | | |
| 32 | 60.8668 | 3.7936 | 1.49700 | 81.61 | 0.0373 | FCD1 |
| 33* | −112.8039 | 3.8793 | | | | |
| 34 | −375.7798 | 3.1680 | 1.83401 | 25.97 | 0.0059 | NBFD26 |
| 35 | −36.7209 | 1.0935 | 1.77377 | 47.17 | −0.0078 | MC-TAF401 |
| 36 | 37.8204 | 12.1595 | | | | |
| 37 | 34.2697 | 9.6289 | 1.72825 | 28.32 | 0.0101 | E-FD10L |
| 38 | −36.0121 | 1.2985 | 2.05090 | 26.94 | 0.0052 | TAFD65 |
| 39 | 44.1965 | 1.3616 | | | | |
| 40 | 37.3682 | 9.3993 | 1.62205 | 41.08 | −0.0051 | S-NBM52 |
| 41 | −42.0220 | 1.9991 | 1.43700 | 95.10 | 0.0564 | FCD100 |
| 42 | 51.7543 | 7.2884 | 1.61396 | 44.29 | −0.0055 | LAF45 |
| 43 | −151.0671 | 7.8174 | | | | |
| 44 | −65.2979 | 1.2005 | 2.05090 | 26.94 | 0.0052 | TAFD65 |
| 45 | 24.4970 | 8.5832 | 1.85478 | 24.80 | 0.0085 | S-NBH56 |
| 46 | −226.8012 | 37.8500 | | | | |
| 47 | ∞ | 2.8800 | 1.51633 | 64.14 | 0.0023 | S-BSL7 |
| 48 | ∞ | (BF) | | | | |
| Image surface | ∞ | | | | | |

[Aspherical surface data]

| | 33 surfaces |
|---|---|
| K | 0.00000 |
| A4 | −9.37955E−08 |
| A6 | −4.14007E−09 |
| A8 | 3.98623E−11 |
| A10 | −2.50375E−13 |
| A12 | 5.56762E−16 |

[Various types of data]
Zoom ratio 3.79

| | Wide angle | Middle | Telephoto |
|---|---|---|---|
| Focal length | 206.00 | 500.00 | 780.00 |
| F number | 6.48 | 7.10 | 8.20 |
| Total angle of view 2ω | 11.73 | 4.81 | 3.08 |
| Image height Y | 21.63 | 21.63 | 21.63 |
| Total lens length | 365.10 | 365.10 | 365.10 |

[Variable distance data]

| | Wide angle | Middle | Telephoto |
|---|---|---|---|
| d0 | ∞ | ∞ | ∞ |
| d7 | 5.8058 | 35.4881 | 41.3565 |
| d13 | 81.3328 | 30.9813 | 2.5000 |
| d17 | 3.7510 | 8.3309 | 3.6278 |
| d23 | 14.5366 | 12.0615 | 5.9448 |
| d26 | 19.3333 | 23.5294 | 47.8260 |
| d31 | 2.6955 | 17.0638 | 26.2000 |
| BF | 1.0000 | 1.0000 | 1.0000 |
| d0 | 3500.0000 | 3500.0000 | 3500.0000 |
| d7 | 5.8058 | 35.4881 | 41.3565 |
| d13 | 81.3328 | 30.9813 | 2.5000 |
| d17 | 3.7510 | 8.3309 | 3.6278 |
| d23 | 16.6206 | 22.2946 | 25.4716 |
| d26 | 17.2494 | 13.2963 | 28.2991 |
| d31 | 2.6955 | 17.0638 | 26.2000 |
| BF | 1.0000 | 1.0000 | 1.0000 |

[Lens group data]

| Group | Starting surface | Focal length |
|---|---|---|
| G1 | 1 | 182.02 |
| G2 | 8 | −45.57 |
| G3 | 14 | 350.09 |
| G4 | 18 | 64.30 |
| G5 | 24 | −122.03 |
| G6 | 27 | −283.92 |
| G7 | 32 | −193.52 |

### Example 14

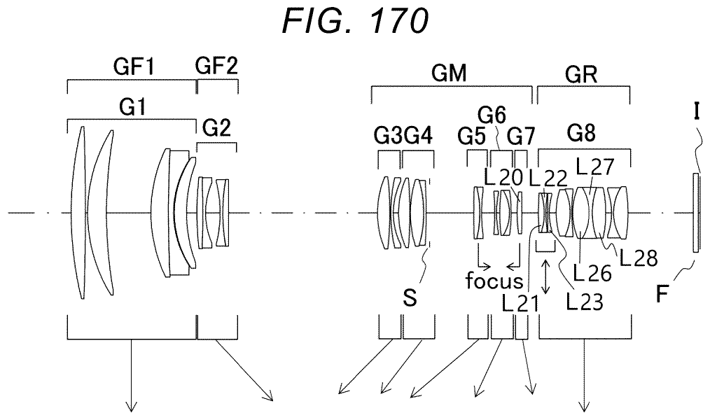

FIG. 170 is a lens configuration diagram of a variable magnification imaging optical system according to Example 14 at a wide-angle end in a case of focusing on infinity.

The variable magnification imaging optical system of FIG. 170 is composed of, in order from the object side: a first front lens group GF1 consisting of a first lens group G1 having a positive refractive power; a second front lens group GF2 consisting of a second lens group G2 having a negative refractive power; a middle group GM consisting of a third lens group G3 having a positive refractive power, a fourth lens group G4 having a positive refractive power, a fifth lens group G5 having a negative refractive power, a sixth lens group G6 having a positive refractive power, and a seventh lens group G7 having a positive refractive power; and a subsequent group GR consisting of an eighth lens group G8 having a negative refractive power.

The first lens group G1 is composed of, in order from the object side, a biconvex lens, a meniscus positive lens having a convex surface on the object side, a cemented lens of a meniscus positive lens having a convex surface on the object side and a meniscus negative lens having a convex surface on the object side, and a meniscus positive lens having a convex surface on the object side. The second lens group G2 is composed of a cemented lens of a biconvex lens and a biconcave lens, and a cemented lens of a biconcave lens and a biconvex lens. The third lens group G3 is composed of a biconvex lens and a meniscus negative lens having a convex surface on the object side. The fourth lens group G4 is composed of a biconvex lens, a cemented lens of a biconvex lens and a meniscus negative lens having a convex surface on the image side, and an aperture diaphragm S. The fifth lens group G5 is composed of a cemented lens of a biconvex lens and a biconcave lens. The sixth lens group G6 is composed of a biconcave lens, and a cemented lens of a biconvex lens and a meniscus negative lens having a convex surface on the image side. The seventh lens group G7 is composed of a biconvex lens L20. The eighth lens group G8 is composed of: a cemented lens of a biconvex lens L21 and a biconcave lens L22; a biconcave lens L23; a cemented lens of a biconvex lens and a biconcave lens; a cemented lens of a biconvex lens L26, a biconcave lens L27, and a biconvex lens L28; and a cemented lens of a biconcave lens and a biconvex lens. In addition, the eighth lens group G8 can also function as a vibration reduction group by moving L21 to L23 as one body in a direction substantially perpendicular to the optical axis, but lenses other than L21 to L23 may also function as a vibration reduction group.

During magnification change from the wide-angle end to the telephoto end, the first lens group G1 and the eighth lens group G8 are fixed with respect to the image surface, the second lens group moves toward the image side, the third lens group G3 to the sixth lens group G6 move toward the object side along different trajectories, the seventh lens group G7 moves toward the image side, a distance between the first lens group G1 and the second lens group G2 increases, a distance between the second lens group G2 and the third lens group G3 decreases, a distance between the third lens group G3 and the fourth lens group G4 increases, a distance between the fourth lens group G4 and the fifth lens group G5 decreases, a distance between the fifth lens group G5 and the sixth lens group G6 increases, a distance between the sixth lens group G6 and the seventh lens group G7 increases, a distance between the seventh lens group G7 and the eighth lens group G8 decreases, and during focusing from the infinite distance object to the close distance object, the fifth lens group G5 moves toward the image side, and the seventh lens group G7 moves toward the object side.

The lenses on the image side from L20 of the seventh lens group G7 are lenses that are incident on a higher position than an axial marginal ray incident on the lens surface on the object side among off-axis principal rays at the telephoto end at infinity. Therefore, in the variable magnification imaging optical system according to Example 14, Lb is L20.
L26 and L28 are lenses satisfying Conditional Expressions (11) and (12).
L27 is a lens satisfying Conditional Expression (13).
L27 is a lens satisfying Conditional Expression (14).
L27 is a lens satisfying Conditional Expression (15).

The following shows numerical values of the variable magnification imaging optical system according to Example 14.

### Numerical Example 14

Unit: mm
[Surface data]

| | | | | | | Corresponding |
|---|---|---|---|---|---|---|
| Surface number | r | d | nd | vd | ΔPgF | glass material |
| Object surface | ∞ | (d0) | | | | |
| 1 | 210.8782 | 8.2483 | 1.48749 | 70.23 | 0.0080 | S-FSL5 |
| 2 | −1480.0000 | 1.2933 | | | | |
| 3 | 90.8192 | 10.9727 | 1.49700 | 81.61 | 0.0373 | FCD1 |
| 4 | 265.3286 | 25.8000 | | | | |
| 5 | 85.7263 | 10.1955 | 1.49700 | 81.61 | 0.0373 | FCD1 |
| 6 | 797.9878 | 2.9746 | 1.65253 | 39.48 | −0.0042 | NBFD38 |
| 7 | 56.8131 | 0.4250 | | | | |
| 8 | 57.7485 | 7.1009 | 1.49700 | 81.61 | 0.0373 | FCD1 |
| 9 | 82.9717 | (d9) | | | | |
| 10 | 187.1781 | 3.3611 | 1.85478 | 24.80 | 0.0085 | S-NBH56 |
| 11 | −693.6196 | 1.6500 | 1.72916 | 54.68 | −0.0055 | S-LAL18 |
| 12 | 44.4901 | 8.4120 | | | | |
| 13 | −74.8818 | 1.6031 | 1.72916 | 54.68 | −0.0055 | S-LAL18 |
| 14 | 116.2202 | 3.4101 | 1.85478 | 24.80 | 0.0085 | S-NBH56 |
| 15 | −1564.7421 | (d15) | | | | |
| 16 | 54.8985 | 7.1100 | 1.43875 | 94.66 | 0.0560 | S-FPL55 |
| 17 | −182.1655 | 0.5500 | | | | |
| 18 | 92.6553 | 1.4634 | 1.77250 | 49.63 | −0.0088 | TAF1 |
| 19 | 41.7971 | (d19) | | | | |
| 20 | 50.7109 | 6.5287 | 1.49700 | 81.61 | 0.0373 | FCD1 |
| 21 | −248.4364 | 0.3000 | | | | |
| 22 | 65.4404 | 7.7095 | 1.43875 | 94.66 | 0.0560 | S-FPL55 |
| 23 | −67.6154 | 1.4961 | 1.77250 | 49.63 | −0.0088 | TAF1 |
| 24 | −278.2548 | 2.0000 | | | | |
| 25 (diaphragm) | ∞ | (d25) | | | | |
| 26 | 448.7305 | 3.4455 | 1.78472 | 25.68 | 0.0140 | S-TIH11 |
| 27 | −67.1847 | 1.1399 | 1.91082 | 35.25 | −0.0017 | TAFD35L |
| 28 | 106.6862 | (d28) | | | | |
| 29 | 128.1661 | 0.9985 | 1.92286 | 20.88 | 0.0281 | E-FDS1-W |
| 30 | 61.0956 | 1.8974 | | | | |
| 31 | 117.7672 | 5.5915 | 1.73037 | 32.23 | −0.0005 | NBFD32 |
| 32 | −25.3847 | 0.9958 | 1.45860 | 90.19 | 0.0491 | FCD10A |
| 33 | −86.6087 | (d33) | | | | |
| 34 | 94.7454 | 2.8092 | 1.49700 | 81.61 | 0.0373 | FCD1 |
| 35 | −488.3473 | (d35) | | | | |
| 36 | 204.4552 | 3.2976 | 1.83401 | 25.97 | 0.0059 | NBFD26 |
| 37 | −38.5066 | 1.0000 | 1.81600 | 46.62 | −0.0077 | S-LAH59 |
| 38 | 78.8671 | 1.0530 | | | | |
| 39 | −2352.4593 | 0.9223 | 1.77250 | | −0.0088 | TAF1 |
| 40 | 37.6281 | 4.0000 | | | | |
| 41 | 46.0607 | 8.0572 | 1.69895 | 30.05 | 0.0084 | E-FD15L |
| 42 | −32.5263 | 1.0000 | 2.05090 | 26.94 | 0.0052 | TAFD65 |
| 43 | 119.3557 | 0.5189 | | | | |
| 44 | 39.2644 | 9.5939 | 1.61396 | 44.29 | −0.0055 | LAF45 |
| 45 | −28.7469 | 1.9844 | 1.43875 | 94.66 | 0.0560 | S-FPL55 |
| 46 | 46.7784 | 7.7143 | 1.61396 | 44.29 | −0.0055 | LAF45 |
| 47 | −72.4254 | 3.3491 | | | | |
| 48 | −38.7570 | 1.1948 | 2.05090 | 26.94 | 0.0052 | TAFD65 |
| 49 | 28.2227 | 8.3965 | 1.83401 | 25.97 | 0.0059 | NBFD26 |
| 50 | −91.9036 | 37.8500 | | | | |
| 51 | ∞ | 2.8800 | 1.51633 | 64.14 | 0.0023 | S-BSL7 |
| 52 | ∞ | (BF) | | | | |
| Image surface | ∞ | | | | | |

[Various types of data]

| | |
|---|---|
| Zoom ratio | 3.79 |

| | Wide angle | Middle | Telephoto |
|---|---|---|---|
| Focal length | 206.00 | 500.00 | 780.00 |
| F number | 6.17 | 6.86 | 8.20 |
| Total angle of view 2ω | 11.71 | 4.80 | 3.06 |
| Image height Y | 21.63 | 21.63 | 21.63 |
| Total lens length | 365.10 | 365.10 | 365.10 |

[Variable distance data]

| | Wide angle | Middle | Telephoto |
|---|---|---|---|
| d0 | ∞ | ∞ | ∞ |
| d9 | 6.0226 | 38.2750 | 43.3484 |
| d15 | 86.4208 | 34.4610 | 2.5000 |
| d19 | 3.0472 | 7.6848 | 7.8704 |
| d25 | 25.7474 | 20.5069 | 15.5120 |
| d28 | 7.5596 | 20.0428 | 48.8001 |
| d33 | 3.4482 | 16.2099 | 21.7793 |
| d35 | 9.5646 | 4.6301 | 2.0000 |
| BF | 1.0000 | 1.0000 | 1.0000 |
| d0 | 3100.0000 | 3100.0000 | 3100.0000 |
| d9 | 6.0226 | 38.2750 | 43.3484 |
| d15 | 86.4208 | 34.4610 | 2.5000 |
| d19 | 3.0472 | 7.6848 | 7.8704 |
| d25 | 27.1677 | 24.9971 | 33.5867 |
| d28 | 6.1393 | 15.5526 | 30.7255 |
| d33 | 1.2000 | 1.2000 | 9.5960 |
| d35 | 11.8128 | 19.6399 | 14.1833 |
| BF | 1.0000 | 1.0000 | 1.0000 |

[Lens group data]

| Group | Starting surface | Focal length |
|---|---|---|
| G1 | 1 | 194.22 |
| G2 | 10 | −49.59 |
| G3 | 16 | 1114.20 |
| G4 | 20 | 61.62 |
| G5 | 26 | −115.86 |
| G6 | 29 | 587.63 |
| G7 | 34 | 159.92 |
| G8 | 36 | −46.76 |

### Example 15

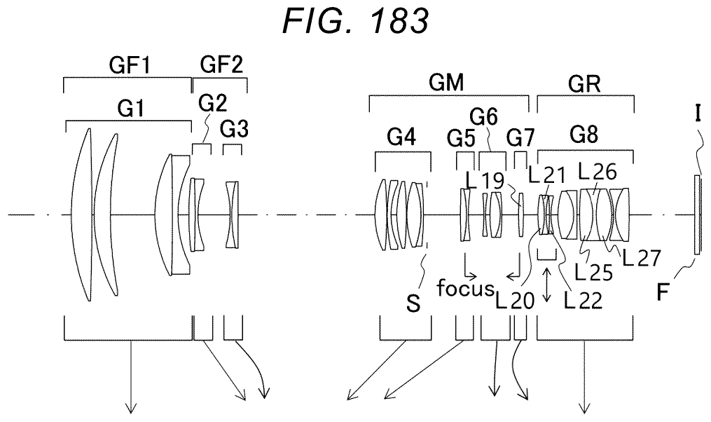

FIG. 183 is a lens configuration diagram of a variable magnification imaging optical system according to Example 15 at a wide-angle end in a case of focusing on infinity.

The variable magnification imaging optical system of FIG. 183 is composed of, in order from the object side: a first front lens group GF1 consisting of a first lens group G1 having a positive refractive power; a second front lens group GF2 consisting of a second lens group G2 having a negative refractive power and a third lens group G3 having a negative refractive power and having a negative refractive power as a whole; a middle group GM consisting of a fourth lens group G4 having a positive refractive power, a fifth lens group G5 having a negative refractive power, a sixth lens group G6 having a positive refractive power, and a seventh lens group G7 having a positive refractive power; and a subsequent group GR consisting of an eighth lens group G8 having a negative refractive power.

The first lens group G1 is composed of, in order from the object side, a biconvex lens, a meniscus positive lens having a convex surface on the object side, and a cemented lens of a biconvex lens and a biconcave lens. The second lens group G2 is composed of a cemented lens of a biconvex lens and a biconcave lens. The third lens group G3 is composed of a cemented lens of a biconcave lens and a meniscus positive lens having a convex surface on the object side. The fourth lens group G4 is composed of a biconvex lens, a meniscus negative lens having a convex surface on the object side, a biconvex lens, a cemented lens of a biconvex lens and a meniscus negative lens having a convex surface on the image side, and an aperture diaphragm S. The fifth lens group G5 is composed of a cemented lens of a biconvex lens and a biconcave lens. The sixth lens group G6 is composed of a biconcave lens, and a cemented lens of a biconvex lens and a meniscus negative lens having a convex surface on the image side. The seventh lens group G7 is composed of a biconvex lens L19. The eighth lens group G8 is composed of: a cemented lens of a biconvex lens L20 and a biconcave lens L21; a biconcave lens L22; a cemented lens of a biconvex lens and a biconcave lens, a cemented lens of a biconvex lens L25, a biconcave lens L26, and a biconvex lens L27; and a cemented lens of a biconcave lens and a biconvex lens. In addition, the eighth lens group G8 can also function as a vibration reduction group by moving L20 to L22 as one body in a direction substantially perpendicular to the optical axis, but lenses other than L20 to L22 may also function as a vibration reduction group.

During magnification change from the wide-angle end to the telephoto end, the first lens group G1 and the eighth lens group G8 are fixed with respect to the image surface, the second lens group G2 and the third lens group G3 move toward the image side along different trajectories, the fourth lens group G4 to the sixth lens group G6 move toward the object side along different trajectories, the seventh lens group G7 moves toward the object side and then moves toward the image side, a distance between the first lens group G1 and the second lens group G2 increases, a distance between the second lens group G2 and the third lens group G3 decreases, a distance between the third lens group G3 and the fourth lens group G4 decreases, a distance between the fourth lens group G4 and the fifth lens group G5 decreases and then increases, and the spacing is smaller at the telephoto end than at the wide-angle end, a distance between the fifth lens group G5 and the sixth lens group G6 increases, a distance between the sixth lens group G6 and the seventh lens group G7 decreases and then increases, and the spacing is larger at the telephoto end than at the wide-angle end, a distance between the seventh lens group G7 and the eighth lens group G8 increases and then decreases, and the spacing is smaller at the telephoto end than at the wide-angle end, and during focusing from the infinite distance object to the close distance object, the fifth lens group G5 moves toward the image side, and the seventh lens group G7 moves toward the object side.

The lenses on the image side from L19 of the seventh lens group G7 are lenses that are incident on a higher position than an axial marginal ray incident on the lens surface on the object side among off-axis principal rays at the telephoto end at infinity. Therefore, in the variable magnification imaging optical system according to Example 15, Lb is L19.
L25 and L27 are lenses satisfying Conditional Expressions (11) and (12).
L26 is a lens satisfying Conditional Expression (13).
L26 is a lens satisfying Conditional Expression (14).
L26 is a lens satisfying Conditional Expression (15).

The following shows numerical values of the variable magnification imaging optical system according to Example 15.

### Numerical Example 15

Unit: mm
[Surface data]

| | | | | | | Corresponding |
|---|---|---|---|---|---|---|
| Surface number | r | d | nd | vd | ΔPgF | glass material |
| Object surface | ∞ | (d0) | | | | |
| 1 | 130.3819 | 11.9007 | 1.48749 | 70.23 | 0.0080 | S-FSL5 |
| 2 | −1480.0000 | 1.3018 | | | | |
| 3 | 95.8914 | 9.4308 | 1.45860 | 90.19 | 0.0491 | FCD10A |
| 4 | 236.2911 | 25.8046 | | | | |
| 5 | 77.0672 | 10.1911 | 1.45860 | 90.19 | 0.0491 | FCD10A |
| 6 | −1148.7100 | 3.1952 | 1.65253 | 39.48 | −0.0042 | NBFD38 |
| 7 | 65.9424 | (d7) | | | | |
| 8 | 182.7915 | 3.6235 | 1.85478 | 24.80 | 0.0085 | S-NBH56 |
| 9 | −559.1998 | 1.6500 | 1.72000 | 50.23 | −0.0059 | S-LAL10 |
| 10 | 49.8472 | (d10) | | | | |
| 11 | −66.2730 | 1.0000 | 1.73400 | 51.47 | −0.0071 | S-LAL59 |
| 12 | 90.6028 | 3.6224 | 1.85478 | 24.80 | 0.0085 | S-NBH56 |
| 13 | 5263.3043 | (d13) | | | | |
| 14 | 49.2142 | 6.7980 | 1.43700 | 95.10 | 0.0564 | FCD100 |
| 15 | −232.1272 | 0.3000 | | | | |
| 16 | 97.0940 | 2.2418 | 1.77250 | 49.63 | −0.0088 | TAF1 |
| 17 | 43.3704 | 3.3492 | | | | |
| 18 | 64.8513 | 5.5001 | 1.49700 | 81.61 | 0.0373 | FCD1 |
| 19 | −188.6833 | 0.3000 | | | | |
| 20 | 57.8834 | 8.1407 | 1.43700 | 95.10 | 0.0564 | FCD100 |
| 21 | −56.1664 | 1.4990 | 1.77250 | 49.63 | −0.0088 | TAF1 |
| 22 | −163.7335 | 2.0000 | | | | |
| 23 (diaphragm) | ∞ | (d23) | | | | |
| 24 | 420.2916 | 3.4613 | 1.78880 | 28.43 | 0.0036 | S-NBH58 |
| 25 | −72.1606 | 1.1508 | 1.91082 | 35.25 | −0.0017 | TAFD35L |
| 26 | 104.3180 | (d26) | | | | |
| 27 | −112.9248 | 1.0050 | 1.92286 | 20.88 | 0.0281 | E-FDS1-W |
| 28 | 66.7926 | 2.5628 | | | | |
| 29 | 84.9132 | 5.9034 | 1.73037 | 32.23 | −0.0005 | NBFD32 |
| 30 | −30.2741 | 1.0027 | 1.45860 | 90.19 | 0.0491 | FCD10A |
| 31 | −111.1711 | (d31) | | | | |
| 32 | 147.8020 | 2.8455 | 1.49700 | 81.61 | 0.0373 | FCD1 |
| 33 | −179.3490 | (d33) | | | | |
| 34 | 60.3257 | 3.7050 | 1.83401 | 25.97 | 0.0059 | NBFD26 |
| 35 | −48.4422 | 1.0000 | 1.81600 | 46.62 | −0.0077 | S-LAH59 |
| 36 | 45.0535 | 1.9364 | | | | |
| 37 | −147.8132 | 0.9593 | 1.77250 | 49.63 | −0.0088 | TAF1 |
| 38 | 39.2869 | 4.0001 | | | | |
| 39 | 43.3856 | 9.1273 | 1.80518 | 25.46 | 0.0131 | FD60-W |
| 40 | −23.6492 | 1.8594 | 2.05090 | 26.94 | 0.0052 | TAFD65 |
| 41 | 1829.6639 | 1.5562 | | | | |
| 42 | 159.2890 | 7.8615 | 1.61396 | 44.29 | −0.0055 | LAF45 |
| 43 | −29.7068 | 1.9991 | 1.45860 | 90.19 | 0.0491 | FCD10A |
| 44 | 51.3774 | 8.8891 | 1.61396 | 44.29 | −0.0055 | LAF45 |
| 45 | −36.8338 | 1.0128 | | | | |
| 46 | −43.3202 | 1.2034 | 2.10200 | 23.38 | 0.0139 | TAFD75-W |
| 47 | 27.8789 | 7.8999 | 1.90110 | 27.06 | 0.0074 | NBFD27 |
| 48 | −293.1116 | 37.8500 | | | | |
| 49 | ∞ | 2.8800 | 1.51633 | 64.14 | 0.0023 | S-BSL7 |
| 50 | ∞ | (BF) | | | | |
| Image surface | ∞ | | | | | |

[Various types of data]

| | |
|---|---|
| Zoom ratio | 3.79 |

| | Wide angle | Middle | Telephoto |
|---|---|---|---|
| Focal length | 206.00 | 500.00 | 780.00 |
| F number | 6.17 | 6.76 | 8.22 |
| Total angle of view 2ω | 11.64 | 4.77 | 3.05 |
| Image height Y | 21.63 | 21.63 | 21.63 |
| Total lens length | 365.10 | 365.10 | 365.10 |

[Variable distance data]

| | Wide angle | Middle | Telephoto |
|---|---|---|---|
| d0 | ∞ | ∞ | ∞ |
| d7 | 6.2892 | 38.2502 | 44.7526 |
| d10 | 18.6626 | 17.8854 | 13.1709 |
| d13 | 79.1936 | 27.4352 | 2.5000 |
| d23 | 19.4105 | 10.1598 | 11.1365 |
| d26 | 9.1110 | 29.9353 | 46.9214 |
| d31 | 9.5785 | 7.5342 | 30.0944 |
| d33 | 8.3305 | 19.3757 | 2.0000 |
| BF | 1.0000 | 1.0000 | 1.0000 |
| d0 | 3200.0000 | 3200.0000 | 3200.0000 |
| d7 | 6.2892 | 38.2502 | 44.7526 |
| d10 | 18.6626 | 17.8854 | 13.1709 |
| d13 | 79.1936 | 27.4352 | 2.5000 |
| d23 | 20.6420 | 20.8774 | 31.0528 |
| d26 | 7.8795 | 19.2176 | 27.0051 |
| d31 | 7.1237 | 5.4771 | 23.6658 |
| d33 | 10.7853 | 21.4328 | 8.4285 |
| BF | 1.0000 | 1.0000 | 1.0000 |

[Lens group data]

| Group | Starting surface | Focal length |
|---|---|---|
| G1 | 1 | 203.71 |
| G2 | 8 | −107.19 |
| G3 | 11 | −101.01 |
| G4 | 14 | 59.47 |
| G5 | 24 | −117.56 |
| G6 | 27 | 640.70 |
| G7 | 32 | 163.51 |
| G8 | 34 | −48.39 |

### Example 16

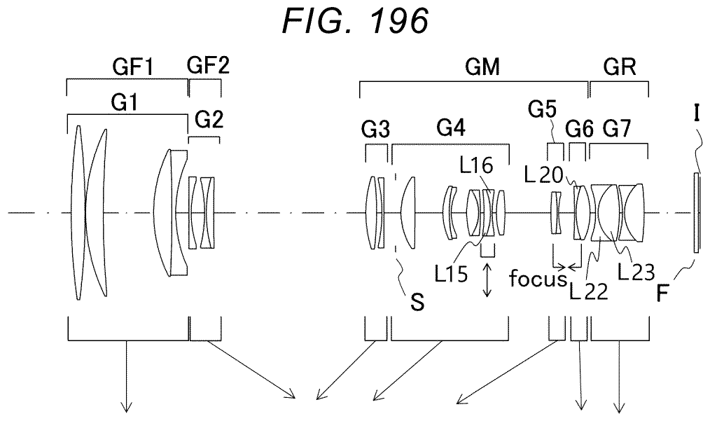

FIG. 196 is a lens configuration diagram of a variable magnification imaging optical system according to Example 16 at a wide-angle end in a case of focusing on infinity.

The variable magnification imaging optical system of FIG. 196 is composed of, in order from the object side: a first front lens group GF1 consisting of a first lens group G1 having a positive refractive power; a second front lens group GF2 consisting of a second lens group G2 having a negative refractive power; a middle group GM consisting of a third lens group G3 having a positive refractive power, a fourth lens group G4 having a positive refractive power, a fifth lens group G5 having a negative refractive power, and a sixth lens group G6 having a positive refractive power; and a subsequent group GR consisting of a seventh lens group G7 having a negative refractive power.

The first lens group G1 is composed of, in order from the object side, a biconvex lens, a meniscus positive lens having a convex surface on the object side, and a cemented lens of a biconvex lens and a biconcave lens. The second lens group G2 is composed of a meniscus negative lens having a convex surface on the object side, and a cemented lens of a biconcave lens and a meniscus positive lens having a convex surface on the object side. The third lens group G3 is composed of a biconvex lens and a plano-concave lens having a plane facing the image side. The fourth lens group G4 is composed of an aperture diaphragm S, a biconvex lens, a cemented lens of a meniscus positive lens having a convex surface on the object side and a meniscus negative lens having a convex surface on the object side, a cemented lens of a biconvex lens L and a meniscus negative lens having a convex surface on the image side, a cemented lens of a meniscus positive lens L15 having a convex surface on the image side and a biconcave lens L16, and a biconvex lens. In addition, the fourth lens group G4 can also function as a vibration reduction group by moving L15 to L16 as one body in a direction substantially perpendicular to the optical axis, but lenses other than L15 to L16 may also function as a vibration reduction group. The fifth lens group G5 is composed of a cemented lens of a biconvex lens and a biconcave lens. The sixth lens group G6 is composed of a cemented lens of a biconcave lens L20 and a biconvex lens. The seventh lens group G7 is composed of a cemented lens of a biconcave lens L22 and a biconvex lens L23, and a cemented lens of a biconcave lens and a biconvex lens.

During magnification change from the wide-angle end to the telephoto end, the first lens group G1 and the seventh lens group G7 are fixed with respect to the image surface, the second lens group G2 moves toward the image side, the third lens group G3 to the fifth lens group G5 move toward the object side along different trajectories, the sixth lens group G6 moves toward the image side, a distance between the first lens group G1 and the second lens group G2 increases, a distance between the second lens group G2 and the third lens group G3 decreases, a distance between the third lens group G3 and the fourth lens group G4 decreases, a distance between the fourth lens group G4 and the fifth lens group G5 decreases, a distance between the fifth lens group G5 and the sixth lens group G6 increases, a distance between the sixth lens group G6 and the seventh lens group G7 decreases, and during focusing from the infinite distance object to the close distance object, the fifth lens group G5 moves toward the image side, and the sixth lens group G6 moves toward the object side.

The lenses on the image side from L20 of the sixth lens group G6 are lenses that are incident on a higher position than an axial marginal ray incident on the lens surface on the object side among off-axis principal rays at the telephoto end at infinity. Therefore, in the variable magnification imaging optical system according to Example 16, Lb is L20.
L23 is a lens satisfying Conditional Expressions (11) and (12).
L22 is a lens satisfying Conditional Expression (13).
L22 is a lens satisfying Conditional Expression (14).
L22 is a lens satisfying Conditional Expression (15).

The following shows numerical values of the variable magnification imaging optical system according to Example 16.

### Numerical Example 16

Unit: mm
[Surface data]

| | | | | | | Corresponding |
|---|---|---|---|---|---|---|
| Surface number | r | d | nd | vd | ΔPgF | glass material |
| Object surface | ∞ | (d0) | | | | |
| 1 | 365.2630 | 7.9808 | 1.55200 | 70.70 | 0.0210 | S-FPM5 |
| 2 | −405.1526 | 0.3000 | | | | |
| 3 | 108.7267 | 10.1004 | 1.43700 | 95.10 | 0.0564 | FCD100 |
| 4 | 547.3047 | 28.8183 | | | | |
| 5 | 81.4177 | 10.4523 | 1.43700 | 95.10 | 0.0564 | FCD100 |
| 6 | −805.9166 | 2.2001 | 1.62205 | 41.08 | −0.0051 | S-NBM52 |
| 7 | 76.0877 | (d7) | | | | |
| 8 | 6399.5097 | 1.2982 | 1.59349 | 67.00 | 0.0088 | PCD51 |
| 9 | 61.5132 | 7.6611 | | | | |
| 10 | −79.8729 | 1.0000 | 1.64000 | 60.08 | −0.0033 | S-BSM81 |
| 11 | 78.4126 | 4.3095 | 1.90110 | 27.06 | 0.0074 | NBFD27 |
| 12 | 1012.9343 | (d12) | | | | |
| 13 | 68.6585 | 6.1479 | 1.59410 | 60.47 | 0.0156 | FCD600 |
| 14 | −172.2927 | 3.0715 | | | | |
| 15 | −86.3237 | 1.1941 | 1.80440 | 39.58 | −0.0010 | S-LAH63Q |
| 16 | ∞ | (d16) | | | | |
| 17 (diaphragm) | ∞ | 3.0000 | | | | |
| 18 | 37.0081 | 8.0111 | 1.45860 | 90.19 | 0.0491 | FCD10A |
| 19 | −1048.6287 | 16.0098 | | | | |
| 20 | 35.6551 | 3.5991 | 1.50137 | 56.42 | 0.0064 | S-FTL10 |
| 21 | 67.1064 | 1.1981 | 1.95375 | 32.32 | 0.0003 | S-LAH98 |
| 22 | 28.2709 | 8.8132 | | | | |
| 23 | 49.2672 | 6.9920 | 1.60342 | 38.01 | 0.0028 | E-F5 |
| 24 | −22.6251 | 0.9997 | 1.95375 | 32.32 | 0.0003 | S-LAH98 |
| 25 | −129.7317 | 2.1065 | | | | |
| 26 | −105.5844 | 3.6596 | 1.79360 | 37.09 | 0.0011 | S-LAM73 |
| 27 | −36.6566 | 0.9981 | 1.65160 | 58.54 | −0.0041 | S-LAL7Q |
| 28 | 65.0219 | 2.3951 | | | | |
| 29 | 45.5776 | 4.9109 | 1.56732 | 42.84 | 0.0030 | E-FL6 |
| 30 | −101.3875 | (d30) | | | | |
| 31 | 155.6678 | 3.4701 | 1.71736 | 29.50 | 0.0087 | E-FD1L |
| 32 | −114.5685 | 0.8992 | 1.75500 | 52.32 | −0.0067 | S-LAH97 |
| 33 | 44.5077 | (d33) | | | | |
| 34 | −311.7986 | 0.9498 | 1.90110 | 27.06 | 0.0074 | NBFD27 |
| 35 | 43.6812 | 7.9604 | 1.64769 | 33.84 | 0.0049 | E-FD2 |
| 36 | −36.3610 | (d36) | | | | |
| 37 | −41.0474 | 1.3793 | 1.43700 | 95.10 | 0.0564 | FCD100 |
| 38 | 20.3175 | 12.1546 | 1.62205 | 41.08 | −0.0051 | S-NBM52 |
| 39 | −74.2838 | 1.7704 | | | | |
| 40 | −52.3302 | 1.1999 | 2.00100 | 29.13 | 0.0035 | TAFD55-W |
| 41 | 22.3068 | 11.2282 | 1.77047 | 29.74 | 0.0002 | NBFD29 |
| 42 | −128.6626 | (d42) | | | | |
| 43 | ∞ | 2.3700 | 1.51633 | 64.14 | 0.0023 | S-BSL7 |
| 44 | ∞ | (BF) | | | | |
| Image surface | ∞ | | | | | |

[Various types of data]

| | |
|---|---|
| Zoom ratio | 3.78 |

| | Wide angle | Middle | Telephoto |
|---|---|---|---|
| Focal length | 206.00 | 500.00 | 778.00 |
| F number | 6.18 | 7.01 | 8.22 |
| Total angle of view 2ω | 11.42 | 4.71 | 3.05 |
| Image height Y | 21.63 | 21.63 | 21.63 |
| Total lens length | 360.00 | 360.00 | 360.00 |

[Variable distance data]

| | Wide angle | Middle | Telephoto |
|---|---|---|---|
| d0 | ∞ | ∞ | ∞ |
| d7 | 7.5467 | 50.2320 | 60.8259 |
| d12 | 86.8603 | 33.4646 | 1.5000 |
| d16 | 6.7012 | 4.4469 | 1.5000 |
| d30 | 26.2456 | 15.5839 | 3.0000 |
| d33 | 9.0739 | 33.7223 | 70.8346 |
| d36 | 3.2328 | 2.2109 | 2.0000 |
| d42 | 28.7317 | 28.7317 | 28.7317 |
| BF | 1.0000 | 1.0000 | 1.0000 |
| d0 | 3300.0000 | 3300.0000 | 3300.0000 |
| d7 | 7.5467 | 50.2320 | 60.8259 |
| d12 | 86.8603 | 33.4646 | 1.5000 |
| d16 | 6.7012 | 4.4469 | 1.5000 |
| d30 | 30.5940 | 31.6192 | 28.4135 |
| d33 | 4.6469 | 14.7964 | 38.9335 |
| d36 | 3.3115 | 5.1015 | 8.4876 |
| d42 | 28.7317 | 28.7317 | 28.7317 |
| BF | 1.0000 | 1.0000 | 1.0000 |

[Lens group data]

| Group | Starting surface | Focal length |
|---|---|---|
| G1 | 1 | 222.28 |
| G2 | 8 | −64.36 |
| G3 | 13 | 301.05 |
| G4 | 17 | 96.22 |
| G5 | 31 | −80.09 |
| G6 | 34 | 101.14 |
| G7 | 37 | −63.54 |

### Example 17

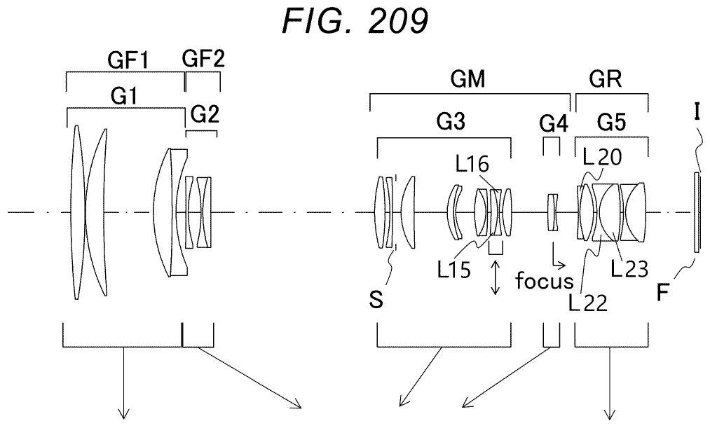

FIG. 209 is a lens configuration diagram of a variable magnification imaging optical system according to Example 17 at a wide-angle end in a case of focusing on infinity.

The variable magnification imaging optical system of FIG. 209 is composed of, in order from the object side: a first front lens group GF1 consisting of a first lens group G1 having a positive refractive power; a second front lens group GF2 consisting of a second lens group G2 having a negative refractive power; a middle group GM consisting of a third lens group G3 having a positive refractive power and a fourth lens group G4 having a negative refractive power; and a subsequent group GR consisting of a fifth lens group G5 having a negative refractive power.

The first lens group G1 is composed of, in order from the object side, a biconvex lens, a meniscus positive lens having a convex surface on the object side, and a cemented lens of a biconvex lens and a biconcave lens. The second lens group G2 is composed of a biconcave lens, and a cemented lens of a biconcave lens and a meniscus positive lens having a convex surface on the object side. The third lens group G3 is composed of a biconvex lens, a meniscus negative lens having a convex surface on the image side, an aperture diaphragm S, a meniscus positive lens having a convex surface on the object side, a cemented lens of a meniscus positive lens having a convex surface on the object side and a meniscus negative lens having a convex surface on the object side, a cemented lens of a biconvex lens and a meniscus negative lens having a convex surface on the image side, a cemented lens of a meniscus positive lens L15 having a convex surface on the image side and a biconcave lens L16, and a biconvex lens. In addition, the third lens group G3 can also function as a vibration reduction group by moving L15 to L16 as one body in a direction substantially perpendicular to the optical axis, but lenses other than L15 to L16 may also function as a vibration reduction group. The fourth lens group G4 is composed of a cemented lens of a biconvex lens and a biconcave lens. The fifth lens group G5 is composed of a cemented lens of a biconcave lens L20 and a biconvex lens, a cemented lens of a biconcave lens L22 and a biconvex lens L23, and a cemented lens of a biconcave lens and a biconvex lens.

During magnification change from the wide-angle end to the telephoto end, the first lens group G1 and the fifth lens group G5 are fixed with respect to the image surface, the second lens group G2 moves toward the image side, the third lens group G3 and the fourth lens group G4 move toward the object side along different trajectories, a distance between the first lens group G1 and the second lens group G2 increases, a distance between the second lens group G2 and the third lens group G3 decreases, a distance between the third lens group G3 and the fourth lens group G4 decreases, a distance between the fourth lens group G4 and the fifth lens group G5 increases, and during focusing from the infinite distance object to the close distance object, the fourth lens group G4 moves toward the image side.

The lenses on the image side from L20 of the fifth lens group G5 are lenses that are incident on a higher position than an axial marginal ray incident on the lens surface on the object side among off-axis principal rays at the telephoto end at infinity. Therefore, in the variable magnification imaging optical system according to Example 17, Lb is L20.
L23 is a lens satisfying Conditional Expressions (11) and (12).
L22 is a lens satisfying Conditional Expression (13).
L22 is a lens satisfying Conditional Expression (14).
L22 is a lens satisfying Conditional Expression (15).

The following shows numerical values of the variable magnification imaging optical system according to Example 17.

### Numerical Example 17

Unit: mm
[Surface data]

| | | | | | | Corresponding |
|---|---|---|---|---|---|---|
| Surface number | r | d | nd | vd | ΔPgF | glass material |
| Object surface | ∞ | (d0) | | | | |
| 1 | 501.4587 | 8.1103 | 1.48749 | 70.44 | 0.0090 | FC5 |
| 2 | −309.2830 | 0.3000 | | | | |
| 3 | 108.5531 | 10.4779 | 1.43700 | 95.10 | 0.0564 | FCD100 |
| 4 | 626.0201 | 28.5810 | | | | |
| 5 | 82.0071 | 10.8007 | 1.43700 | 95.10 | 0.0564 | FCD100 |
| 6 | −657.3335 | 2.2023 | 1.62205 | 41.08 | −0.0051 | S-NBM52 |
| 7 | 80.9739 | (d7) | | | | |
| 8 | −814.8531 | 1.2953 | 1.58913 | 61.14 | 0.0023 | S-BAL35 |
| 9 | 66.5839 | 7.3705 | | | | |
| 10 | −76.7037 | 1.0000 | 1.65160 | 58.54 | −0.0041 | S-LAL7Q |
| 11 | 73.4042 | 4.5472 | 1.83401 | 25.97 | 0.0059 | NBFD26 |
| 12 | 4874.8922 | (d12) | | | | |
| 13 | 80.4596 | 5.9613 | 1.59282 | 68.62 | 0.0192 | FCD515 |
| 14 | −136.7484 | 2.7879 | | | | |
| 15 | −85.7450 | 1.4434 | 1.85150 | 40.78 | −0.0055 | S-LAH89 |
| 16 | −849.1940 | 2.0000 | | | | |
| 17 (diaphragm) | ∞ | 3.0000 | | | | |
| 18 | 37.1605 | 7.5210 | 1.43700 | 95.10 | 0.0564 | FCD100 |
| 19 | 589.4671 | 19.0432 | | | | |
| 20 | 29.3751 | 3.6527 | 1.56732 | 42.84 | 0.0030 | E-FL6 |
| 21 | 43.6503 | 1.2010 | 1.95375 | 32.32 | 0.0003 | S-LAH98 |
| 22 | 25.5433 | 10.8635 | | | | |
| 23 | 57.3672 | 6.6448 | 1.62205 | 41.08 | −0.0051 | S-NBM52 |
| 24 | 22.8484 | 0.9992 | 1.95375 | 32.32 | −0.0002 | TAFD45 |
| 25 | −137.3476 | 2.0000 | | | | |
| 26 | −151.6610 | 3.6743 | 1.80610 | 33.27 | −0.0001 | NBFD15-W |
| 27 | −39.6183 | 0.9960 | 1.69680 | 55.46 | −0.0060 | LAC14 |
| 28 | 61.8115 | 2.0000 | | | | |
| 29 | 40.4760 | 5.1020 | 1.54814 | 45.82 | 0.0040 | E-FEL1 |
| 30 | −104.5226 | (d30) | | | | |
| 31 | 156.9027 | 3.7538 | 1.69895 | 30.05 | 0.0084 | E-FD15L |
| 32 | −71.2811 | 0.9005 | 1.75500 | 52.32 | −0.0067 | S-LAH97 |
| 33 | 43.3459 | (d33) | | | | |
| 34 | −157.3513 | 0.9498 | 2.10200 | 23.39 | 0.0139 | TAFD75-W |
| 35 | 50.9104 | 7.7507 | 1.77047 | 29.74 | 0.0002 | NBFD29 |
| 36 | −36.5769 | 2.0000 | | | | |
| 37 | −40.3107 | 1.3799 | 1.43700 | 95.10 | 0.0564 | FCD100 |
| 38 | 20.4704 | 12.0735 | 1.62205 | 41.08 | −0.0051 | S-NBM52 |
| 39 | −94.6686 | 1.8194 | | | | |
| 40 | 60.8828 | 1.2006 | 2.00100 | 29.13 | 0.0035 | TAFD55-W |
| 41 | 22.0104 | 11.6367 | 1.77047 | 29.74 | 0.0002 | NBFD29 |
| 42 | −116.4259 | (d42) | | | | |
| 43 | ∞ | 2.3700 | 1.51633 | 64.14 | 0.0023 | S-BSL7 |
| 44 | ∞ | (BF) | | | | |
| Image surface | ∞ | | | | | |

[Various types of data]

| | |
|---|---|
| Zoom ratio | 4.2 |

| | Wide angle | Middle | Telephoto |
|---|---|---|---|
| Focal length | 185.40 | 500.00 | 778.00 |
| F number | 6.39 | 7.19 | 8.22 |
| Total angle of view 2ω | 12.71 | 4.71 | 3.05 |
| Image height Y | 21.63 | 21.63 | 21.63 |
| Total lens length | 362.00 | 362.00 | 362.00 |

[Variable distance data]

| | Wide angle | Middle | Telephoto |
|---|---|---|---|
| d0 | ∞ | ∞ | ∞ |
| d7 | 5.7288 | 53.3458 | 63.9093 |
| d12 | 94.2307 | 33.0119 | 1.5000 |
| d30 | 20.7158 | 13.7708 | 3.3672 |
| d33 | 12.8465 | 33.3933 | 64.7453 |
| d42 | 28.0676 | 28.0675 | 28.0675 |
| BF | 1.0000 | 1.0000 | 1.0000 |
| d0 | 3200.0000 | 3200.0000 | 3200.0000 |
| d7 | 5.7288 | 53.3458 | 63.9093 |
| d12 | 94.2307 | 33.0119 | 1.5000 |
| d30 | 23.7820 | 29.1292 | 28.5092 |
| d33 | 9.7803 | 18.0349 | 39.6033 |
| d42 | 28.0676 | 28.0675 | 28.0675 |
| BF | 1.0000 | 1.0000 | 1.0000 |

[Lens group data]

| Group | Starting surface | Focal length |
|---|---|---|
| G1 | 1 | 220.60 |
| G2 | 8 | −61.81 |
| G3 | 13 | 77.85 |
| G4 | 31 | −73.87 |
| G5 | 34 | −177.48 |

### Example 18

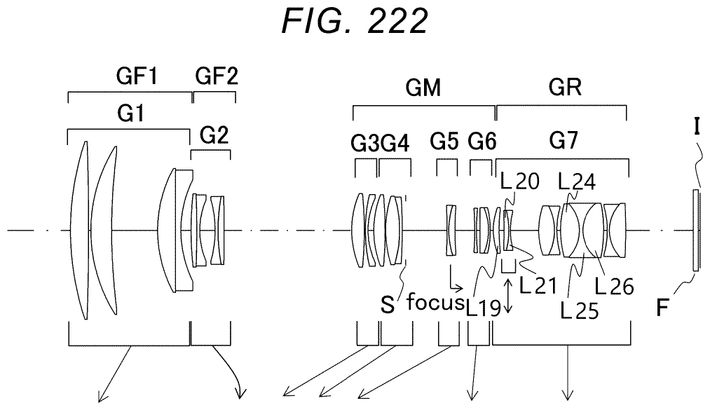

FIG. 222 is a lens configuration diagram of a variable magnification imaging optical system according to Example 18 at a wide-angle end in a case of focusing on infinity.

The variable magnification imaging optical system of FIG. 222 is composed of, in order from the object side: a first front lens group GF1 consisting of a first lens group G1 having a positive refractive power; a second front lens group GF2 consisting of a second lens group G2 having a negative refractive power; a middle group GM consisting of a third lens group G3 having a positive refractive power, a fourth lens group G4 having a positive refractive power, a fifth lens group G5 having a negative refractive power, and a sixth lens group G6 having a positive refractive power; and a subsequent group GR consisting of a seventh lens group G7 having a negative refractive power.

The first lens group G1 is composed of, in order from the object side, a biconvex lens, a meniscus positive lens having a convex surface on the object side, and a cemented lens of a meniscus positive lens having a convex surface on the object side and a meniscus negative lens having a convex surface on the object side. The second lens group G2 is composed of a cemented lens of a biconvex lens and a biconcave lens, and a cemented lens of a biconcave lens and a biconvex lens. The third lens group G3 is composed of a biconvex lens and a meniscus negative lens having a convex surface on the object side. The fourth lens group G4 is composed of a biconvex lens, a cemented lens of a biconvex lens and a meniscus negative lens having a convex surface on the image side, and an aperture diaphragm S. The fifth lens group G5 is composed of a cemented lens of a biconcave lens and a meniscus positive lens having a convex surface on the object side. The sixth lens group G6 is composed of a biconcave lens, and a cemented lens of a biconvex lens and a meniscus negative lens having a convex surface on the image side. The seventh lens group G7 is composed of: a meniscus positive lens L19 having a convex surface on the object side; a cemented lens of a meniscus positive lens L20 having a convex surface on the image side and a biconcave lens L21; a cemented lens of a biconvex lens and a biconcave lens; a cemented lens of a biconvex lens L24, a biconcave lens L25, and a biconvex lens L26; and a cemented lens of a biconcave lens and a biconvex lens. In addition, the seventh lens group G7 can also function as a vibration reduction group by moving L20 to L21 as one body in a direction substantially perpendicular to the optical axis, but lenses other than L20 to L21 may also function as a vibration reduction group.

During magnification change from the wide-angle end to the telephoto end, the first lens group G1 moves toward the object side, the second lens group G2 moves toward the image side and then moves toward the object side, the third lens group G3 to the sixth lens group G6 move toward the object side along different trajectories, the seventh lens group G7 is fixed with respect to the image surface, a distance between the first lens group G1 and the second lens group G2 increases, a distance between the second lens group G2 and the third lens group G3 decreases, a distance between the third lens group G3 and the fourth lens group G4 increases and then decreases, and the spacing is larger at the telephoto end than at the wide-angle end, a distance between the fourth lens group G4 and the fifth lens group G5 decreases and then increases, and the spacing is smaller at the telephoto end than at the wide-angle end, a distance between the fifth lens group G5 and the sixth lens group G6 increases, a distance between the sixth lens group G6 and the seventh lens group G7 increases, and during focusing from the infinite distance object to the close distance object, the fifth lens group G5 moves toward the image side.

The lenses on the image side from L19 of the seventh lens group G7 are lenses that are incident on a higher position than an axial marginal ray incident on the lens surface on the object side among off-axis principal rays at the telephoto end at infinity. Therefore, in the variable magnification imaging optical system according to Example 18, Lb is L19.
L24 and L26 are lenses satisfying Conditional Expressions (11) and (12).
L25 is a lens satisfying Conditional Expression (13).
L25 is a lens satisfying Conditional Expression (14).
L25 is a lens satisfying Conditional Expression (15).

The following shows numerical values of the variable magnification imaging optical system according to Example 18.

### Numerical Example 18

Unit: mm
[Surface data]

| | | | | | | Corresponding |
|---|---|---|---|---|---|---|
| Surface number | r | d | nd | vd | ΔPgF | glass material |
| Object surface | ∞ | (d0) | | | | |
| 1 | 158.3164 | 10.1507 | 1.48749 | 70.23 | 0.0080 | S-FSL5 |
| 2 | −1480.0000 | 1.2841 | | | | |
| 3 | 88.4455 | 11.7077 | 1.43700 | 95.10 | 0.0564 | FCD100 |
| 4 | 352.1214 | 25.8000 | | | | |
| 5 | 72.9560 | 10.0393 | 1.43700 | 95.10 | 0.0564 | FCD100 |
| 6 | 7547.9912 | 3.0336 | 1.65253 | 39.48 | −0.0042 | NBFD38 |
| 7 | 64.6010 | (d7) | | | | |
| 8 | 193.4691 | 3.2451 | 1.83401 | 25.97 | 0.0059 | NBFD26 |
| 9 | −464.1545 | 1.6500 | 1.72916 | 54.54 | −0.0049 | TAC8P |
| 10 | 44.1292 | 8.6031 | | | | |
| 11 | −62.9756 | 1.6518 | 1.73400 | 51.47 | −0.0071 | S-LAL59 |
| 12 | 106.1943 | 3.4267 | 1.85478 | 24.80 | 0.0085 | S-NBH56 |
| 13 | −923.1379 | (d13) | | | | |
| 14 | 53.3024 | 7.0934 | 1.43700 | 95.10 | 0.0564 | FCD100 |
| 15 | −193.4884 | 0.5504 | | | | |
| 16 | 90.3129 | 1.4959 | 1.77250 | 49.63 | −0.0088 | TAF1 |
| 17 | 43.3036 | (d17) | | | | |
| 18 | 55.7009 | 6.3519 | 1.52841 | 76.46 | 0.0287 | S-FPM4 |
| 19 | −209.9024 | 0.3000 | | | | |
| 20 | 64.4256 | 7.7812 | 1.43700 | 95.10 | 0.0564 | FCD100 |
| 21 | −66.4512 | 1.4955 | 1.77250 | 49.63 | −0.0088 | TAF1 |
| 22 | −284.2354 | 2.0000 | | | | |
| 23 (diaphragm) | ∞ | (d23) | | | | |
| 24 | −265.9606 | 1.0004 | 1.91082 | 35.25 | −0.0017 | TAFD35L |
| 25 | 46.7659 | 3.4772 | 1.78880 | 28.43 | 0.0036 | S-NBH58 |
| 26 | 183.0515 | (d26) | | | | |
| 27 | −168.1223 | 0.9951 | 1.92286 | 20.88 | 0.0281 | E-FDS1-W |
| 28 | 139.5772 | 1.9077 | | | | |
| 29 | 3795.5444 | 4.7965 | 1.73037 | 32.23 | −0.0005 | NBFD32 |
| 30 | −32.2102 | 0.9972 | 1.45860 | 90.19 | 0.0491 | FCD10A |
| 31 | −53.9864 | (d31) | | | | |
| 32 | 36.4710 | 3.2317 | 1.49700 | 81.61 | 0.0373 | FCD1 |
| 33 | 107.8431 | 2.7588 | | | | |
| 34 | −309.7678 | 2.6343 | 1.83401 | 25.97 | 0.0059 | NBFD26 |
| 35 | −46.7658 | 0.9392 | 1.76385 | 48.49 | −0.0022 | S-LAH96 |
| 36 | 40.2049 | 15.8591 | | | | |
| 37 | 42.3222 | 8.7981 | 1.69895 | 30.05 | 0.0084 | E-FD15L |
| 38 | −30.0205 | 1.3543 | 2.05090 | 26.94 | 0.0052 | TAFD65 |
| 39 | 47.7902 | 2.0913 | | | | |
| 40 | 56.9196 | 10.5366 | 1.62205 | 41.08 | −0.0051 | S-NBM52 |
| 41 | −21.8600 | 2.0186 | 1.43700 | 95.10 | 0.0564 | FCD100 |
| 42 | 19.5536 | 11.7311 | 1.62205 | 41.08 | −0.0051 | S-NBM52 |
| 43 | −75.5552 | 2.0609 | | | | |
| 44 | −49.2463 | 1.2062 | 2.05090 | 26.94 | 0.0052 | TAFD65 |
| 45 | 21.9441 | 9.1228 | 1.83401 | 25.97 | 0.0059 | NBFD26 |
| 46 | −278.9547 | 37.8500 | | | | |
| 47 | ∞ | 2.8800 | 1.51633 | 64.14 | 0.0023 | S-BSL7 |
| 48 | ∞ | (BF) | | | | |
| Image surface | ∞ | | | | | |

[Various types of data]

| | |
|---|---|
| Zoom ratio | 3.79 |

| | Wide angle | Middle | Telephoto |
|---|---|---|---|
| Focal length | 206.00 | 500.00 | 780.00 |
| F number | 6.24 | 6.76 | 8.22 |
| Total angle of view 2ω | 11.67 | 4.78 | 3.05 |
| Image height Y | 21.63 | 21.63 | 21.63 |
| Total lens length | 353.72 | 366.42 | 373.72 |

[Variable distance data]

| | Wide angle | Middle | Telephoto |
|---|---|---|---|
| d0 | ∞ | ∞ | ∞ |
| d7 | 5.7126 | 40.5349 | 44.3312 |
| d13 | 71.8461 | 29.3437 | 2.5000 |
| d17 | 3.2211 | 6.7271 | 4.6325 |
| d23 | 23.0948 | 18.2707 | 20.4055 |
| d26 | 11.2410 | 28.3328 | 58.1868 |
| d31 | 1.7012 | 6.2987 | 6.7606 |
| BF | 1.0000 | 1.0000 | 1.0000 |
| d0 | 3300.0000 | 3300.0000 | 3300.0000 |
| d7 | 5.7126 | 40.5349 | 44.3312 |
| d13 | 71.8461 | 29.3437 | 2.5000 |
| d17 | 3.2211 | 6.7271 | 4.6325 |
| d23 | 25.2935 | 28.6623 | 41.6990 |
| d26 | 9.0422 | 17.9412 | 36.8933 |
| d31 | 1.7012 | 6.2987 | 6.7606 |
| BF | 1.0000 | 1.0000 | 1.0000 |

[Lens group data]

| Group | Starting surface | Focal length |
|---|---|---|
| G1 | 1 | 194.22 |
| G2 | 8 | −45.14 |
| G3 | 14 | 559.36 |
| G4 | 18 | 61.10 |
| G5 | 24 | −96.10 |
| G6 | 27 | 165.94 |
| G7 | 32 | −65.21 |

The following shows a list of corresponding values of the conditional expressions in each of the above examples.

| | EX1 | EX2 | EX3 | EX4 | EX5 | EX6 |
|---|---|---|---|---|---|---|
| (1) | 3.528 | 3.455 | 3.383 | 7.290 | 4.722 | 3.548 |
| (2) | 0.449 | 0.455 | 0.462 | 0.248 | 0.467 | 0.455 |
| (3) | 3.528 | 3.455 | 3.878 | 7.290 | 5.143 | 3.548 |
| (4) | 3.78 | 3.78 | 3.78 | 3.78 | 2.52 | 3.78 |
| (5) | 92.4 | 93.8 | 95.1 | 102.0 | 144.3 | 93.8 |
| (6) | 2.61 | 2.66 | 2.71 | 2.52 | 1.95 | 2.58 |
| (7) | 0.619 | 0.651 | 0.798 | 0.646 | 0.764 | 0.645 |
| (8) | 0.235 | 0.184 | 0.150 | 0.159 | 0.134 | 0.187 |
| (9) | 0.586 | 0.531 | 0.511 | 0.527 | 0.345 | 0.534 |
| (10) | 1.43 | 1.15 | 1.06 | 1.13 | 0.53 | 1.16 |
| (11) | 0.07 | 0.07 | 0.07 | 0.06 | 0.06 | 0.07 |
| (12) | −0.0051 | −0.0051 | −0.0051 | −0.0054 | −0.0055 | −0.0051 |
| (13) | 0.0564 | 0.0564 | 0.0564 | 0.0564 | 0.0373 | 0.0564 |
| (14) | 5.36 | 5.36 | 5.36 | 5.36 | 3.04 | 5.36 |
| (15) | 5.36 | 5.36 | 5.36 | 5.36 | 3.04 | 5.36 |
| (16) | 13.85 | 21.44 | 23.64 | 98.17 | 25.73 | 20.98 |
| (17) | 6.22 | 9.76 | 10.91 | 24.31 | 12.01 | 9.55 |
| (18) | 0.0090 | 0.0090 | 0.0373 | 0.0080 | 0.0088 | 0.0090 |
| (19) | 1.487 | 1.487 | 1.497 | 1.487 | 1.593 | 1.487 |
| (20) | −16.22 | −13.63 | −12.58 | −28.25 | −16.94 | −14.66 |
| (21) | −4.60 | −3.94 | −3.72 | −3.87 | −3.59 | −4.13 |
| (22) | 0.37 | 0.41 | 0.41 | 0.41 | 0.51 | 0.37 |
| | EX7 | EX8 | EX9 | EX10 | EX11 | EX12 |
| (1) | 3.427 | 3.683 | 3.175 | 4.099 | 3.459 | 3.321 |
| (2) | 0.468 | 0.471 | 0.587 | 0.473 | 0.462 | 0.605 |
| (3) | 3.427 | 3.683 | 3.175 | 4.099 | 3.459 | 3.321 |
| (4) | 3.78 | 3.79 | 3.74 | 2.52 | 3.78 | 3.74 |
| (5) | 96.4 | 97.0 | 90.7 | 146.3 | 95.1 | 93.4 |
| (6) | 2.69 | 2.23 | 2.04 | 2.01 | 2.37 | 1.95 |
| (7) | 0.638 | 0.546 | 0.644 | 0.589 | 0.650 | 0.622 |
| (8) | 0.205 | 0.204 | 0.187 | 0.170 | 0.186 | 0.208 |
| (9) | 0.595 | 0.507 | 0.422 | 0.277 | 0.479 | 0.497 |
| (10) | 1.49 | 1.05 | 0.75 | 0.41 | 0.93 | 1.01 |
| (11) | 0.07 | 0.07 | 0.07 | 0.06 | 0.07 | 0.07 |
| (12) | −0.0051 | −0.0051 | −0.0042 | −0.0055 | −0.0051 | −0.0051 |
| (13) | 0.0564 | 0.0564 | 0.0564 | 0.0177 | 0.0564 | 0.0564 |
| (14) | 5.36 | 5.36 | 5.36 | 1.20 | 5.36 | 5.36 |
| (15) | 5.36 | 5.36 | 5.36 | 1.20 | 5.36 | 5.36 |
| (16) | 19.61 | 20.27 | 16.30 | 30.58 | 25.24 | 14.41 |
| (17) | 9.18 | 9.54 | 9.57 | 14.48 | 11.65 | 8.72 |
| (18) | 0.0358 | 0.0192 | 0.008 | 0.0088 | 0.009 | 0.008 |
| (19) | 1.497 | 1.593 | 1.550 | 1.593 | 1.487 | 1.487 |
| (20) | −15.55 | −15.97 | −14.52 | −13.95 | −11.89 | −15.01 |
| (21) | −4.54 | −4.34 | −4.57 | −3.40 | −3.44 | −4.52 |
| (22) | 0.41 | 0.38 | 0.40 | 0.50 | 0.40 | 0.41 |
| | EX13 | EX14 | EX15 | EX16 | EX17 | EX18 |
| (1) | 4.285 | 4.016 | 3.829 | 3.500 | 3.527 | 4.016 |
| (2) | 0.467 | 0.467 | 0.467 | 0.462 | 0.464 | 0.478 |
| (3) | 4.285 | 4.016 | 3.829 | 3.500 | 3.527 | 4.016 |
| (4) | 3.79 | 3.79 | 3.79 | 3.78 | 4.20 | 3.79 |
| (5) | 96.2 | 96.2 | 96.2 | 95.1 | 86.1 | 98.4 |
| (6) | 1.91 | 2.04 | 2.15 | 2.35 | 2.33 | 2.05 |
| (7) | 0.599 | 0.617 | 0.611 | 0.653 | 0.664 | 0.604 |
| (8) | 0.193 | 0.207 | 0.191 | 0.183 | 0.183 | 0.187 |
| (9) | 0.413 | 0.385 | 0.417 | 0.481 | 0.473 | 0.416 |
| (10) | 0.73 | 0.65 | 0.74 | 0.94 | 0.90 | 0.74 |
| (11) | 0.06 | 0.06 | 0.06 | 0.07 | 0.07 | 0.07 |
| (12) | −0.0055 | −0.0055 | −0.0055 | −0.0051 | −0.0051 | −0.0051 |
| (13) | 0.0564 | 0.056 | 0.0491 | 0.0564 | 0.0564 | 0.0564 |
| (14) | 5.36 | 5.30 | 4.43 | 5.36 | 5.36 | 5.36 |
| (15) | 5.36 | 5.30 | 4.43 | 5.36 | 5.36 | 5.36 |
| (16) | 19.14 | 19.14 | 19.14 | 24.86 | 25.40 | 19.14 |
| (17) | 8.94 | 8.94 | 8.94 | 11.48 | 11.79 | 9.15 |
| (18) | 0.0224 | 0.008 | 0.008 | 0.021 | 0.009 | 0.008 |
| (19) | 1.571 | 1.487 | 1.487 | 1.552 | 1.487 | 1.487 |
| (20) | −17.12 | −15.73 | −15.84 | −12.09 | −12.59 | −17.28 |
| (21) | −3.99 | −3.92 | −4.14 | −3.45 | −3.57 | −4.30 |
| (22) | 0.39 | 0.40 | 0.41 | 0.40 | 0.40 | 0.39 |

### OTHER EMBODIMENTS

The technology disclosed in the present example is not limited to the description of the above-described embodiments and examples, and various modification implementations can be made. The shapes and numerical values of each part shown in the above-described numerical examples are merely examples for carrying out the present technology, and the technical scope of the present technology is not limited thereto.

The present technology can also have the following configuration.

### [Item 1]

A variable magnification imaging optical system comprising in order from an object side, a first front lens group GF1 consisting of one or two lens groups and having a positive refractive power as a whole, a second front lens group GF2 consisting of one or more lens groups and having a negative refractive power as a whole, a middle group GM consisting of one or more lens groups, and a subsequent group GR, in which the first front lens group GF1 has a first lens group G1 at a position closest to the object side, an aperture diaphragm S is disposed closer to an image side than the second front lens group GF2, the second front lens group GF2 has a lens group having a strongest negative refractive power among lens groups disposed closer to the object side than an aperture diaphragm S, distances between adjacent lens groups change during magnification change or focusing, and during magnification change from a wide-angle end to a telephoto end (in a case of focusing on an infinite distance object), a lens group having a largest negative refractive power among lens groups constituting the second front lens group GF2 moves to the image side, and the following conditional expressions are satisfied:

$$2.50 < fT / fF 1 < 11. \qquad ( 1 )$$

$$0.15 < LiT / fT < 0.7 \qquad ( 2 )$$

where:
fT: focal length of entire system at telephoto end at infinity
fF1: focal length of the first front lens group GF1 at telephoto end at infinity
LiT: length on optical axis from lens surface closest to object side at telephoto end at infinity to image surface.

### [Item 2]

The variable magnification imaging optical system according to [Item 1], in which the first lens group G1 satisfies the following conditional expression:

$$2.50 < fT / f 1 < 11. \qquad ( 3 )$$

where:
fT: focal length of entire system at telephoto end at infinity
f1: focal length of the first lens group G1.

### [Item 3]

The variable magnification imaging optical system according to [Item 1] or [Item 2], in which the following conditional expression is satisfied:

$$1. 2 < fT / fW < 7.0 \qquad ( 4 )$$

where:
fT: focal length of entire system at telephoto end at infinity
fW: focal length of entire system at wide-angle end at infinity.

### [Item 4]

The variable magnification imaging optical system according to any one of [Item 1] to [Item 3], in which the following conditional expression is satisfied:

$$60 < LiT / ( fT / fW ) < 250 \qquad ( 5 )$$

where
LiT: length on optical axis from lens surface closest to object side at telephoto end at infinity to image surface
fW: focal length of entire system at wide-angle end at infinity
fT: focal length of entire system at telephoto end at infinity.

### [Item 5]

The variable magnification imaging optical system according to any one of [Item 1] to [Item 4], in which the first lens group G1 is fixed with respect to an image surface during magnification change from a wide-angle end to a telephoto end.

### [Item 6]

The variable magnification imaging optical system according to any one of [Item 1] to [Item 5], in which the first front lens group GF1 satisfies the following conditional expression:

$$1.5 < fF 1 / Φ S 1 T < 5. \qquad ( 6 )$$

where:
fF1: focal length of the first front lens group GF1 at telephoto end at infinity
ΦS1T: axial marginal ray diameter on surface closest to object side at telephoto end at infinity.

### [Item 7]

The variable magnification imaging optical system according to any one of [Item 1] to [Item 6], in which the first front lens group GF1 satisfies the following conditional expression:

$$0.40 < Φ G 1 FrT / Φ S 1 T < 0.87 \qquad ( 7 )$$

where:
ΦG1FrT: axial marginal ray diameter on surface closest to image side in the first front lens group GF1 at telephoto end at infinity
ΦS1T: axial marginal ray diameter on surface closest to object side at telephoto end at infinity.

### [Item 8]

The variable magnification imaging optical system according to any one of [Item 1] to [Item 7], in which the following conditional expression is satisfied:

$$0.08 < LGF 1 / LrT < 0.50 \qquad ( 8 )$$

where:
LGF1: length on optical axis of the first front lens group GF1 at telephoto end at infinity
LrT: length on optical axis from lens surface closest to object side to lens surface closest to image side at telephoto end at infinity.

### [Item 9]

The variable magnification imaging optical system according to any one of [Item 1] to [Item 8], in which the first front lens group GF1 satisfies the following conditional expression:

$$0.15 < LairGF 1 / LGF 1 < 0.83 \qquad ( 9 )$$

where:
LairGF1: maximum air-space distance on optical axis in the first front lens group GF1 at telephoto end at infinity
LGF1: length on optical axis of the first front lens group GF1 at telephoto end at infinity.

### [Item 10]

The variable magnification imaging optical system according to any one of [Item 1] to [Item 9], in which a convex lens is disposed closest to the object side and a concave lens is disposed closest to the image side in the first front lens group GF1.

### [Item 11]

The variable magnification imaging optical system according to any one of [Item 1] to [Item 10], in which, in the first front lens group GF1, a convex lens is disposed closest to the object side, and the following conditional expression is satisfied:

$$0.20 < LairGF 1 / LgGf 1 < 3.5 \qquad ( 10 )$$

where:
LairGF1: maximum air-space distance on optical axis in the first front lens group GF1 at telephoto end at infinity
LgGF1: sum of thicknesses on optical axis of all lenses constituting the first front lens group GF1.

### [Item 12]

The variable magnification imaging optical system according to any one of [Item 1] to [Item 11], in which the subsequent group GR includes one or more convex lenses satisfying the following conditional expressions:

$$0.00 < ( - 0.01176 \times vdpLgr - ndpLgr + 2.2719 ) / ( {( {( - 0.01176 )}^{⋀} 2 + {( 2.2719 )}^{⋀} 2 )}^{⋀} ( 1 / 2 ) ) \qquad ( 11 )$$

$$Δ PgFpLgr < - 0.001 \qquad ( 12 )$$

where:
vdpLgr: Abbe number of convex lens included in the subsequent group GR
ndpLgr: refractive index of convex lens included in the subsequent group GR
ΔPgFpLgr: anomalous dispersion of convex lens included in the subsequent group GR.

### [Item 13]

The variable magnification imaging optical system according to any one of [Item 1] to [Item 12], in which, in the telephoto end at infinity, a lens that is disposed closer to the image side than the aperture diaphragm S, and is disposed closest to the object side among lenses in which an off-axis principal ray is incident at a higher position than an axial marginal ray incident on the lens surface on the object side is denoted by Lb, and one or more concave lenses satisfying the following conditional expression are disposed from Lb toward the image side:

$$Δ PgFnLbr > 0.009 \qquad ( 13 )$$

where:
ΔPgFnLbr: anomalous dispersion of concave lens disposed from the lens Lb toward image side.

### [Item 14]

The variable magnification imaging optical system according to any one of [Item 1] to [Item 13], in which one or more concave lenses satisfying the following conditional expression are disposed from the lens Lb toward the image side:

$$vdnLbr \times Δ PgFnLbr > 0.8 \qquad ( 14 )$$

where:
vdnLbr: Abbe number of concave lens disposed from the lens Lb toward image side
ΔPgFnLbr: anomalous dispersion of concave lens disposed from the lens Lb toward image side.

### [Item 15]

The variable magnification imaging optical system according to any one of [Item 1] to [Item 14], in which the subsequent group GR includes one or more concave lenses satisfying the following conditional expression:

$$vdnLgr \times Δ PgFnLgr > 0.8 \qquad ( 15 )$$

where:
vdnLgr: Abbe number of concave lens included in the subsequent group GR
ΔPgFnLgr: anomalous dispersion of concave lens included in the subsequent group GR.

### [Item 16]

The variable magnification imaging optical system according to any one of [Item 1] to [Item 15], in which the following conditional expression is satisfied:

$$4.5 < fT / BFT < 130 \qquad ( 16 )$$

where:
fT: focal length of entire system at telephoto end at infinity
BFT: length on optical axis from lens surface closest to image side at telephoto end at infinity to the image surface.

### [Item 17]

The variable magnification imaging optical system according to any one of [Item 1] to [Item 16], in which the following conditional expression is satisfied:

$$4. < LiT / BFT < 35. \qquad ( 17 )$$

where:
LiT: length on optical axis from lens closest to object side at telephoto end at infinity to the image surface
BFT: length on optical axis from lens surface closest to image side at telephoto end at infinity to image surface.

### [Item 18]

The variable magnification imaging optical system according to any one of [Item 1] to [Item 17], in which all convex lenses constituting the first front lens group GF1 satisfy the following conditional expression:

$$Δ PgFpGF 1 > 0. \qquad ( 18 )$$

where:
ΔPgFpGF1: anomalous dispersion of convex lens included in front lens group GF1.

### [Item 19]

The variable magnification imaging optical system according to any one of [Item 1] to [Item 18], in which all convex lenses constituting the first front lens group GF1 satisfy the following conditional expression:

$$ndpGF 1 < 1.68 \qquad ( 19 )$$

where:
ndpGF1: refractive index of convex lens included in front lens group GF1.

### [Item 20]

The variable magnification imaging optical system according to any one of [Item 1] to [Item 19], in which the following conditional expression is satisfied:

$$- 75. < fT / fF 2 < - 5. \qquad ( 20 )$$

where:
fT: focal length of entire system at telephoto end at infinity
fF2: focal length of the second front lens group GF2 at telephoto end at infinity.

### [Item 21]

The variable magnification imaging optical system according to any one of [Item 1] to [Item 20], in which the following conditional expression is satisfied:

$$- 7. < fF 1 / fF 2 < - 2. \qquad ( 21 )$$

where:
fF1: focal length of the first front lens group GF1 at telephoto end at infinity
fF2: focal length of the second front lens group GF2 at telephoto end at infinity.

### [Item 22]

The variable magnification imaging optical system according to any one of [Item 2] to [Item 21], in which the following conditional expression is satisfied:

$$0.2 < ϕ G 2 FfT / ϕ S 1 T < 0.6 \qquad ( 22 )$$

where:
ΦG2FfT: axial marginal ray diameter on surface closest to object side in the second front lens group GF2 at telephoto end at infinity
ΦS1T: axial marginal ray diameter on surface closest to object side at telephoto end at infinity.

### [Item 23]

The variable magnification imaging optical system according to any one of [Item 1] to [Item 22], in which, in a case where the first front lens group GF1 consists of two lens groups, a lens group on the image side moves toward the object side during magnification change from a wide-angle end to a telephoto end.

### [Item 24]

The variable magnification imaging optical system according to any one of [Item 1] to [Item 23], in which, in a case where the first front lens group GF1 consists of two lens groups, a lens group on the image side has a reduced distance with the first lens group G1 disposed on the object side and has an increased distance with the second front lens group GF2 disposed on the image side during magnification change from a wide-angle end to a telephoto end.

### [Item 25]

The variable magnification imaging optical system according to any one of [Item 1] to [Item 24], in which, in a case where at least one lens group of the lens groups constituting the middle group GM moves along an optical axis during focusing from an infinite distance object to a close distance object.

### [Item 26]

The variable magnification imaging optical system according to any one of [Item 1] to [Item 25], in which the variable magnification imaging optical system does not include a diffractive optical element.

### [Item 27]

The variable magnification imaging optical system according to any one of [Item 1] to [Item 26], in which all lens groups constituting the second front lens group GF2 move toward an image side during magnification change from a wide-angle end to a telephoto end.

### [Item 28]

The variable magnification imaging optical system according to any one of [Item 1] to [Item 27], in which the subsequent group GR is fixed with respect to an image surface during magnification change from a wide-angle end to a telephoto end.

It goes without saying that various modifications, combinations, sub-combinations, and changes may be conceived by those skilled in the art in accordance with design requirements or other factors, and such variations are to be included within the scope of the appended claims and their equivalents.

### DESCRIPTION OF REFERENCE NUMERALS AND SIGNS

G1: first lens group
G2: second lens group
G3: third lens group
G4: fourth lens group
G5: fifth lens group
G6: sixth lens group
G7: seventh lens group
GF1: first front lens group
GF2: second front lens group
GM: middle group
GR: subsequent group
S: aperture diaphragm
F: filter
I: image surface

What is claimed is:

1. A variable magnification imaging optical system comprising in order from an object side, a first front lens group GF1 consisting of one or two lens groups and having a positive refractive power as a whole, a second front lens group GF2 consisting of one or more lens groups and having a negative refractive power as a whole, a middle group GM consisting of one or more lens groups, and a subsequent group GR,
wherein the first front lens group GF1 has a first lens group G1 at a position closest to the object side, an aperture diaphragm S is disposed closer to an image side than the second front lens group GF2, the second front lens group GF2 has a lens group having a strongest negative refractive power among lens groups disposed closer to the object side than an aperture diaphragm S, distances between adjacent lens groups change during magnification change or focusing, and during magnification change from a wide-angle end to a telephoto end (in a case of focusing on an infinite distance object), a lens group having a largest negative refractive power among lens groups constituting the second front lens group GF2 moves to the image side, and the following conditional expressions are satisfied:
$$2.5 < fT / fF 1 < 11. \qquad ( 1 )$$
$$0.15 < LiT / fT < 0.7 \qquad ( 2 )$$
where:
fT: focal length of entire system at telephoto end at infinity
fF1: focal length of the first front lens group GF1 at telephoto end at infinity
LiT: length on optical axis from a lens surface closest to object side at telephoto end at infinity to image surface.

2. The variable magnification imaging optical system according to claim 1, wherein the first lens group G1 satisfies the following conditional expression:
$$2.5 < fT / f 1 < 11. \qquad ( 3 )$$
where:
fT: focal length of entire system at telephoto end at infinity
f1: focal length of the first lens group G1.

3. The variable magnification imaging optical system according to claim 1,
wherein the following conditional expression is satisfied:
$$1.2 < fT / fW < 7. \qquad ( 4 )$$
where:
fT: focal length of entire system at telephoto end at infinity
fW: focal length of entire system at wide-angle end at infinity.

4. The variable magnification imaging optical system according to claim 1,
wherein the following conditional expression is satisfied:
$$60 < LIT / ( fT / fW ) < 250 \qquad ( 5 )$$
LiT: length on optical axis from lens surface closest to object side at telephoto end at infinity to image surface
where:
fW: focal length of entire system at wide-angle end at infinity
fT: focal length of entire system at telephoto end at infinity.

5. The variable magnification imaging optical system according to claim 1, wherein the first lens group G1 is fixed with respect to the image surface during magnification change from the wide-angle end to the telephoto end.

6. The variable magnification imaging optical system according to claim 1, wherein the first front lens group GF1 satisfies the following conditional expression:
$$1.5 < fF 1 / ϕ S 1 t < 5. \qquad ( 6 )$$
where:
fF1: focal length of the first front lens group GF1 at telephoto end at infinity
ΦS1T: axial marginal ray diameter on a surface closest to object side at telephoto end at infinity.

7. The variable magnification imaging optical system according to claim 1, wherein the first front lens group GF1 satisfies the following conditional expression:
$$0.4 < ϕ G 1 FrT / ϕ S 1 T < 0.87 \qquad ( 7 )$$
where:
ΦG1FrT: axial marginal ray diameter on a surface closest to image side in the first front lens group GF1 at telephoto end at infinity
ΦS1T: axial marginal ray diameter on a surface closest to object side at telephoto end at infinity.

8. The variable magnification imaging optical system according to claim 1, wherein the first front lens group GF1 satisfies the following conditional expression:
$$0.08 < LGF 1 / LrT < 0.5 \qquad ( 8 )$$
where:
LGF1: length on optical axis of the first front lens group GF1 at telephoto end at infinity
LrT: length on optical axis from lens surface closest to object side to a lens surface closest to image side at telephoto end at infinity.

9. The variable magnification imaging optical system according to claim 1, wherein the first front lens group GF1 satisfies the following conditional expression:
$$0.15 < LairGF 1 / LGF 1 < 0.83 \qquad ( 9 )$$
where:
LairGF1: maximum air-space distance on optical axis in the first front lens group GF1 at telephoto end at infinity
LGF1: length on optical axis of the first front lens group GF1 at telephoto end at infinity.

10. The variable magnification imaging optical system according to claim 1, wherein a convex lens is disposed closest to the object side and a concave lens is disposed closest to the image side in the first front lens group GF1.

11. The variable magnification imaging optical system according to claim 1, wherein, in the first front lens group GF1, a convex lens is disposed closest to the object side, and the following conditional expression is satisfied:
$$0.2 < LairGF 1 / LgGF 1 < 3.5 \qquad ( 10 )$$
where:
LairGF1: maximum air-space distance on optical axis in the first front lens group GF1 at telephoto end at infinity
LgGF1: sum of thicknesses on optical axis of all lenses constituting the first front lens group GF1.

12. The variable magnification imaging optical system according to claim 1, wherein the subsequent group GR includes one or more convex lenses satisfying the following conditional expressions:
$$0. < ( - 0.01176 \times vdpLgr \cdot ndpLgr + 2.2719 ) / ( {( {( - 0.01176 )}^{⋀} 2 + {( 2.2719 )}^{⋀} 2 )}^{⋀} ( 1 / 2 ) ) \qquad ( 11 )$$
$$Δ PgFpLgr < - 0.001 \qquad ( 12 )$$
where:
vdpLgr: Abbe number of convex lens included in the subsequent group GR
ndpLgr: refractive index of convex lens included in the subsequent group GR
ΔPgFpLgr: anomalous dispersion of convex lens included in the subsequent group GR.

13. The variable magnification imaging optical system according to claim 1, wherein, in the telephoto end at infinity, a lens that is disposed closer to the image side than the aperture diaphragm S, and is disposed closest to the object side among lenses in which an off-axis principal ray is incident at a higher position than an axial marginal ray incident on the lens surface on the object side is denoted by Lb, and one or more concave lenses satisfying the following conditional expression are disposed from Lb toward the image side:
$$Δ PgFnLbr < - 0.009 \qquad ( 13 )$$
where:
ΔPgFnLbr: anomalous dispersion of concave lens disposed from the lens Lb toward image side.

14. The variable magnification imaging optical system according to claim 1, wherein one or more concave lenses satisfying the following conditional expression are disposed from the lens Lb toward the image side:
$$vdnLbr \times Δ PgFnLbr > 0.8 \qquad ( 14 )$$
where:
vdnLbr: Abbe number of concave lens disposed from the lens Lb toward image side
ΔPgFnLbr: anomalous dispersion of concave lens disposed from the lens Lb toward image side.

15. The variable magnification imaging optical system according to claim 1, wherein the subsequent group GR includes one or more concave lenses satisfying the following conditional expression:
$$vdnLgr \times Δ PgFnLgr > 0.8 \qquad ( 15 )$$
where:
vdnLgr: Abbe number of concave lens included in the subsequent group GR
ΔPgFnLgr: anomalous dispersion of concave lens included in the subsequent group GR.

16. The variable magnification imaging optical system according to claim 1, wherein the following conditional expression is satisfied:
$$4.5 < fT / BFT < 130 \qquad ( 16 )$$
where:
fT: focal length of entire system at telephoto end at infinity
BFT: length on optical axis from a lens surface closest to image side at telephoto end at infinity to the image surface.

17. The variable magnification imaging optical system according to claim 1, wherein the following conditional expression is satisfied:
$$4. < LiT / BFT < 35. \qquad ( 17 )$$
where:
LiT: length on optical axis from lens closest to object side at telephoto end at infinity to the image surface
BFT: length on optical axis from lens surface closest to image side at telephoto end at infinity to the image surface.

18. The variable magnification imaging optical system according to claim 1, wherein all convex lenses constituting the first front lens group GF1 satisfy the following conditional expression:
$$Δ PgFpGF 1 > 0. \qquad ( 18 )$$
where:
ΔPgFpGF1: anomalous dispersion of convex lens included in front lens group GF1.

19. The variable magnification imaging optical system according to claim 1, wherein all convex lenses constituting the first front lens group GF1 satisfy the following conditional expression:
$$ndpGF 1 < 1.68 \qquad ( 19 )$$
where:
ndpGF1: refractive index of convex lens included in front lens group GF1.

20. The variable magnification imaging optical system according to claim 1, wherein the following conditional expression is satisfied:
$$- 75. < fT / fF 2 < - 5. \qquad ( 20 )$$
where:
fT: focal length of entire system at telephoto end at infinity
fF2: focal length of the second front lens group GF2 at telephoto end at infinity.

21. The variable magnification imaging optical system according to claim 1, wherein the following conditional expression is satisfied:
$$- 7. < fF 1 / fF 2 < - 2. \qquad ( 21 )$$
where:
fF1: focal length of the first front lens group GF1 at telephoto end at infinity
fF2: focal length of the second front lens group GF2 at telephoto end at infinity.

22. The variable magnification imaging optical system according to claim 2, wherein the following conditional expression is satisfied:
$$0.2 < ϕ G 2 FfT / ϕ S 1 T < 0.6 \qquad ( 22 )$$
where:
ΦG2FfT: axial marginal ray diameter on a surface closest to object side in the second front lens group GF2 at telephoto end at infinity
ΦS1T: axial marginal ray diameter on a surface closest to object side at telephoto end at infinity.

23. The variable magnification imaging optical system according to claim 1, wherein, in a case where the first front lens group GF1 consists of two lens groups, a lens group on the image side moves toward the object side during magnification change from a wide-angle end to a telephoto end.

24. The variable magnification imaging optical system according to claim 1, wherein, in a case where the first front lens group GF1 consists of two lens groups, a lens group on the image side has a reduced distance with the first lens group G1 disposed on the object side and has an increased distance with the second front lens group GF2 disposed on the image side during magnification change from a wide-angle end to a telephoto end.

25. The variable magnification imaging optical system according to claim 1, wherein, in a case where at least one lens group of the lens groups constituting the middle group GM moves along an optical axis during focusing from an infinite distance object to a close distance object.

26. The variable magnification imaging optical system according to claim 1, wherein the variable magnification imaging optical system does not include a diffractive optical element.

27. The variable magnification imaging optical system according to claim 1, wherein all lens groups constituting the second front lens group GF2 move toward an image side during magnification change from a wide-angle end to a telephoto end.

28. The variable magnification imaging optical system according to claim 1, wherein the subsequent group GR is fixed with respect to an image surface during magnification change from a wide-angle end to a telephoto end.
